(19) United States
(12) Patent Application Publication
(10) Pub. No.: US 2008/0249751 A1
(43) Pub. Date: Oct. 9, 2008

(54) Method and Apparatus for Modeling Atherosclerosis

(75) Inventors: Kapil GADKAR, Mountain View, CA (US); Ananth Kadambi, San Mateo, CA (US); Kortney Leabourne, Redwood City, CA (US); Arthur Lo, San Francisco, CA (US); Thomas S. Paterson, Redondo Beach, CA (US); Lynn Powell, San Mateo, CA (US)

Correspondence Address: ENTELOS, INC.;c/o Law Offices of Karen E. Flick, P.O. Box 515, El Granada, CA, 94018-0515, US

(73) Assignee: Entelos, Inc.

(21) Appl. No.: 11/875,809

(22) Filed: Oct. 19, 2007

Related U.S. Application Data
(60) Provisional application No. 60/853,280, filed on Oct. 19, 2006.

(51) Int. Cl. G06F 17/10; G06G 7/60

(52) U.S. Cl. 703/2; 703/11

(57) ABSTRACT

The invention encompasses novel computer models of atherosclerosis and systems for predicting development and progression of atherosclerosis as well as associated cardiovascular risk. In particular, the computer model of atherosclerosis comprises a) a cholesterol metabolism module; b) an atherogenesis module; and c) a plaque stability module. The computer model optionally further comprises a cardiovascular risk module.

### CROSS REFERENCE TO RELATED APPLICATIONS

This application claims the benefit of U.S. provisional patent application No. 60/853,280, filed 19 Oct. 2006, incorporated herein by reference in its entirety.

### I. INTRODUCTION

1. Field of the Invention

The present invention relates generally to the field of computer simulation of atherosclerosis and evaluation of the associated cardiovascular risk.

2. Background of the Invention

Cardiovascular disease, principally heart disease and stroke, kills approximately one million Americans each year, making it the number one killer in the United States. Elevated cholesterol levels in the blood have long been recognized as a risk factor and precursor for a wide range of health problems. Cardiovascular disease includes conditions that lead to narrowing or blockage of the heart, arteries, and veins. Atherosclerosis, often described as a hardening of the arteries, occurs when the normal lining of the arteries deteriorates, the walls of arteries thicken, and deposits of fat and plaque build up within the arteries, causing narrowing (or even blockage). Hypertension, or high blood pressure, results from narrowing of vessels due to similar deposits, which reduces the blood supply to all areas of the body, and causes the heart to work harder to pump the same amount of blood. Inadequate oxygen flow to the brain causes stroke.

Environmental pollution, daily stress, and lifestyle behaviors can all contribute to cardiovascular disease, as do a number of health-related behaviors, including tobacco use, lack of physical activity, and poor nutrition. Traditional treatment approaches include medication and surgery, and many scientific studies show a positive effect from changes in diet and lifestyle. Thus, optimal treatment regimens can be complex.

Cardiovascular disease is the leading killer in the developed world, with U.S., deaths from heart disease and stroke accounting for 35% of annual mortality. Cholesterol-lowering drugs are one of the most successful therapies in the world, generating over $27B in 2005 alone. While it is clear that lowering “bad” cholesterol (LDL, low-density lipoproteins) can help prevent a host of serious cardiovascular events and raising “good” cholesterol levels (HDL, high-density lipoproteins) correlates with improved cardiac health, cholesterol levels alone are not the only important factor determining cardiovascular risk. Thus, it is important to understand the links between high cholesterol, increased build-up of fatty deposits (plaque) in the arteries, and heart disease so that treatments can be optimized to specific patients.

### II. SUMMARY OF THE INVENTION

One aspect of the invention provides computer models of atherosclerosis comprising a) a cholesterol metabolism module; b) an atherogenesis module; and c) a plaque stability module. Optionally, the computer model can further comprise a cardiovascular risk module. In a preferred implementation, the cholesterol metabolism module comprises a representation of apoB-100 and apoA-I particles. In another preferred implementation, the atherogenesis module comprises a representation of influx of cholesterol into a vascular intima. Preferably, the representation of influx of cholesterol is a representation of diffusion of apoB-100 particles into the intima. The representation of diffusion of apoB-100 particles into the intima can comprise a representation of endothelial barrier function. Alternatively, or in addition, the representation of diffusion of apoB-100 particles into the intima can comprise a representation of retention of apoB-100 particles by extracellular matrix (ECM) proteoglycans or can comprise a differential rate of diffusion for apoB-100 particles of different size.

In another preferred implementation, the atherogenesis module comprises a representation of processing of cholesterol in a vascular intima, which itself can comprise a representation of deposition of cholesterol in extracellular matrix or uptake of apoB-100 particles by macrophages or foam cells. In yet another implementation, the atherogenesis module comprises a representation of efflux of cholesterol from a vascular intima, which can comprise a representation of cholesterol incorporation into apoA-I particles in the intima, which itself can comprise a representation of an effect of free cholesterol in the membranes of smooth muscle cell and/or a representation of an effect of free cholesterol in the membranes of macrophage and/or foam cells. Optionally, the representation of efflux of cholesterol from the intima can comprise a representation of macrophage and/or foam cell migration from the intima, which can comprise a representation of impairment of migration due to cholesterol loading of cells. In yet another preferred implementation, the atherogenesis module comprises a representation of deposition of cholesterol in the intima, which optionally can comprise a representation of apoptosis of a cell type selected from the group consisting of foam cells, macrophages and smooth muscle cells.

In certain implementations of the computer model, the representation of the plaque comprises a representation of a plaque cap and a plaque shoulder. In another implementation of the model, the plaque stability module further comprises a representation of lipid influx and a representation of lipid efflux, which optionally can comprise a representation of decreased lipid efflux as a function of size of the plaque cap and plaque shoulder. More preferably, the atherogenesis module further comprises a representation of apoptosis of a population of cells, such as macrophages and foam cells in the intima. Preferably, the representation of apoptosis of a population of cells comprises a representation of deposition to the lipid core of lipid resident in the population of cells prior to apoptosis. Alternatively, the representation of apoptosis of a population of cells can comprise a representation of release of inflammatory cytokines into the intima. Preferably, this representation of apoptosis of a population of cells further comprises a representation of apoptosis of smooth muscle cells as a function of the release of inflammatory cytokines.

In another preferred implementation, the atherogenesis module comprises a representation of smooth muscle cells. Preferably, the representation of smooth muscle cells comprises a representation of a thickness of the intima, wherein the thickness is responsive to a measure of inflammation that may be a function of macrophage and lipid density in the intima. In another implementation, the plaque stability module comprises a representation of plaque rupture and/or a representation of blood vessel occlusion by a plaque.

Another aspect of the invention provides systems for simulating atherosclerosis comprising: a) a computer-executable data editor, capable of accepting data describing a subject; b) a computer-executable integrator, capable of executing a computer model of atherosclerosis with the data to generate a set of outputs describing the result of the simulation of atherosclerosis; and c) a computer-executable report generator capable of reporting the set of outputs. The computer model comprises: i) a cholesterol metabolism module; ii) an atherogenesis module; and iii) a plaque stability module. In a preferred implementation, the computer-executable data editor further is capable of accepting a set of parameters describing a virtual patient. In yet another preferred implementation, the computer-executable integrator further is capable of executing the computer model with the set of parameters describing the subject. Preferably, the computer-executable data editor further is capable of accepting a virtual protocol and the computer-executable integrator is capable of executing the computer model with the virtual protocol.

Yet another aspect of the invention provides systems comprising: a) a processor including computer-readable instructions stored thereon that, upon execution by a processor, cause the processor to simulate atherosclerosis; b) a first user terminal, the first user terminal operable to receive a user input specifying one or more parameters associated with one or more mathematical representations defined by the computer readable instructions; and c) a second user terminal, the second user terminal operable to provide the set of outputs to a second user. The computer readable instructions comprise: i) a mathematical representation of one or more biological processes associated with cholesterol metabolism, wherein the one or more biological processes comprises synthesis, catabolism or remodeling of apoB-100 particles; ii) a mathematical representation of one or more biological processes associated with atherogenesis, wherein the one or more biological processes comprises a biological process selected from the group consisting of influx of cholesterol into an intima, processing of cholesterol within the intima, and efflux of cholesterol out of the intima; iii) a mathematical representation of one or more biological processes associated with plaque progression, wherein the one of more biological processes comprises a biological process selected from the group consisting of dimensions of a cap and shoulder of the plaque, influx of cholesterol into the intima, processing of cholesterol within the intima, and efflux of cholesterol out of the intima; iv) defining a set of mathematical relationships between the representations of biological processes associated with cholesterol metabolism, atherogenesis and plaque progression; and v) applying a virtual protocol to the set of mathematical relationships to generate a set of outputs. The first user may be the same as or different than the second user.

### III. BRIEF DESCRIPTION OF THE DRAWINGS

The skilled artisan will understand that the drawings, described below, are for illustration purposes only. The drawings are not intended to limit the scope of the present teaching in any way.

FIG. 1 provides an overview of the modules that can be utilized in designing a computer model of atherosclerosis.

FIG. 2 provides an Summary Diagram illustrating an overview of the cholesterol metabolism module.

FIG. 3 provides a Summary Diagram illustrating an overview of the atherogenesis module.

FIG. 4 provides an Effect Diagram representing apoB-100 particle dynamics.

FIGS. 5A-5C depict the effect of various enzymatic activity on the flux of lipids between the various particles and how changes in lipid content affect the reclassification of these particles.

FIG. 6 provides an Effect Diagram representing HDL particle dynamics.

FIG. 7A provides an Effect Diagram depicting VLDL1 and VLDL2 particle remodeling. FIG. 7B provides an Effect Diagram depicting IDL particle remodeling. FIG. 7C provides an Effect Diagram depicting LDL-L and LDL-S particle remodeling.

FIGS. 8A and 8B illustrate exemplary embodiments of lipid molecule domains in hepatic tissue and peripheral tissue depicted in FIG. 3. FIG. 8A provides an Effect Diagram depicting hepatic lipid stores. FIG. 8B provides an Effect Diagram depicting peripheral lipid stores.

FIG. 9 provides an Effect Diagram depicting the effects of apoB-100 and HDL particle synthesis and catabolism on cholesterol ester and triglycerides stores.

FIGS. 10A-10D illustrate exemplary embodiments depicting the affect of hepatic and peripheral enzymes and receptors on the delipidation of apoB-100 particles and HDL particles. FIG. 10A provides an Effect Diagram depicting the effect of certain hepatic and peripheral enzymes and receptors on delipidation of apoB-100 and HDL particles. FIG. 10B provides an Effect Diagram the activity of hepatic lipase (HL) and lipoprotein lipase (LPL) and their effect on lipid flux. FIG. 10C provides an Effect Diagram the activity of scavenger receptor class B type I (SRB1 or SR-B1) and its effect on lipid flux. FIG. 10D provides an Effect Diagram depicting the effect of low density lipoprotein receptor (LDLr) activity.

FIG. 11A provides an Effect Diagram depicting HDL particle remodeling. FIG. 11B provides an Effect Diagram depicting net enzyme activity in HDL2 and HDL3 particles. FIG. 11C provides an Effect Diagram depicting net enzyme activity in HDL1 particles.

FIGS. 12A and 12B illustrate exemplary embodiments depicting cholesterol ester transfer protein activity on the lipid composition of HDL and apoB-100 particles. FIG. 12A provides an Effect Diagram depicting CETP activity in HDL1 particles. FIG. 12B provides and Effect Diagram depicting CETP activity in HDL2 particles. FIG. 12C provides and Effect Diagram depicting CETP activity in HDL3 particles.

FIGS. 13A and 13B illustrate exemplary embodiments depicting additional biological processes that can affect the synthesis, catabolism, and lipid composition of apoB-100 particles and HDL particles. FIG. 13A provides an exemplary Effect Diagram illustrating characteristics related to monitoring the composition of HDL particles. FIG. 13B provides an Effect Diagram illustrating various calculations that can be mad relating to HDL particles. FIG. 13C provides an Effect Diagram illustrating modifications that can occur to existing HDL and LDL particles that can affect cholesterol metabolism.

FIG. 14 illustrates an exemplary embodiment of a module depicting dietary cholesterol transport.

FIG. 15 illustrates an exemplary embodiment of a module depicting various clinical measures used to provide data for the biological processes depicted in the modules.

FIGS. 16A and 16B provides an exemplary Effect Diagram illustrating the effects of various therapies on cholesterol metabolism.

FIG. 17 illustrates the “mass balance” of plaque formation and growth.

FIG. 18 provides an exemplary Effect Diagram illustrating cholesterol flux in a blood vessel.

FIG. 19 provides an exemplary Effect Diagram illustrating apoB-100 (LDL) penetration, modification and retention by the blood vessel environment.

FIG. 20 provides an exemplary Effect Diagram illustrating the effect of serum amyloid A on apoA-I particles.

FIGS. 21A and 21B provide an exemplary Effect Diagram illustrating plaque cholesterol efflux.

FIG. 22 provides an exemplary Effect Diagram illustrating various biological processes relating to early-stage foam cell lipid processing.

FIG. 23 provides an exemplary Effect Diagram illustrating various biological processes relating to late-stage foam cell lipid processing.

FIG. 24 provides an exemplary Effect Diagram illustrating various biological processes relating to macrophage lipid processing.

FIG. 25A illustrates one implementation representing macrophage and foam cell life cycles in the plaque. FIG. 25B illustrates one implementation representing macrophage and foam cell recruitment and apoptosis.

FIG. 26 provides and exemplary Effect Diagram illustrating macrophage and foam cell reclassification, in which macrophages transition to early-stage foam cells which transition to late-stage foam cells and the reverse.

FIG. 27 provides an exemplary Effect Diagram describing macrophage reclassification and migration rate calculations.

FIG. 28 provides an exemplary Effect Diagram illustrating various biological processes relating to smooth muscle cell (SMC) lipid processing.

FIG. 29 provides an Effect Diagram illustrating a representation of effector cell calculations.

FIG. 30 provides a diagrammatic illustration of an atherosclerotic plaque, with a lipid core, cap and shoulder.

FIG. 31 provides an exemplary Effect Diagram describing biological processes associated with smooth muscle cell life cycle in the shoulder and cap of a atherosclerotic plaque.

FIG. 32 provides an Effect Diagram Illustrating the interactions that can lead to calculation of a tissue-averaged inflammation index dependent upon macrophage density and extracellular cholesterol content.

FIG. 33 provides an exemplary effect diagram illustrating biological processes associated with T-cell and endothelial cell dynamics.

FIG. 34 provides and exemplary Effect Diagram of extracellular matrix (ECM) synthesis and degradation in both shoulder and cap.

FIG. 35A provides exemplary calculations of average inflammatory mediator concentrations. FIG. 35B provides an exemplary calculations of the effects of the smooth muscle cell population and extracellular matrix on inflammation.

FIG. 36 provides an exemplary illustration of shoulder inflammatory mediator pre-processing, in which equilibrium values for the per-cell production rates of each inflammatory mediators in the plaque shoulder are calculated.

FIG. 37 provides exemplary diagrams illustrating shoulder inflammation switches.

FIGS. 38A and 38B provide exemplary effect diagrams describing inflammatory mediator production in a plaque shoulder.

FIGS. 39A and 39B illustrate regulator structure in a plaque shoulder.

FIG. 40A provides an exemplary illustration of inflammatory mediator pre-processing, in which a lumped value for inflammatory mediators is calculated. FIG. 40B provides an Effect Diagram illustrating a correlation between a lumped mediator concentration and individual regulator concentrations in an atherosclerotic plaque.

FIG. 41 provides exemplary diagrams illustrating inflammation switches in the cap of a plaque.

FIGS. 42A and 42B provide exemplary effect diagrams describing inflammatory mediator production in the cap of a plaque.

FIGS. 43A and 43B illustrate regulator structure in a plaque cap. FIG. 43C illustrates additional regulators that may be included in the model of atherosclerosis.

FIG. 44 provides an exemplary illustration of cap inflammatory mediator pre-processing.

FIG. 45 provides a Summary Diagram illustrating an overview of the plaque stability module and cardiovascular risk module.

FIG. 46 provides an overview of various characteristics and pathways that can influence plaque volume.

FIG. 47 provides an exemplary Effect Diagram illustrating calculations that describe plaque geometry and IMT.

FIG. 48 illustrates the derivation of the relationship of the plaque instability index (PII) to a hazard function.

FIG. 49 provides a graphical comparison of the PII as a function of time for a reference virtual patient having two or three risk factors for atherosclerosis in the untreated state and treated with statin therapy.

FIG. 50 illustrates the behavior of a single subclass of lipoprotein particles within one implementation of the invention.

FIGS. 51A-51H illustrate different configurations of vector diagrams of net TG and CE fluxes.

FIG. 52A illustrates the apoB-100 particle composition in a reference virtual patient.

FIG. 52B illustrates the effect of the therapeutic agent, atorvastatin, on the apoB-100 particle composition in a reference virtual patient.

FIG. 52C illustrates the apoB-100 particle composition in a Type IIb dyslipidemic virtual patient.

FIG. 52D illustrates the effect of the therapeutic agent, atorvastatin, on the apoB-100 particle composition in a Type IIb dyslipidemic virtual patient.

FIG. 53A illustrates the HDL particle composition in a reference virtual patient;

FIG. 53B illustrates the effect of the therapeutic agent, atorvastatin, on the HDL particle composition in a reference virtual patient.

FIG. 53C illustrates the HDL particle composition in a Type IIb dyslipidemic virtual patient.

FIG. 53D illustrates the effect of the therapeutic agent, atorvastatin, on the HDL particle composition in a Type IIb dyslipidemic virtual patient.

FIGS. 54A-54B illustrate the effect of the therapeutic agent, atorvastatin, on plasma lipids in a reference virtual patient.

FIGS. 54C-54D illustrate the effect of the therapeutic agent, atorvastatin, on plasma lipids in a Type IIb dyslipidemic virtual patient.

### IV. DETAILED DESCRIPTION

### A. Overview

The invention encompasses novel computer models of atherosclerosis and systems for predicting development and progression of atherosclerosis as well as associated cardiovascular risk. In particular, the computer model of atherosclerosis comprises a) a cholesterol metabolism module; b) an atherogenesis module; and c) a plaque stability module. The computer model optionally further comprises a cardiovascular risk module.

### B. Definitions

As used herein, a “biological system” can include, for example, a collection of cells such as a cell culture, an organ, a tissue, a multi-cellular organism such as an individual human patient, a subset of cells of a multi-cellular organism, or a population of multi-cellular organisms such as a group of human patients or the general human population as a whole. A biological system can also include, for example, a multi-tissue system such as the nervous system, immune system, or cardiovascular system.

The term “biological component” refers to a portion of a biological system. A biological component that is part of a biological system can include, for example, an extra-cellular constituent, a cellular constituent, an intra-cellular constituent, or a combination of them. Examples of suitable biological components, include, but are not limited to, metabolites, DNA, RNA, proteins, surface and intracellular receptors, enzymes, hormones, cells, organs, tissues, portions of cells, tissues, or organs, subcellular organelles, chemically reactive molecules like H⁺, superoxides, ATP, as well as combinations or aggregate representations of these types of biological variables. In addition, biological components can include therapeutic agents such as an HMG-CoA reductase inhibitor, a CETP inhibitor, or a cholesterol absorption inhibitor.

The term “biological process” is used herein to mean an interaction or series of interactions between biological components. Examples of suitable biological processes, include, but are not limited to, activation, apoptosis or recruitment of certain cells (such as macrophages), inflammation, cytokine production, and the like. The term “biological process” can also include a process comprising one or more therapeutic agents, for example an HMG-CoA reductase inhibitor. Each biological variable of the biological process can be influenced, for example, by at least one other biological variable in the biological process by some biological mechanism, which need not be specified or even understood.

The term “parameter” is used herein to mean a value that characterizes the interaction between two or more biological components. Examples of parameters include affinity constants, Kₘ, K_{d}, k_{cat}, half life, or net flux of cells, such macrophages, into particular tissues.

The term “variable,” as used herein refers to a value that characterizes a biological component. Examples of variables include the total number of foam cells, the number of apoptosing macrophages, and the concentration of a cytokine, such as IL-2 or IFN-γ

The term “phenotype” is used herein to mean the result of the occurrence of a series of biological processes. As the biological processes change relative to each other, the phenotype also undergoes changes. One measurement of a phenotype is the level of activity of variables, parameters, and/or biological processes at a specified time and under specified experimental or environmental conditions.

A phenotype can include, for example, the state of an individual cell, an organ, a tissue, and/or a multi-cellular organism. Organisms useful in the methods and models disclosed herein include animals. The term “animal” as used herein includes mammals, such as humans. A phenotype can also include, but is not limited to, behavior of the system as a whole, e.g. the rate of progression an atherosclerotic plaque. The conditions defined by a phenotype can be imposed experimentally, or can be conditions present in a patient type. For example a normal phenotype can include a certain amount of inflammatory cytokines and number of foam cells in a blood vessel. In another example, a disease phenotype can include increased amounts of inflammatory cytokines, increased numbers of foam cells in a blood vessel or a lipid core, plaque, shoulder or cap of a particular size. In yet another example, the phenotype can include the amounts of deposited lipid in a blood vessel for a patient being treated with one or more of the therapeutic agents.

The term “simulation” is used herein to mean the numerical or analytical integration of a mathematical model. For example, simulation can mean the numerical integration of the mathematical model of the phenotype defined by the equation, i.e., dx/dt=f(x,p,t).

The term “biological characteristic” is used herein to refer to a trait, quality, or property of a particular phenotype of a biological system. For example, biological characteristics of skin sensitive to a chemical include clinical signs and diagnostic criteria associated with the sensitized skin. The biological characteristics of a biological system can be measurements of biological variables, parameters, and/or processes. Suitable examples of biological characteristics associated with sensitized skin include, but are not limited to, measurements of total lymph node cellularity, amount and activation of T cells, and concentration of certain inflammatory cytokines.

The term “computer-readable medium” is used herein to include any medium which is capable of storing or encoding a sequence of instructions for performing the methods described herein and can include, but not limited to, optical and/or magnetic storage devices and/or disks, and carrier wave signals.

### C. Methods of Developing Models of Atherosclerosis

The present invention provides a mathematical model of atherosclerosis as part of an integrated in silico/experimental approach to the assessment of cardiovascular risk The exemplified computer model of atherosclerosis is a large-scale nonlinear ordinary differential equation-based representation of the key biological mechanisms involved in the cholesterol metabolism, atherogenesis and stability of atherosclerotic plaques. The computer model is capable of simulating the following sequence of events: (1) cholesterol metabolism; (2) plaque formation, growth and regression; (3) plaque stability and rupture; and (4) the resulting cardiovascular risk in a patient.

A computer model can be designed to model one or more biological processes or functions. The computer model can be built using a “top-down” approach that begins by defining a general set of behaviors indicative of a biological condition, e.g. development of an atherosclerotic plaque. The behaviors are then used as constraints on the system and a set of nested subsystems are developed to define the next level of underlying detail. For example, given a behavior such as lipid deposition in the intima of a blood vessel, the specific mechanisms inducing the behavior can each be modeled in turn, yielding a set of subsystems, which can themselves be deconstructed and modeled in detail. The control and context of these subsystems is, therefore, already defined by the behaviors that characterize the dynamics of the system as a whole. The deconstruction process continues modeling more and more biology, from the top down, until there is enough detail to replicate a given biological behavior. Ideally, the model is capable of modeling biological processes that can be manipulated by a drug or other therapeutic agent.

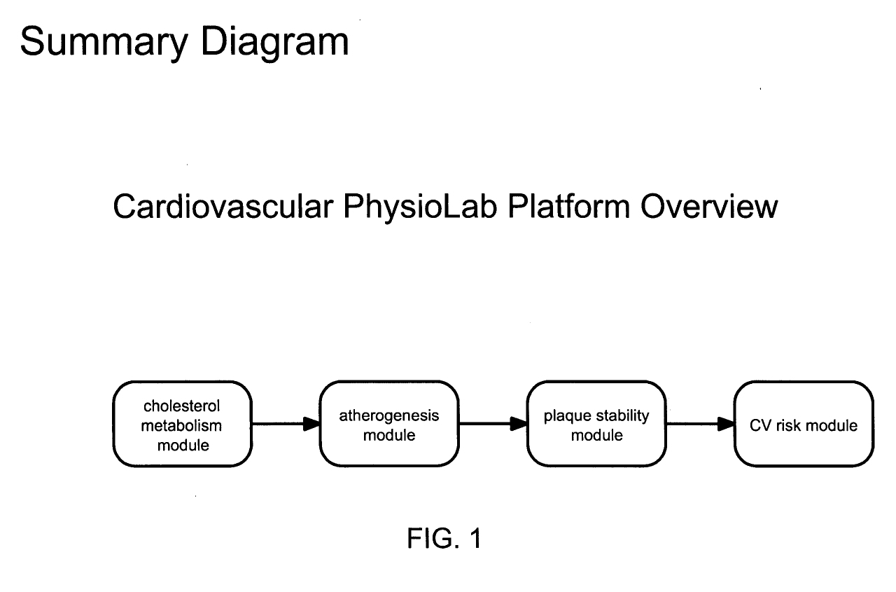

The methods used to develop computer models of atherosclerosis typically begin by identifying one or more biological processes associated with cholesterol metabolism and one or more biological processes associated with atherogenesis. The identification of biological processes associated with cholesterol metabolism or atherogenesis can be informed by data relating to a metabolic or vascular system or any portion thereof. Optionally, the method can also comprise the step of identifying one or biological processes associated with stability of an atherosclerotic plaque. The method next comprises the step of mathematically representing each identified biological process. The biological processes can be mathematically represented in any of a variety of manners. Typically, the biological process is defined by the equation, i.e., dx/dt=f(x,p,t), as described below. The representations of biological processes associated with cholesterol metabolism and atherogenesis are combined, thus forming predictive models of atherosclerosis. FIG. 1 provides an overview of the modules that can be utilized in designing a computer model of atherosclerosis.

In a preferred implementation of the invention, identifying a biological process associated with cholesterol metabolism comprises identifying a biological process related to apoB-100 particles and identifying a biological process related to apoA-I particles. The biological process related to apoB-100 particles can comprise apoB-100 particle remodeling, hepatic lipid stores, or enzymatic activities, e.g. CETP activity. The biological process related to apoA-I particles can comprise HDL particle remodeling or peripheral lipid stores.

In another preferred implementation, identifying a biological process associated with cholesterol metabolism comprises identifying a biological process related to flux of cholesterol into and/or out of a vascular intima and identifying a biological process associated with the processing of cholesterol in a vascular intima.

Once one or more biological processes are identified in the context of the methods of the invention, each biological process is mathematically represented. For example, the computer model can represent a first biological process using a first mathematical relation and a second biological process using a second mathematical relation. A mathematical relation typically includes one or more variables, the behavior (e.g., time evolution) of which can be simulated by the computer model. More particularly, mathematical relations of the computer model can define interactions among variables describing levels or activities of various biological components of the biological system as well as levels or activities of combinations or aggregate representations of the various biological components. In addition, variables can represent various stimuli that can be applied to the physiological system. The mathematical model(s) of the computer-executable software code represents the dynamic biological processes related to atherosclerosis. The form of the mathematical equations employed may include, for example, partial differential equations, stochastic differential equations, differential algebraic equations, difference equations, cellular automata, coupled maps, equations of networks of Boolean or fuzzy logical networks, etc.

In some implementations, the mathematical equations used in the model are ordinary differential equations of the form:

dx/dt=f(x,p,t)

where x is an N dimensional vector whose elements represent the biological variables of the system, t is time, dx/dt is the rate of change of x, p is an M dimensional set of system parameters, and f is a function that represents the complex interactions among biological variables. In one implementation, the parameters are used to represent intrinsic characteristics (e.g., genetic factors) as well as external characteristics (e.g., environmental factors) for a biological system.

In some implementations, the phenotype can be mathematically defined by the values of x and p at a given time. Once a phenotype of the model is mathematically specified, numerical integration of the above equation using a computer determines, for example, the time evolution of the biological variables x(t) and hence the evolution of the phenotype over time.

The representation of the biological processes are combined to generate a model of atherosclerosis. Generation of models of biological systems are described, for example, in U.S. Pat. Nos. 5,657,255 and 5,808,918, entitled “Hierarchical Biological Modeling System and Method”; U.S. Pat. No. 5,914,891, entitled “System and Method for Simulating Operation of Biochemical Systems”; U.S. Pat. No. 5,930,154, entitled “Computer-based System and Methods for Information Storage, Modeling and Simulation of Complex Systems Organized in Discrete Compartments in Time and Space”; U.S. Pat. No. 6,051,029, entitled “Method of Generating a Display for a Dynamic Simulation Model Utilizing Node and Link Representations”; U.S. Pat. No. 6,069,629, entitled “Method of Providing Access to Object Parameters Within a Simulation Model”; U.S. Pat. No. 6,078,739, entitled “A Method of Managing Objects and Parameter Values Associated With the Objects Within a Simulation Model”; U.S. Pat. No. 6,539,347, entitled “Method of Generating a Display For a Dynamic Simulation Model Utilizing Node and Link Representations”; U.S. Application Publication No. 20010032068, entitled “Method and Apparatus for Conducting Linked Simulation Operations Utilizing a Computer-Based System Model”; and PCT publication WO 99/27443, entitled “A Method of Monitoring Values within a Simulation Model.”

The methods further can comprise methods for validating the computer models described herein. For example, the methods can include generating a simulated biological characteristic associated with development or progression of an atherosclerotic plaque, and comparing the simulated biological characteristic with a corresponding reference biological characteristic measured in vivo. The result of this comparison in combination with known dynamic constraints may confirm some part of the model, or may point the user to a change of a mathematical relationship within the model, which improves the overall fidelity of the model. Methods for validating the various models described herein are taught in U.S. Patent Publication 2002-0193979, entitled “Apparatus And Method For Validating A Computer Model,” and in U.S. Pat. No. 6,862,561, entitled “Method and Apparatus for Computer Modeling a Joint.”

### D. Computer Models of Atherosclerosis

The computer model of atherosclerosis and associated cardiovascular risk provides predictive power to rapidly assess, e.g., the efficacy of novel therapeutics prior to investment in large-scale clinical trials. In a preferred implementation, the model contains four modules: 1) a deterministic, mechanistic model of cholesterol metabolism, 2) a model of the disease mechanisms underlying atherosclerosis progression, 3) a model of plaque stability, and 4) a statistical model of cardiovascular risk. The model can be used to establish a population of virtual patients (representing a variety of clinical phenotypes) to rapidly assess the effects of modulating highly-sensitive target pathways on key clinical endpoints. In addition, researchers can assess the efficacy of novel therapeutics, and identify biomarker patterns for predicting long-term clinical efficacy.

The methods of developing models of atherosclerosis described above can be used to generate a model for simulating development and progression of atherosclerotic plaques and the associated cardiovascular risk. In such a case, the simulation model may include hundreds or even thousands of objects, each of which can include a number of parameters. In order to perform effective “what-if” analyses using a simulation model, it is useful to access and observe the input values of certain key parameters prior to performance of a simulation operation, and also possibly to observe output values for these key parameters at the conclusion of such an operation. As many parameters are included in the expression of, and are affected by, a relationship between two objects, a modeler may also need to examine certain parameters at either end of such a relationship. For example, a modeler may wish to examine parameters that specify the effects a specific object has on a number of other objects, and also parameters that specify the effects of these other objects upon the specific object. Complex models are also often broken down into a system of sub-models, either using software features or merely by the modeler's convention. It is accordingly often useful for the modeler simultaneously to view selected parameters contained within a specific sub-model. The satisfaction of this need is complicated by the fact that the boundaries of a sub-model may not be mutually exclusive with respect to parameters, i.e., a single parameter may appear in many sub-models. Further, the boundaries of sub-models often change as the model evolves.

The created computer model represents biological processes at multiple levels and then evaluates the effect of the biological processes on biological processes across all levels. Thus, preferably, the created computer model provides a multi-variable view of a biological system. The created computer model also, preferably, provides cross-disciplinary observations through synthesis of information from two or more disciplines into a single computer model or through linking two computer models that represent different disciplines.

An exemplary computer model reflects a particular biological system, e.g., the vascular system, and anatomical factors relevant to issues to be explored by the computer model. The level of detail incorporated into the model is often dictated by a particular intended use of the computer model. For example, biological components being evaluated often operate at a subcellular level; therefore, the subcellular level can occupy the lowest level of detail represented in the model. The subcellular level includes, for example, biological components such as DNA, mRNA, proteins, therapeutic agents, and subcellular organelles. Similarly, the model can be evaluated at the multicellular level or even at the level of a whole organism. Because an individual biological system, e.g. a single human, is a common entity of interest with respect to the ultimate effect of the biological components, the individual biological system (e.g., represented in the form of clinical outcomes) is the highest level represented in the system. Chemical and therapeutic interventions are introduced into the model through changes in parameters at lower levels, with clinical outcomes being changed as a result of those lower level changes, as opposed to representing effects by directly changing the clinical outcome variables. Typically, the model represents evolving dynamics of cell populations, rather than the sequence of events for a single cell.

The level of detail reported to a user can vary depending on the level of sophistication of the target user. For a healthcare setting, especially for use by members of the public, it may be desirable to include a higher level of abstraction on top of a computer model. This higher level of abstraction can show, for example, major physiological subsystems and their interconnections, but need not report certain detailed elements of the computer model—at least not without the user explicitly deciding to view the detailed elements. This higher level of abstraction can provide a description of the virtual patient's phenotype and underlying physiological characteristics, but need not include certain parametric settings used to create that virtual patient in the computer model. When representing therapies, this higher level of abstraction can describe what the therapy does but need not include certain parametric settings used to simulate that exposure in the computer model. A subset of outputs of the computer model that is particularly relevant for subjects and doctors can be made readily accessible. In an alternative implementation, the output can comprise an identification of one or more biological processes that most significantly affect whether an atherosclerotic plaque will form, progress, regress or rupture. In certain implementations, the output may suggest biological assays that can be used to assess the likelihood that a subject may develop atherosclerosis and the associated cardiovascular risk.

In a preferred implementation, the computer model is configured to allow visual representation of mathematical relations as well as interrelationships between variables, parameters, and biological processes. This visual representation includes multiple modules or functional areas that, when grouped together, represent a large complex model of a biological system.

In one implementation, simulation modeling software is used to provide a computer model, e.g., as described in U.S. Pat. No. 5,657,255, issued Aug. 12, 1997, titled “Hierarchical Biological Modeling System and Method”; U.S. Pat. No. 5,808,918, issued Sep. 15, 1998, titled “Hierarchical Biological Modeling System and Method”; U.S. Pat. No. 6,051,029, issued Apr. 18, 2000, titled “Method of Generating a Display for a Dynamic Simulation Model Utilizing Node and Link Representations”; U.S. Pat. No. 6,539,347, issued Mar. 25, 2003, titled “Method of Generating a Display For a Dynamic Simulation Model Utilizing Node and Link Representations”; U.S. Pat. No. 6,078,739, issued Jan. 25, 2000, titled “A Method of Managing Objects and Parameter Values Associated With the Objects Within a Simulation Model”; and U.S. Pat. No. 6,069,629, issued May 30, 2000, titled “Method of Providing Access to Object Parameters Within a Simulation Model”. An example of simulation modeling software is found in U.S. Pat. No. 6,078,739.

Various Diagrams can be used to illustrate the dynamic relationships among the elements of the model of skin sensitization. Examples of suitable diagrams include Effect and Summary Diagrams.

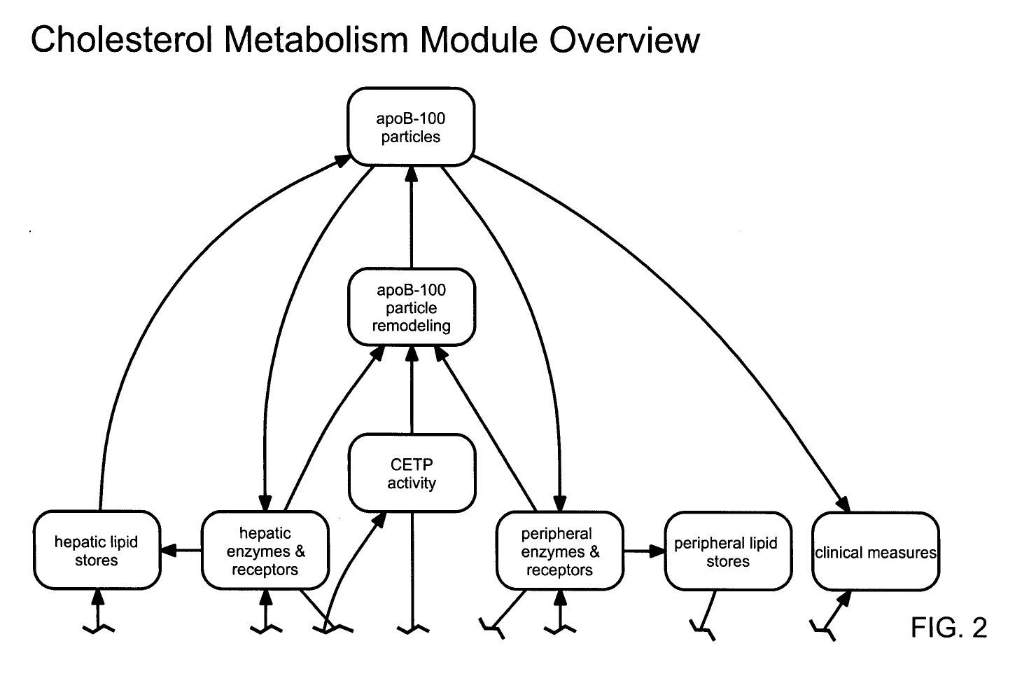

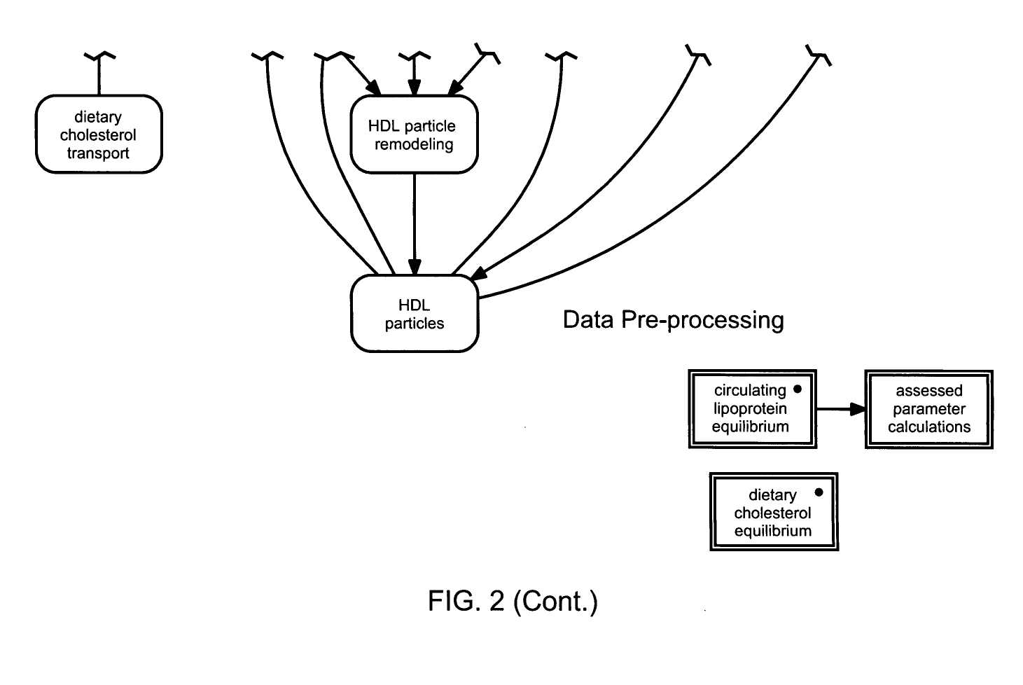

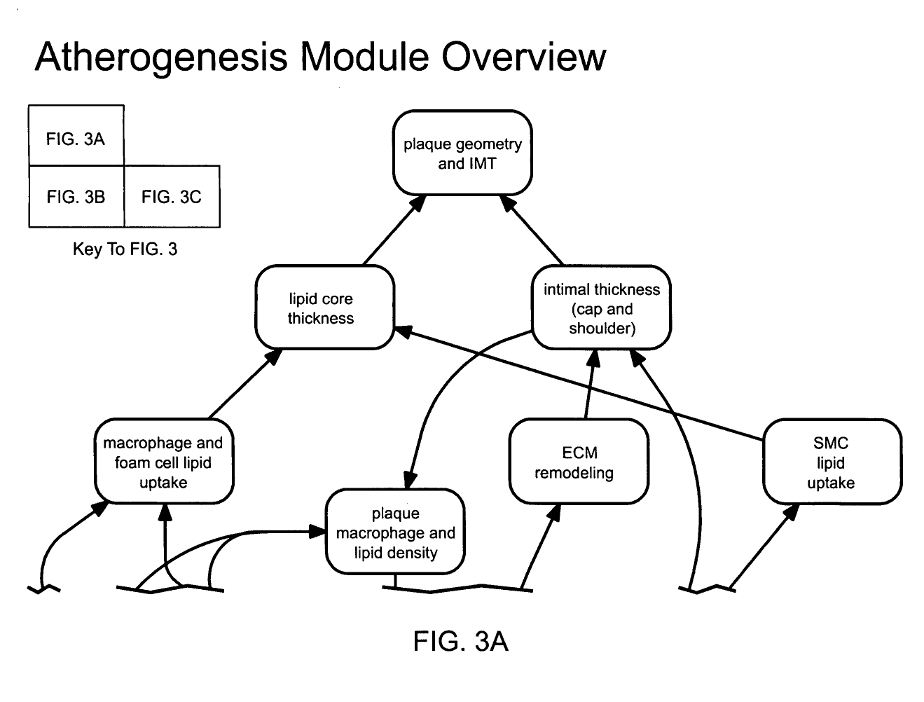

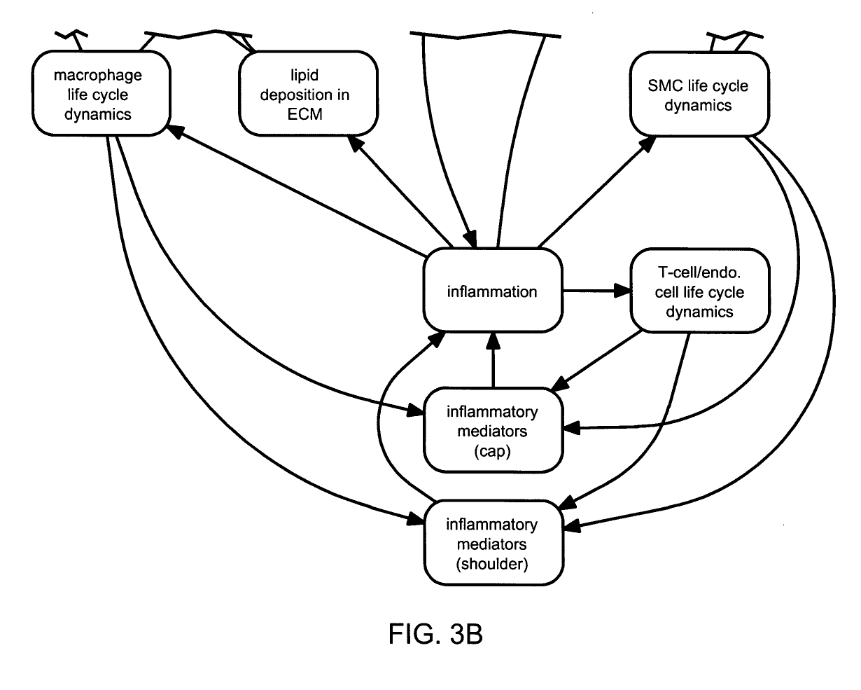

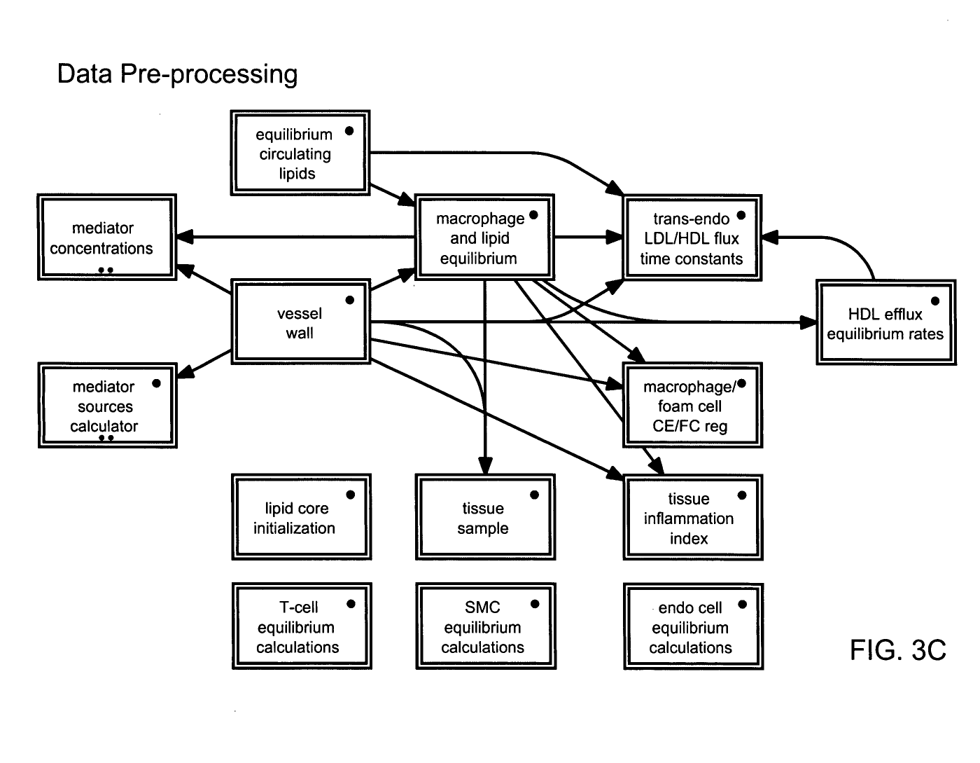

A Summary Diagram can provide an overview of the various pathways modeled in the methods and models described herein. For example, the Summary Diagram illustrated in FIG. 1 provides an overview of modules that can form the atherosclerosis model. A Summary Diagram also can provide an overview of pathways modeled in a particular module. For example, the Summary Diagram illustrated in FIG. 2 provides an overview of the cholesterol metabolism module. The Summary Diagram illustrated in FIG. 3 provides an overview of the atherogenesis module. A Summary Diagram can also provide links to individual modules of the model. The models represent the relevant components of the phenotype through the use of “state” and “function” nodes whose relations are defined through the use of diagrammatic arrow symbols. Thus, the complex and dynamic mathematical relationships for the various elements of the phenotype are easily represented in a user-friendly manner.

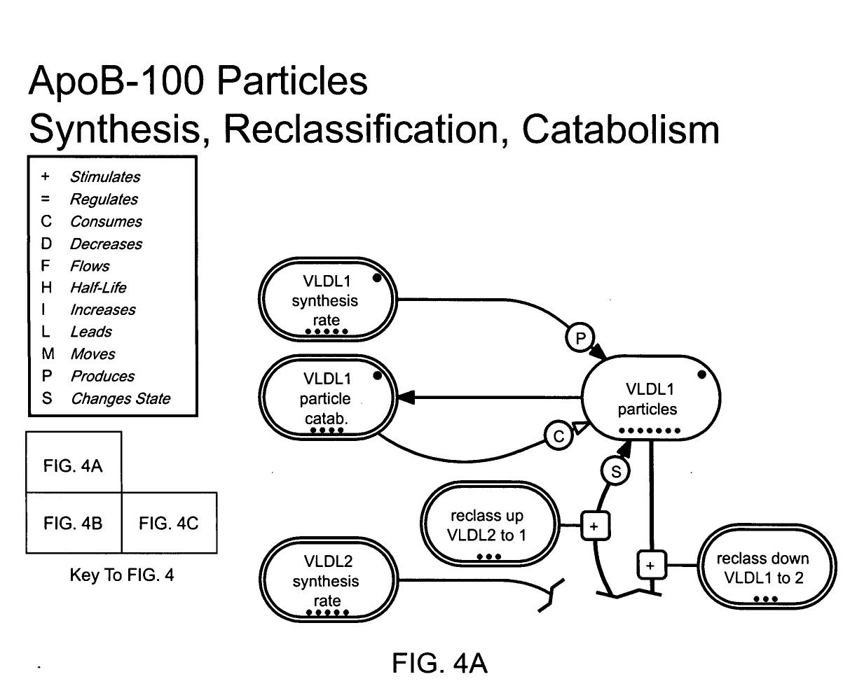

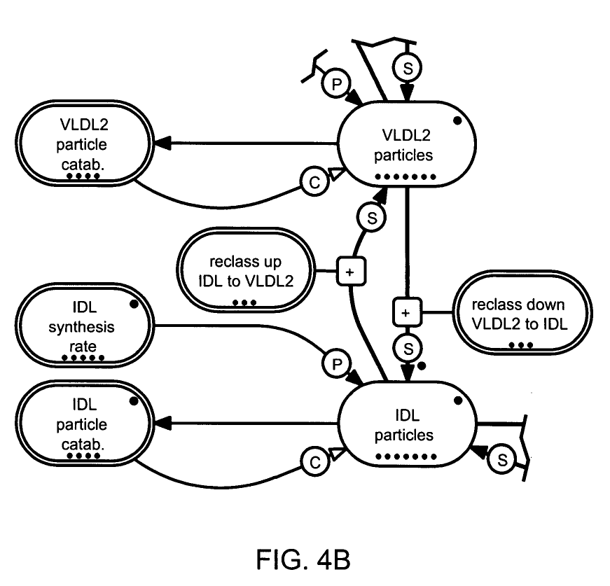

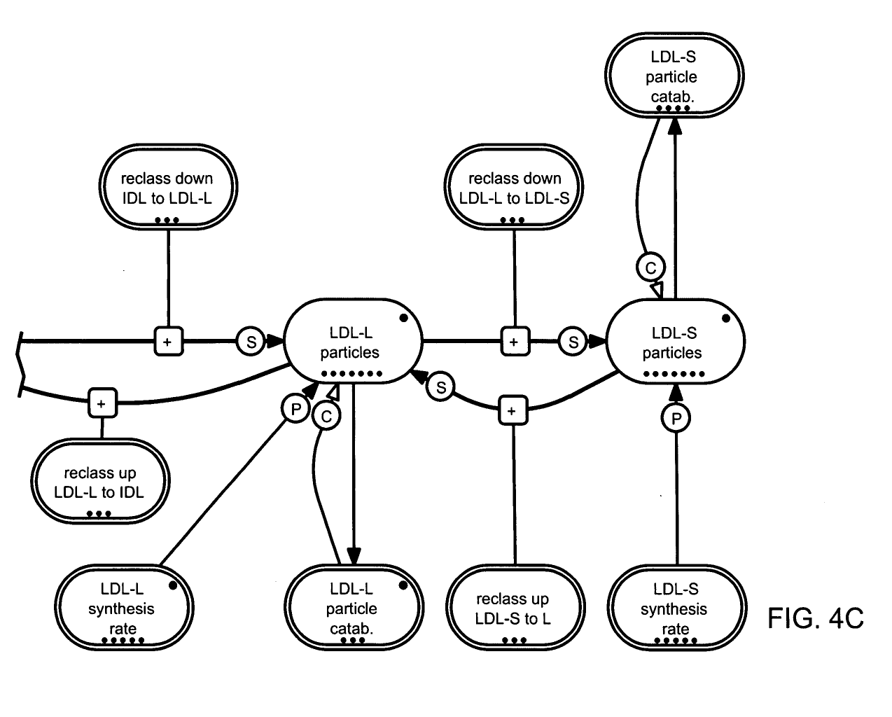

An Effect Diagram can be a visual representation of the model equations and illustrate the dynamic relationships among the elements of the model. FIG. 4 provides an example of an Effect Diagram illustrating how apoB-100 particles can be reclassified to reflect changes in lipid content and composition. The Effect Diagram is organized into modules, or functional areas, which when grouped together represent the large complex physiology of the phenotype being modeled.

State and function nodes show the names of the variables they represent and their location in the model. The arrows and modifiers show the relationship of the state and function nodes to other nodes within the model. State and function nodes also contain the parameters and equations that are used to compute the values of the variables the represent in simulated experiments. In some embodiments, the state and function nodes are represented according to the method described in U.S. Pat. No. 6,051,029, entitled “Method of Generating a Display for a Dynamic Simulation Model Utilizing Node and Link Representations,” incorporated herein by reference. Examples of state and function nodes are further discussed below.

State nodes are represented by single-border ovals and represent variables in the system, the values of which are determined by the cumulative effects of inputs over time. “Input” refers to any parameter that can affect the variable being modeled by the state node. For example, input for a state node representing LDL-L particles can be LDL-L synthesis and LDL-L particle catabolism. State node values are defined by differential equations. The predefined parameters for a state node include its initial value (S₀) and its status. In some embodiments, state nodes can have a half-life. In these embodiments, a circle containing an “H” is attached to the node that has a half-life.

Function nodes are represented by double-border ovals and represent variables in the system, the values of which, at any point in time, are determined by inputs at the same point in time. Function nodes are defined by algebraic functions of their inputs. The predefined parameters for a function node include its initial value (F₀) and its status. Setting the status of a node effects how the value of the node is determined. The status of a state or function node can be: 1) Computed, i.e., the value is calculated as a result of its inputs; 2) Specified-Locked, i.e., the value is held constant over time; or 3) Specified Data, i.e., the value varies with time according to predefined data points.

State and function nodes can appear more than once in the module diagram as alias nodes. Alias nodes are indicated by one or more dots (see, e.g., state node “IDL Particles” in FIG. 4). State and Function nodes are also defined by their position, with respect to arrows and other nodes, as being source nodes (S) and/or target nodes (T). Source nodes are located at the tails of arrows and target nodes are located at the heads of arrows. Nodes can be active or inactive.

Arrows link source nodes to target nodes and represent the mathematical relationship between the nodes. Arrows can be labeled with circles that indicate the activity of the arrow. A key to the annotations in the circles is located in the upper left corner of each effect Diagram. If an arrowhead is solid, the effect is positive. If the arrowhead is hollow, the effect is negative. For further description of arrow types, arrow characteristics, and arrow equations, see, e.g., U.S. Pat. No. 6,051,029, U.S. Pat. No. 6,069,629, U.S. Pat. No. 6,078,739, and U.S. Pat. No. 6,539,347.

The computer model of the invention includes three main modules, plus an optional fourth module (FIG. 1). The plaque stability module extends the clinical outputs of the atherogenesis module to endpoints of plaque stability, while the cardiovascular risk module, e.g., employs statistical methods and patient data to translate the outputs of the plaque stability module into a probability of cardiovascular risk over time.

The fully-integrated computer model of atherosclerosis preferably is capable of representing a breadth of patient phenotypes in terms of their lipid profiles, additional risk factors for cardiovascular disease, and alternate genetic and/or hypothesized mechanistic variants. The resulting virtual patients can be used to predict the effect of therapeutic and/or dietary intervention on the rate of plaque progression and changes in plaque stability and risk of cardiovascular endpoints.

The methods disclosed herein can be used to form a computer model capable of simulating patient phenotypes and further can incorporate the addition of new components, as well as increased detail in components already modeled. For example, computer models predicting changes in the steady-state cholesterol balance in dyslipidemic patients with different genetic dysfunctions can be modeled. The genetic dysfunctions can be known genetic dysfunctions, such as a deficiency of cholesteryl ester transfer protein (see, e.g., Barter, et al., Arterioscler Thromb Vasc Biol, 23: 160-167, 2003). As will be appreciated by a person skilled in the art, newly discovered genetic defects in cholesterol metabolism can also be modeled using the methods described herein. Similarly, the computer models can incorporate biological features associated with lipoprotein particle classification, reclassification, synthesis, and catabolism.

1. Cholesterol Metabolism Module

Atherosclerosis progression and regression are believed to be primarily driven by the balance between cholesterol retention and efflux from the vessel. This cholesterol balance is dependent on both the retention of circulating LDL and HDL particles within the plaque and cholesterol efflux from the plaque to apoA-I particles. Dynamic tracking of changes in circulating lipoprotein particles in response to drug therapy or dietary changes enables prediction of how these interventions affect plaque progression. The cholesterol metabolism module, an example of which is described in co-pending patent application Ser. No. 11/305,317, published as U.S. Patent Publication 2006-0195308, provides this capability by computing the dynamic equilibrium of apoB-100 and apoA-I particles in the circulation, and predicting changes both in particle numbers and cholesterol content. An overview of the cholesterol metabolism module is shown in FIG. 2.

The cholesterol metabolism module tracks the synthesis, catabolism, and reclassification of apoB-100 and apoA-I particles, and calculates the new steady-state equilibrium that arises from perturbations to the virtual patients due to therapeutic interventions, including HMG CoA-reductase inhibition, CETP inhibition, niacin, fibrate, or cholesterol absorption inhibition therapy. The effects of dietary modulations, including increased dietary fiber, can also be investigated. Furthermore, the module contains explicit representations of feedback mechanisms critical for the regulation of particle synthesis in the hepatic compartment, remodeling in the circulation, and LDL-receptor expression. Changes in parameters affecting whole-body cholesterol metabolism are dynamically computed. Exemplary parameters that can be dynamically computed include (1) free cholesterol, cholesterol ester, and triglyceride content of apoB-100 and apoA-I lipoprotein particles, (2) the number of particles in five classes of apoB-100 particles based on size (VLDL-1, VLDL-2, IDL, large LDL, small LDL) and four classes of HDL (lipid free apoA-I, small, large, and very large HDL), (3) synthesis and catabolism rates of lipoprotein particles, (4) the activity of key enzymes, e.g., CETP, LPL, HL, LCAT, that remodel particles in the circulation and are responsible for their reclassification amongst particle size classes, and (5) hepatic and peripheral cholesterol stores. In a preferred implementation, the module includes representations of biological processes associated with both lipid flux and lipoprotein particles.

Metabolism of cholesterol involves two distinct domains: lipoprotein particles that facilitate the intravascular transport of hydrophobic lipids between hepatic and peripheral tissues, and the lipid molecules themselves. Lipoprotein particles consist of two major classes: apoB-100 particles synthesized and secreted by the liver, including very low-density lipoproteins (VLDL), intermediate density lipoproteins (IDL), and low-density lipoproteins (LDL); and apoA particles, also called high-density lipoproteins (HDL). Lipid molecules include free and esterified cholesterol (FC and CE, respectively) and triglycerides (TG), which are packaged by the liver into lipoprotein particles. Lipoprotein particles are secreted by the liver into the bloodstream, once in the bloodstream they can be acted upon by peripheral tissue enzymes that remove TG and CE. Particle remnants are subsequently catabolized by specific receptors and degraded, typically in the liver. These enzymatic and receptor-mediated changes affect the particle number, size, and classification, as well as the concentration of lipids intravascularly and in tissues.

The lipid molecule domain relates to the flux of lipid between various biological compartments and lipoprotein particles. Lipid molecules can be described as primarily residing in one of three compartments: the liver (hepatic liver stores), lipoprotein particles, or the remainder of the body including the circulation (peripheral lipid stores). Additional compartments relating to cholesterol uptake (e.g. an intestinal compartment) or secretion can also be included in the model.

To effectively capture the complex interactions between the lipoprotein particle domain and the lipid molecule domain, the model represents biological processes that occur in both domains. These biological processes incorporate core components in in vivo pathways underlying lipoprotein particle number and lipid composition, i.e., the lipoprotein particle domain or compartment, with core components in in vivo pathways underlying the transport of lipid molecules between hepatic and peripheral tissue, i.e., the lipid molecule domain or compartment. The resulting computer models can provide predictive representations of cholesterol metabolism in healthy and/or diseased animals. The models can simulate perturbations in cholesterol metabolism in response to dietary changes, therapeutic agents, metabolic disorders, etc., in healthy and diseased animals. Comparisons between the models can be used, for example, to predict the lipoprotein particle profile and plasma lipid profile in healthy versus diseased animals. Other uses include, but are not limited to, comparing the effect of various therapeutic agents on the lipoprotein particle profile and plasma lipid profile in healthy versus diseased animals. Comparison with clinical data can be used to fine-tune the core components of the computer models.

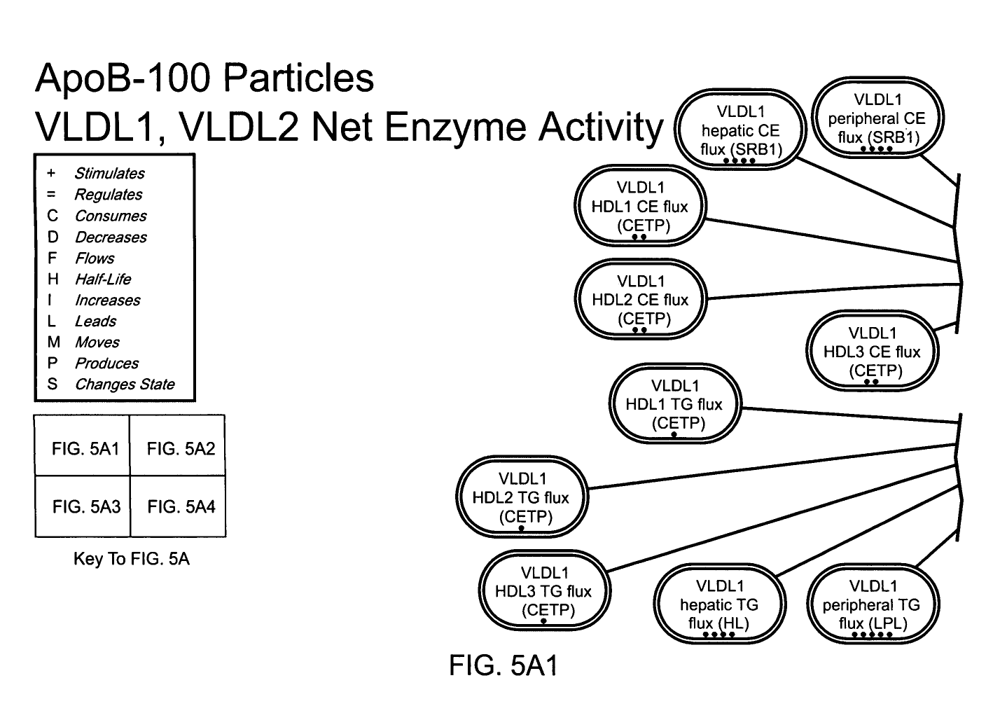

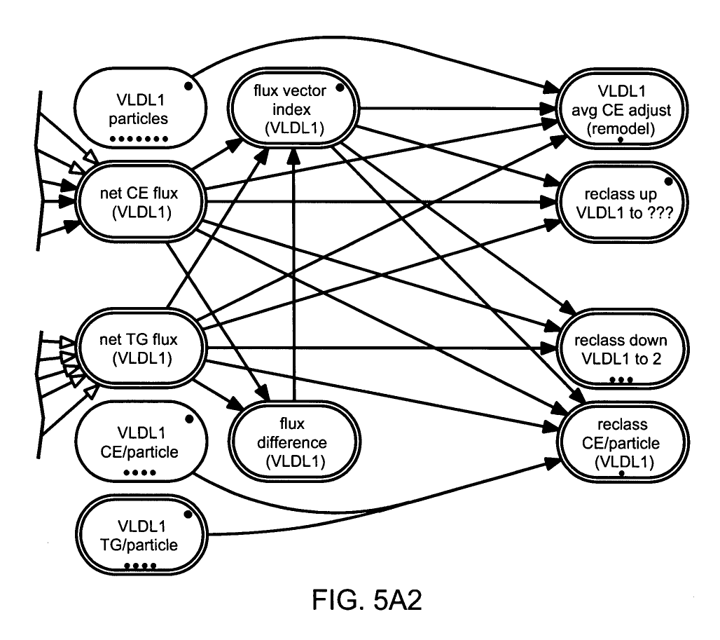

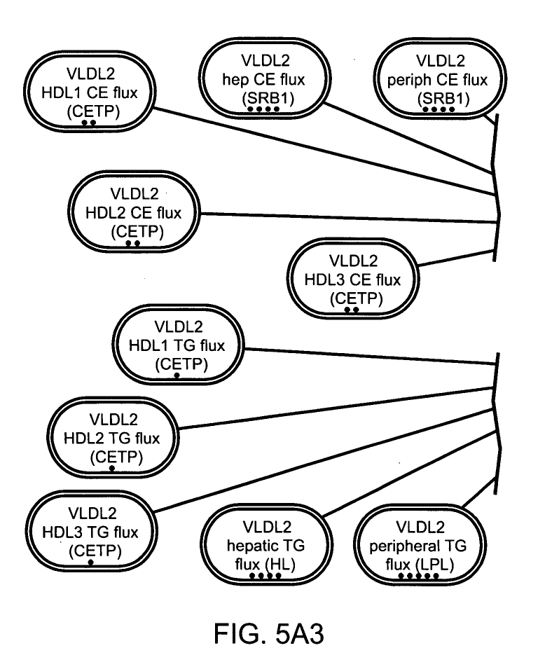

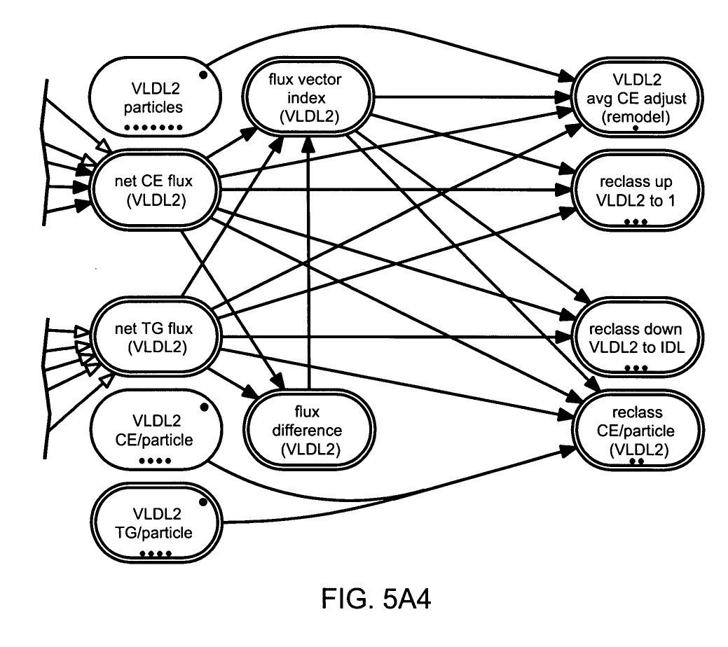

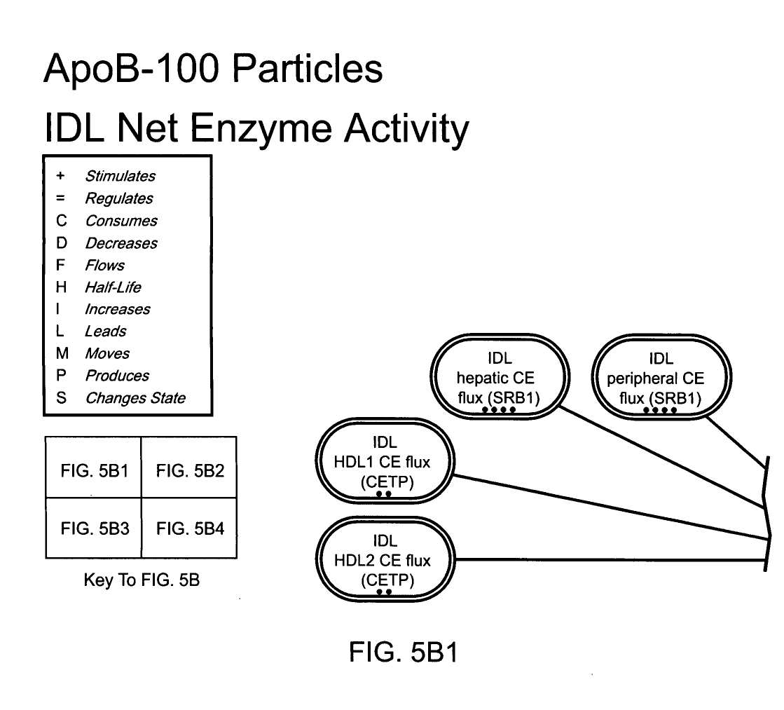

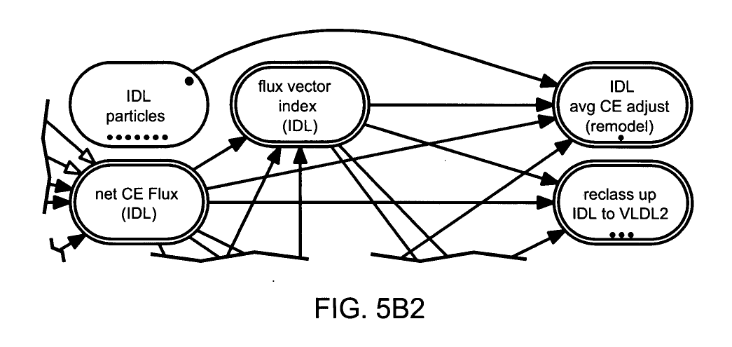

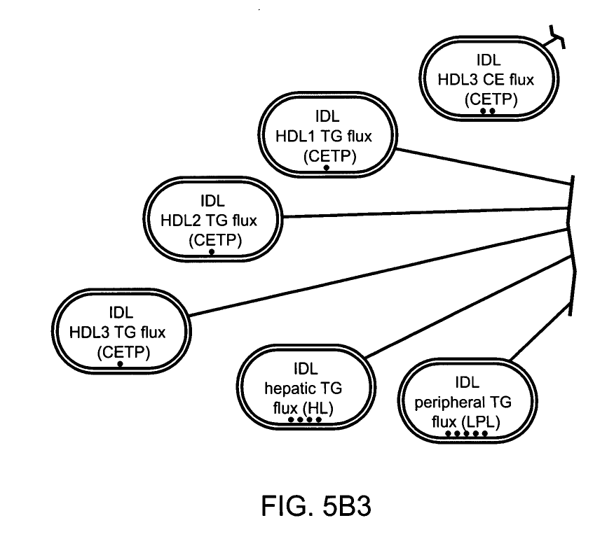

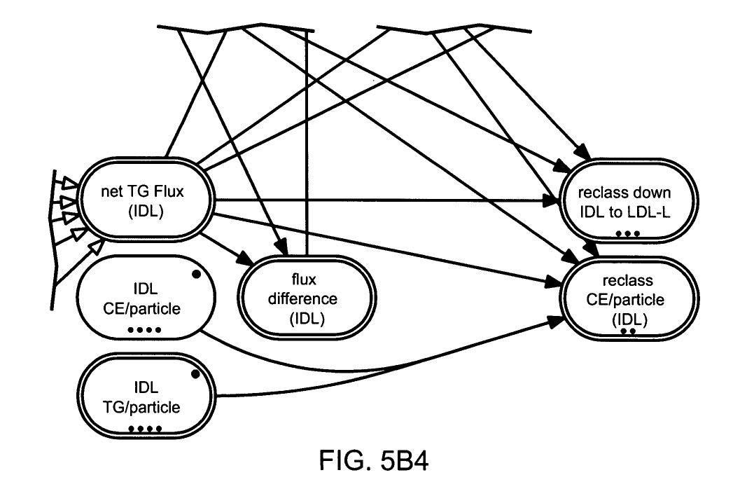

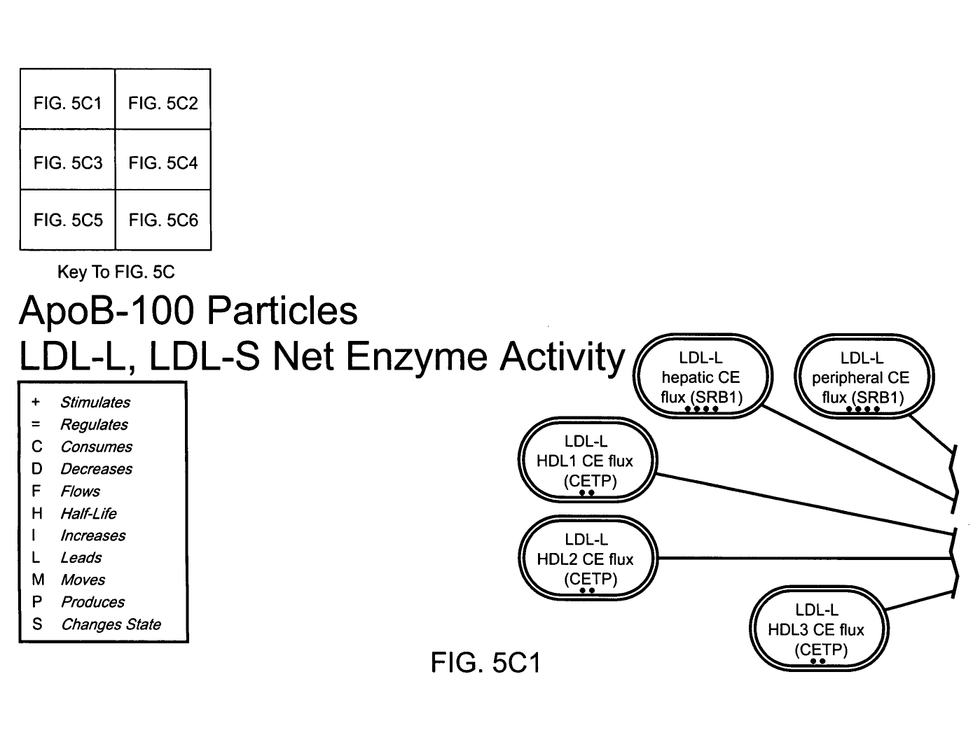

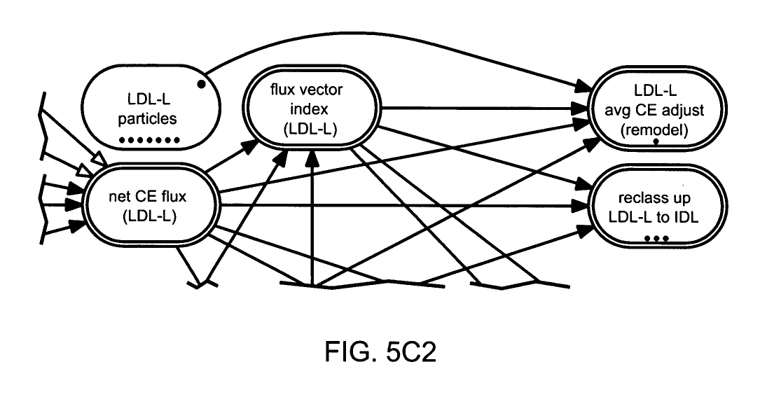

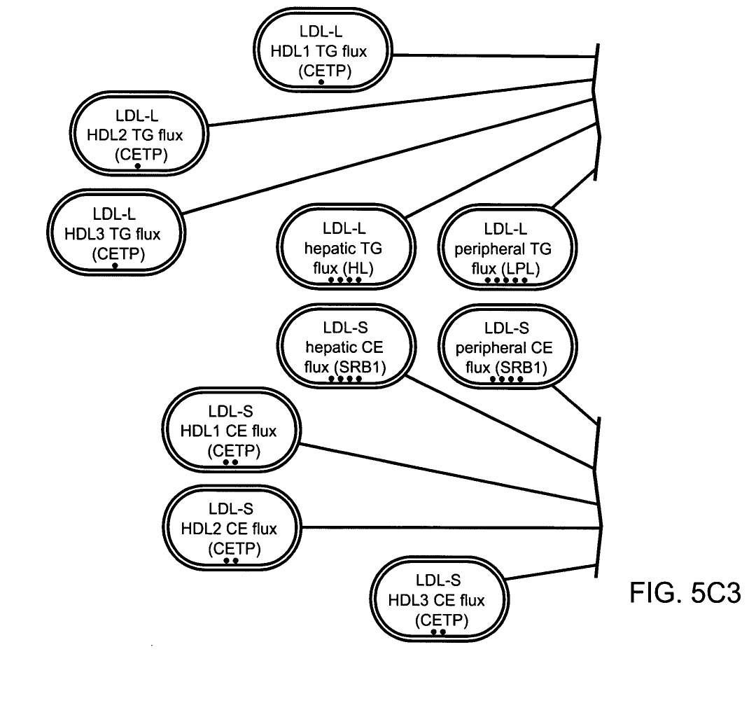

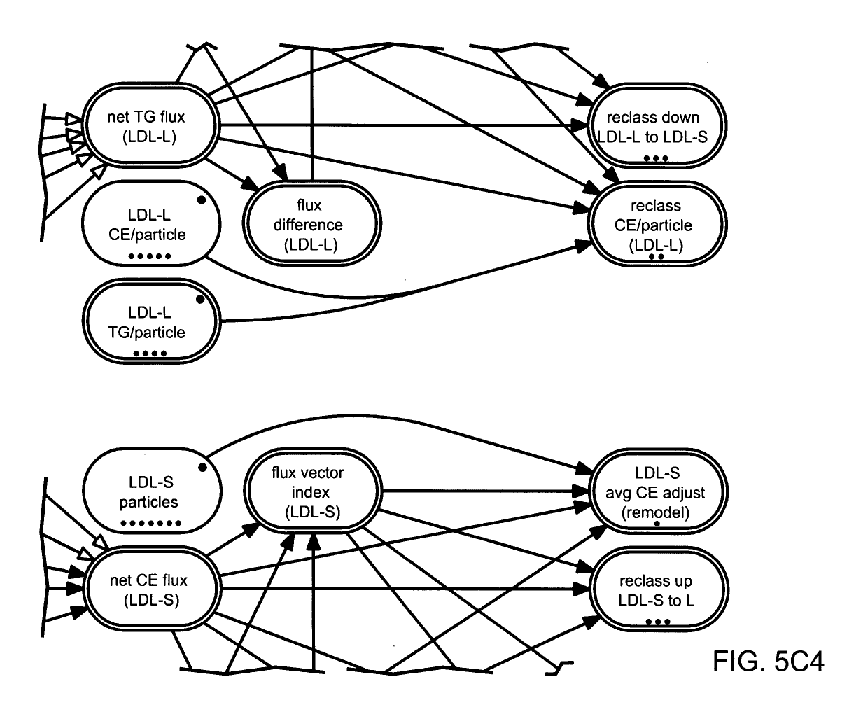

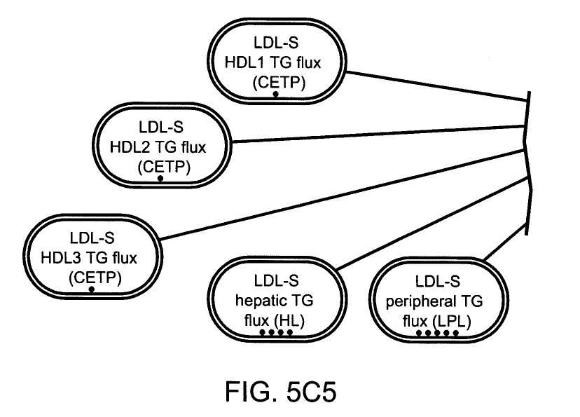

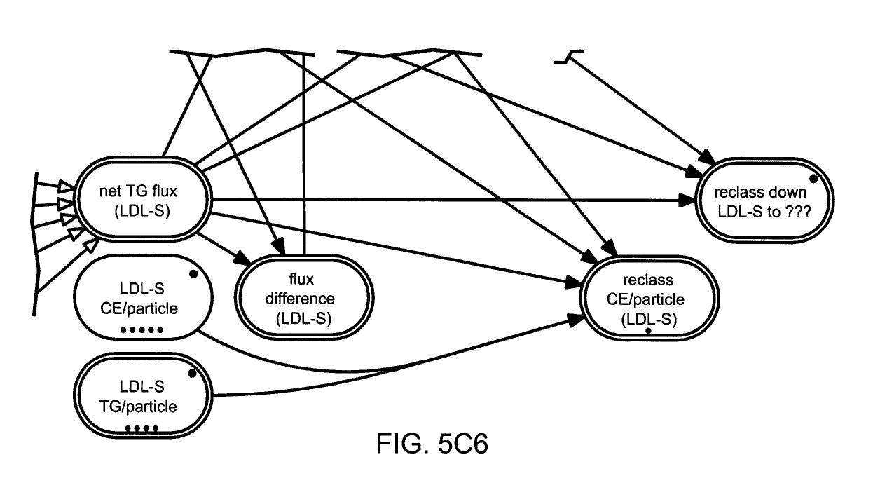

apoB-100 particles can be fractionated into three major classes, i.e., VLDL, IDL, and LDL. The three major classes can be fractioned into additional classes defined by their size. VLDL particles vary in size from about 350 angstroms to 700 angstroms diameter. Most of the difference in size is due to the triglyceride core. Within the 350 angstroms to 700 angstroms diameter range, two or three additional subfractions have been identified: VLDL₁ of S_{f} 60 to 400 and VLDL₂ S_{f} 20 to 60, or alternatively VLDL₁ of S_{f} 100 to 400, VLDL₂ S_{f} 60 to 100, and VLDL₃ S_{f} 20 to 60. IDL particles vary in size from 270 to 300 angstroms. Although two subfractions have been identified, they are similar in size and density, and hence cannot be readily isolated. LDL particles vary in size from 200 to 270 angstroms. Within the 200 angstroms to 270 angstrom diameter range, three additional subfractions have been identified: LDL-1, density (d)=1.025 g/ml to 1.034 g/ml; LDL-II. D=1.034 g/ml to 1.044 g/ml, LDL-III, d=1.044 g/ml to 1.060 g/ml (see, e.g., Packard and Shepherd, 1997, supra). In one implementation of the invention, the size of a particle is a measure of the volume of the particle. The particle diameter and volume is calculated assuming that each particle is a sphere. Given, the total volume is calculated based on an average density for CE and TG in the particle, a total mass of CE and TG, and an average protein content per particle. Thus the size of a particle is correlated to lipid as well as protein content. The Effect Diagrams illustrated in FIGS. 5A-5C depict the effect of various enzymatic activity on the flux of lipids between the various particles and how changes in lipid content affect the reclassification of these particles.

Reclassification and remodeling of apoB-100 particles is carried out by the action of lipoprotein lipase (LPL), hepatic lipase (HL), and scavenger receptor class B type 1 (SR-B1). These enzymes alter the TG and CE content of each particle and, hence, contribute to changes in particle size as previously described. Modules, in which the overall action of enzymes are combined into a net CE and net TG flux affecting each particle class separately are depicted in FIGS. 5A-5C (“Net CE Flux” and “Net TG Flux”). These fluxes affect the average CE and TG content of each particle class from the equilibrium values (“Avg CE adjust-remodel”). Large particles are thus reclassified into small ones or vice versa (“Avg CE Adjust-reclass up” and “Avg CE Adjust-reclass down”).

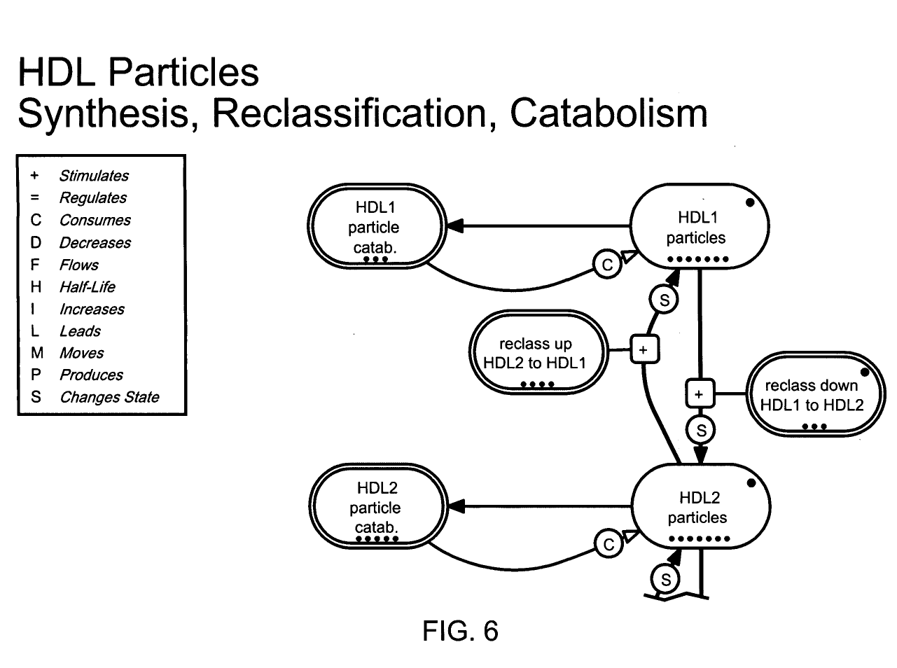

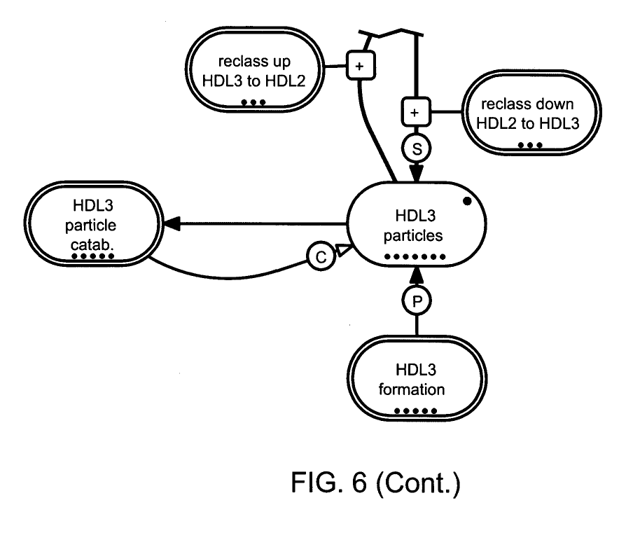

FIG. 4 provides an Effect Diagram representing apoB-100 particle dynamics. All apoB-100 particles are synthesized by the liver. Particles are “reclassified” between states based upon the concerted action of key enzymes (LPL, HL, CETP, LCAT), explicitly represented in the submodel, that remove triglyceride and/or cholesterol from particles and change their size. Additionally, all particles in the circulation can be catabolized. The representation of apoA-I particle dynamics in implemented in a similar fashion (see FIG. 6).

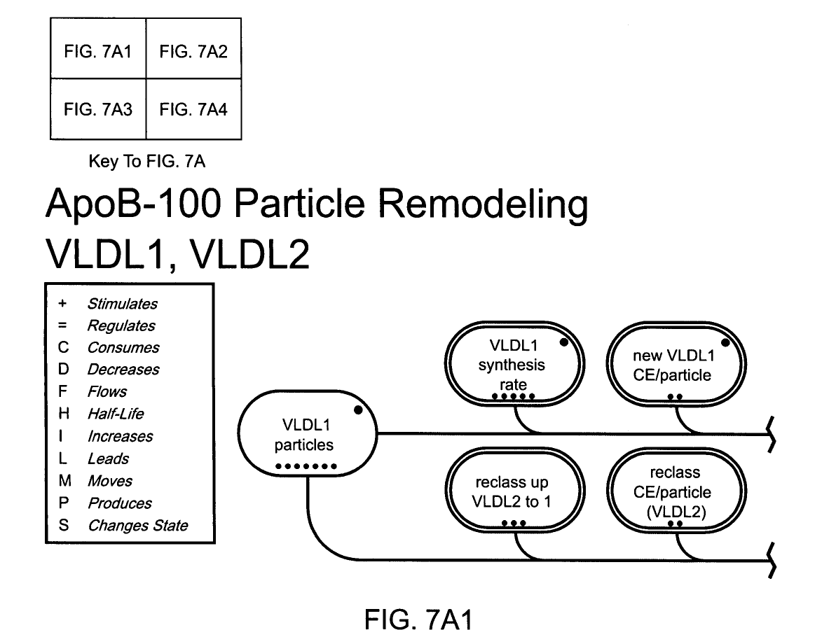

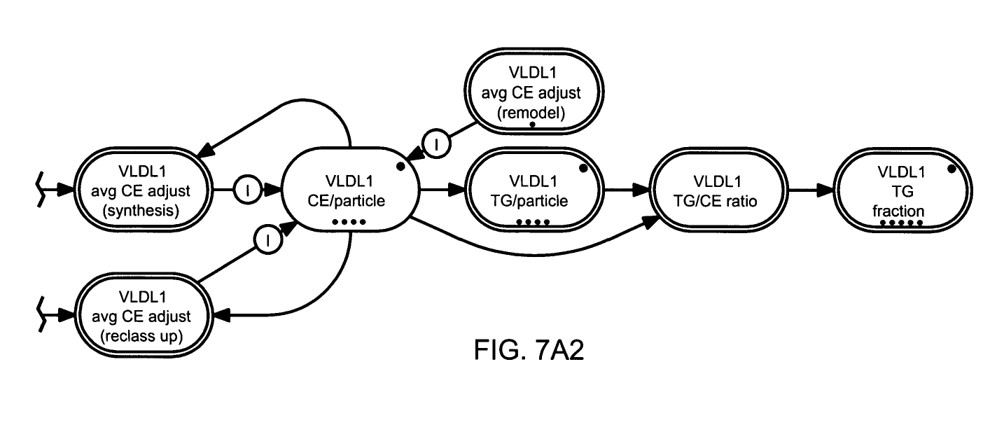

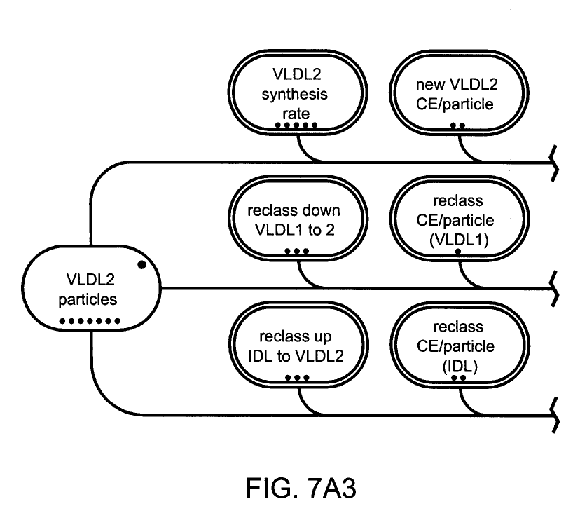

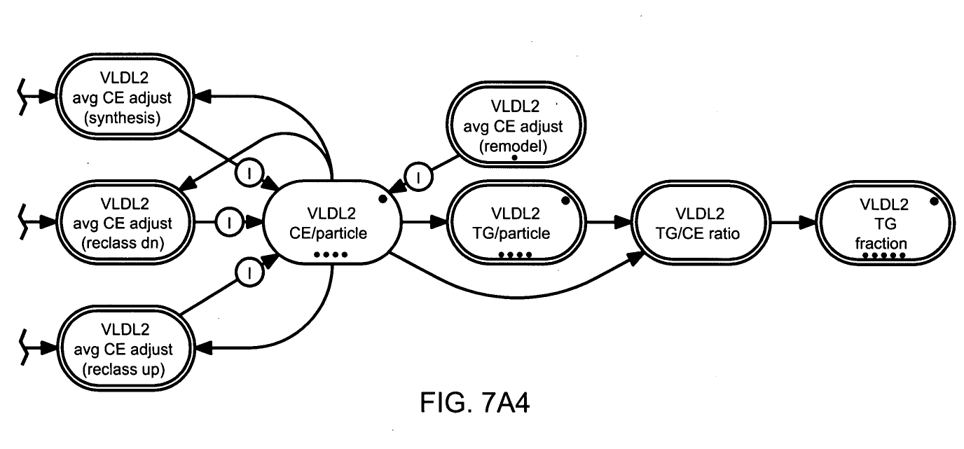

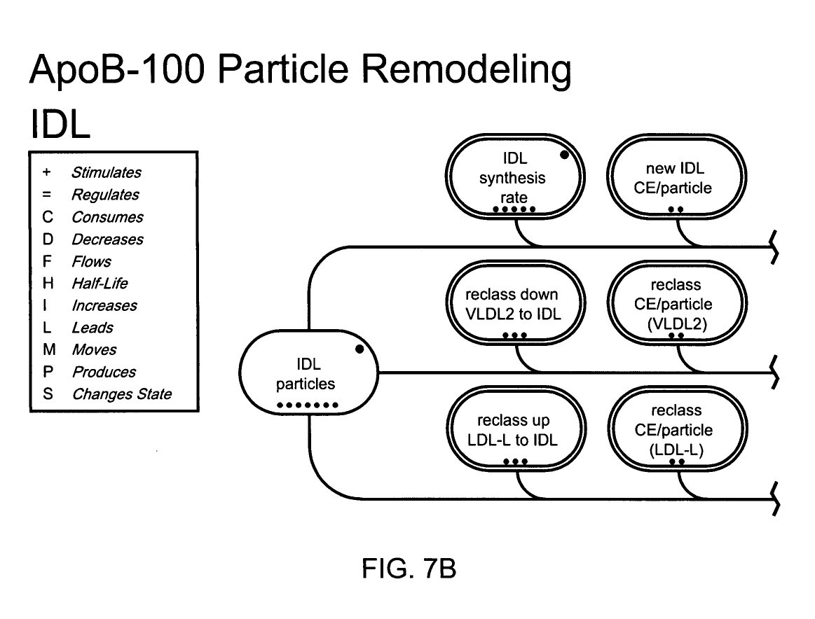

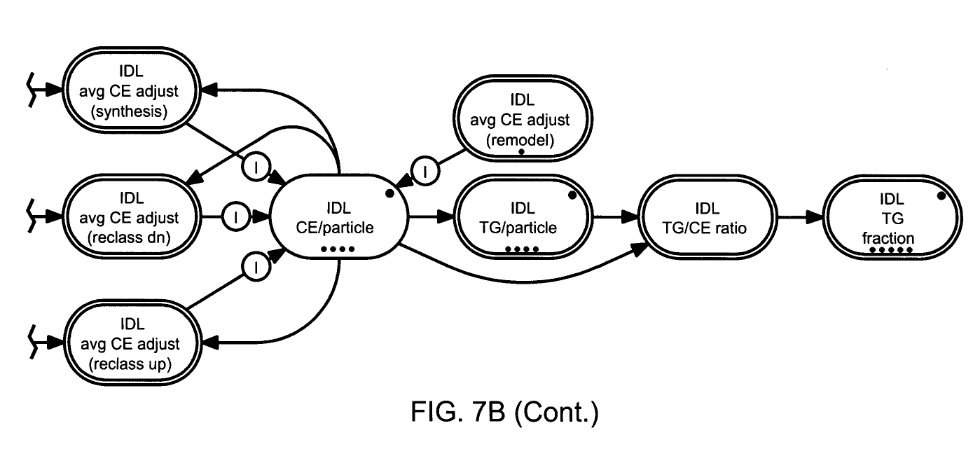

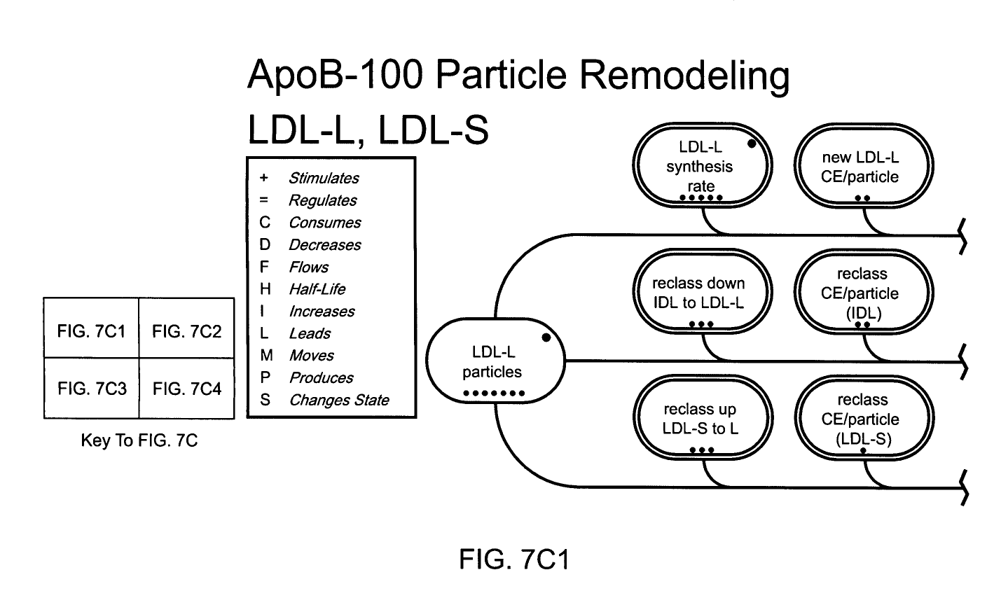

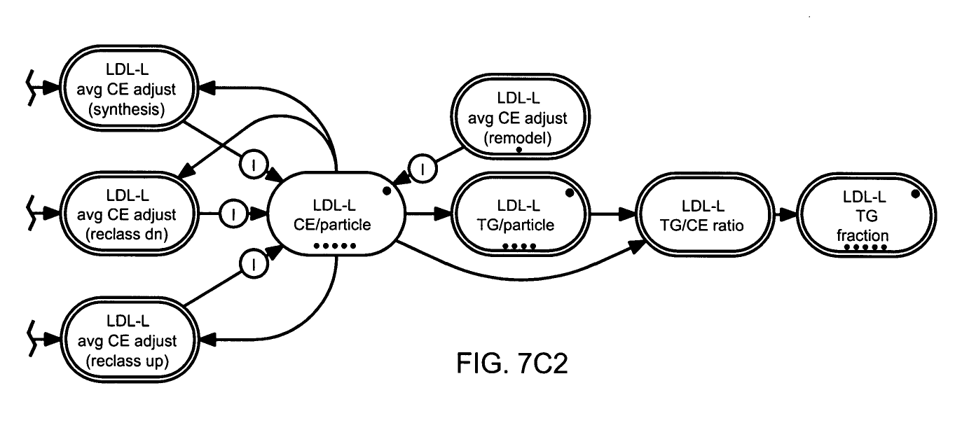

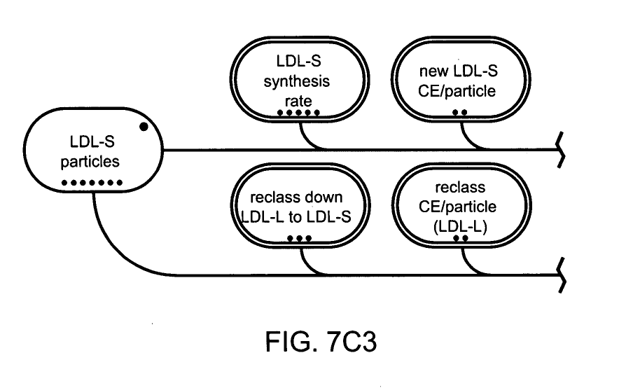

The apoB-100 particle lipoprotein composition for a reference virtual patient can be determined by analyzing and integrating data from literature reports or experimental protocols. Values are compiled for each particle class for the following parameters: 1) CE and TG per particle; 2) rates of hepatic synthesis and catabolism; 3) number of particles. In homeostatic situations, e.g. following an overnight fast, CE and FC are considered to be equivalent due to the relatively fast dynamics of interconversion. Furthermore, the state variable CE/particle is tracked for each particle class (see, e.g., FIGS. 7A-7C). TG/particle is calculated based upon the constraint that particles in a specific class remain at a specified “mean” size, determined from reports in the literature. Changes to particle composition that alter the particle size effect a reclassification of the particle into a different class. Particle size can be determined by a number of different methods, including density gradient centrifugation, electrophoresis, affinity chromatography and NMR. Generally, NMR is used to determine particle number. Other means of determining particle number include the use of radiolabeled tracer studies combined with centrifugation. As will be appreciated by a person skilled in the art, different numbers of particles will be obtained using different methods.

FIG. 7A provides an Effect Diagram depicting VLDL1 and VLDL2 particle remodeling. FIG. 7B provides an Effect Diagram depicting IDL particle remodeling. FIG. 7C provides an Effect Diagram depicting LDL-L and LDL-S particle remodeling.

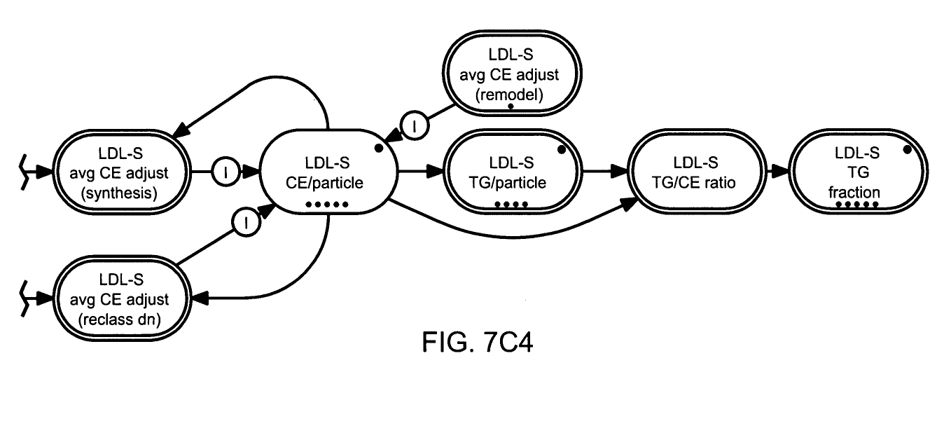

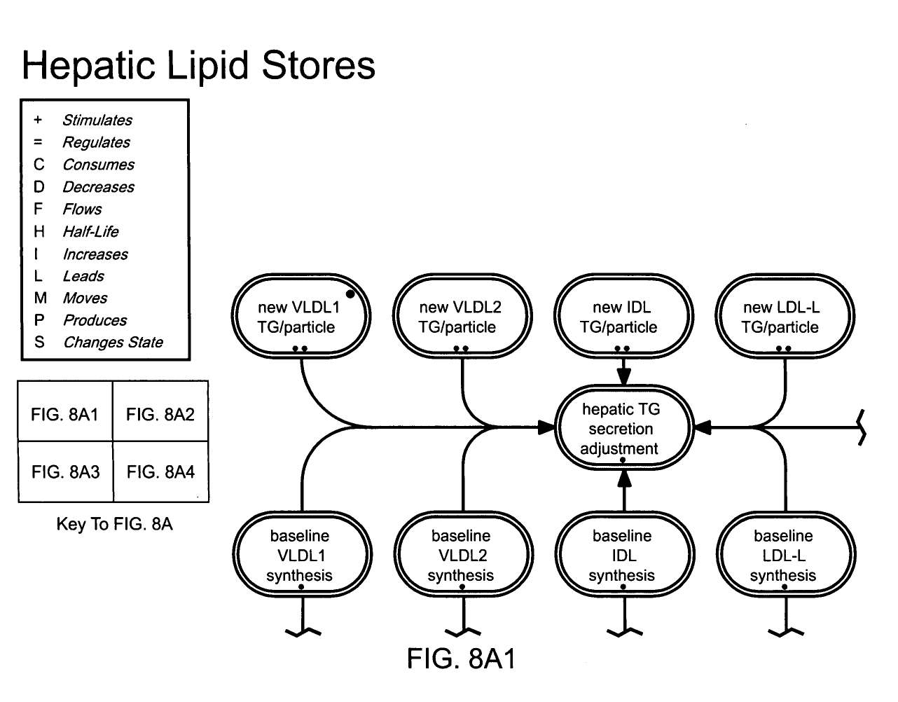

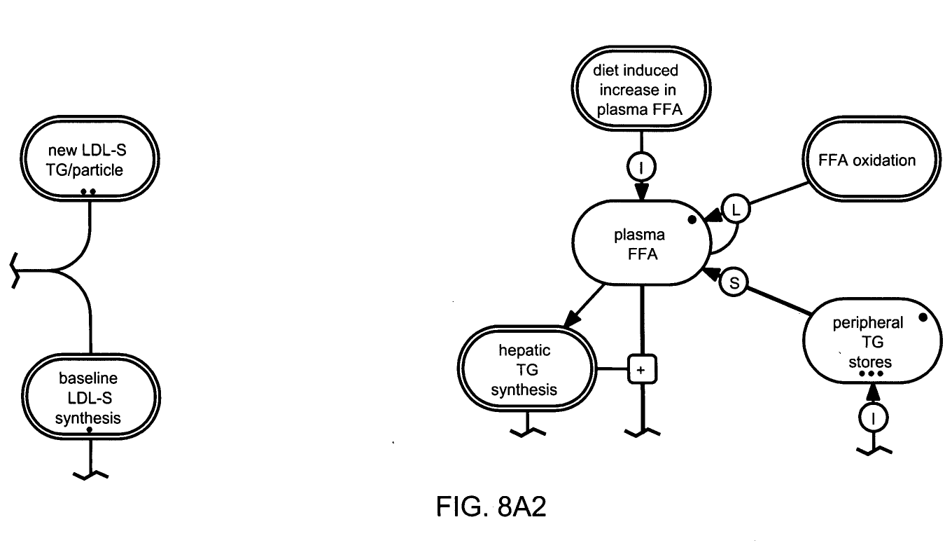

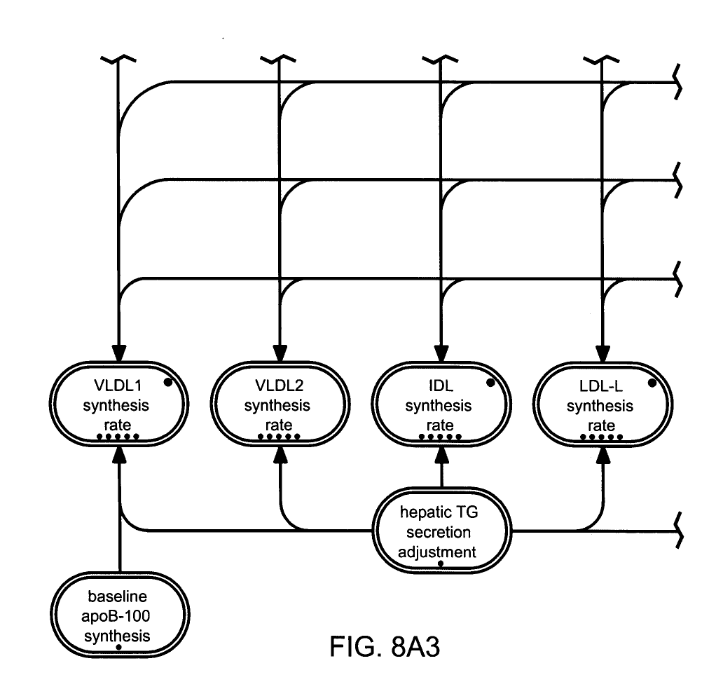

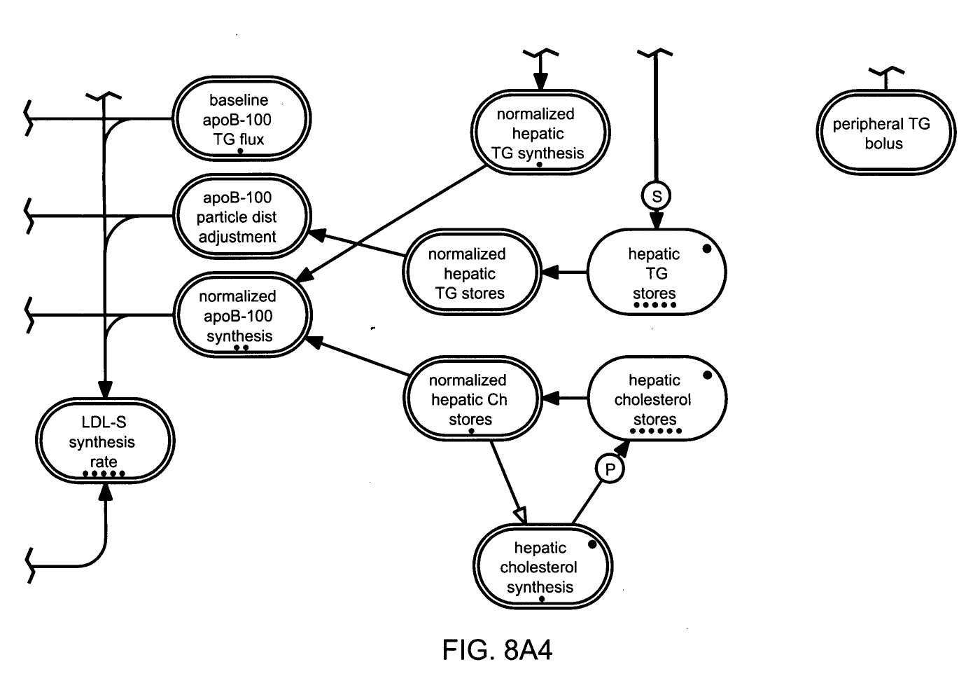

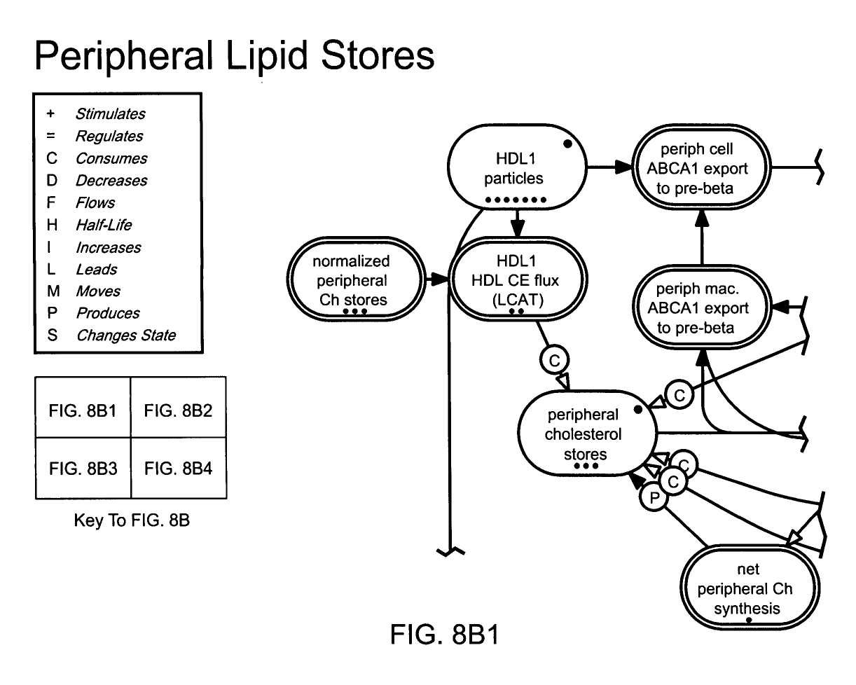

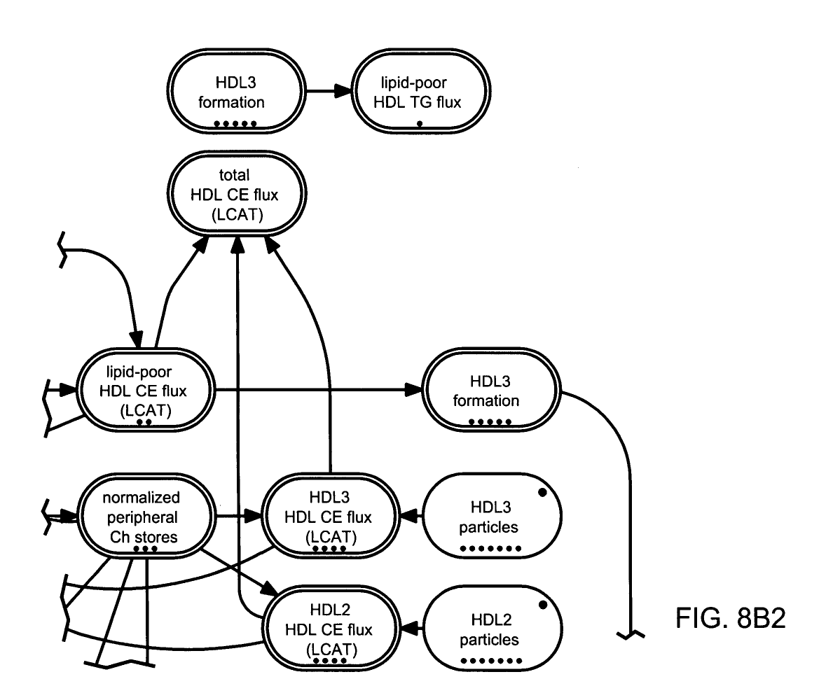

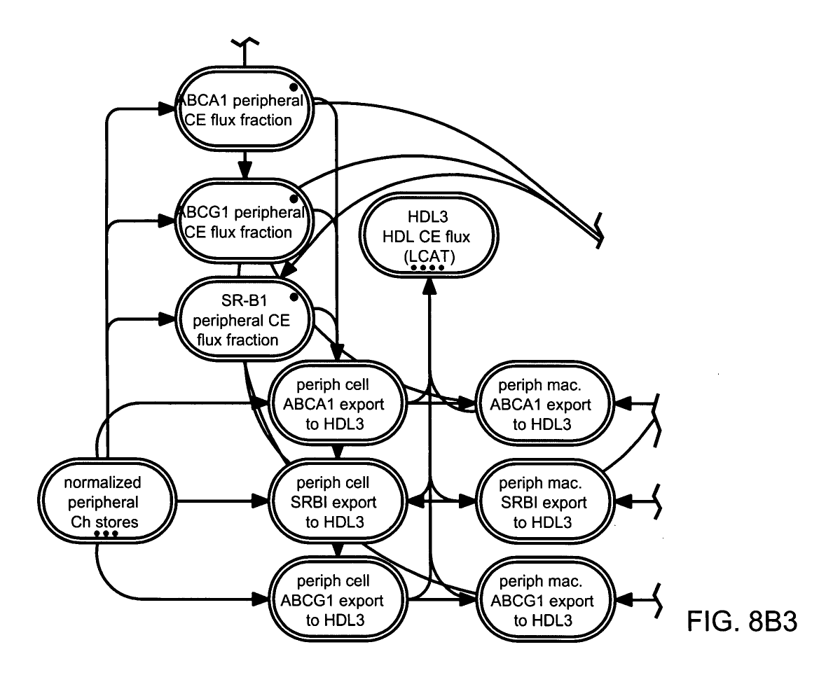

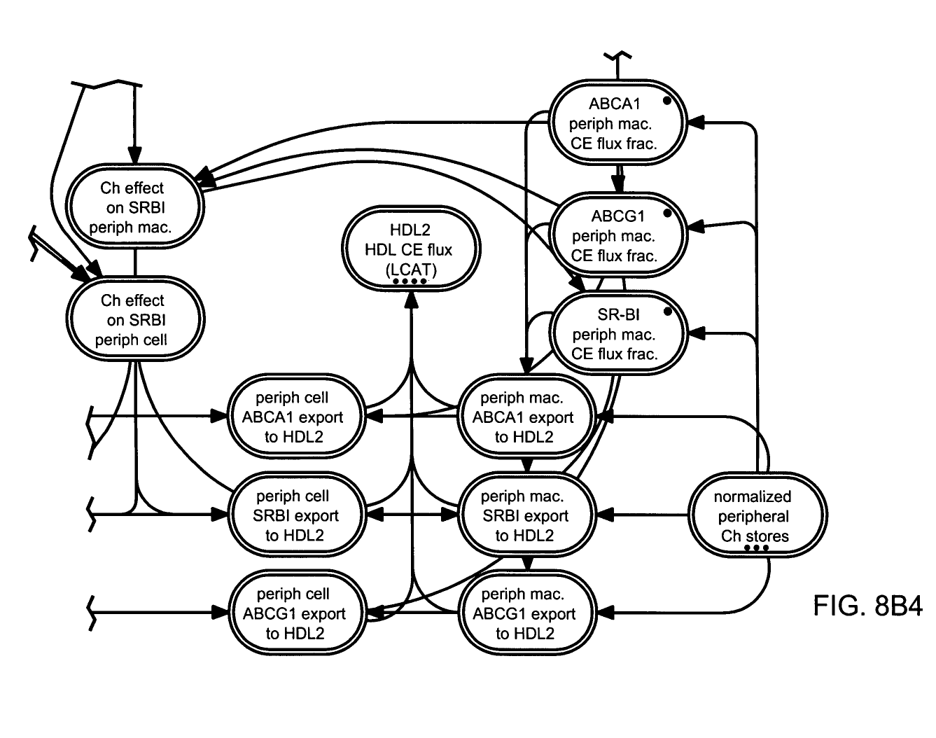

FIGS. 8A and 8B illustrate exemplary embodiments of lipid molecule domains in hepatic tissue and peripheral tissue depicted in FIG. 3. FIG. 8A provides an Effect Diagram depicting hepatic lipid stores. FIG. 8B provides an Effect Diagram depicting peripheral lipid stores.

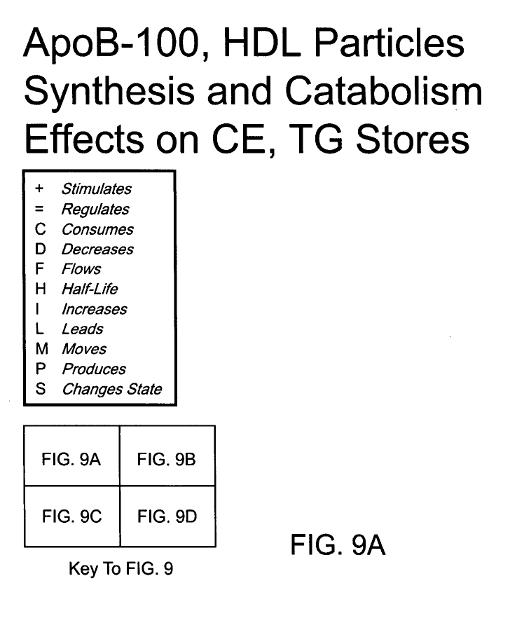

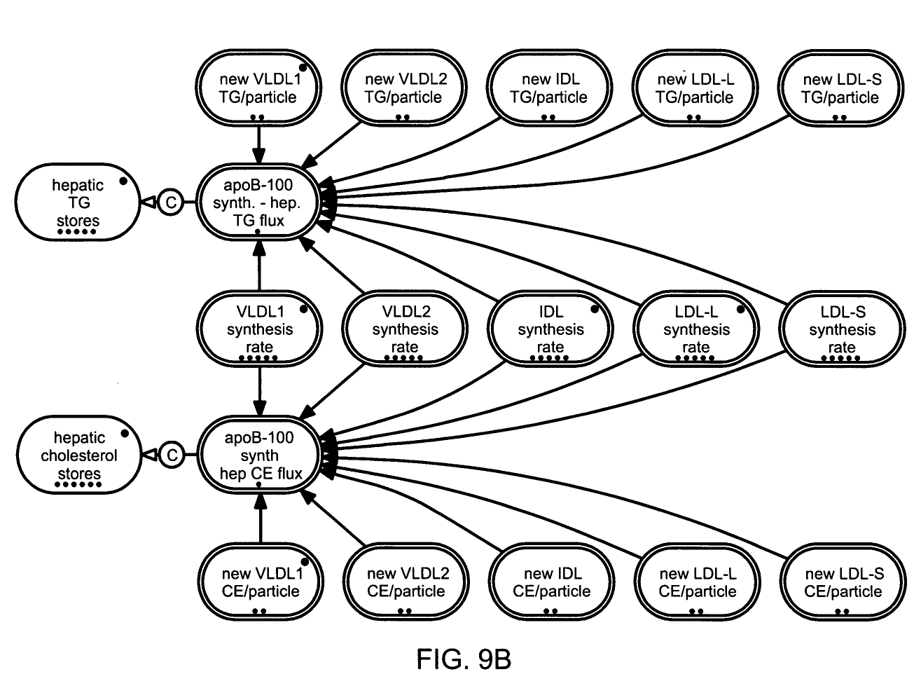

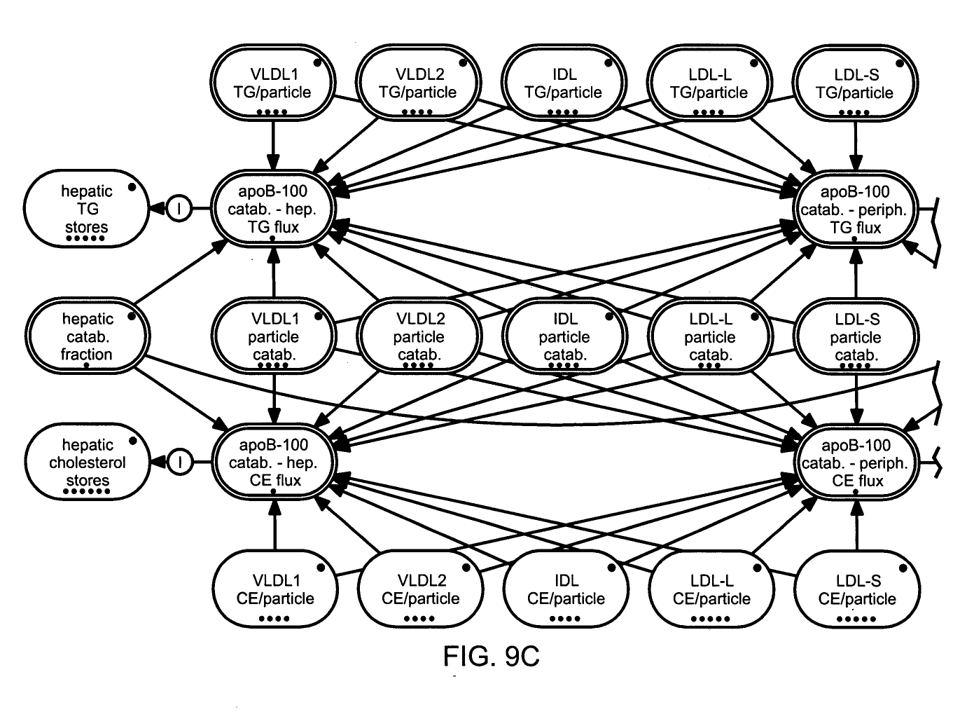

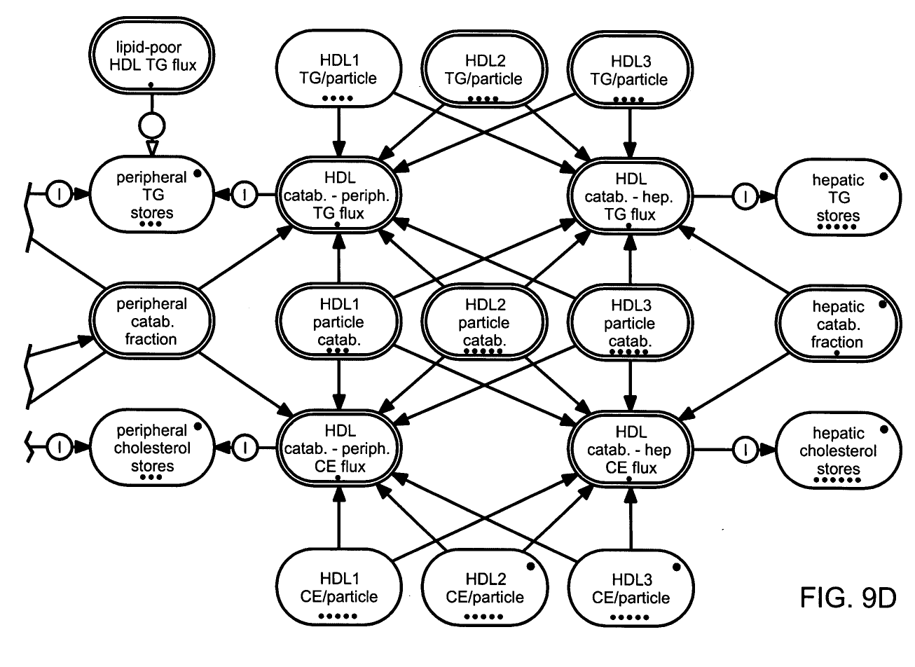

FIG. 9 illustrates an exemplary embodiment of a module depicting cholesteryl ester and triglyceride flux between the lipoprotein particle domain and the lipid molecule domain depicted in FIG. 3. FIG. 9 provides an Effect Diagram depicting the effects of apoB-100 and HDL particle synthesis and catabolism on cholesterol ester and triglycerides stores.

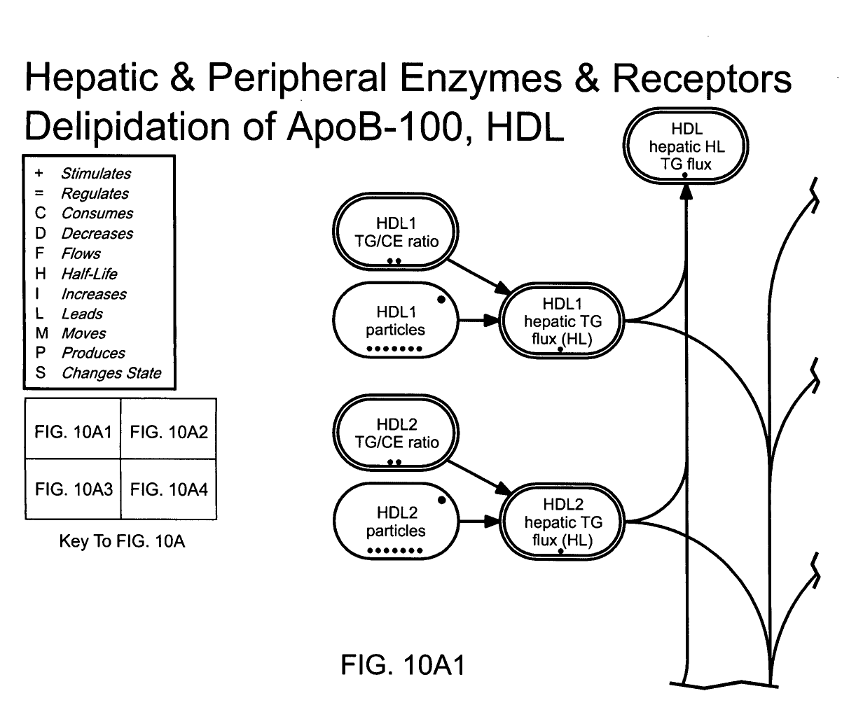

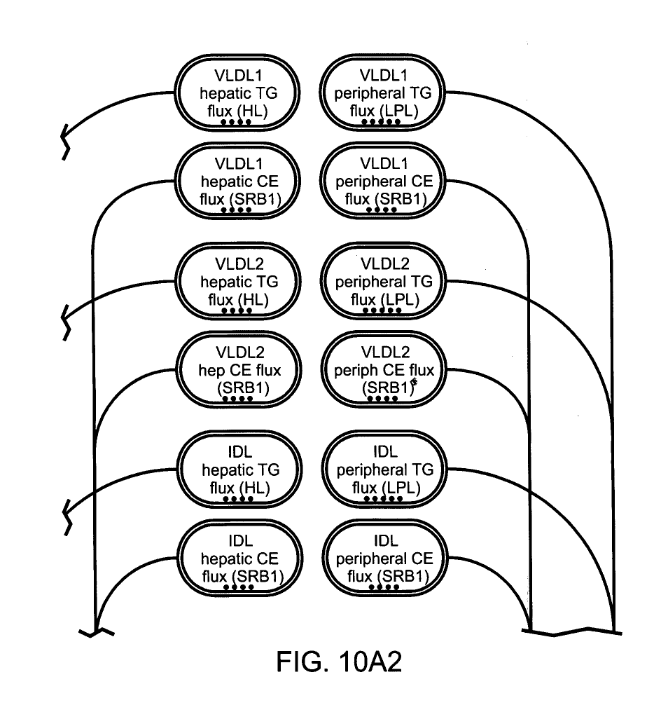

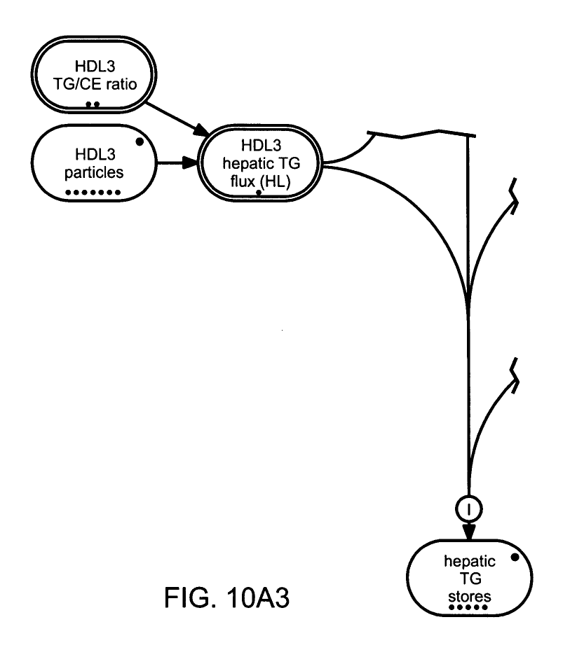

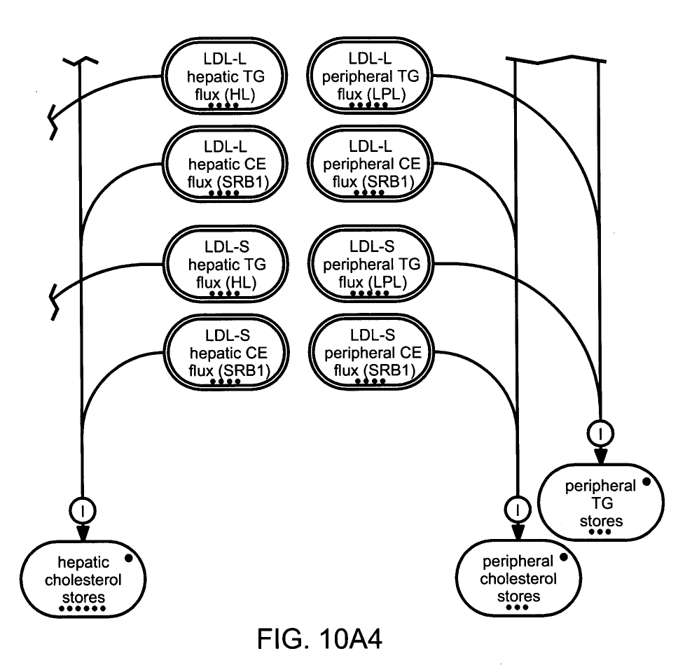

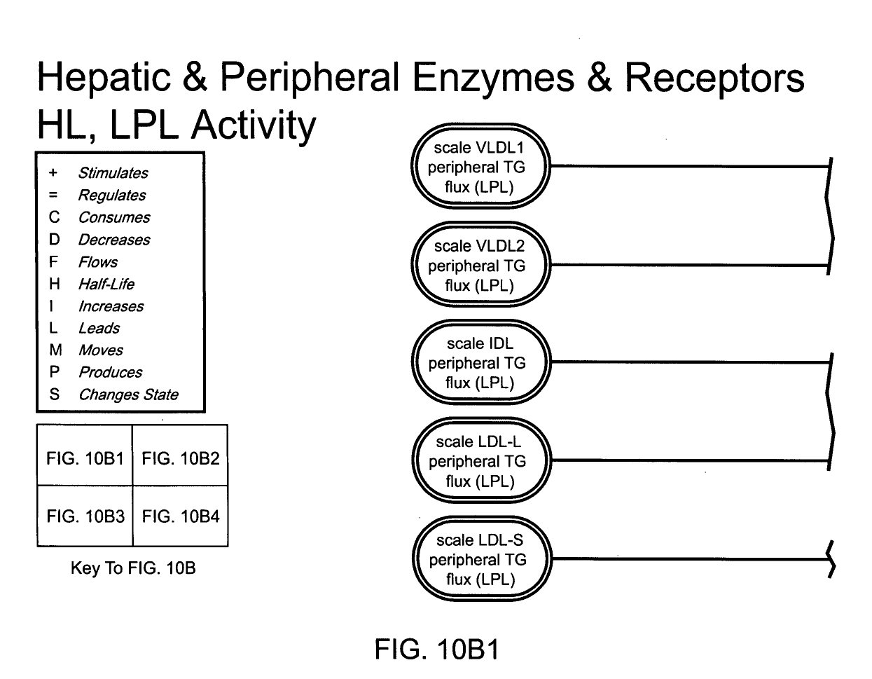

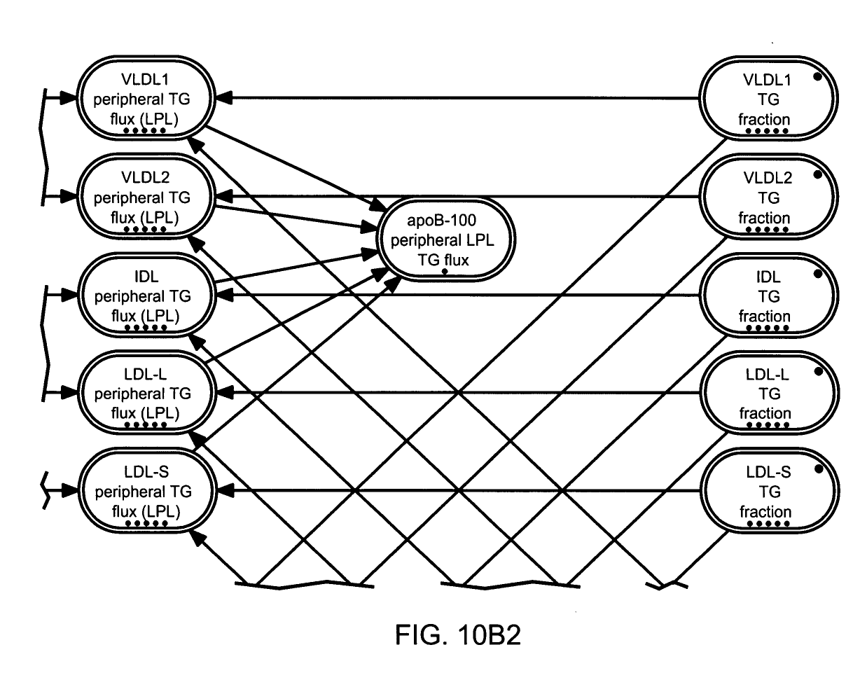

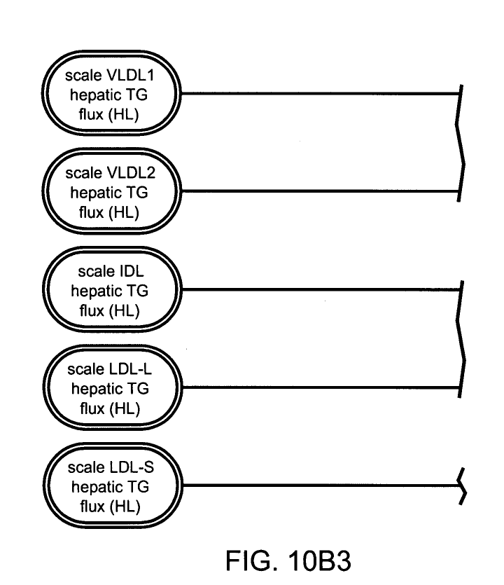

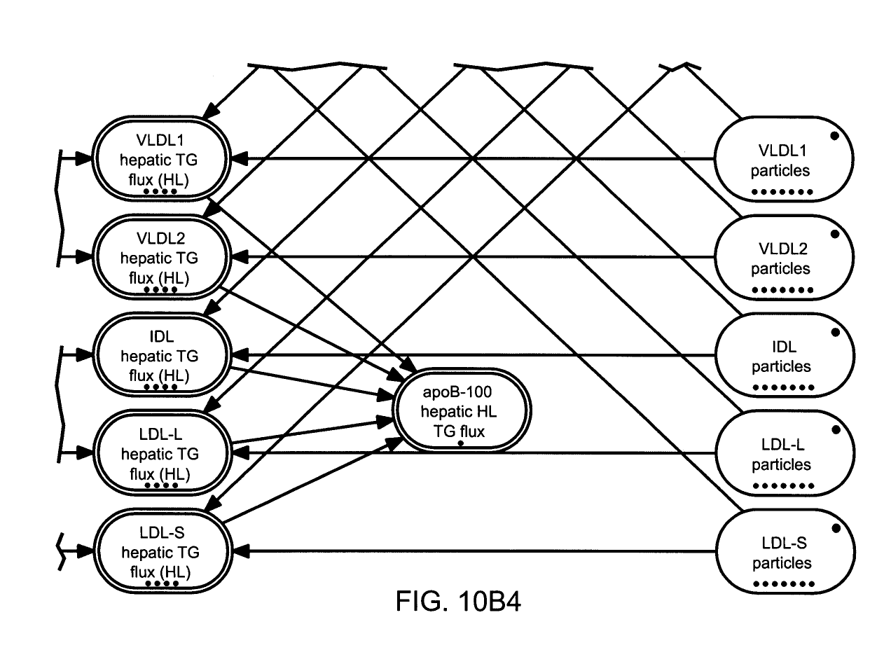

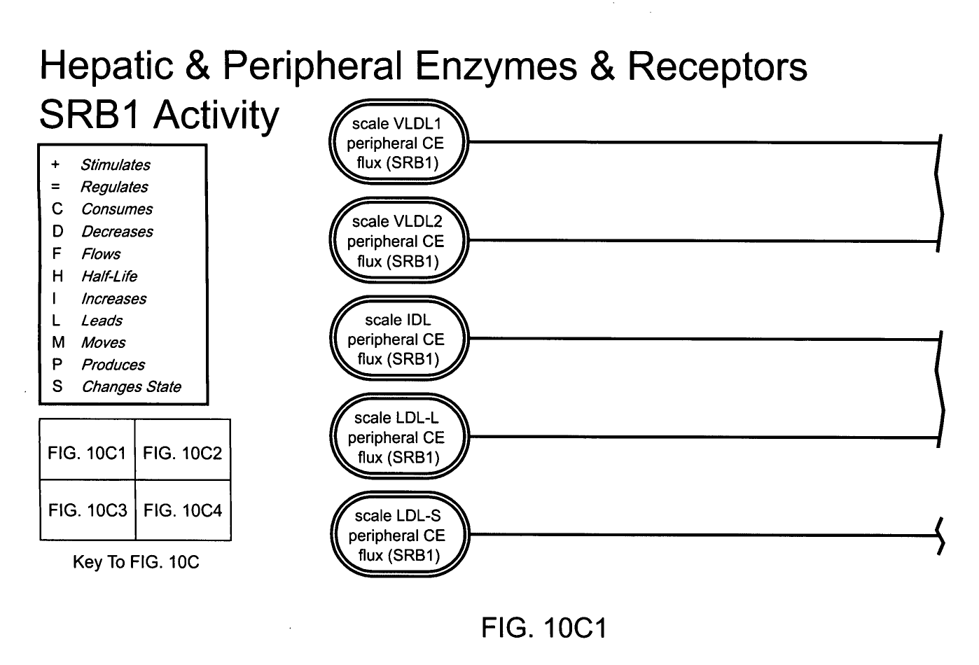

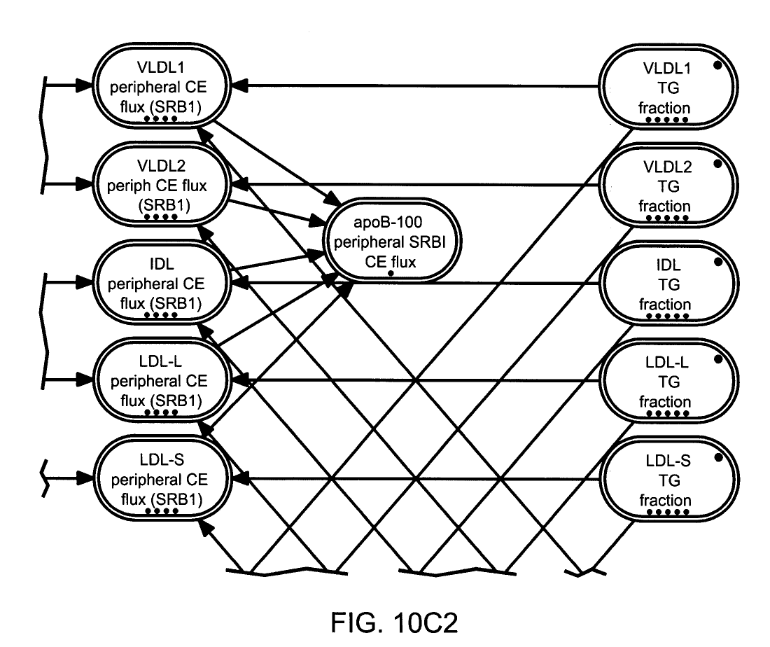

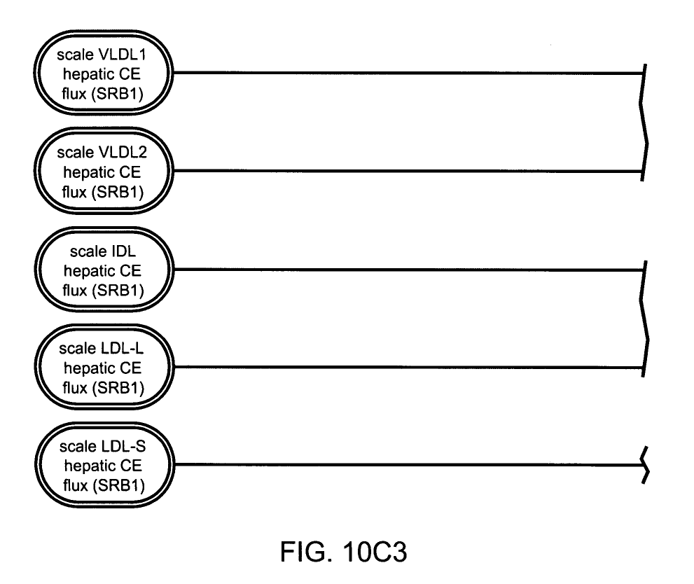

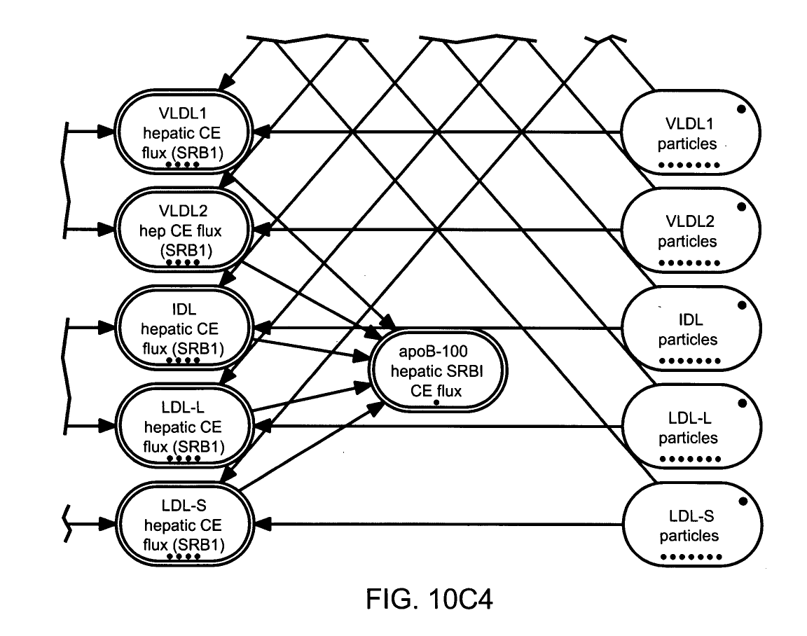

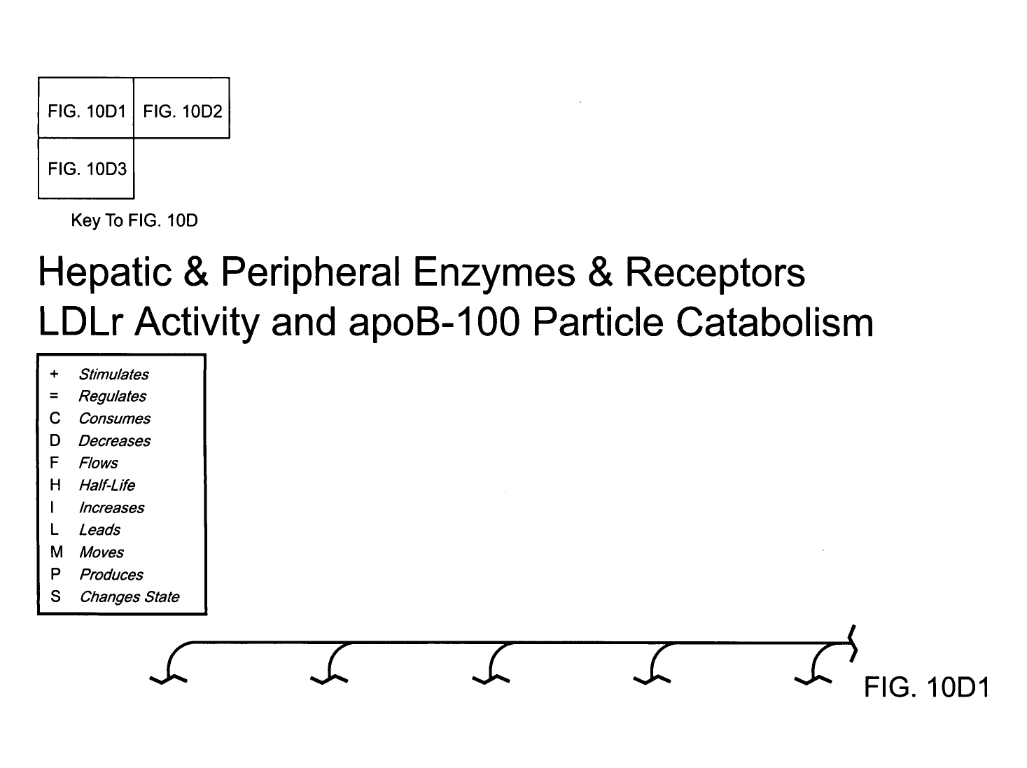

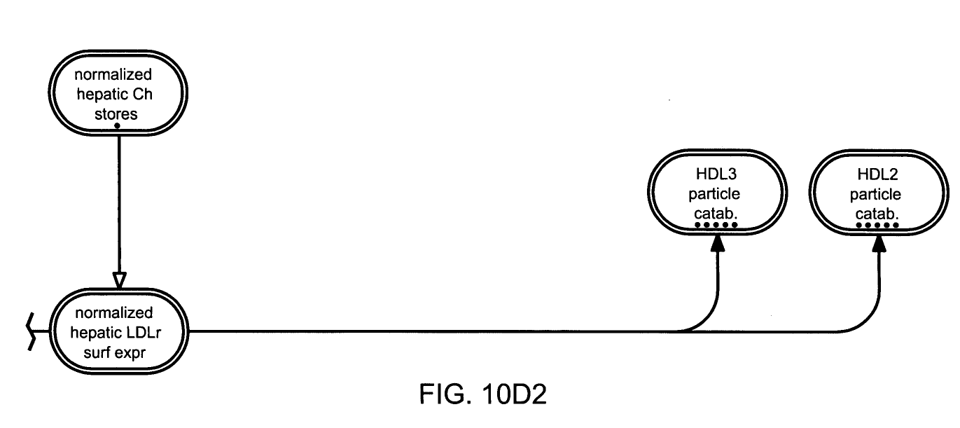

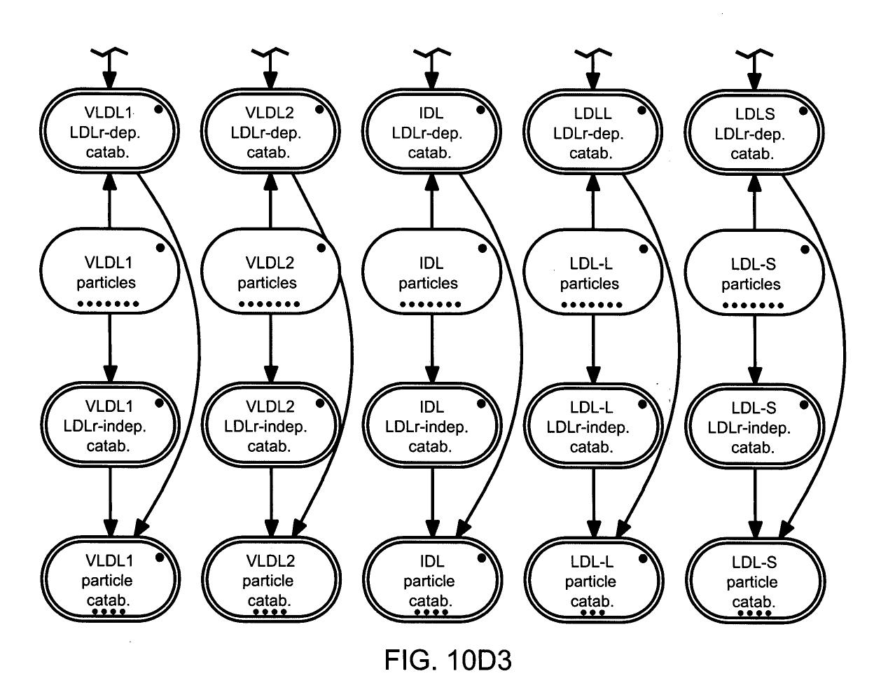

FIGS. 10A-10D illustrate exemplary embodiments depicting the effect of hepatic and peripheral enzymes and receptors on the delipidation of apoB-100 particles and HDL particles depicted in FIG. 2. FIG. 10A provides an Effect Diagram depicting the effect of certain hepatic and peripheral enzymes and receptors on delipidation of apoB-100 and HDL particles. FIG. 10B provides an Effect Diagram the activity of hepatic lipase (HL) and lipoprotein lipase (LPL) and their effect on lipid flux. FIG. 10C provides an Effect Diagram the activity of scavenger receptor class B type I (SRB1 or SR-B1) and its effect on lipid flux. FIG. 10D provides an Effect Diagram depicting the effect of low density lipoprotein receptor (LDLr) activity and the associated apoB-100 particle catabolism.

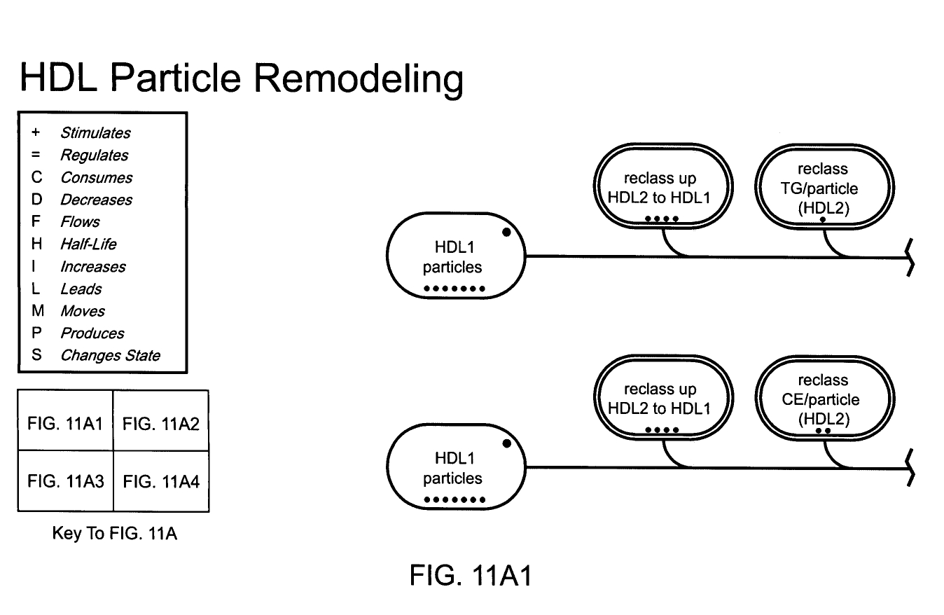

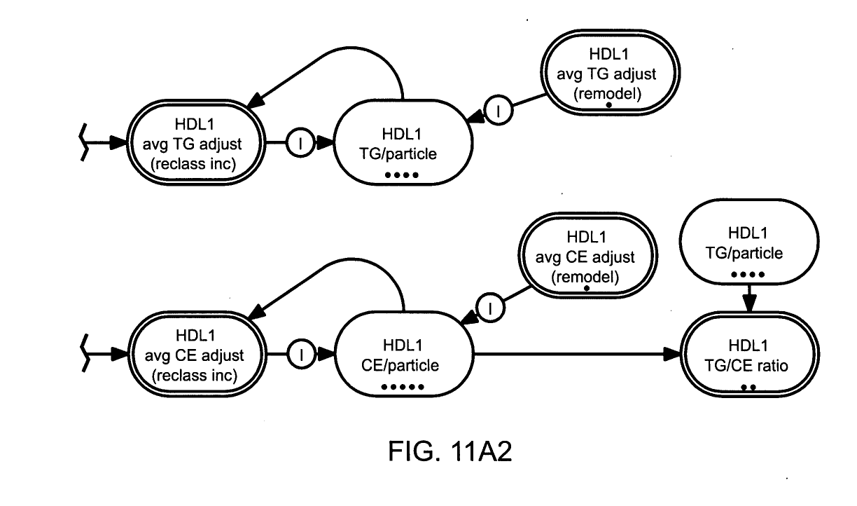

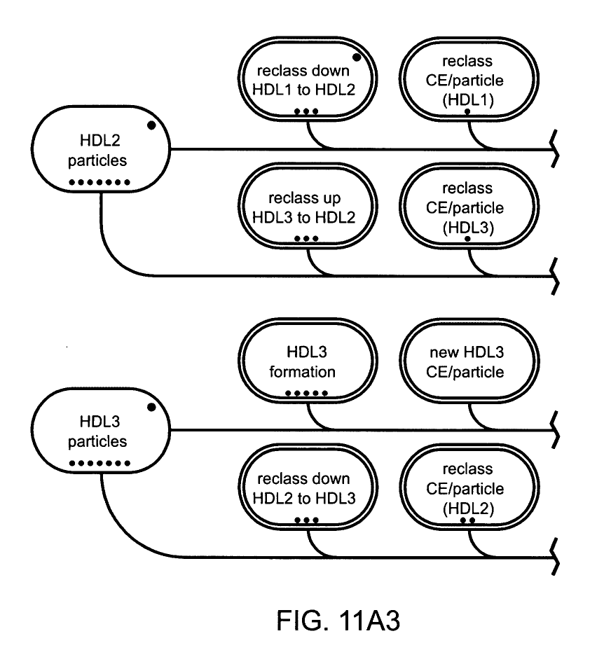

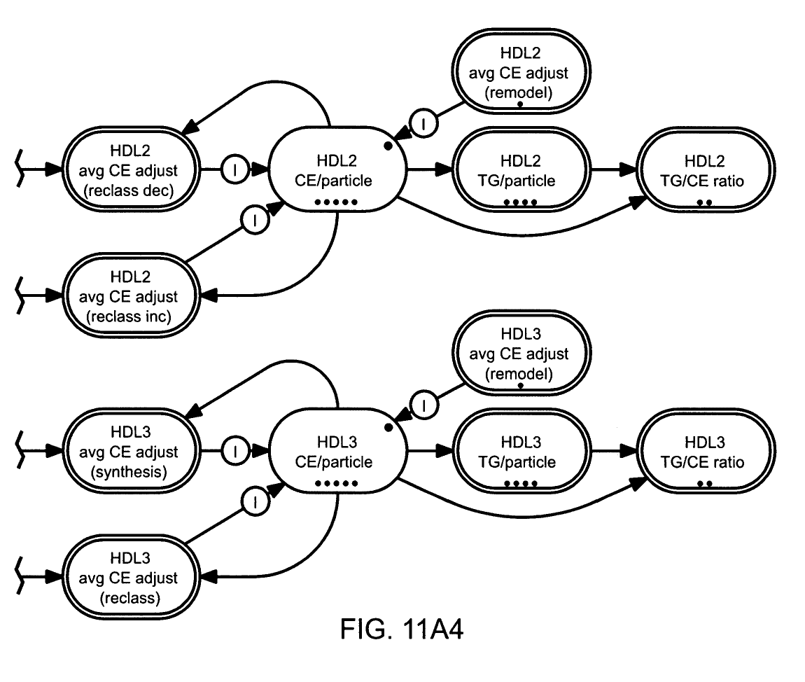

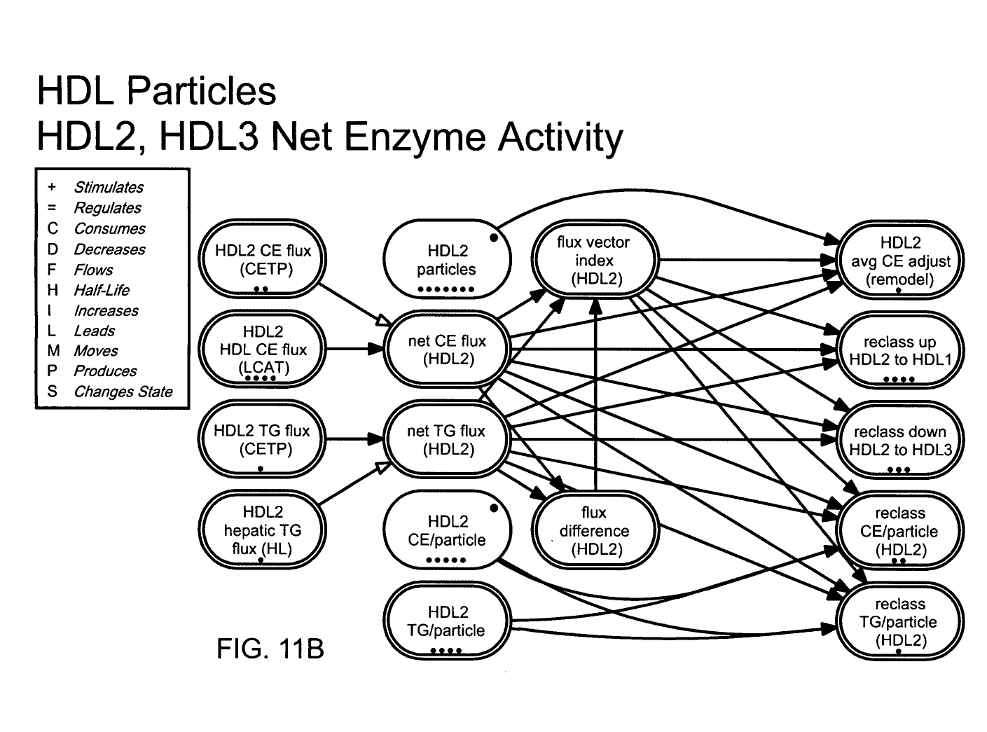

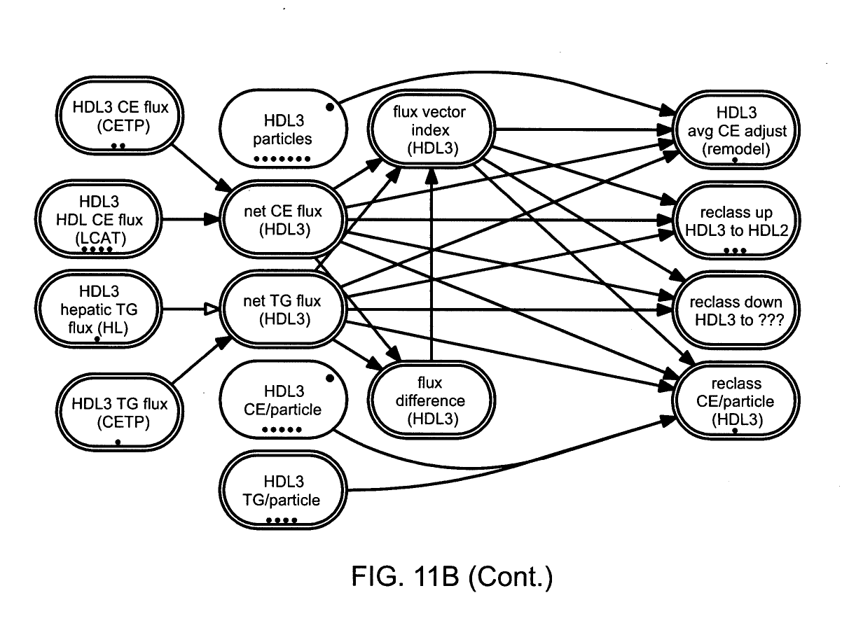

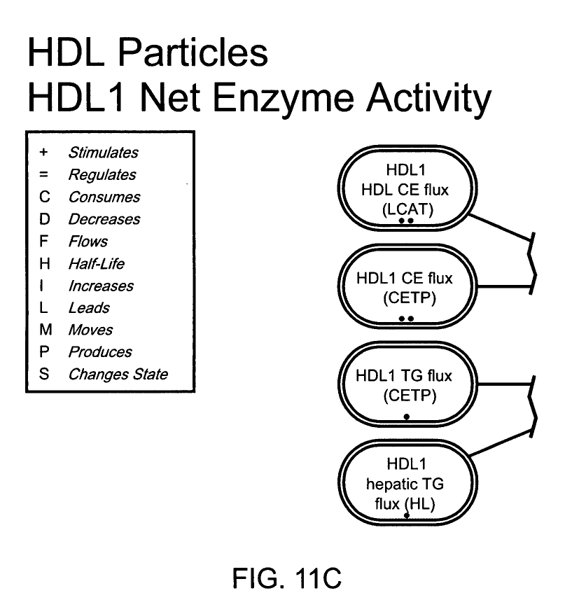

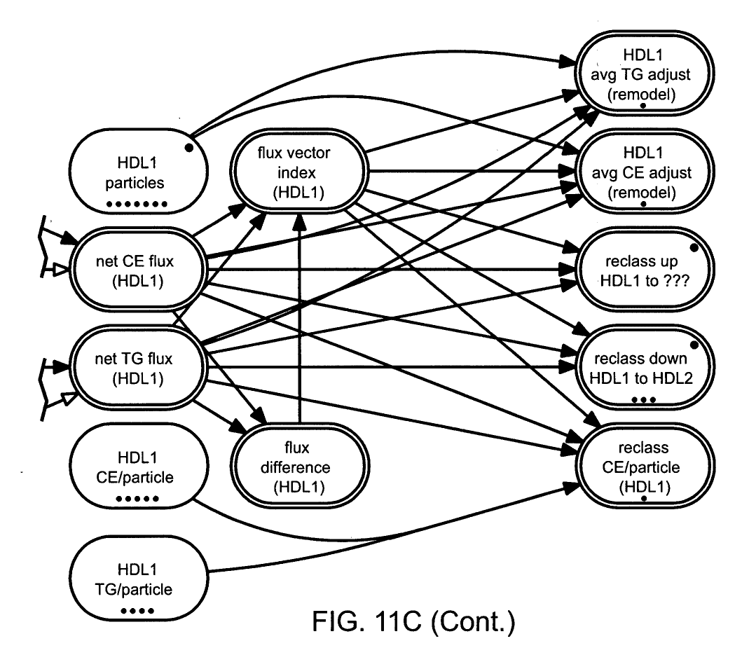

FIGS. 6, and 11A-11C illustrate exemplary embodiments of modules depicting biological processes affecting HDL particle synthesis, reclassification and catabolism. FIG. 6 provides an Effect Diagram depicting synthesis, reclassification and catabolism of HDL particles in general. FIG. 11A provides an Effect Diagram depicting HDL particle remodeling. FIG. 11B provides an Effect Diagram depicting net enzyme activity in HDL2 and HDL3 particles. FIG. 11C provides an Effect Diagram depicting net enzyme activity in HDL1 particles.

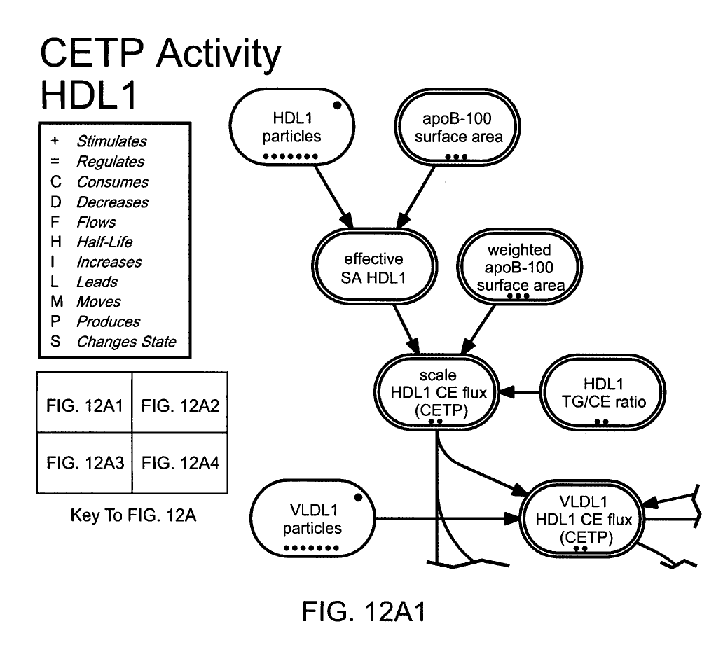

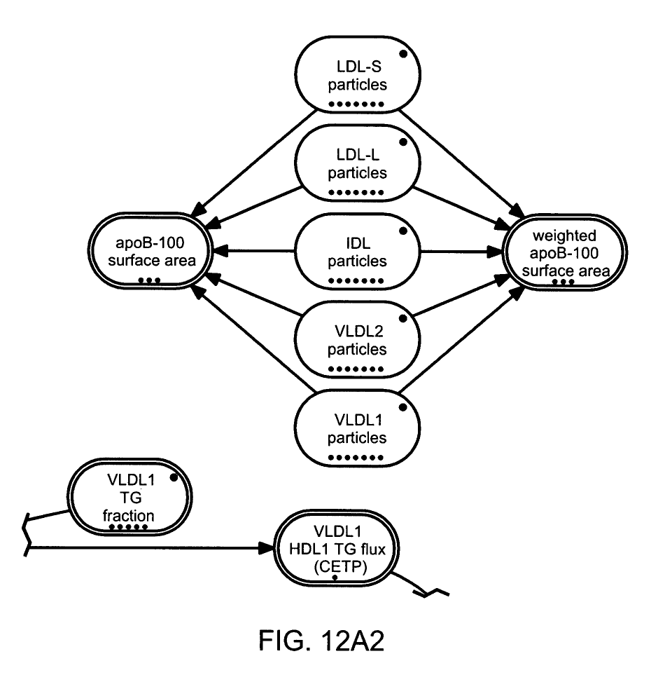

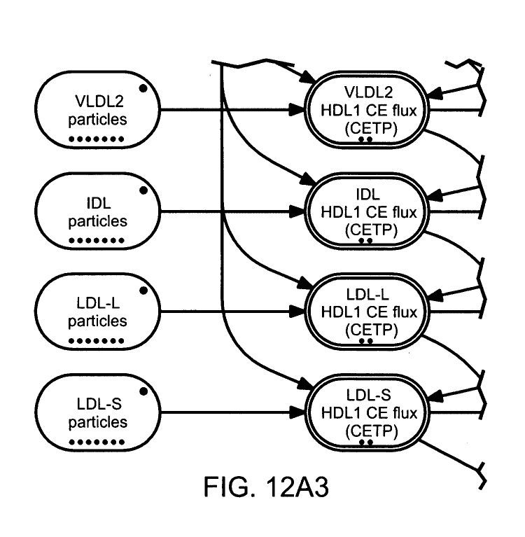

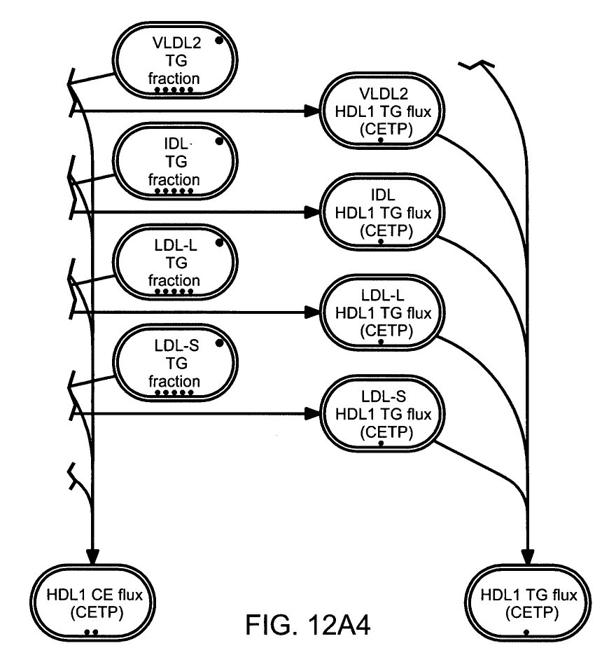

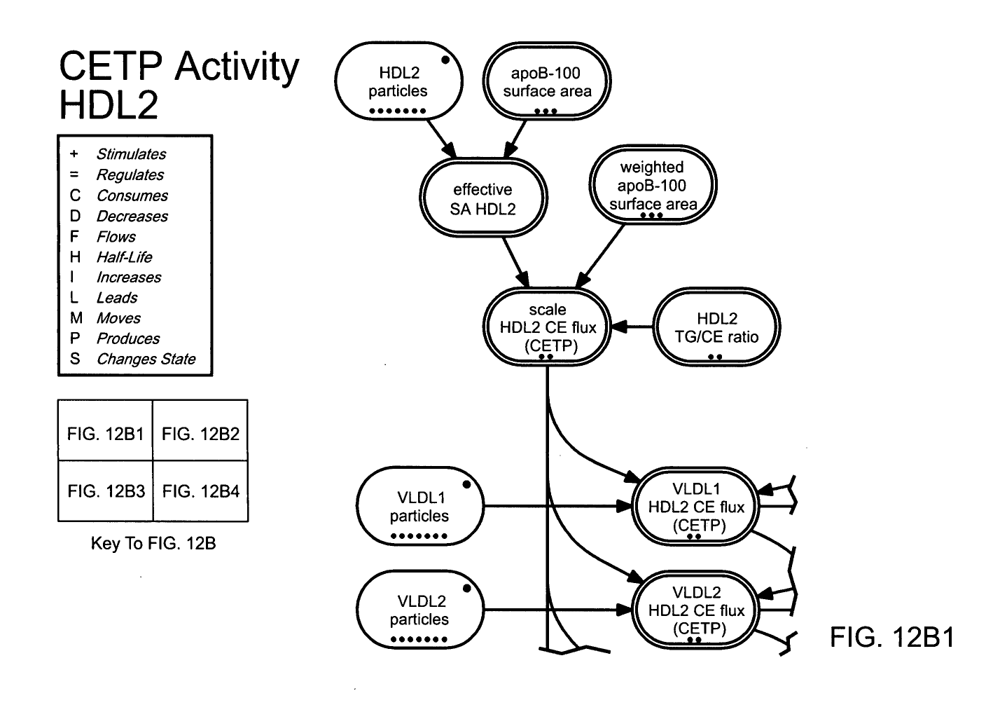

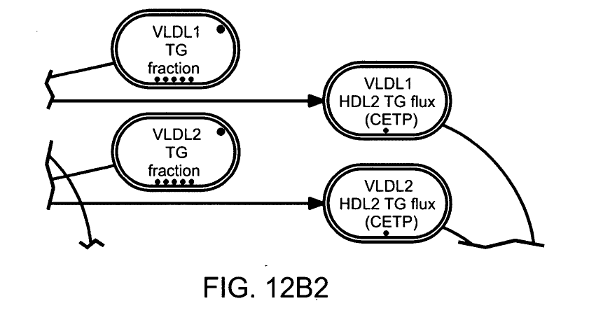

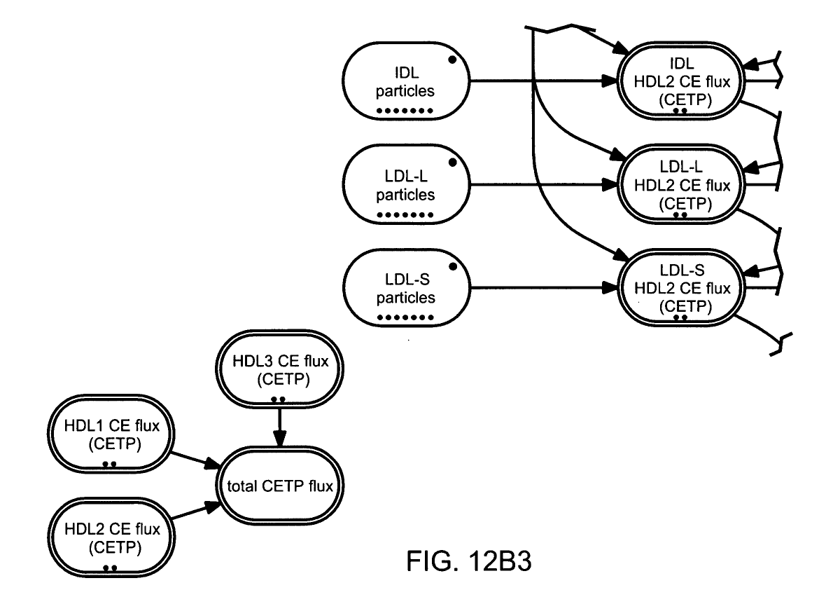

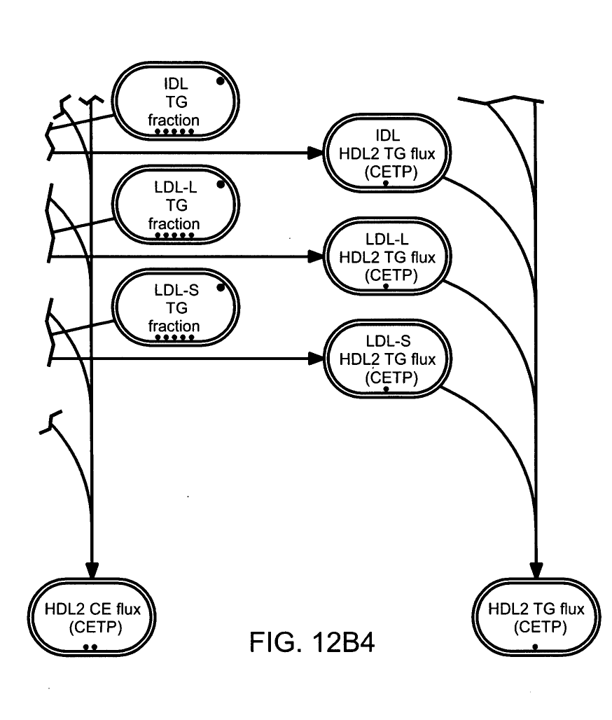

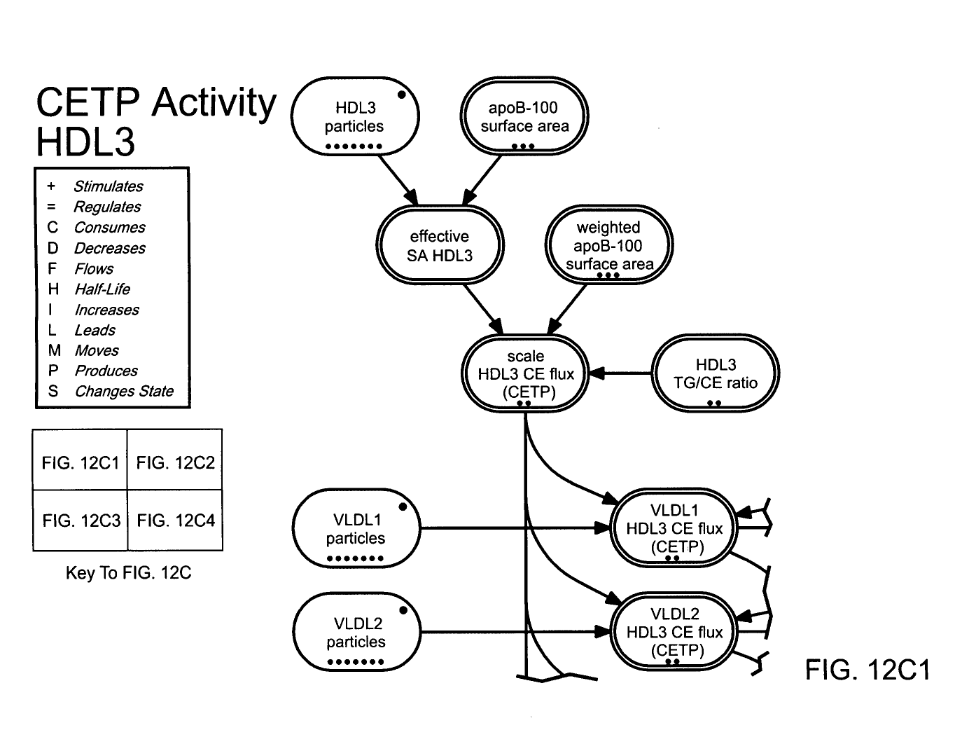

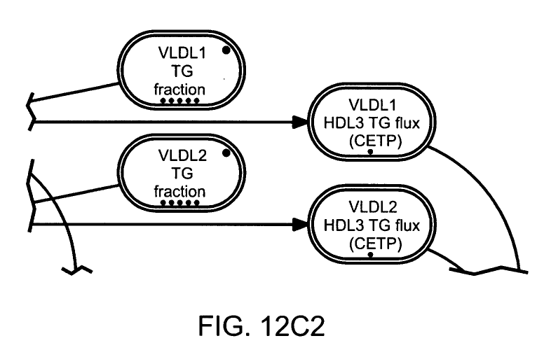

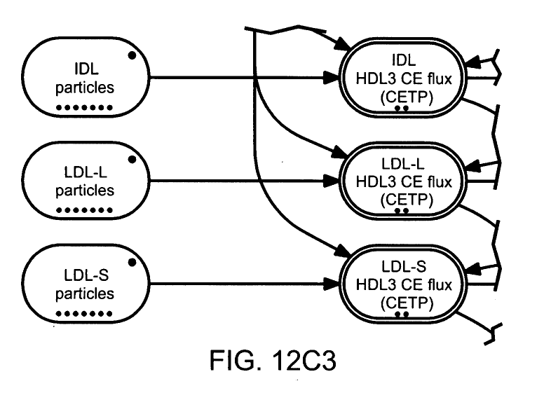

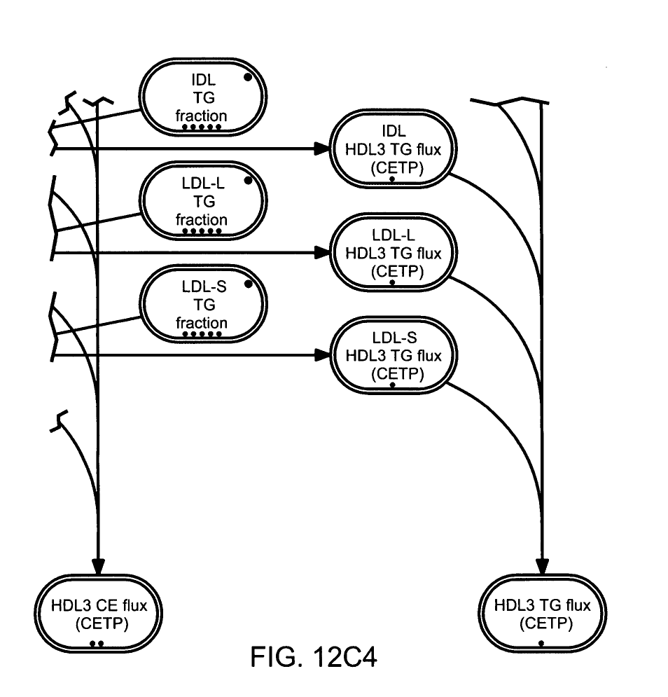

FIGS. 12A and 12B illustrate exemplary embodiments depicting cholesterol ester transfer protein activity the lipid composition of HDL and apoB-100 particles. FIG. 12A provides an Effect Diagram depicting CETP activity in HDL1 particles. FIG. 12B provides an Effect Diagram depicting CETP activity in HDL2 particles. FIG. 12C provides an Effect Diagram depicting CETP activity in HDL3 particles.

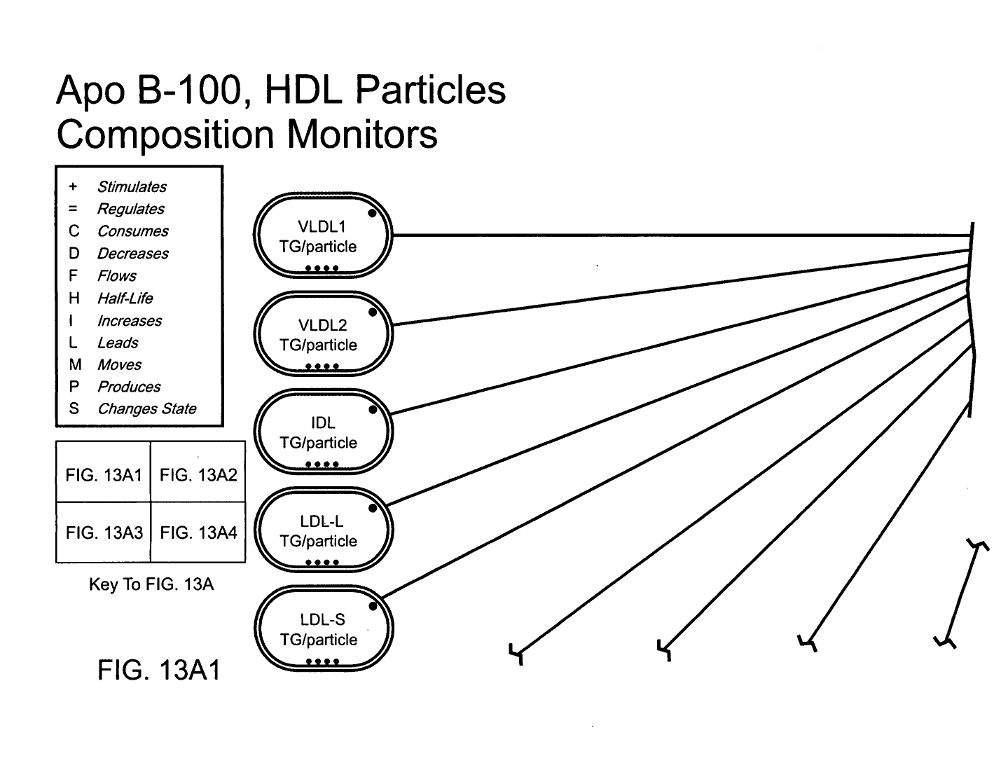

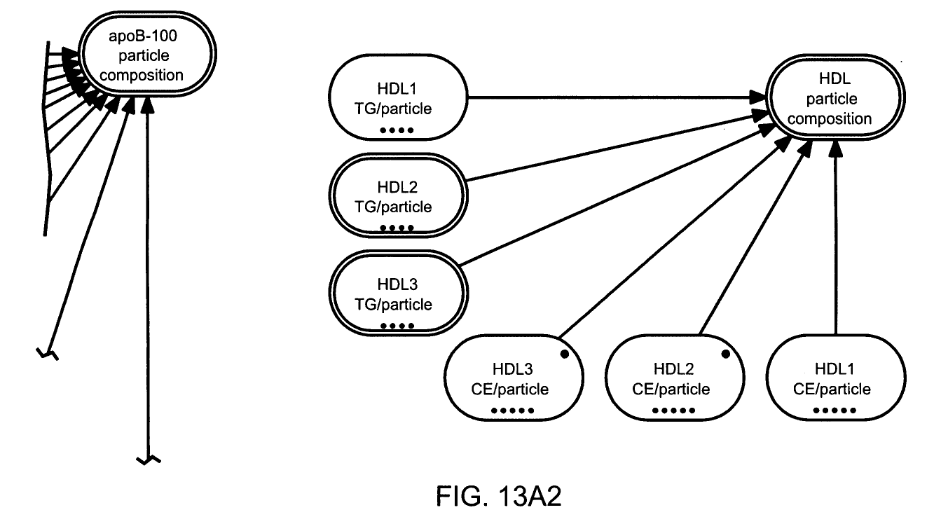

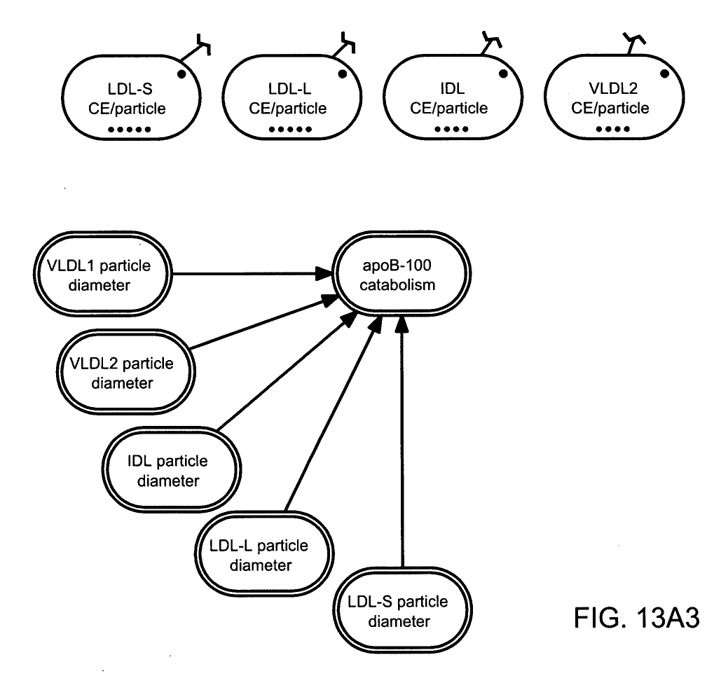

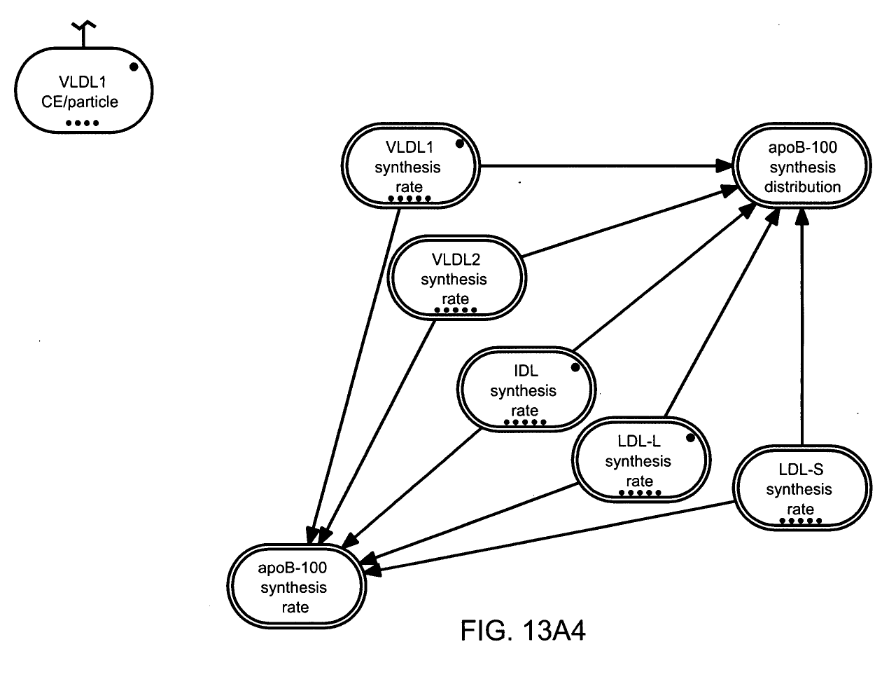

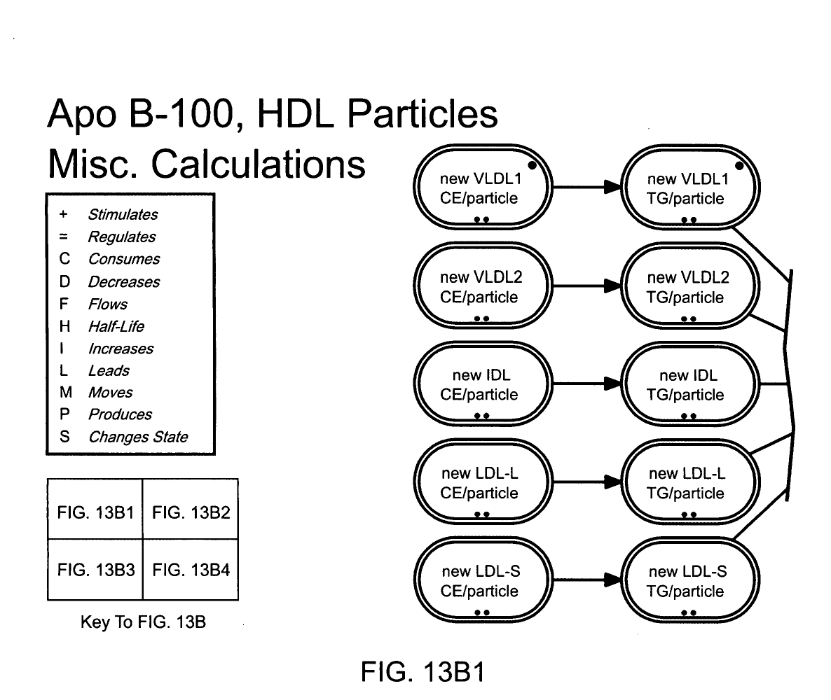

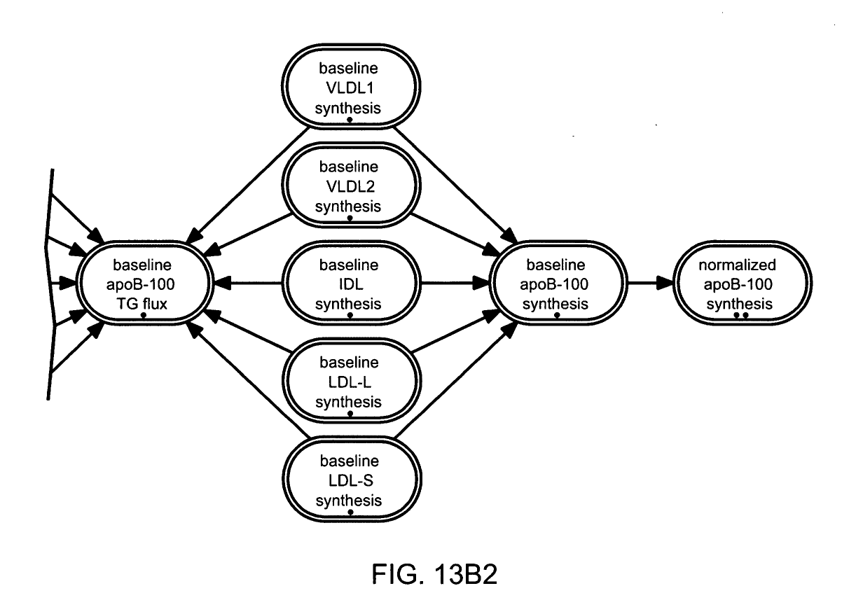

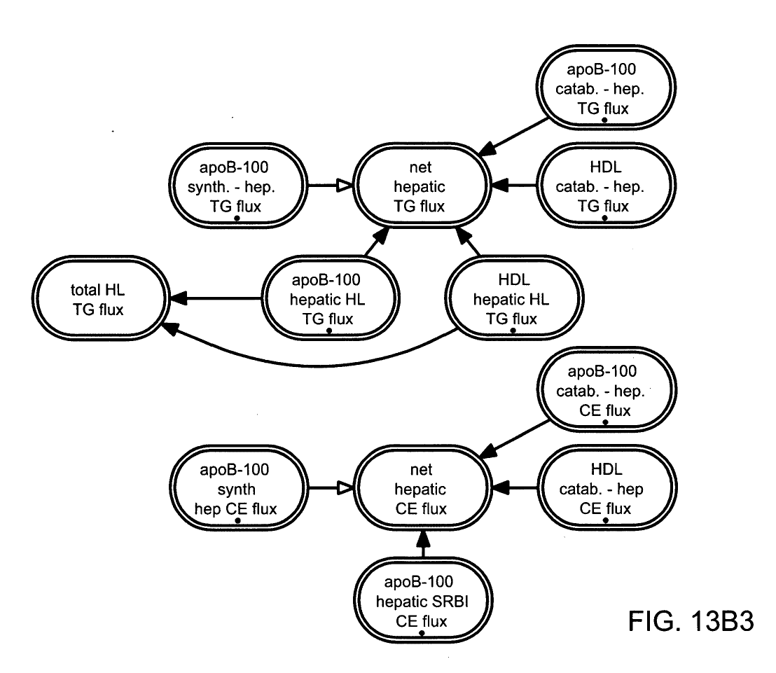

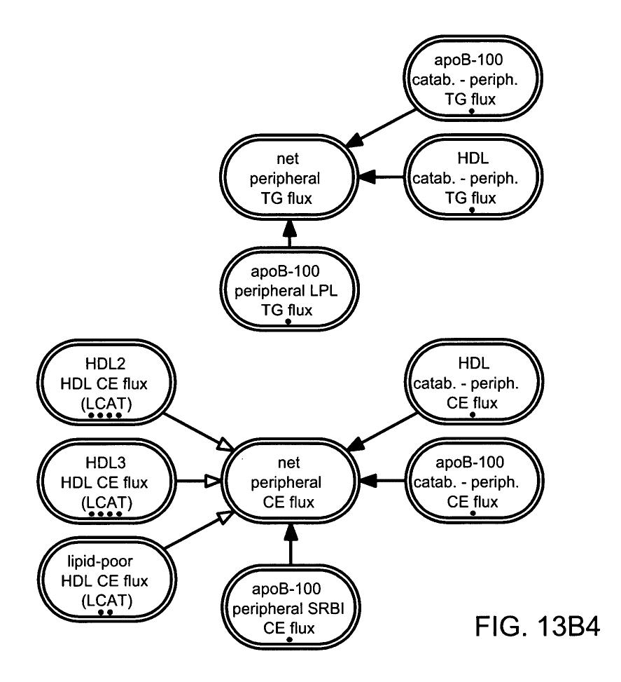

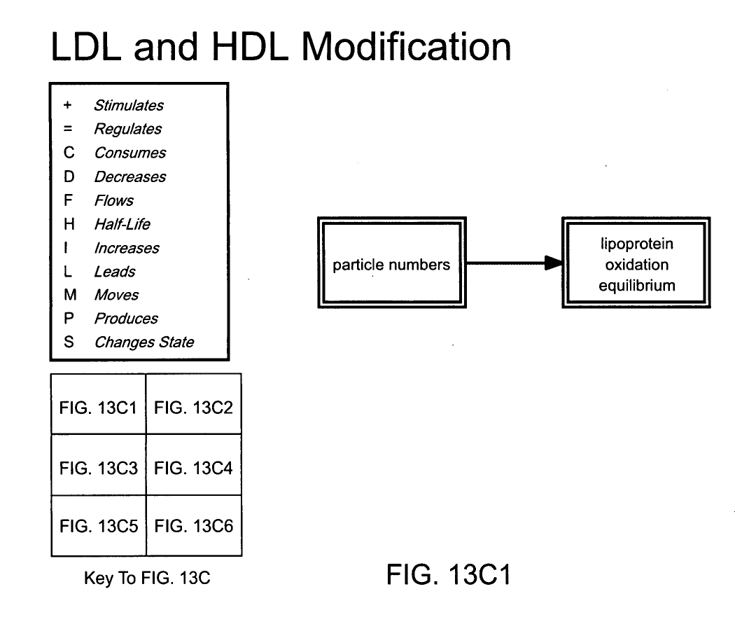

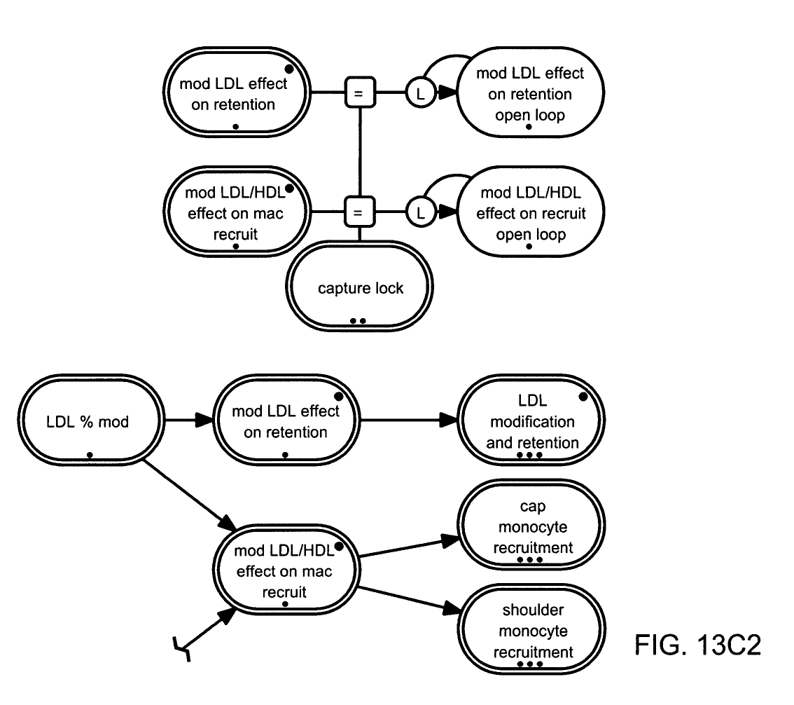

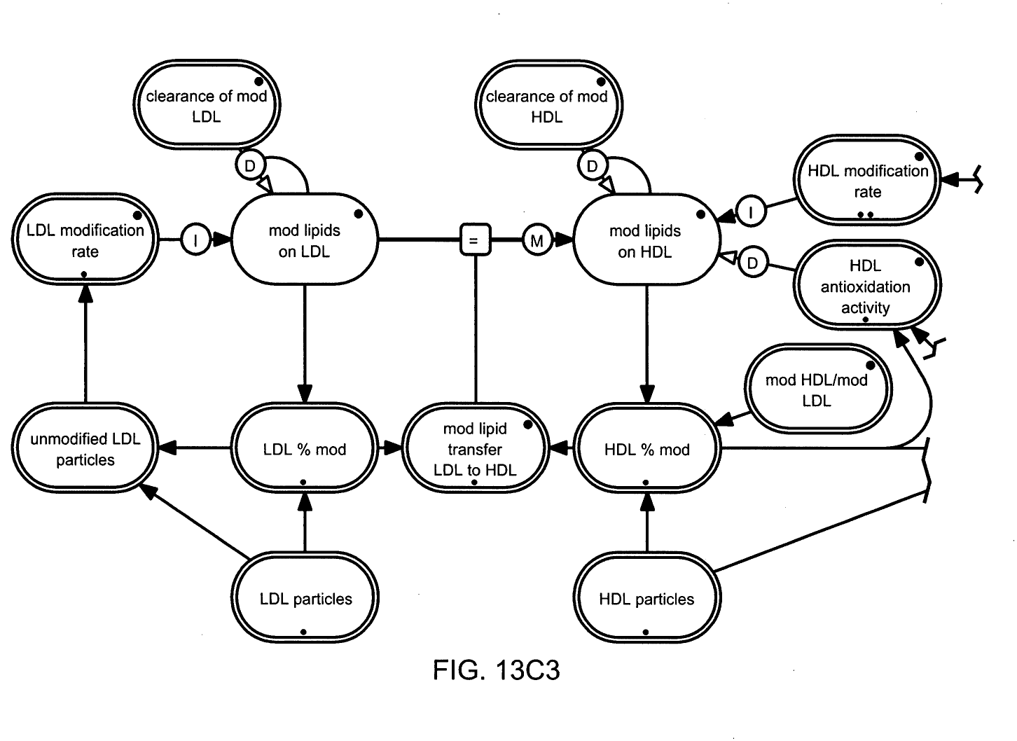

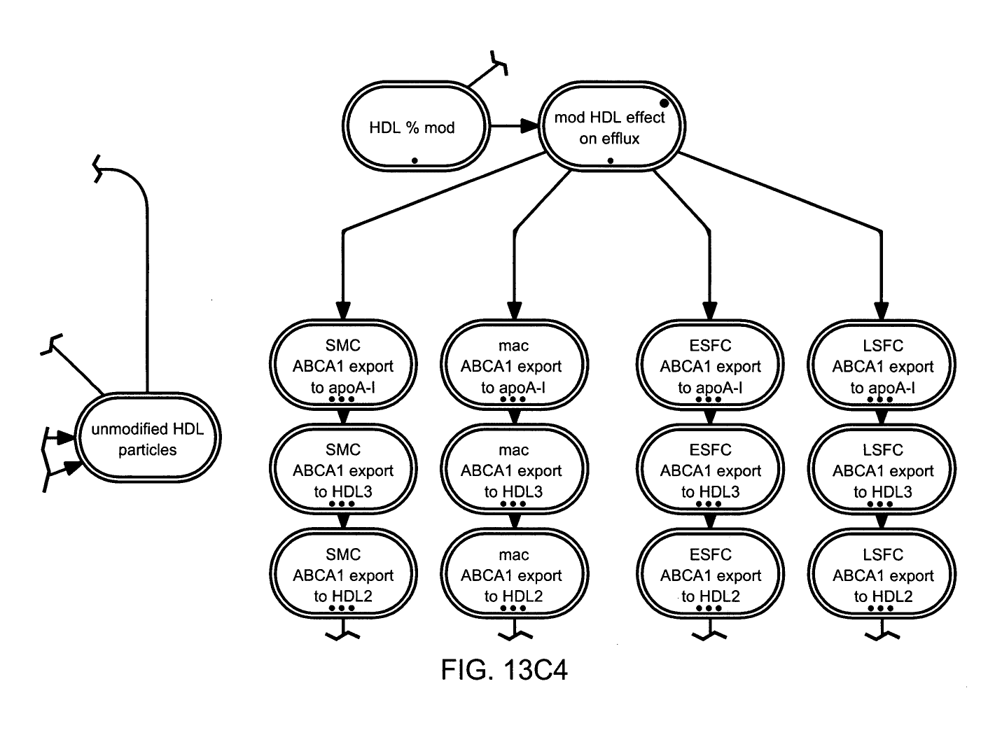

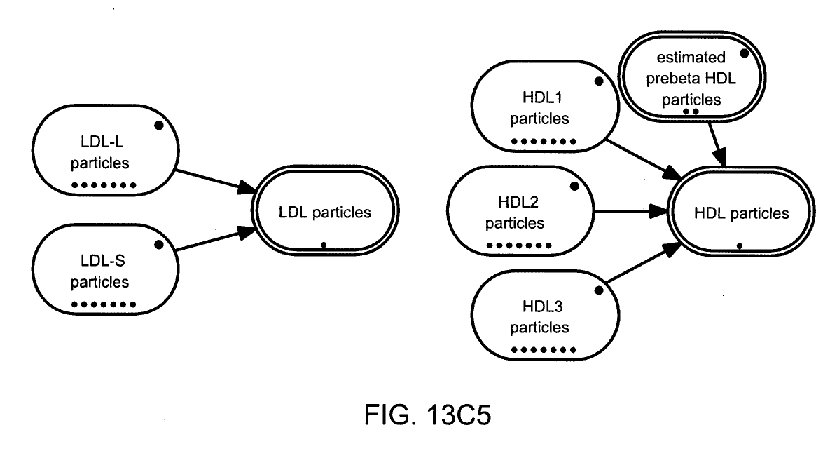

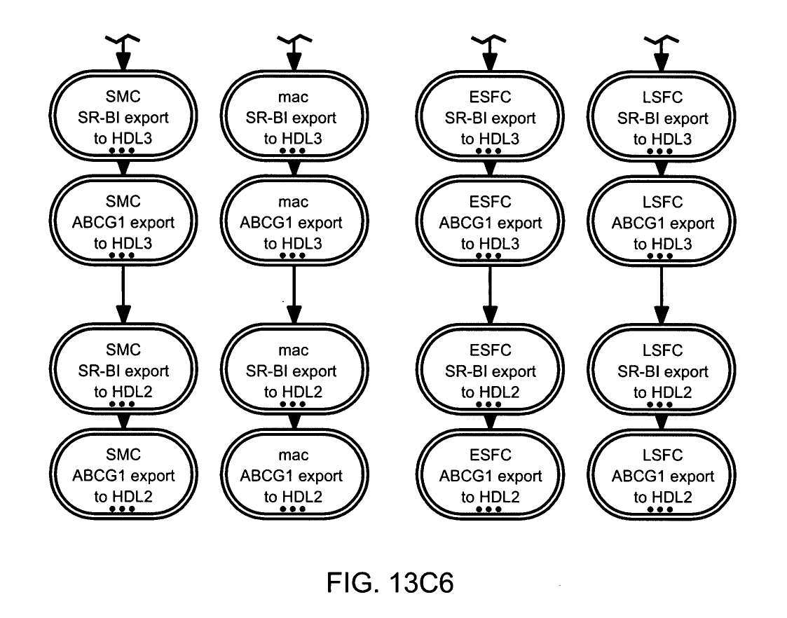

FIGS. 13A and 13B illustrate exemplary embodiments depicting additional biological processes that can affect the synthesis, catabolism, and lipid composition of apoB-100 particles and HDL particles. FIG. 13A provides an exemplary Effect Diagram illustrating characteristics related to monitoring the composition of HDL particles. FIG. 13B provides an Effect Diagram illustrating various calculations that can be made relating to HDL particles. FIG. 13C provides an Effect Diagram illustrating modifications that can occur to existing HDL and LDL particles that can affect cholesterol metabolism.

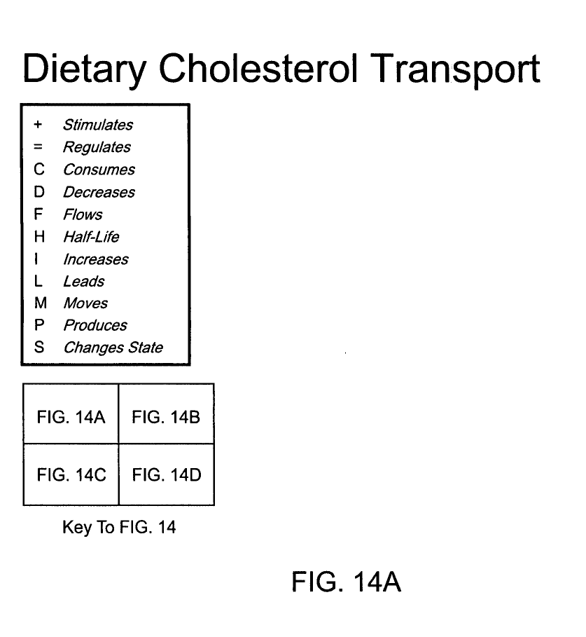

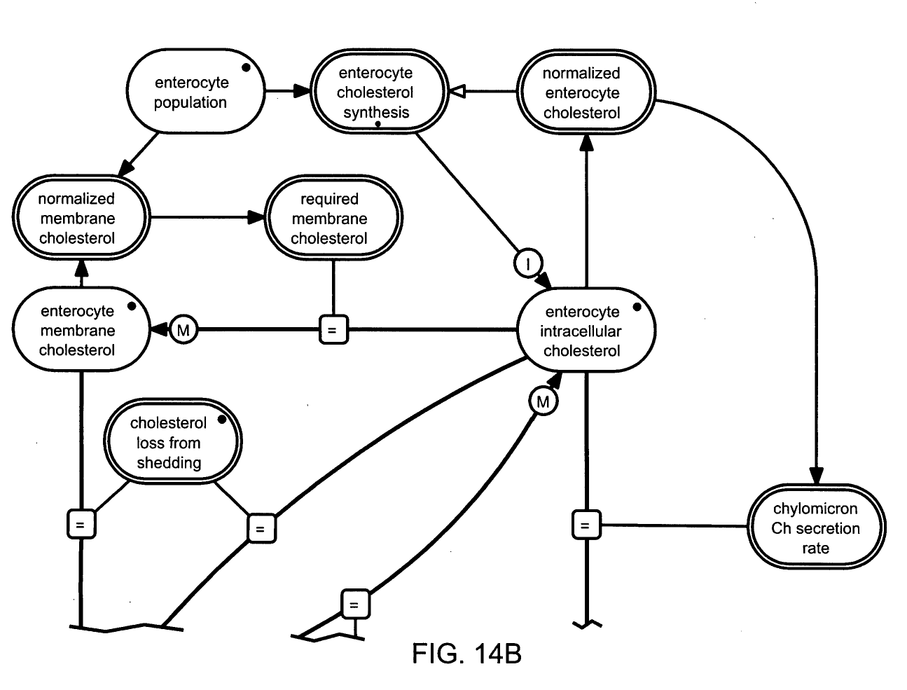

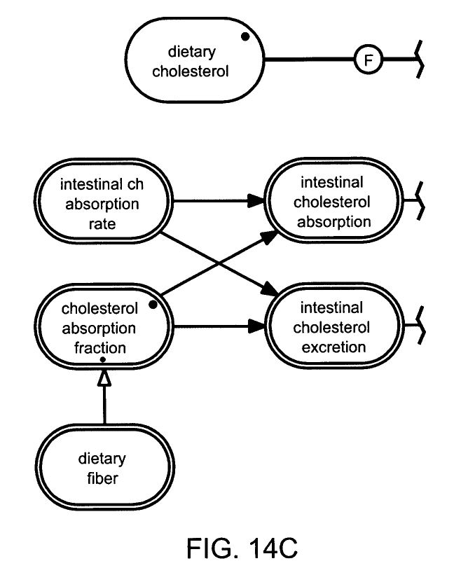

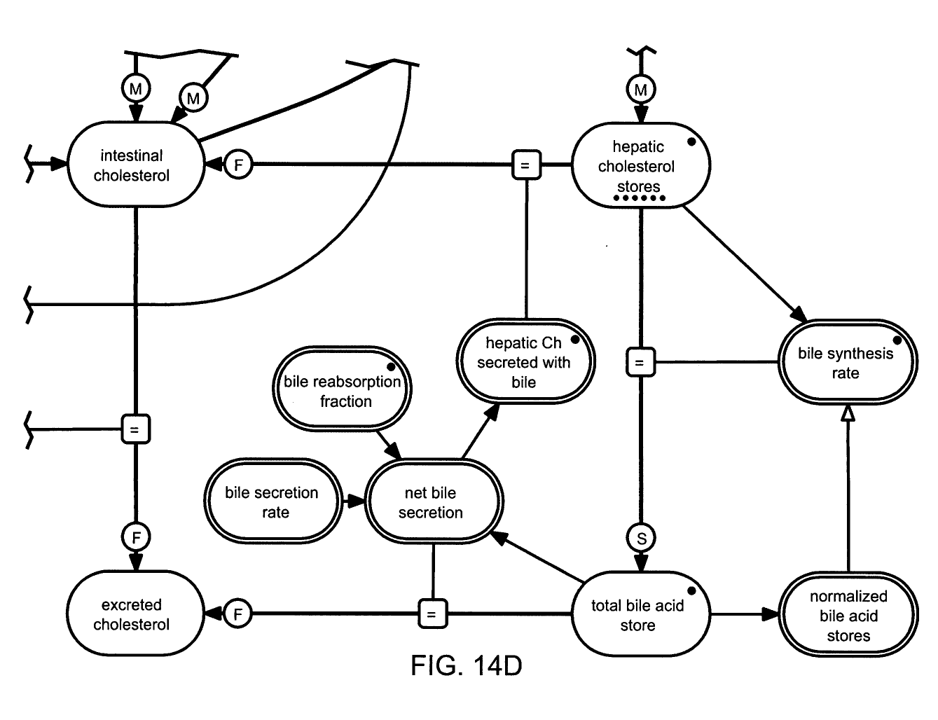

FIG. 14 illustrates an exemplary embodiment of a module depicting dietary cholesterol transport. The pathways described in FIG. 14 depict one method of modeling the processing of dietary cholesterol. In this embodiment, a fraction of the total amount of intestinal cholesterol is absorbed into the enterocytes; the remaining fraction is directly excreted. The absorbed cholesterol fraction is regulated by external factors, including dietary fiber or therapeutic interventions. Contributors to the total pool of intestinal cholesterol include (1) intracellular and membrane cholesterol in the enterocytes lost via cell shedding, and (2) dietary cholesterol sources. The absorbed intestinal cholesterol fraction contributes to the total intracellular enterocyte cholesterol pool. Cholesterol from this pool is transported to the hepatic compartment via chylomicra. In certain implementations, a time-averaged representation of chylomicron secretion by the enterocytes can be included rather than explicitly representing transient chylomicron dynamics in the postprandial state. Cholesterol can be removed from the hepatic pool by (1) packaging and synthesis of lipoprotein particles, (2) conversion into bile and excreted via secretion into the intestinal tract, or (3) transport of unconverted cholesterol trapped in the bile into the intestinal tract.

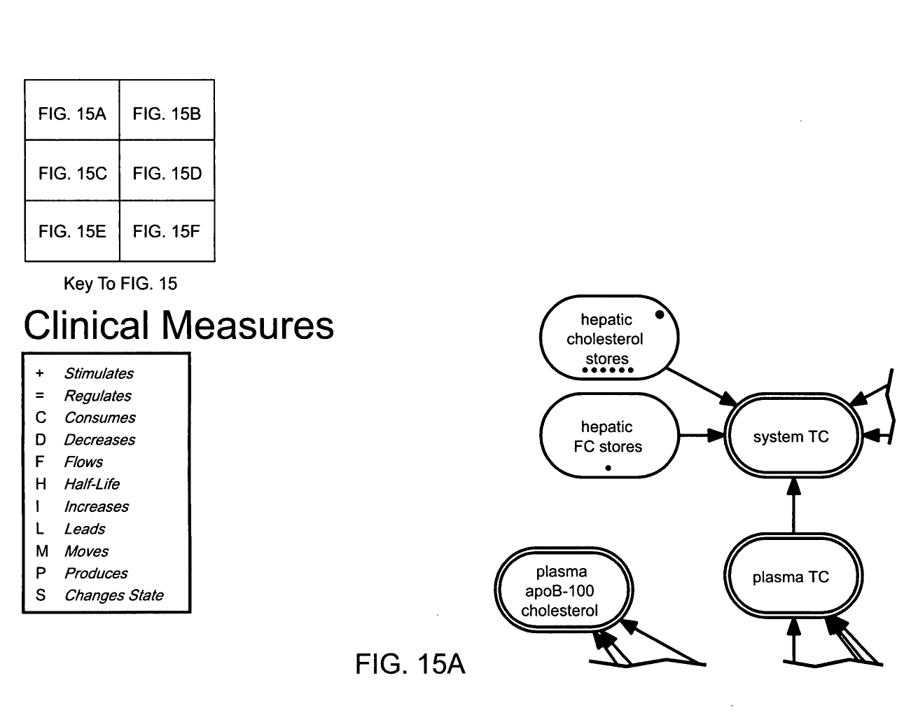

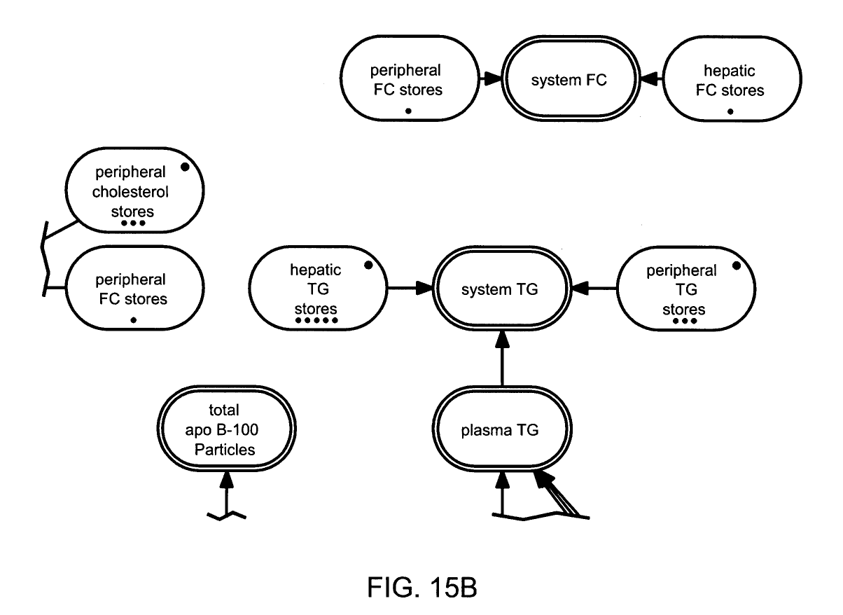

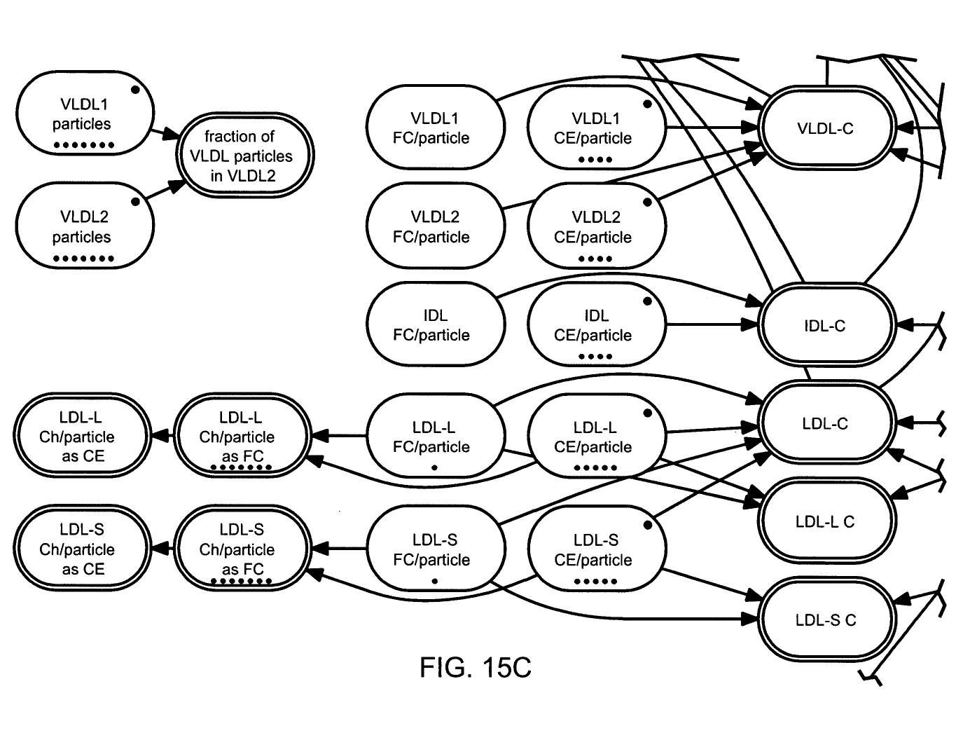

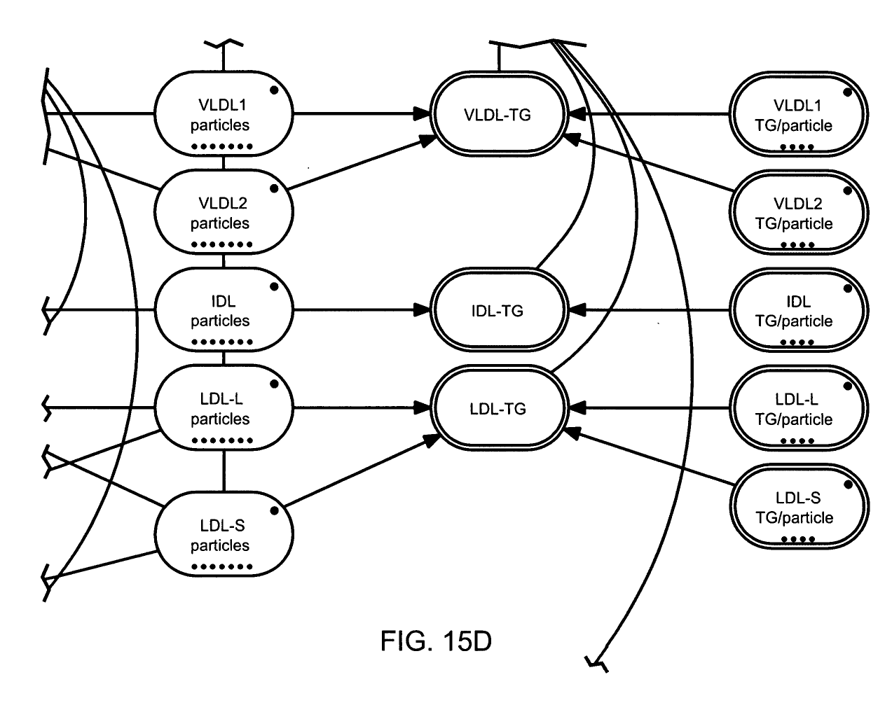

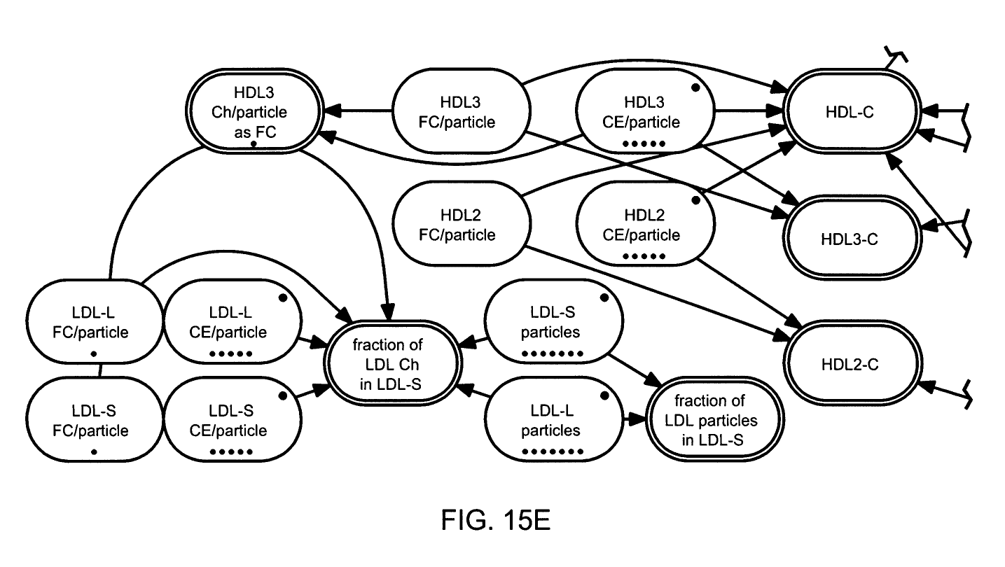

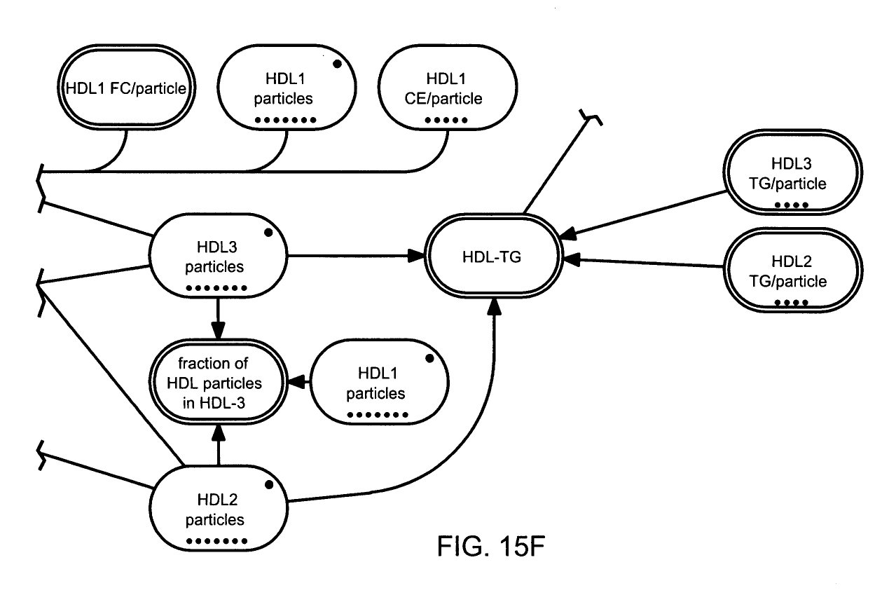

FIG. 15 illustrates an exemplary embodiment of a module depicting various clinical measures used to provide data for the biological processes depicted in the modules.

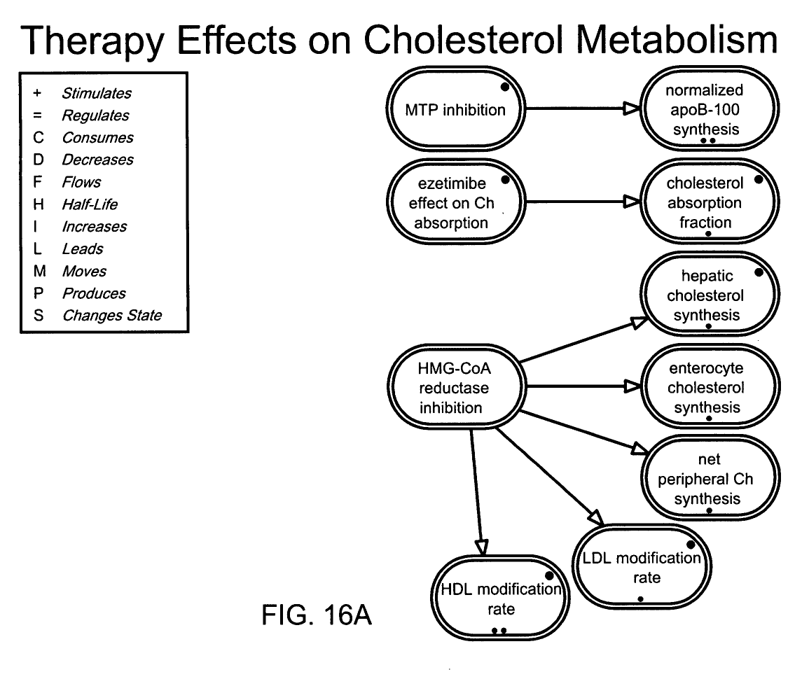

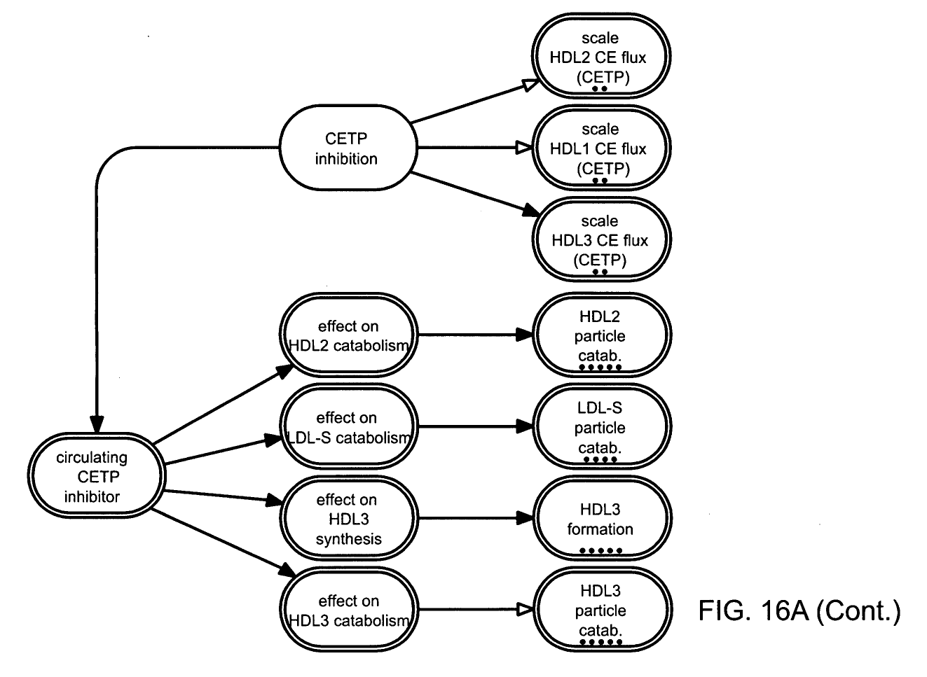

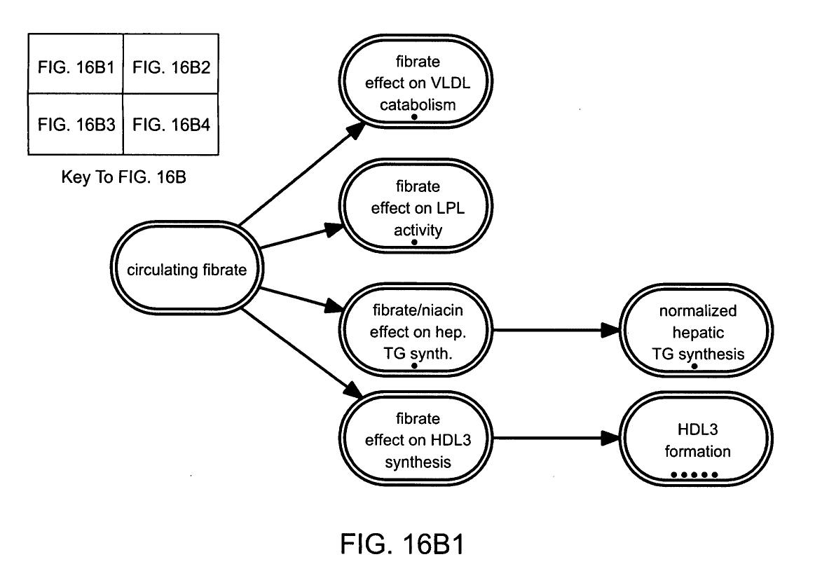

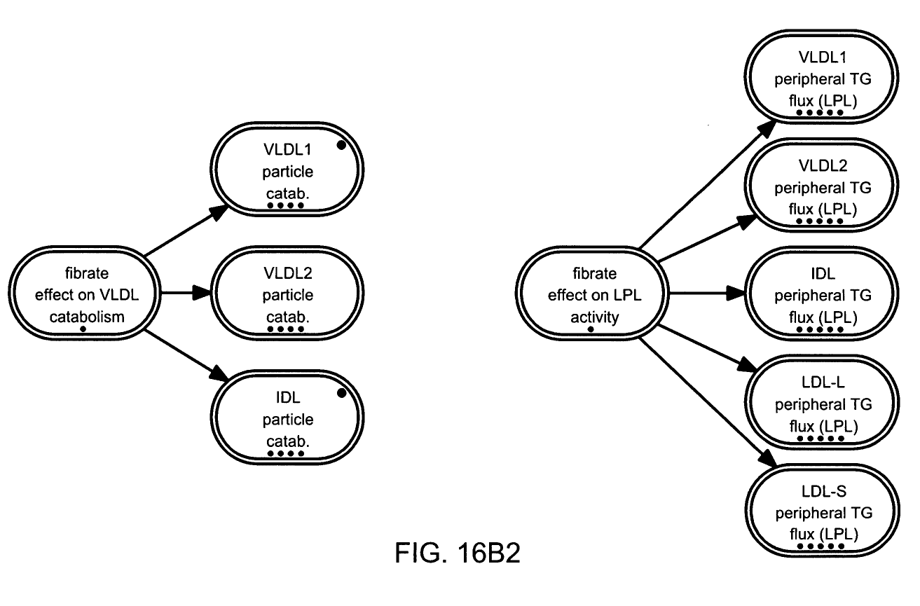

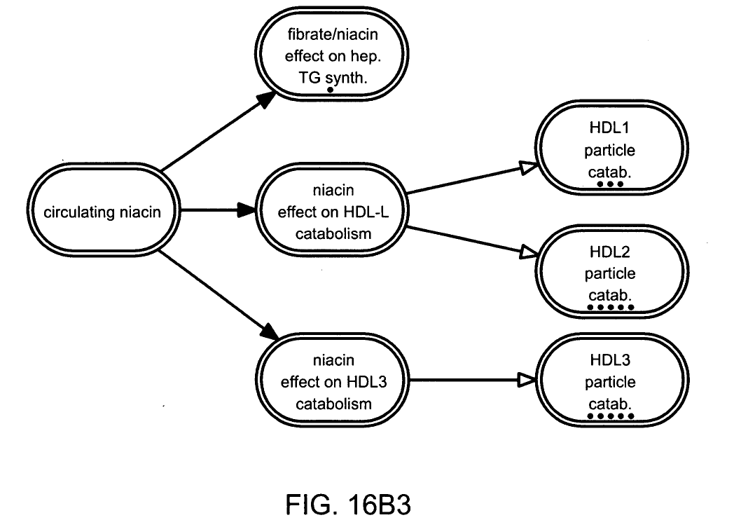

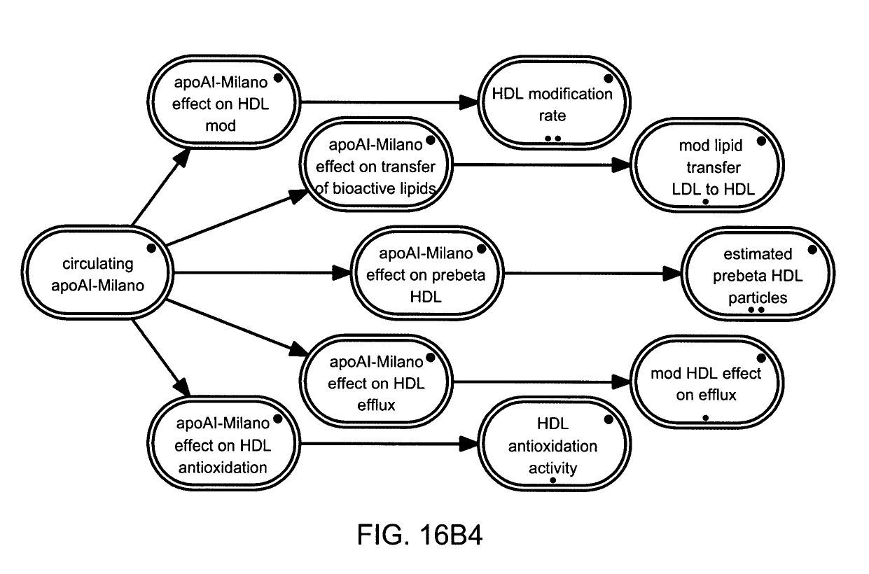

FIGS. 16A and 16B provides an exemplary Effect Diagram illustrating the effects of various therapies on cholesterol metabolism. Exemplary therapies that can be simulated using the models and systems of the invention include, microsomal triglyceride transfer protein (MTP) inhibition, ezetimibe, HMG-CoA reductase inhibition, fibrate, niacin, CETP inhibition, and apoA1-Milano, a recombinant apoA1 particle that mimics a genetic variation found in a population near Milan, Italy.

2. Plaque Formation (Atherogenesis) Module

The atherogenesis module provides a framework for integrating the effects of circulating lipid levels, sources of inflammation external to a plaque, and inflammatory cell trafficking within the vessel intima to predict the growth and/or regression of a “typical” atherosclerotic plaque in a representative vessel. The module can predict how changes in the dynamics underlying these cellular and physical processes affect clinically meaningful endpoints, including intimal thickness, lipid core area, and inflammation within the plaque cap and shoulder.

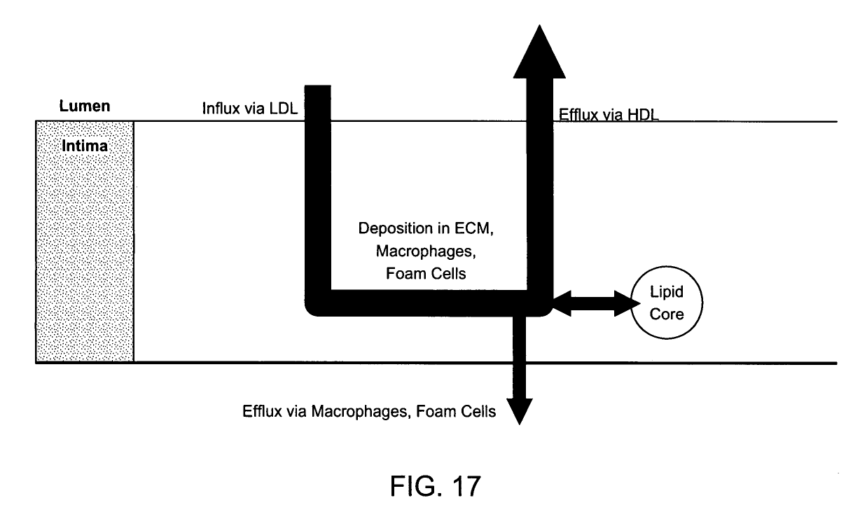

Plaque growth is driven by circulating lipid levels. In one implementation, the formation and growth of a plaque is treated as a “mass balance” problem, balancing influx of cholesterol into the blood vessel against processing an efflux of the cholesterol out of the vessel (FIG. 17). Circulating cholesterol, in the form of LDL, diffuses from the lumen into the vessel wall (intima). LDL can be retained within the intima. LDL can also be modified, aggregated or degraded within the intima. Smooth muscle cells and macrophages can phagocytose the cholesterol within LDL and process the cholesterol. In a healthy patient, the macrophages process the cholesterol for efflux from the intima. The dominant pathway for efflux of cholesterol from the intima is transfer of the cholesterol from macrophages to HDL.

FIG. 3 illustrates various biological processes associated with atherogenesis. Intima-media thickness (IMT), i.e., the sum of the thicknesses of these two layers of the artery, is affected by both lipid core thickness and intimal smooth muscle thickness. Lipid core thickness, in turn, is a function of macrophage lipid uptake, which is responsive to macrophage recruitment and lipid deposition in a blood vessel. Intimal smooth muscle cell thickness, on the other hand, is a function of intimal smooth muscle cell (SMC) composition and extracellular matrix composition. The SMC composition is responsive to apoptosis rates, SMC proliferation rates and influx/chemotaxis rates. Ultimately, each biological process is responsive, directly or indirectly, to inflammation.

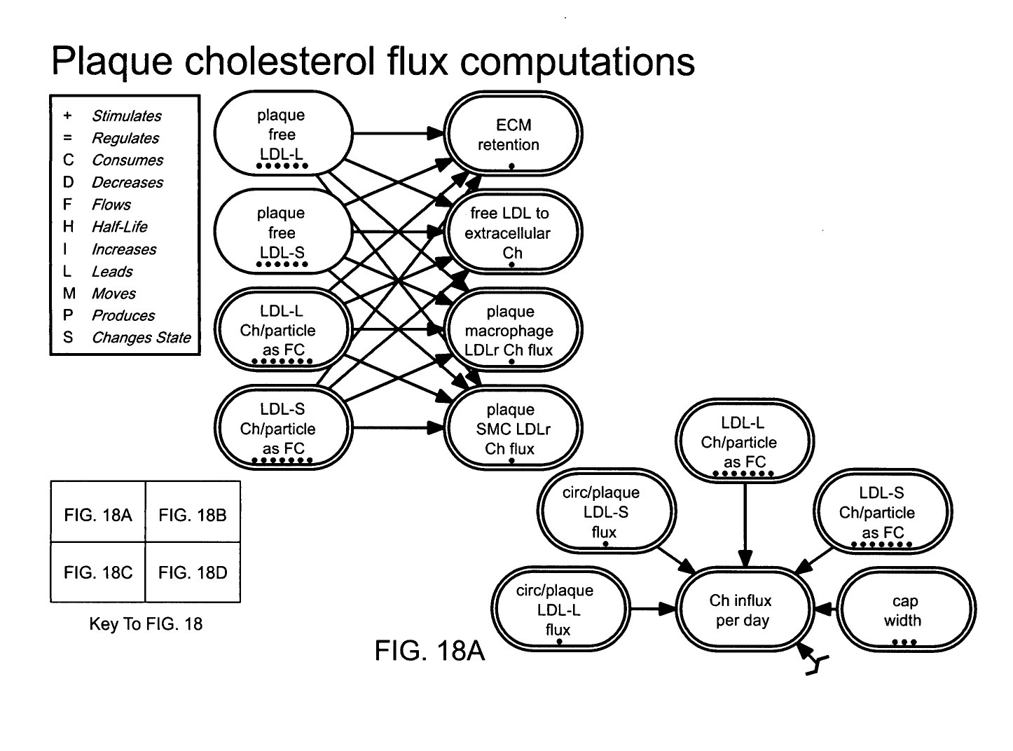

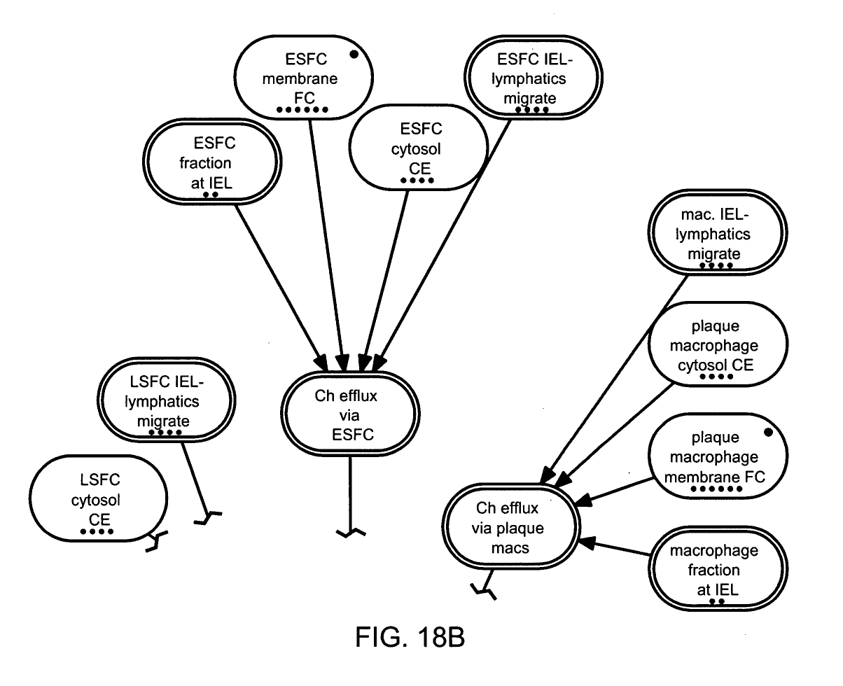

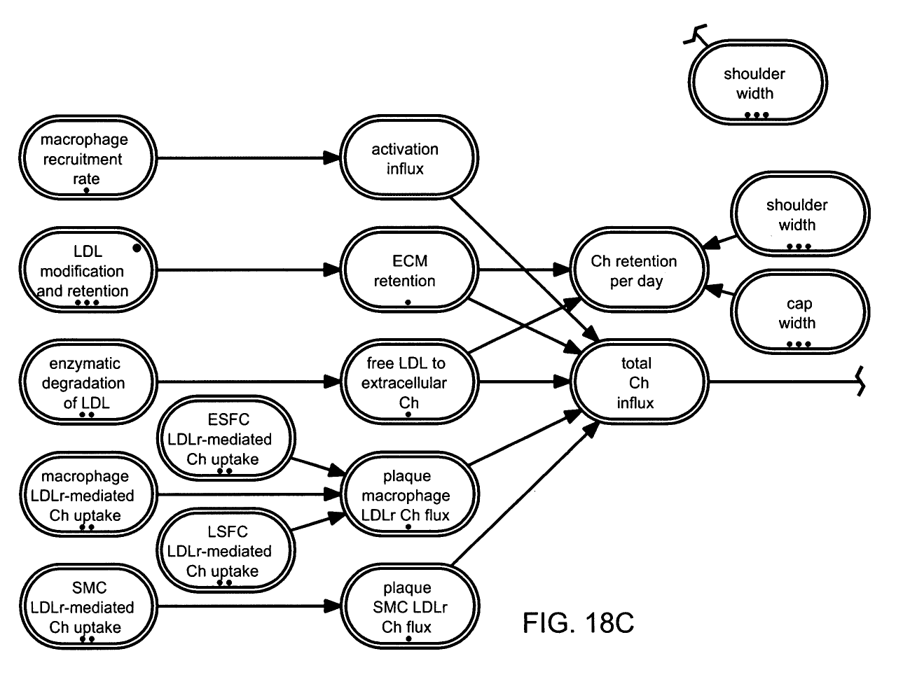

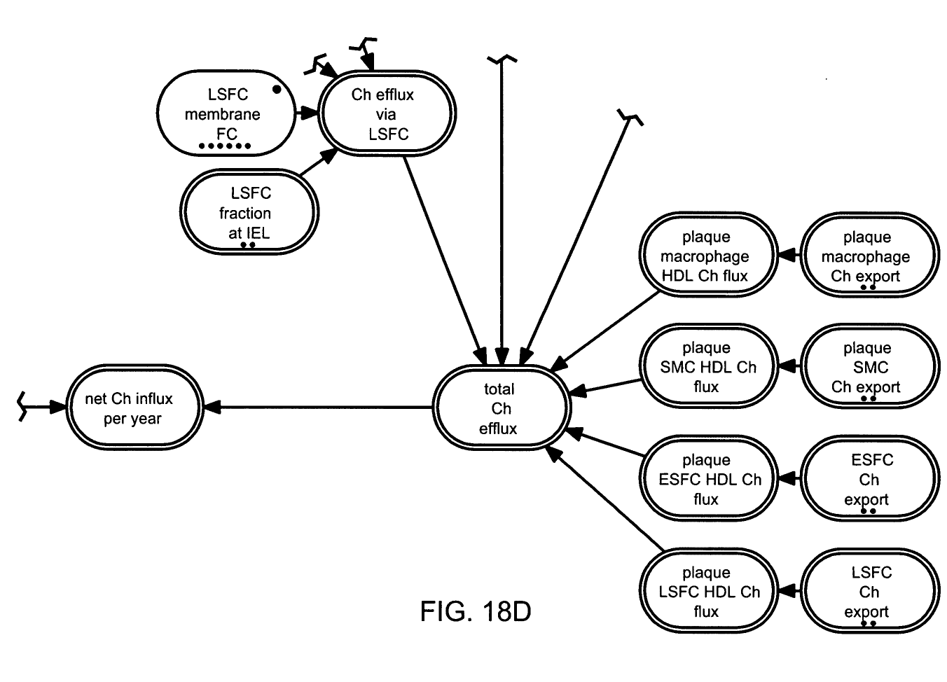

When the natural process of cholesterol removal is exceeded by cholesterol deposition, a core of lipid forms inside the arterial wall. Therefore, increased levels of circulating lipids increases the rate of lipid deposition in arterial walls. FIG. 18 provides an exemplary Effect Diagram illustrating cholesterol flux in a blood vessel. Normally cholesterol removal is in dynamic equilibrium with diffusion of cholesterol into the blood vessel.

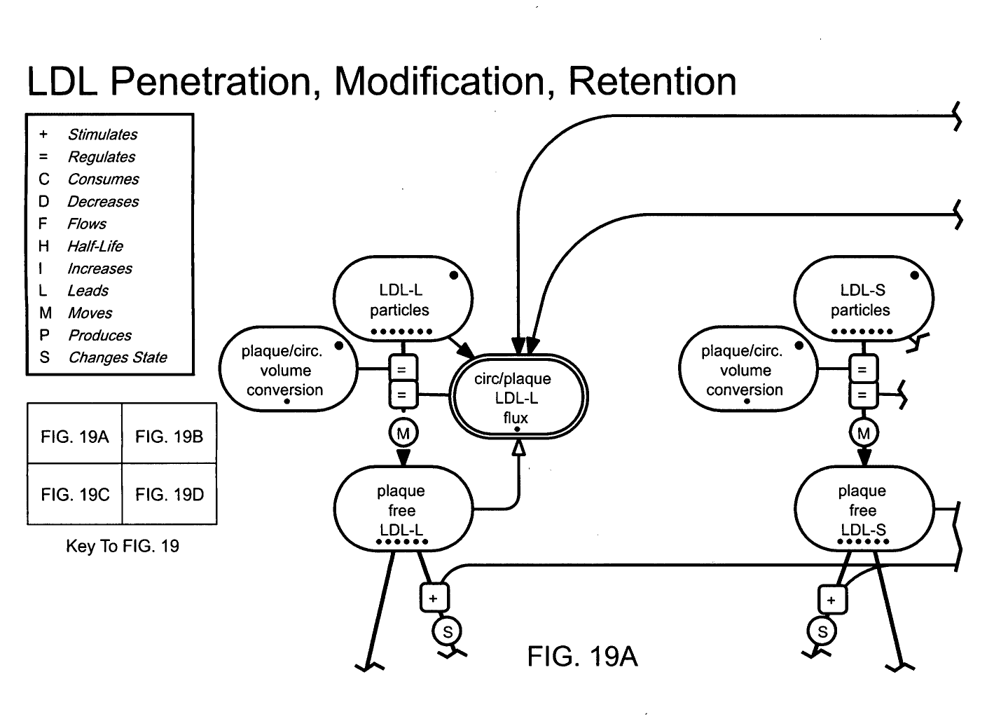

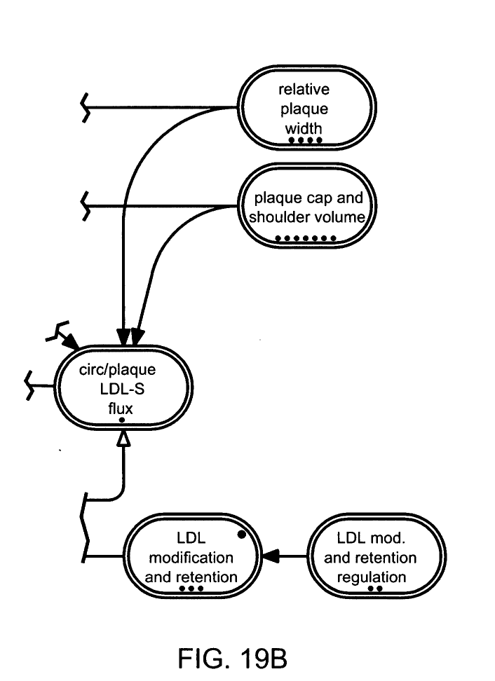

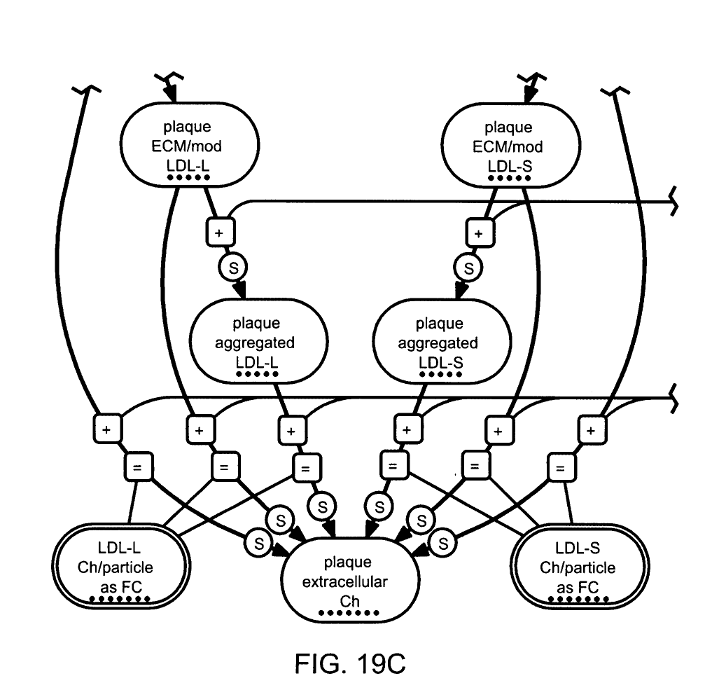

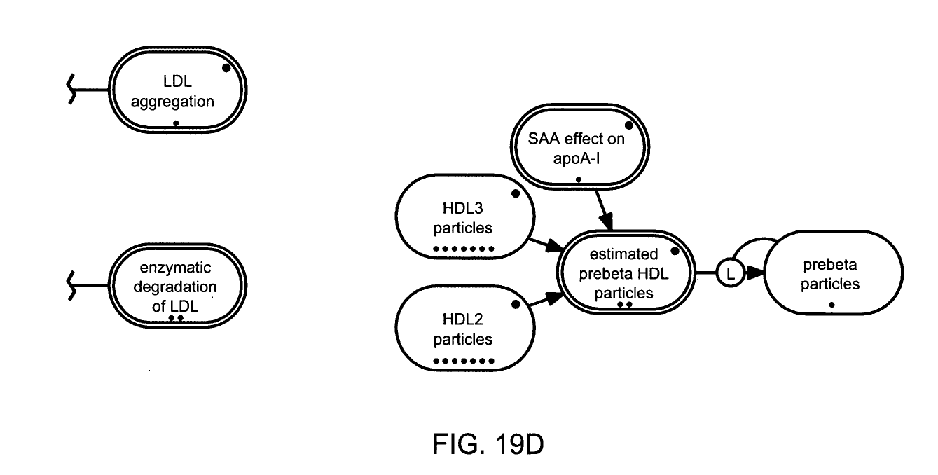

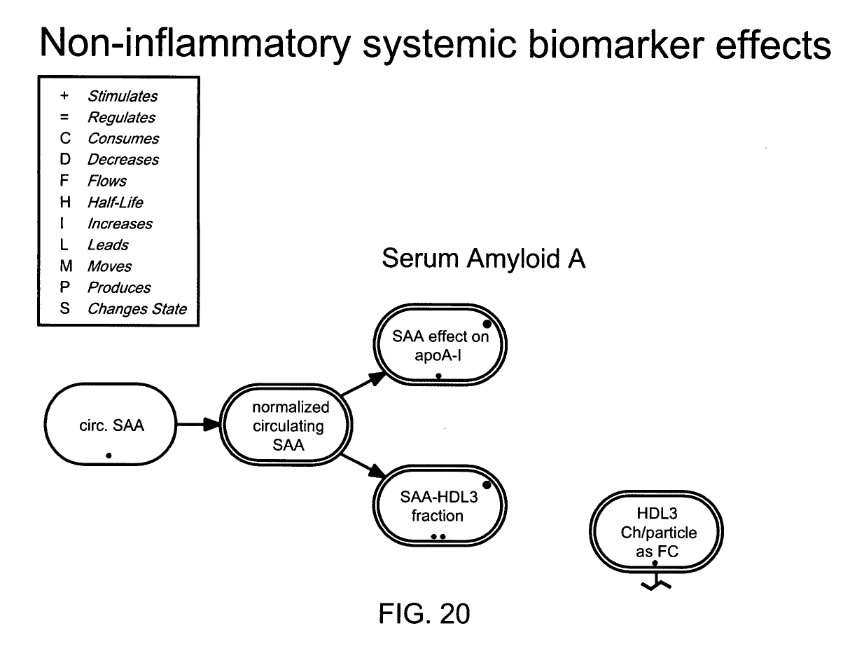

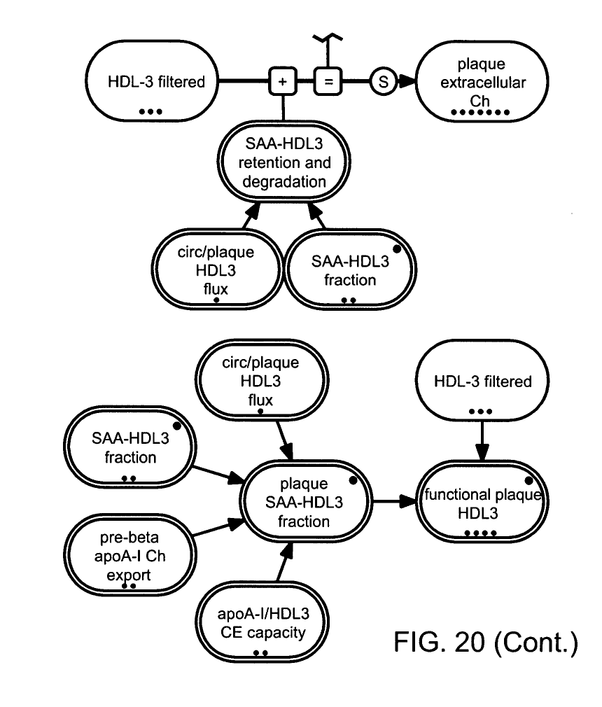

Diffusion and inflammation are the primary aspects of lipid deposition. FIG. 19 provides an exemplary Effect Diagram illustrating apoB-100 (LDL) penetration, modification and retention by the blood vessel environment. Inflammation acts primarily by influencing permeability of the blood vessel and thereby altering rate of diffusion. FIG. 20 provides an exemplary Effect Diagram illustrating the effect of serum amyloid A on apoA-I particles. The effects of serum amyloid A can be correlated to a biomarker of non-inflammatory effects relating to atherosclerosis by utilizing the model and system of the invention.

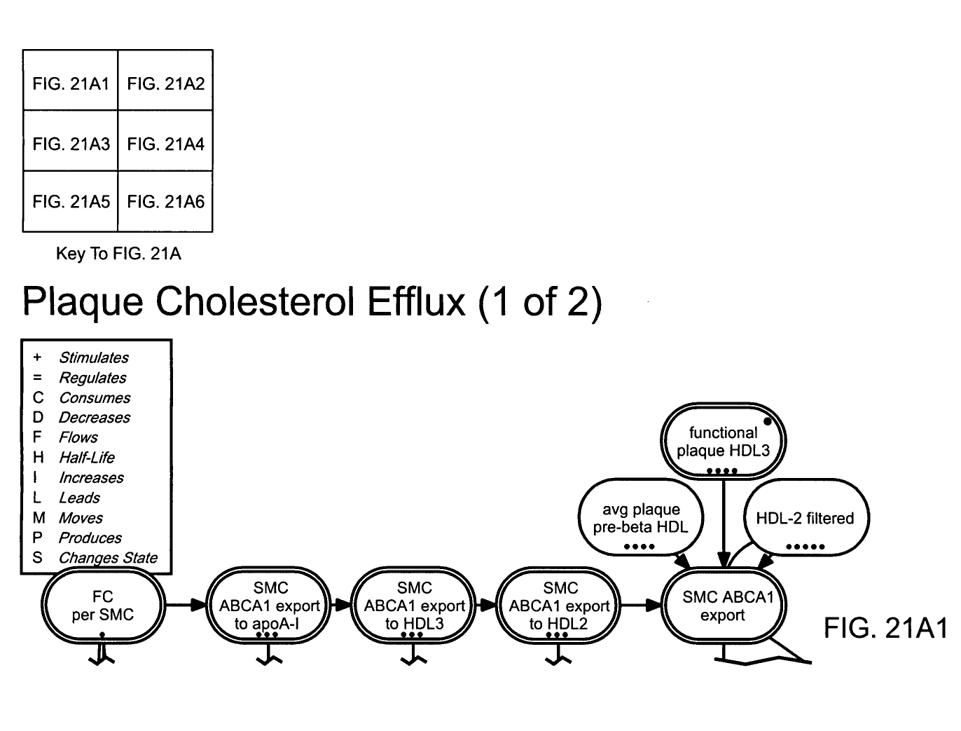

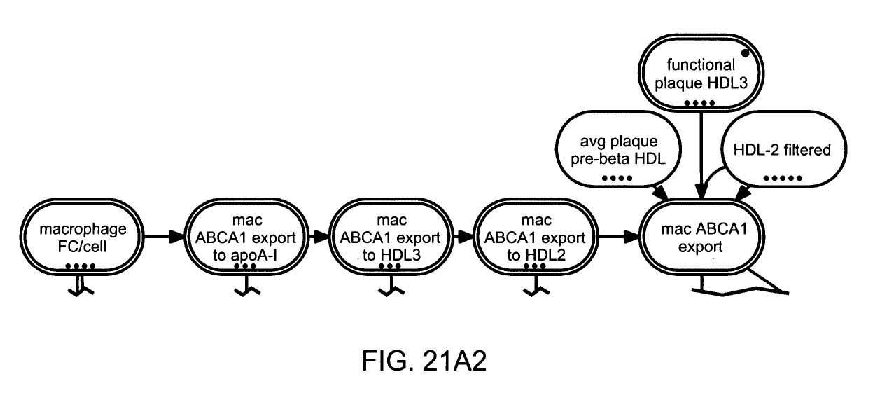

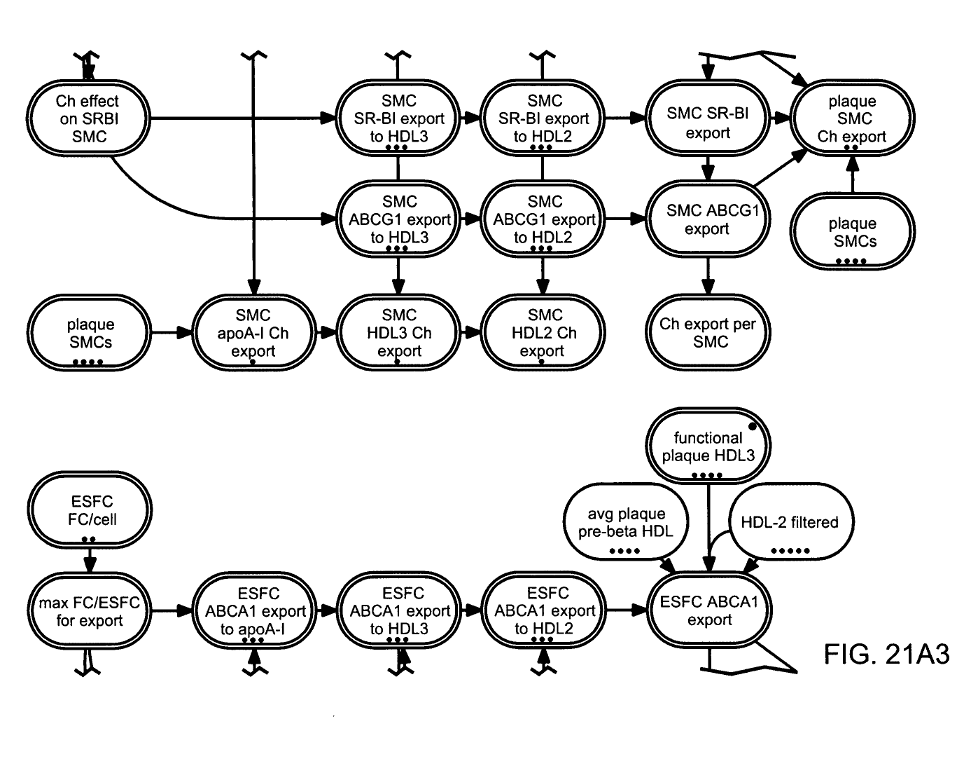

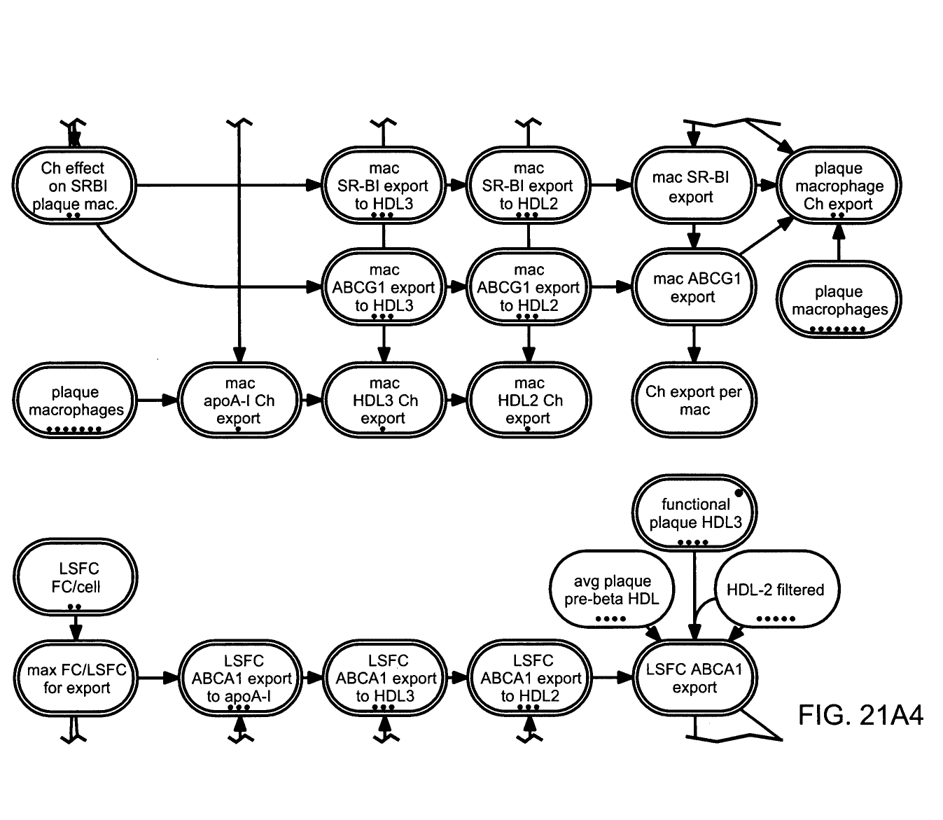

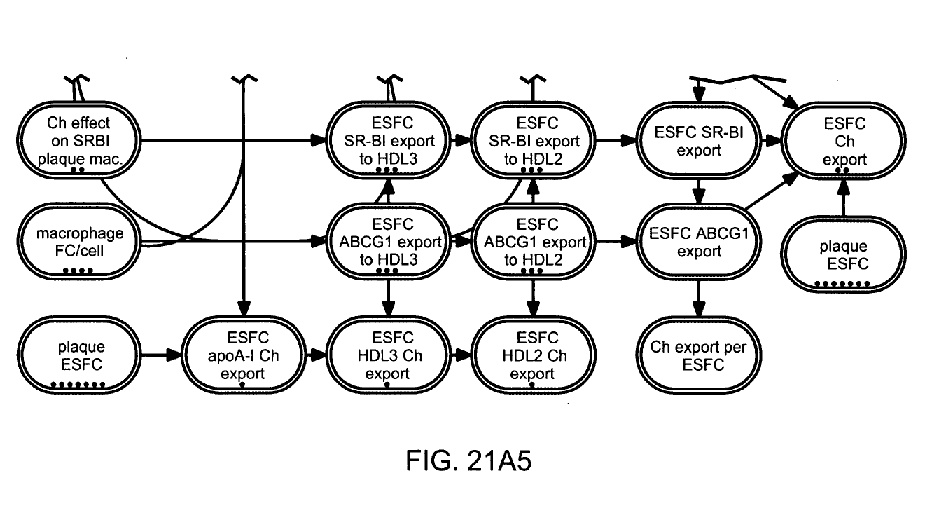

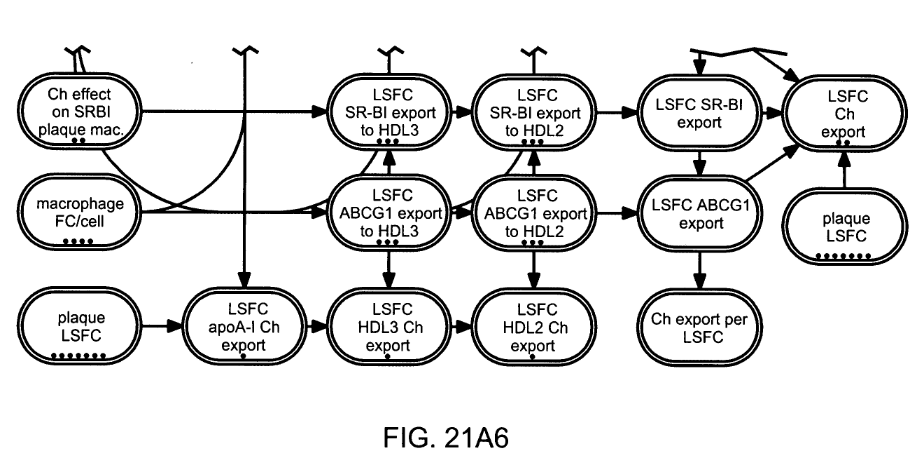

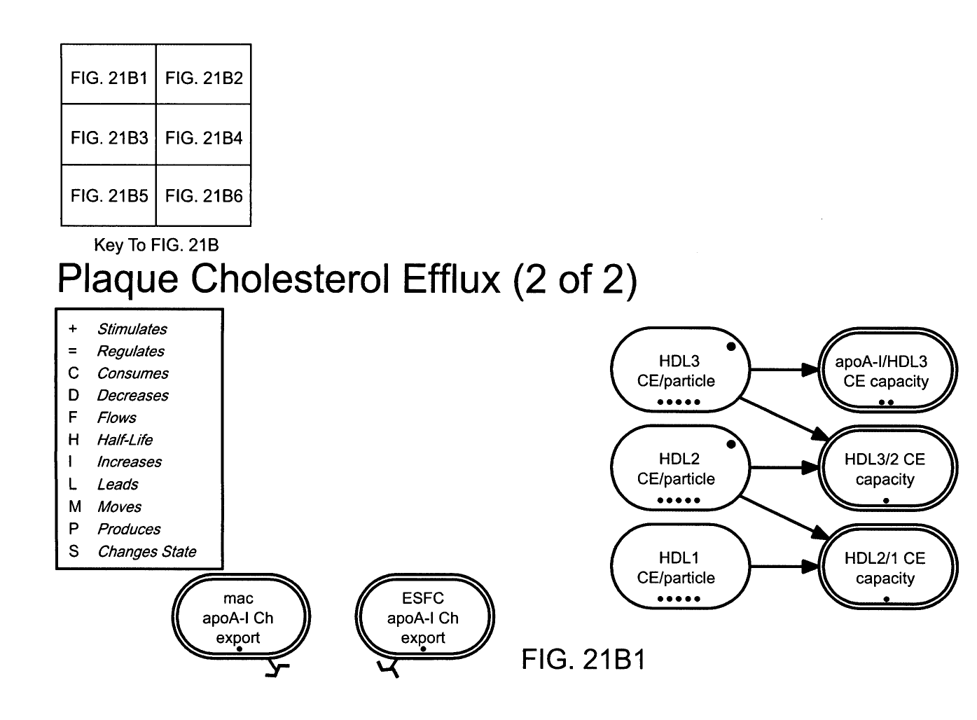

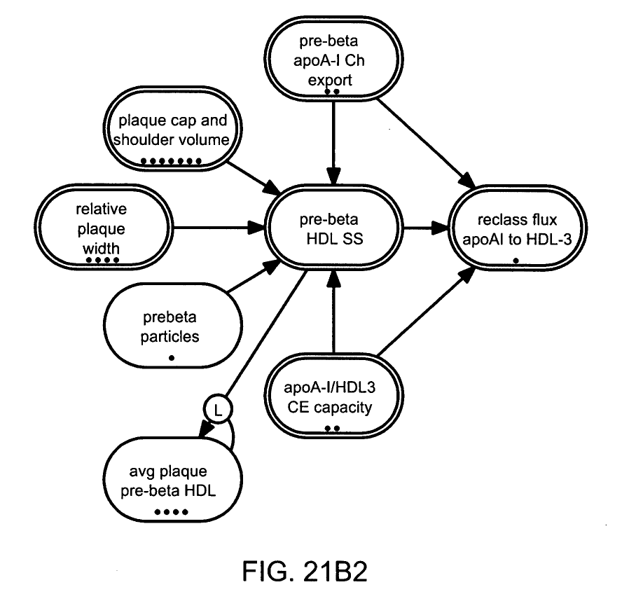

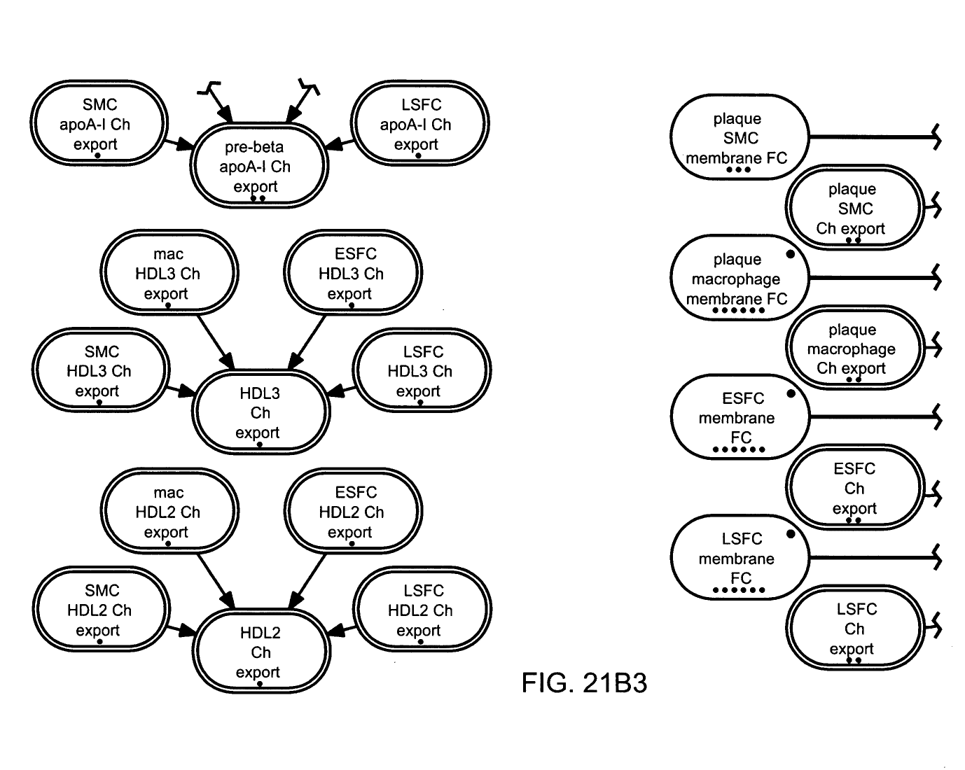

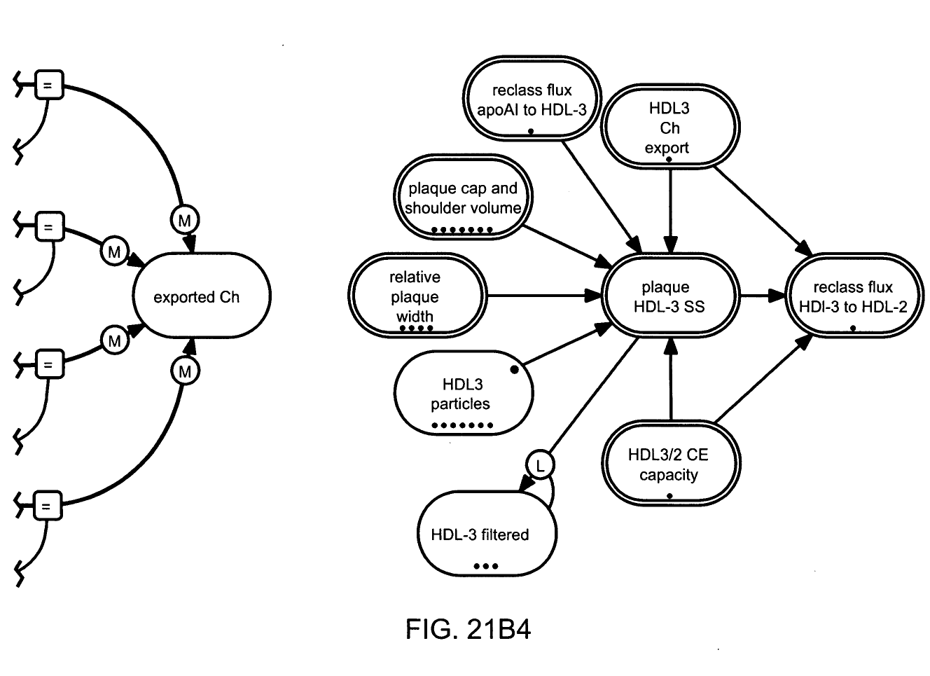

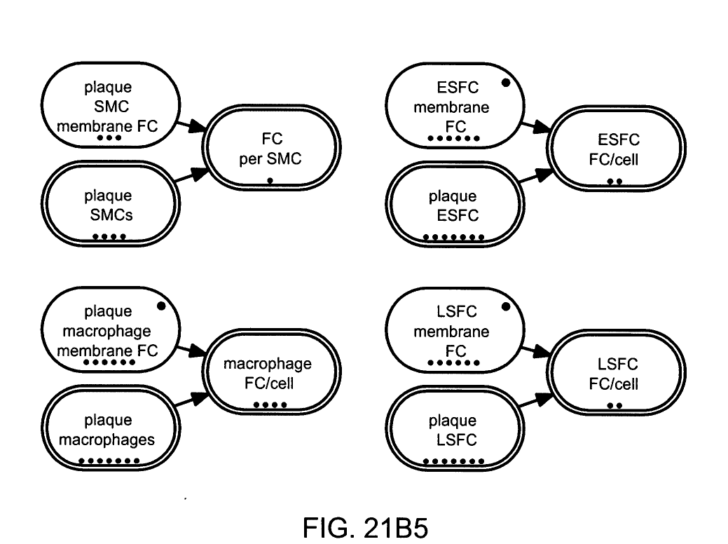

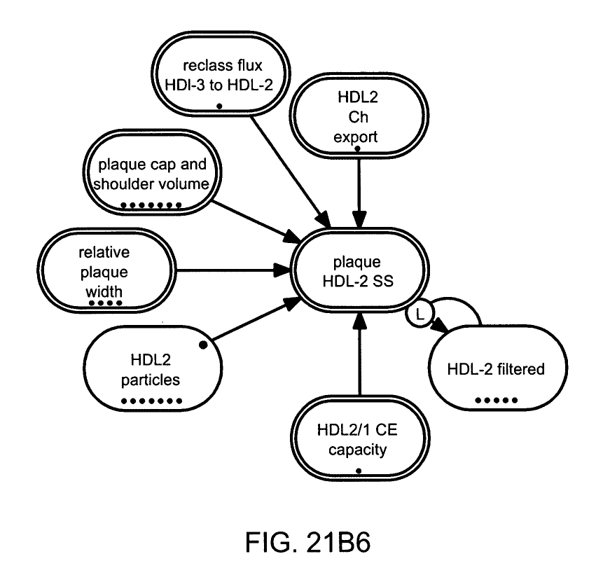

In a plaque, lipid deposition is still a dynamic process. Cholesterol continues to flow in and out of the blood vessel. The flow of cholesterol can be hampered by the physical structure of the plaque. The center of the plaque, as it grows, will develop a core that has been described as necrotic, fibrotic or calcified. This core becomes an obstacle to cell movement and thus lipid efflux. FIGS. 21A and 21B provide an exemplary Effect Diagram illustrating plaque cholesterol efflux.

The atherogenesis module preferably contains a composite representation of transporter-mediated efflux of cholesterol from the plaque via a representative transporter to a single acceptor, small HDL (HDL1). In an exemplary implementation, the representation of cholesterol efflux can include explicit representations of ABCA-1, ABCG-1, scavenger receptor B-I (SR-BI), and lipid-free apoA-I and large HDL (HDL2) as additional cholesterol acceptors (see FIG. 21A). Such an implementation facilitates prediction of patient response to a therapeutic intervention, e.g., CETP inhibition, and further enables exploration of knowledge gaps associated with the roles of different transporters and acceptors in the efflux process. Insights gained from this process implicate two key parameters governing cholesterol efflux: (1) particle capacity and (2) plaque HDL particle concentration. Preferably the model represents smaller HDL particles as having a greater carrying capacity and potential for cholesterol efflux than larger HDL particles. Typically in the model, the total number (or concentration) of HDL particles in the plaque has a greater impact on cholesterol efflux than total HDL-C.

Evidence in the literature suggests that HDL-2, as well as lipid-free apoA-I, may play a significant role in removing cholesterol from the plaque via transporters other than ABCA-1. For example, “passive” efflux via SR-BI may be dependent upon the total surface area of HDL particles; and efflux via ABCG-1 may be primarily dependent upon the concentration of HDL-2 particles. Accordingly, in a preferred implementation, cholesterol efflux is implemented as a “cascade-like” process in which particles are passed from transporter to transporter, consistent with reports on the synergistic effect of transporters. Each particle class is assumed to have reached its capacity for CE before being passed to the next transporter in the chain. Differential fluxes of lipid-free apoA-I, HDL-1, and HDL-2 into the plaque and tracked. A maximum capacity state (HDL-3) is defined; particles in this state no longer accept additional CE and leave the plaque.

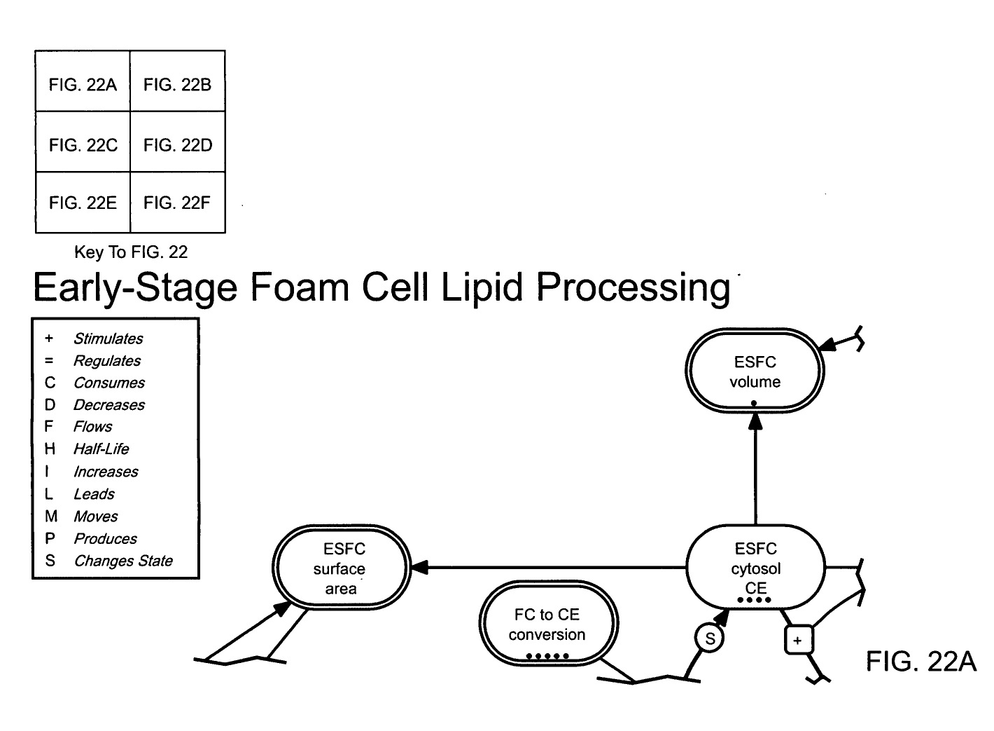

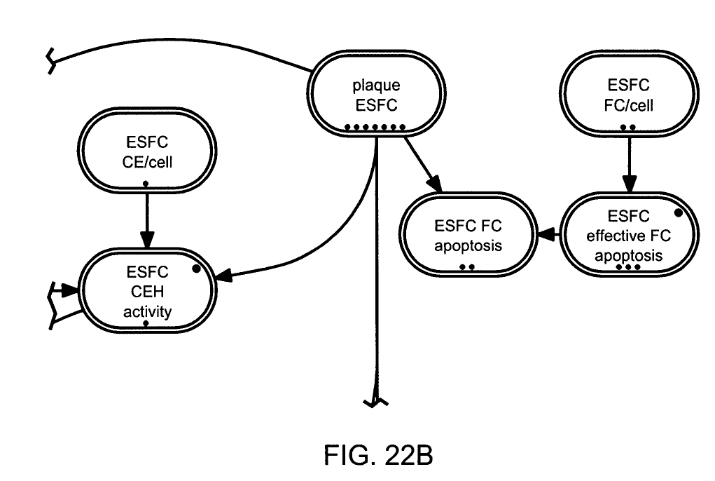

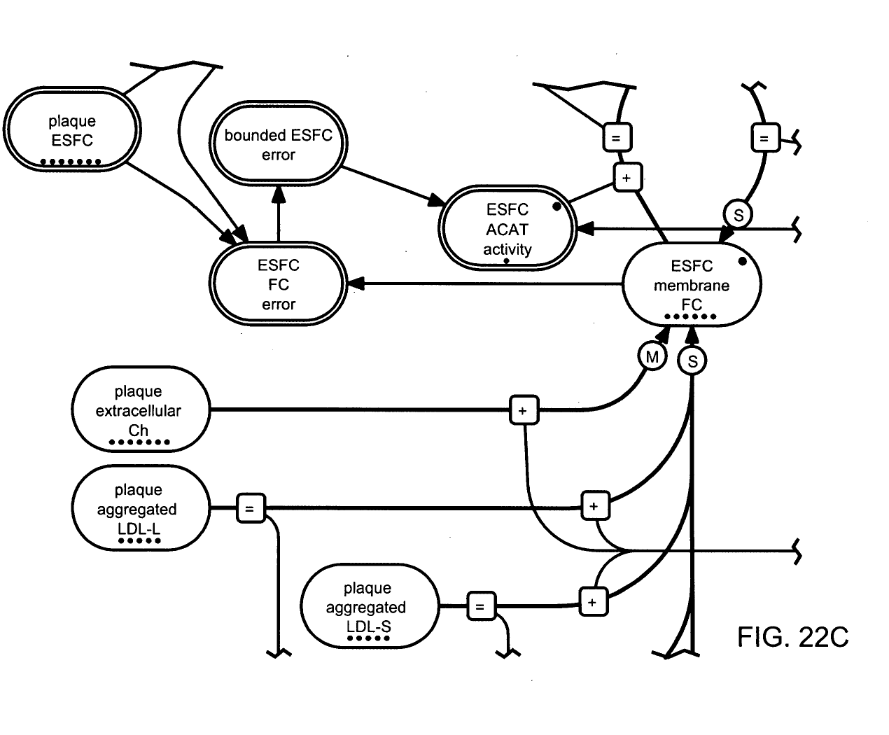

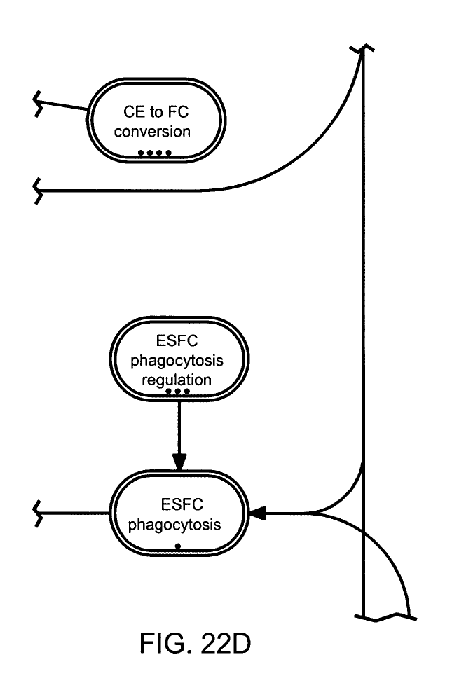

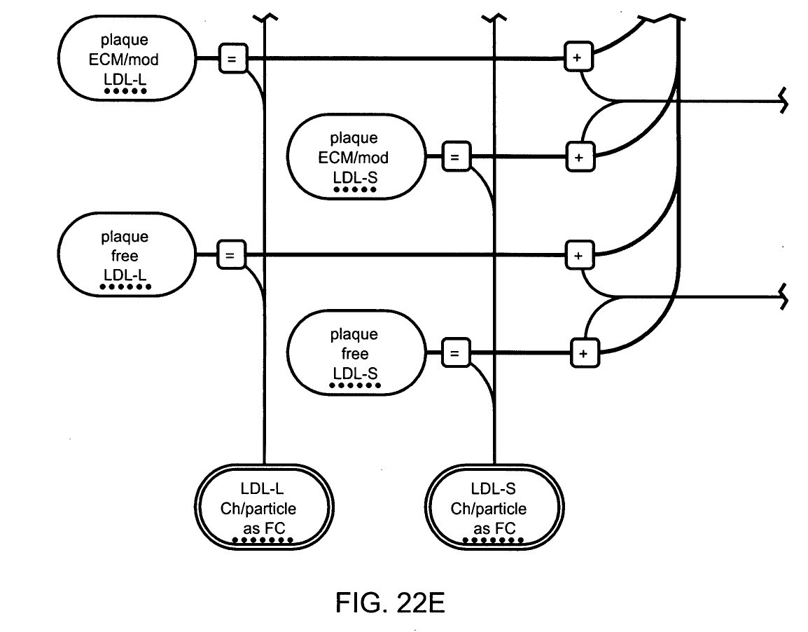

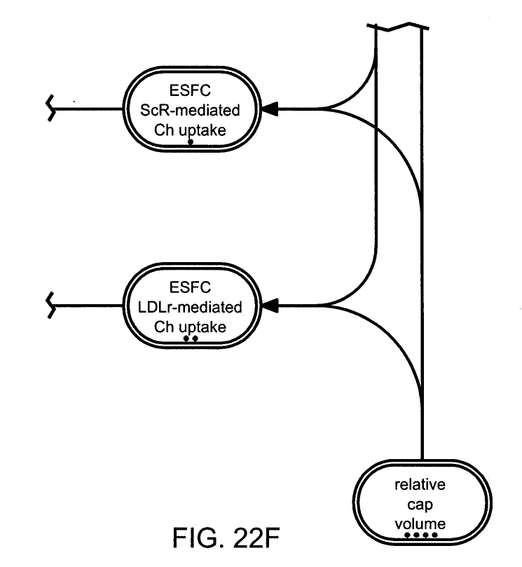

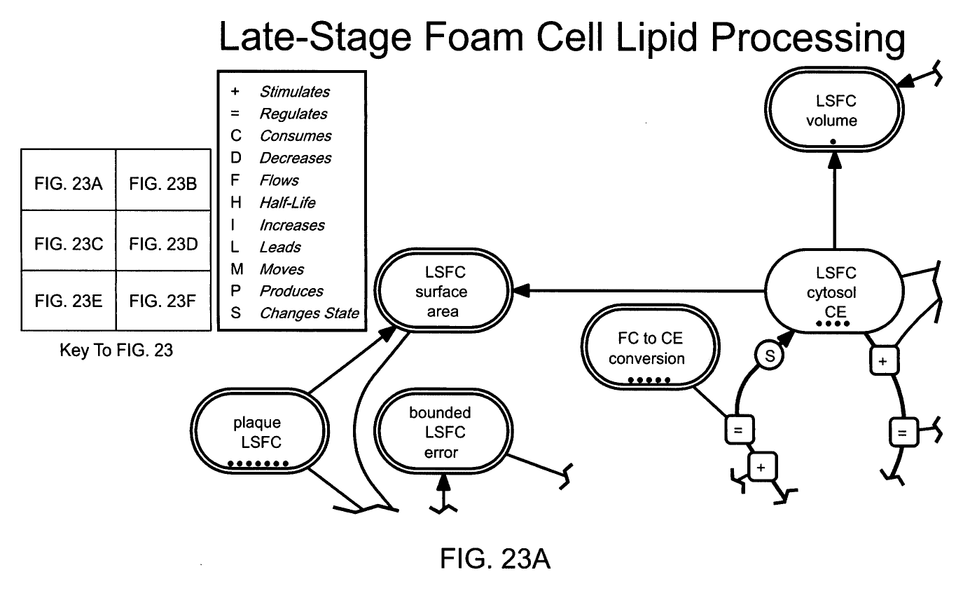

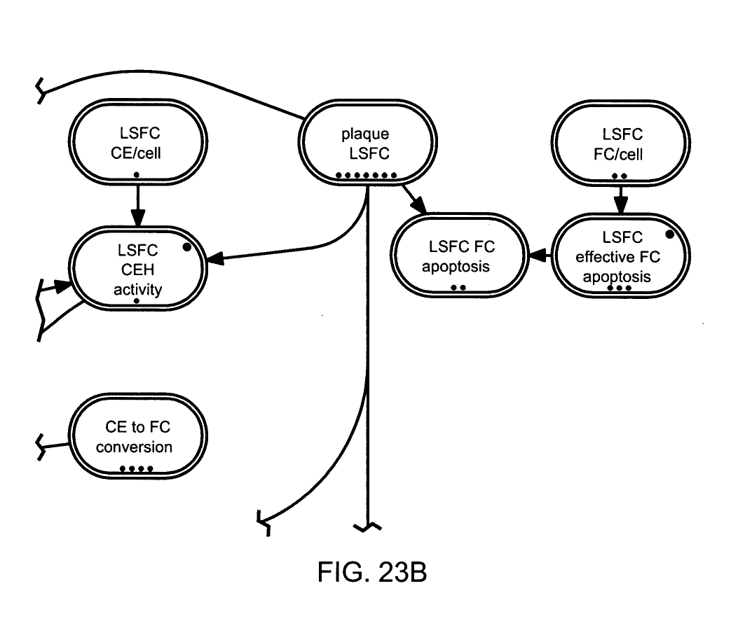

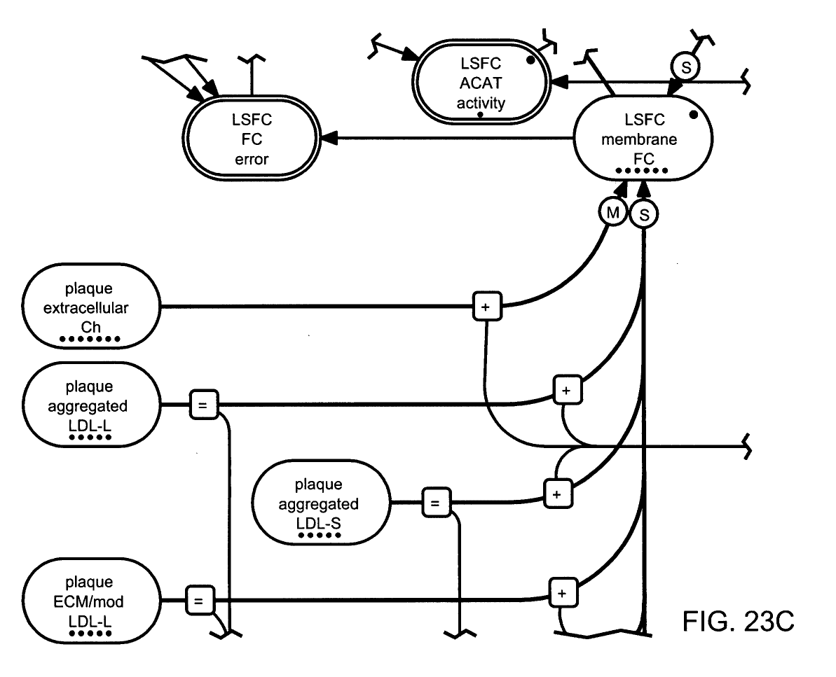

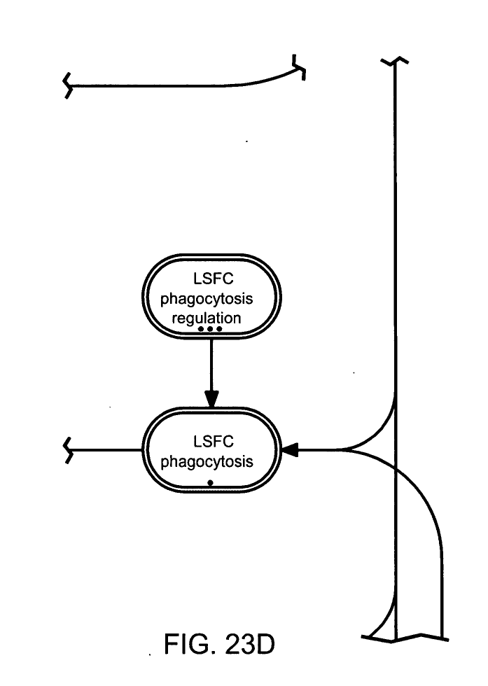

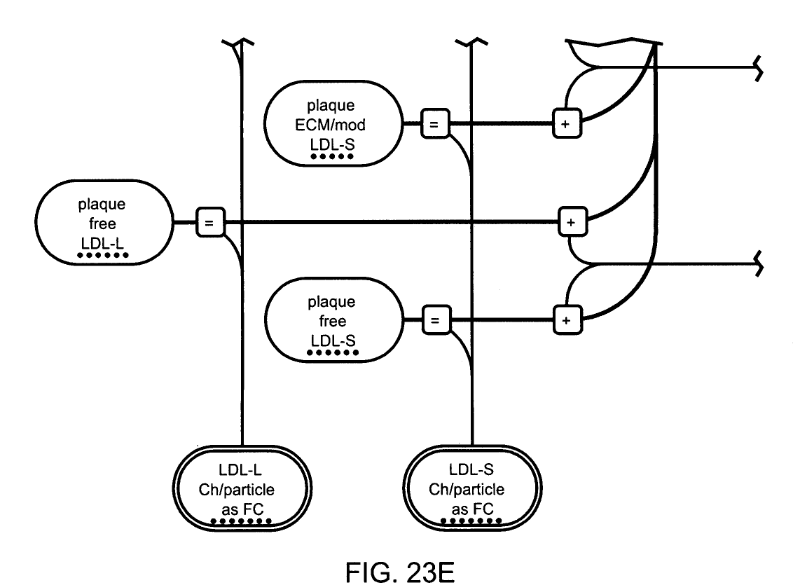

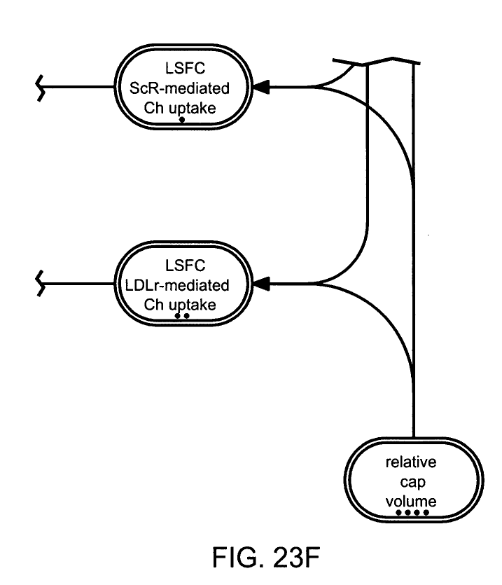

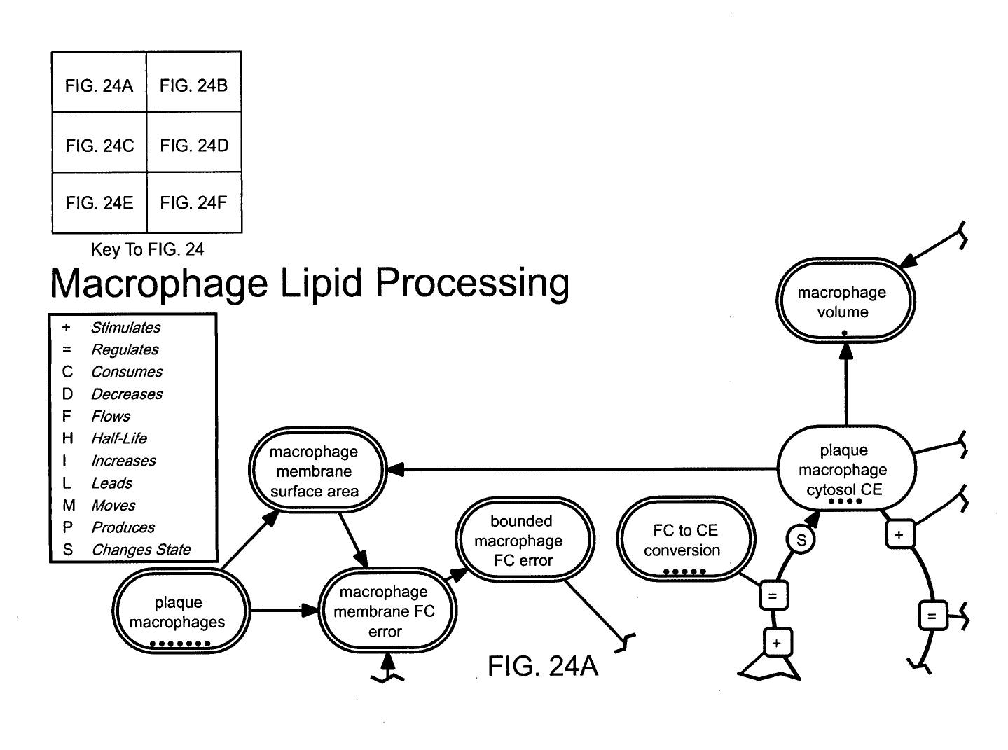

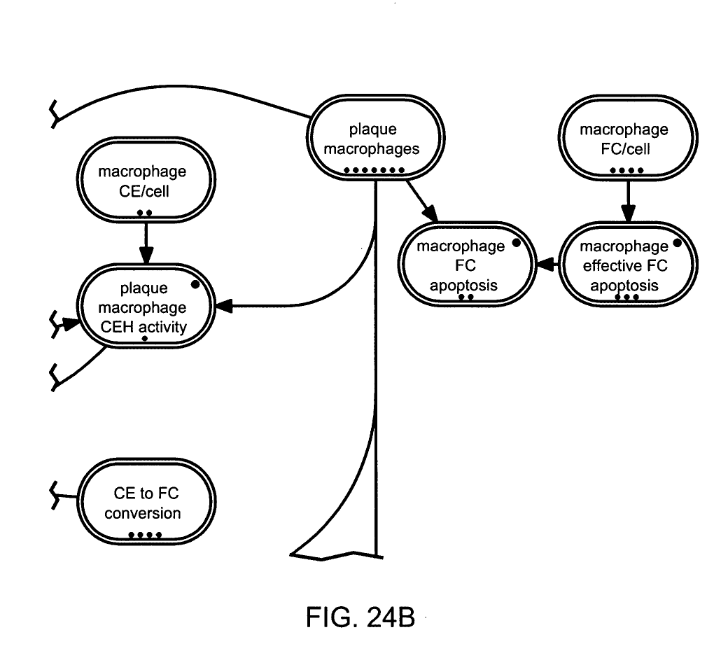

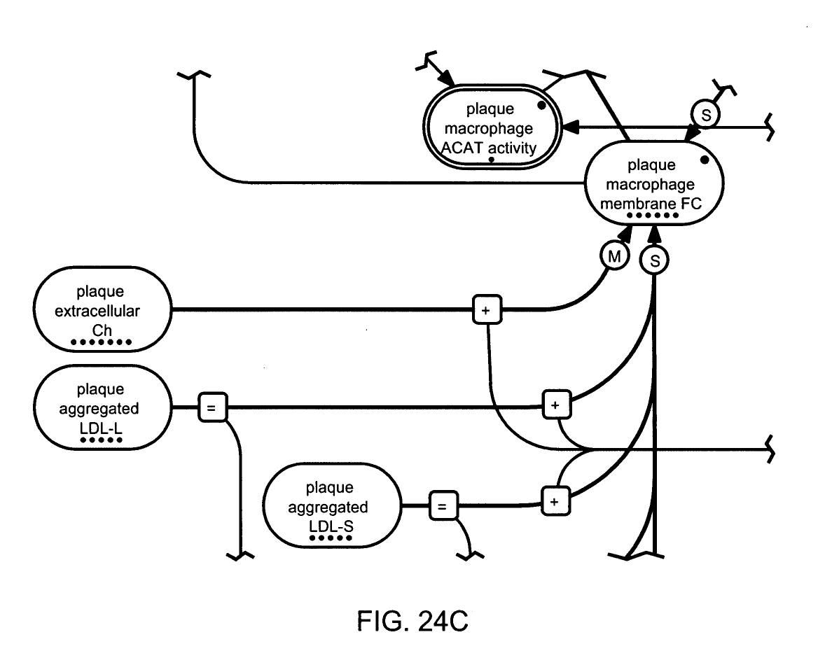

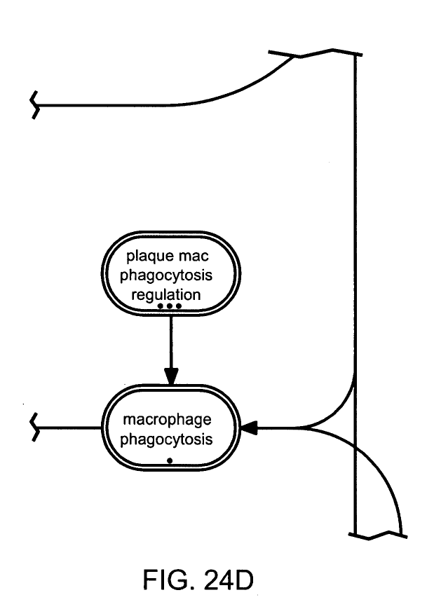

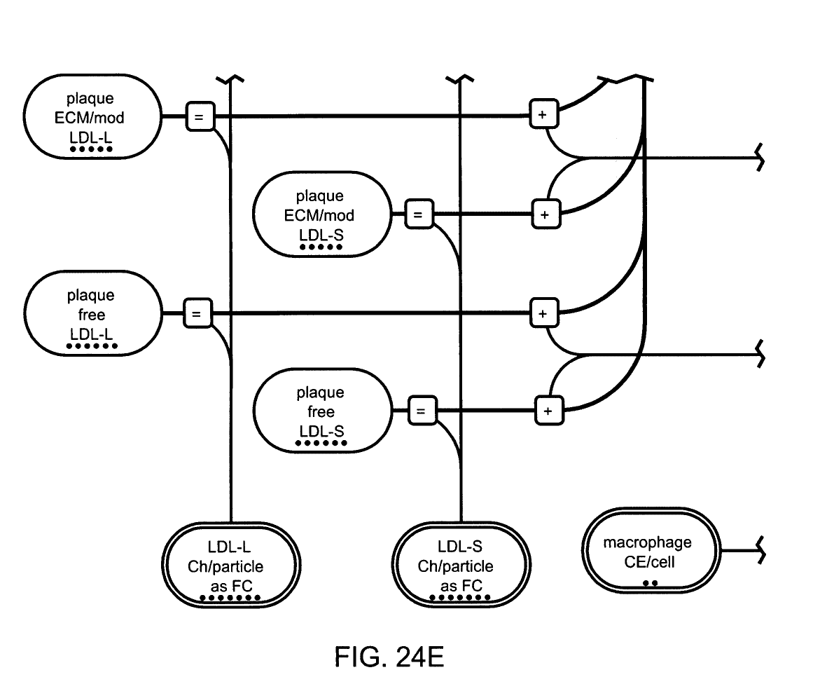

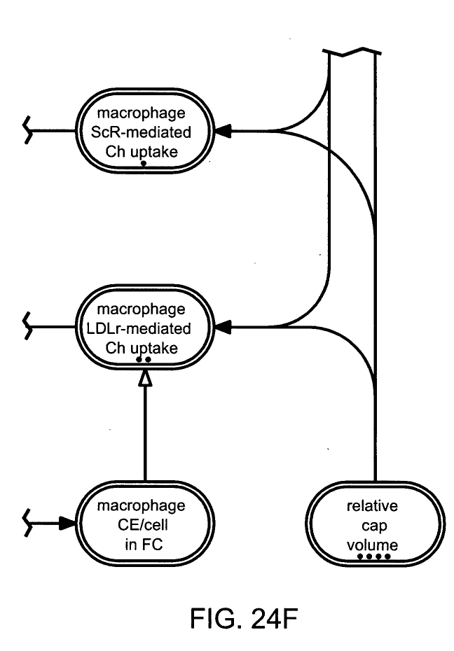

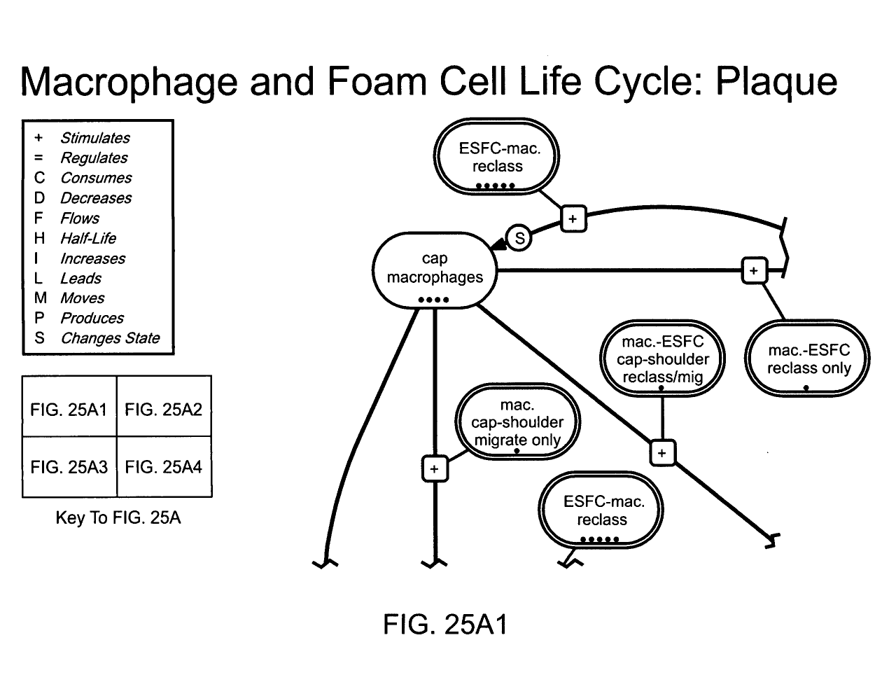

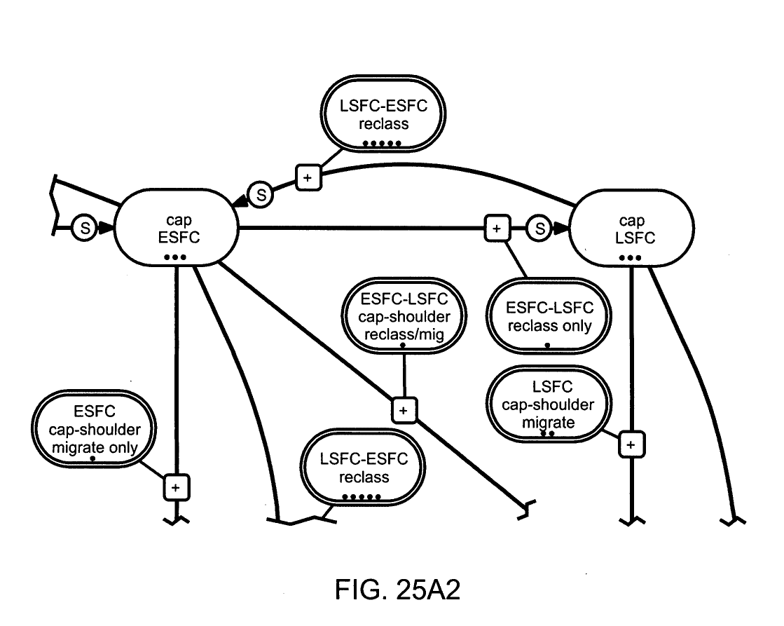

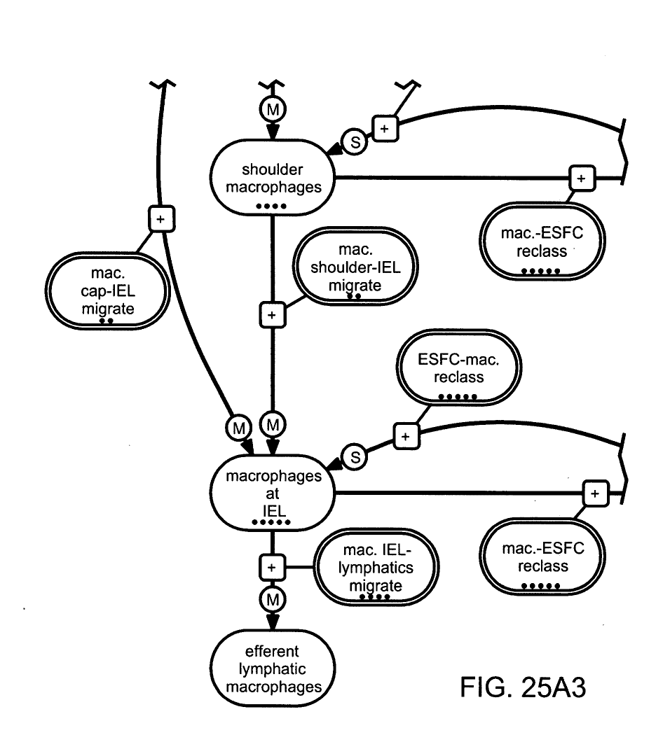

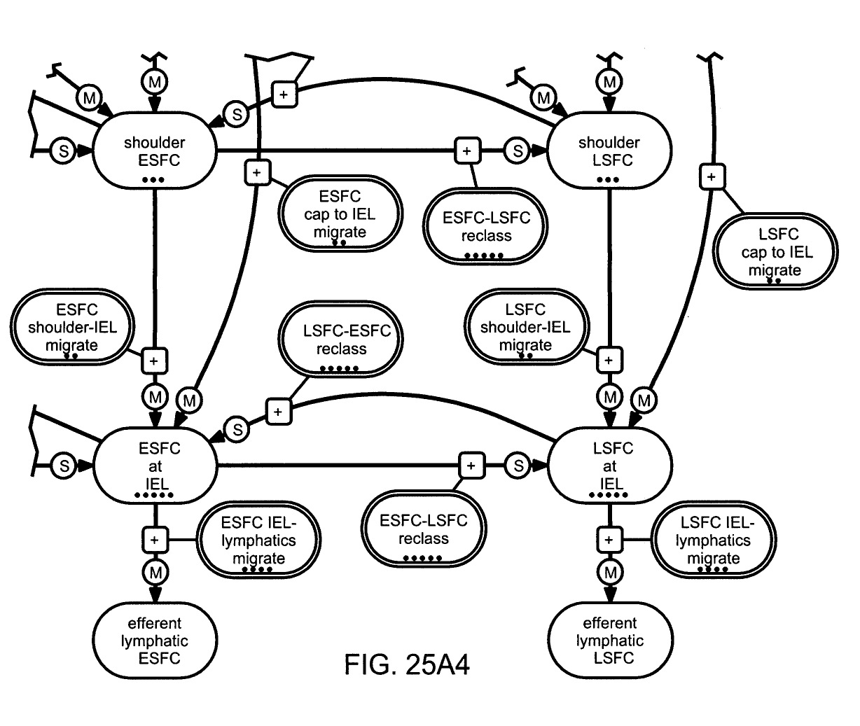

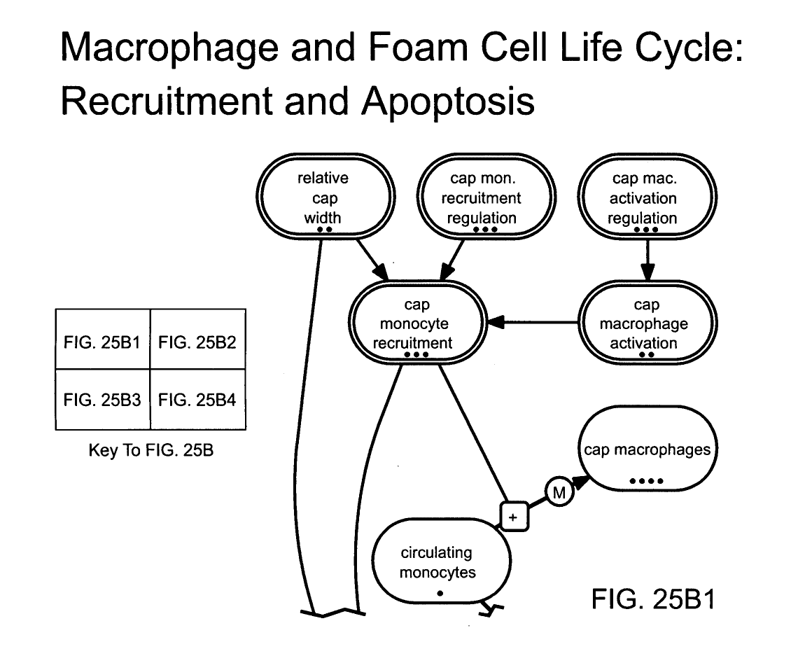

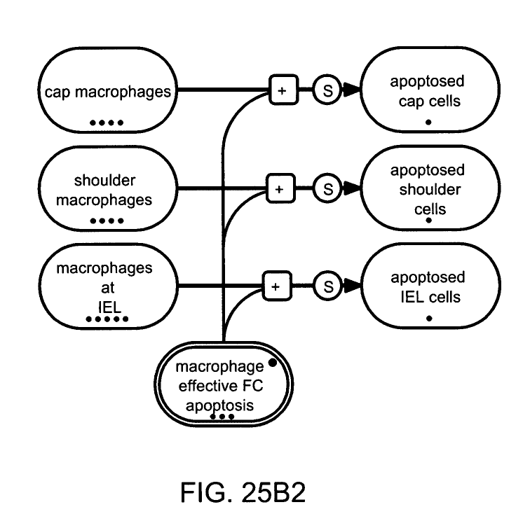

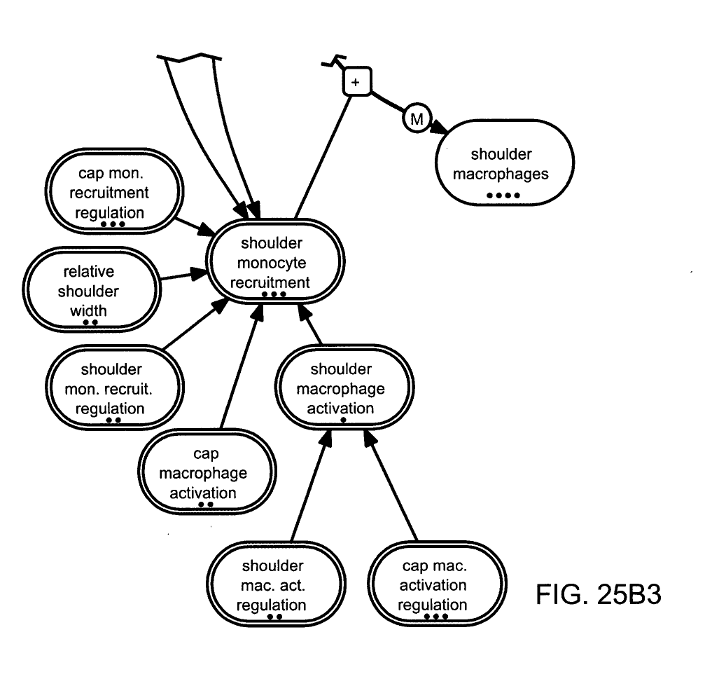

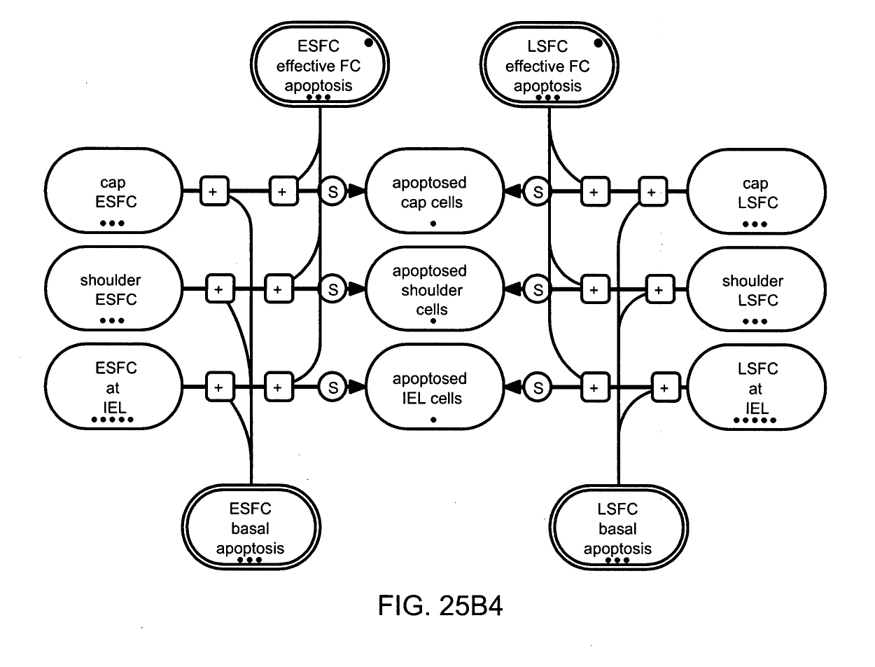

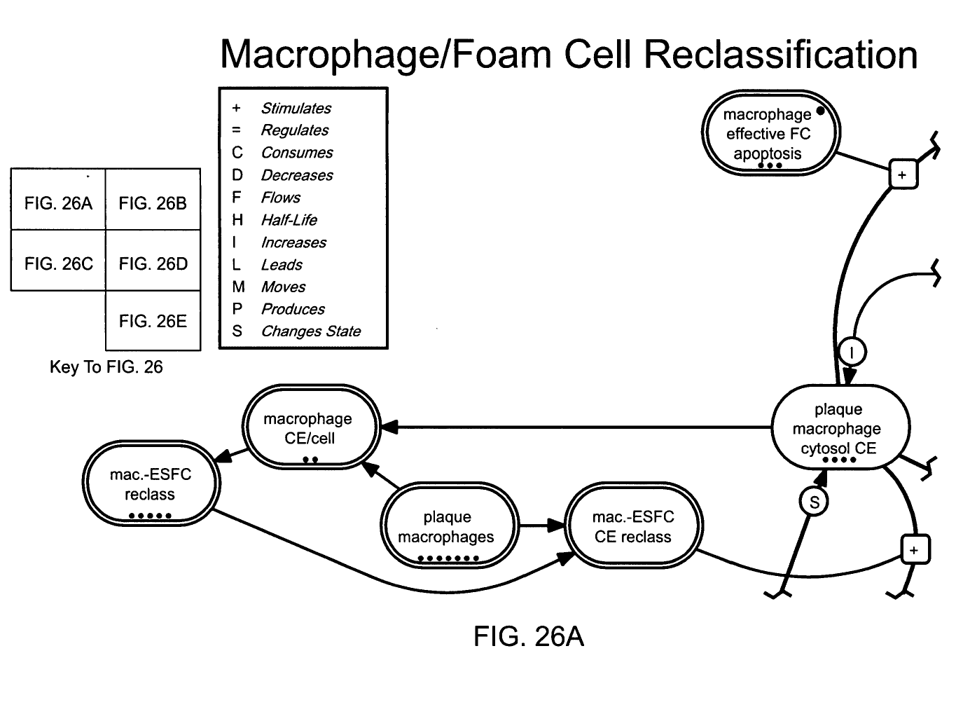

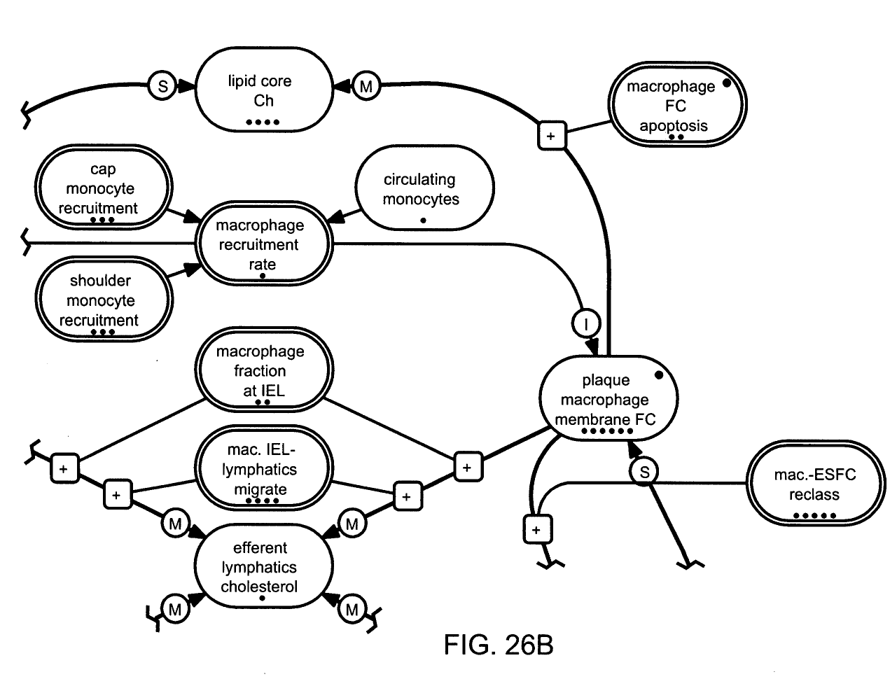

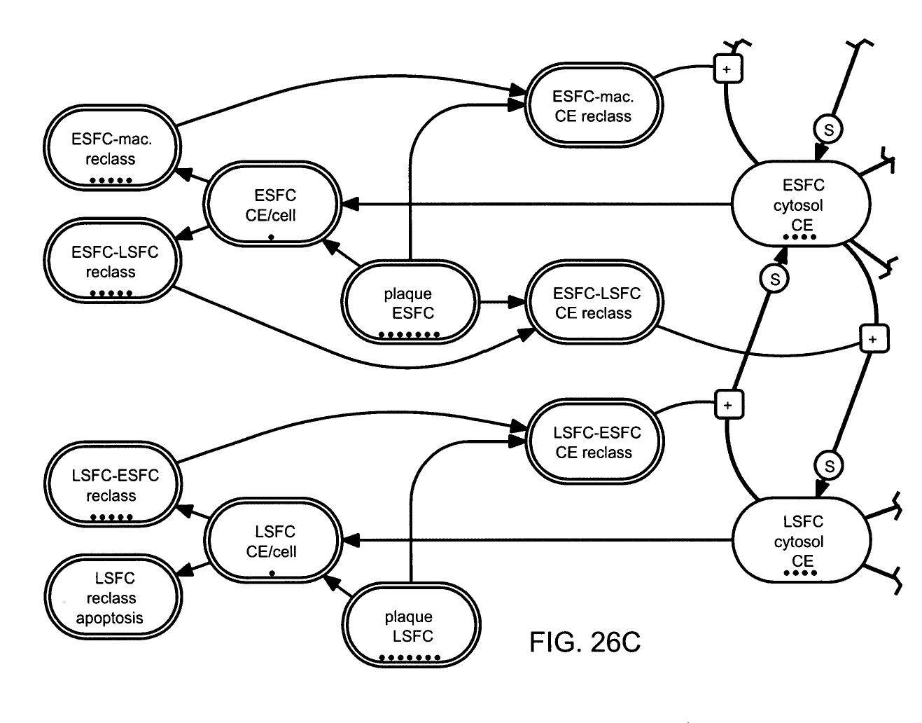

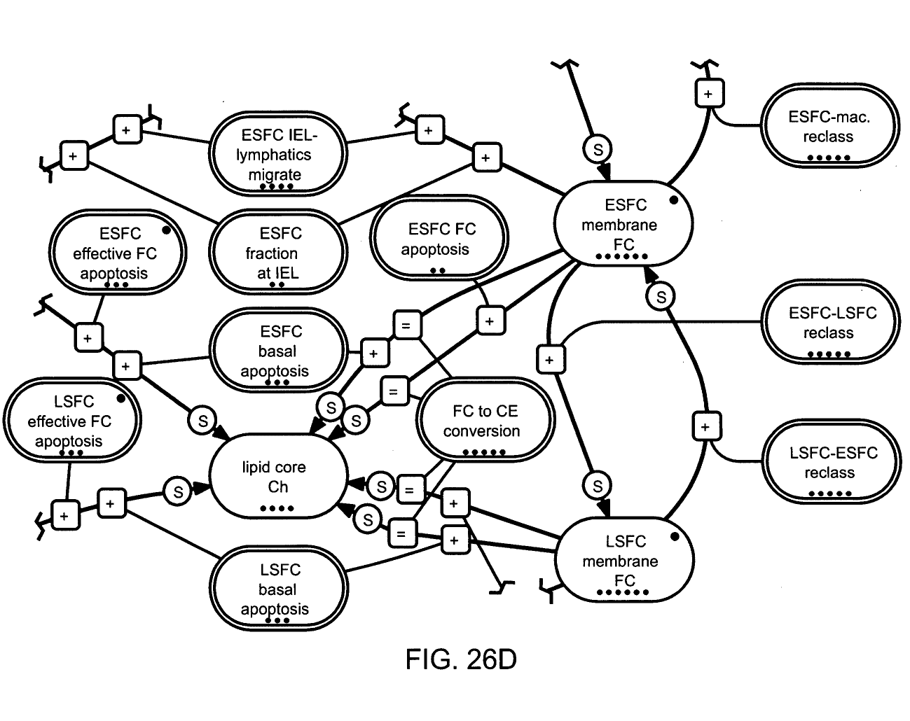

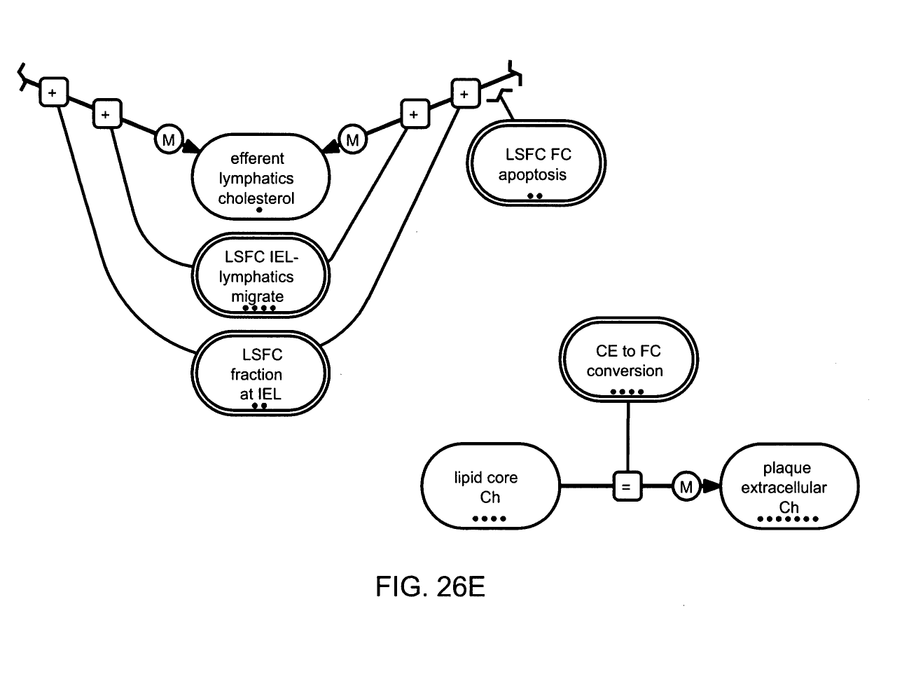

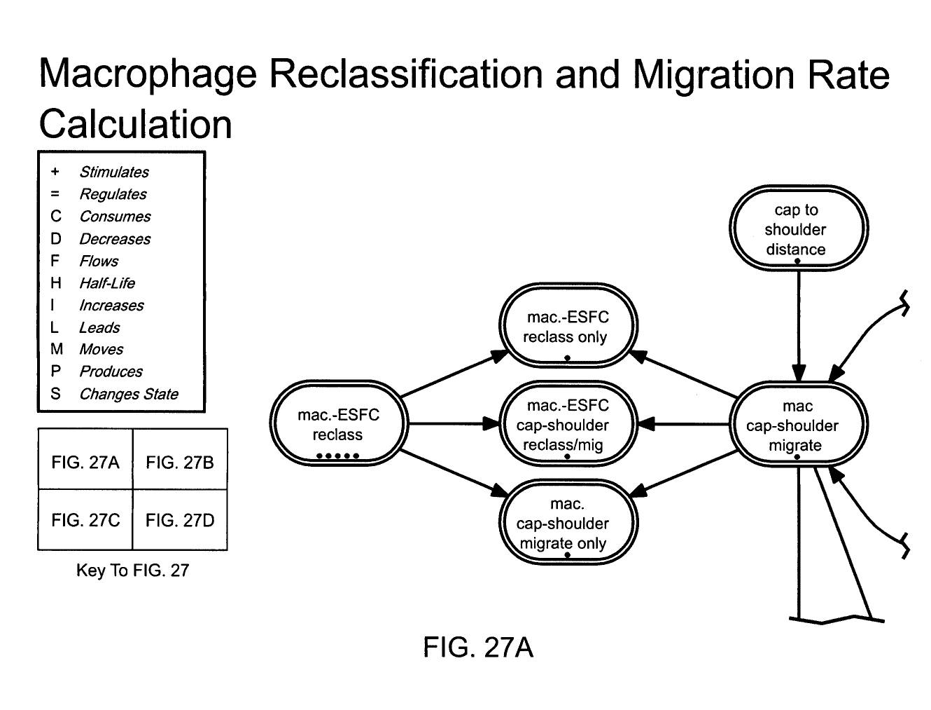

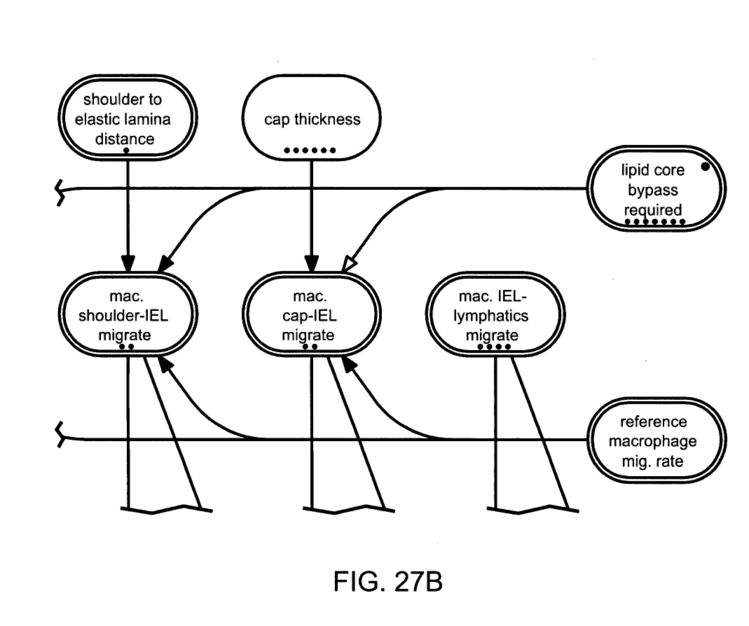

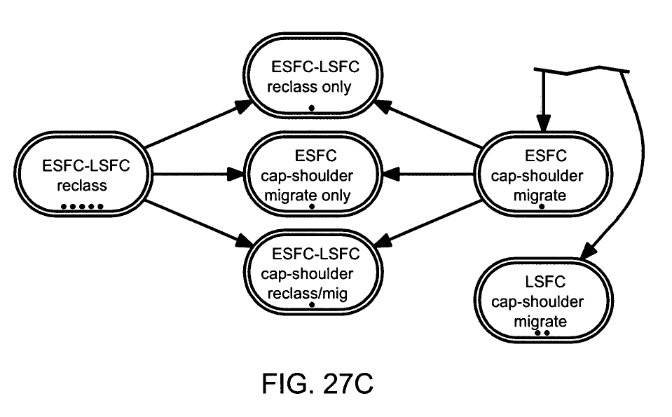

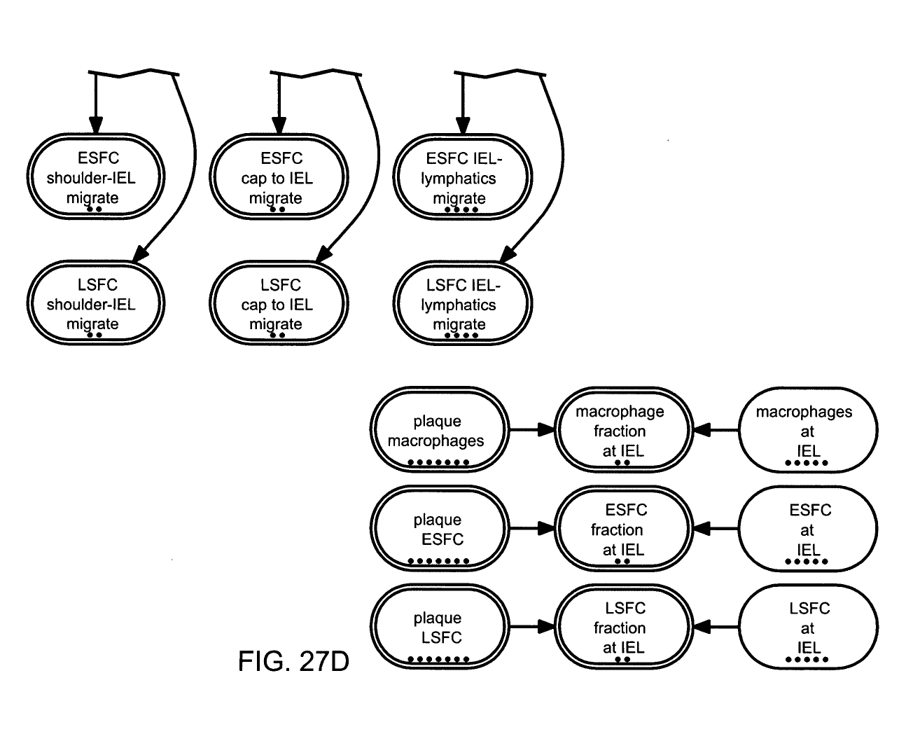

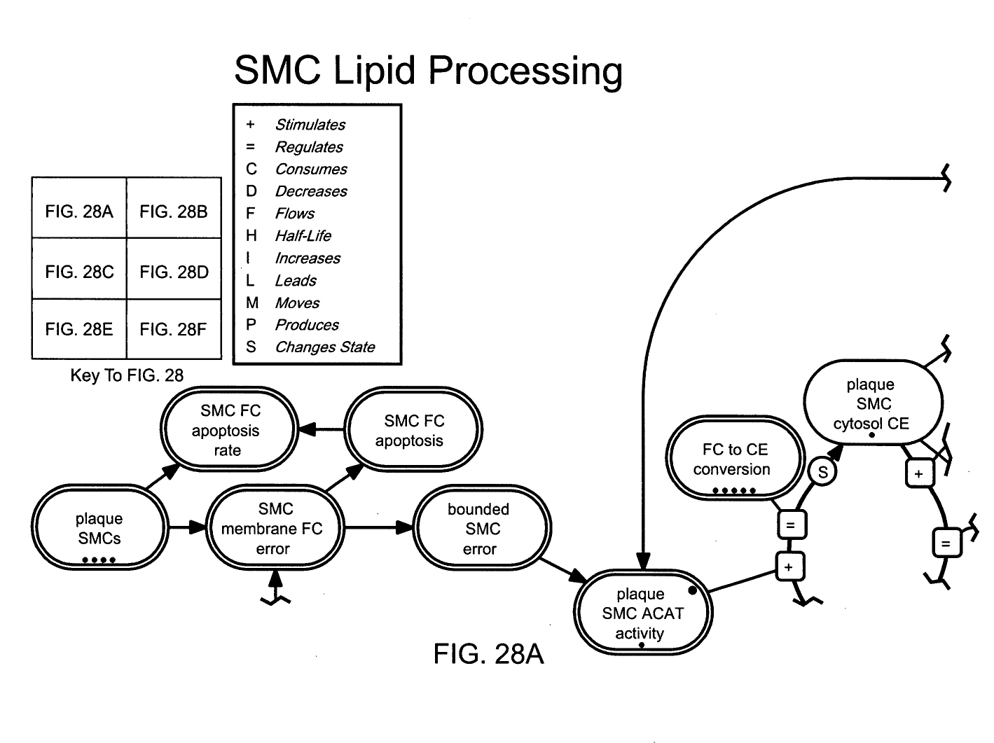

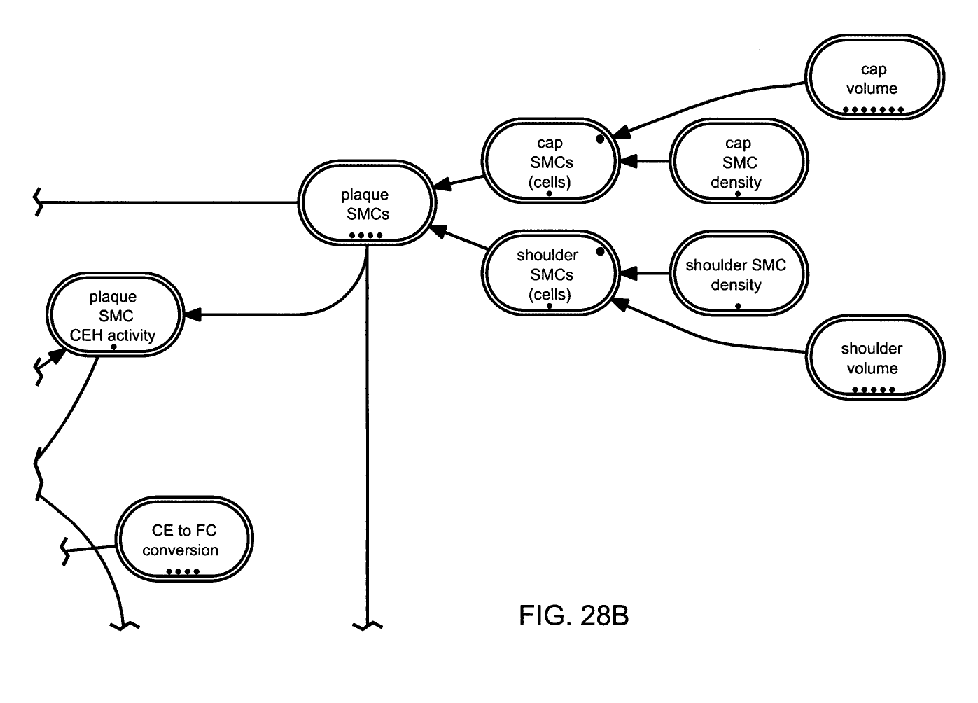

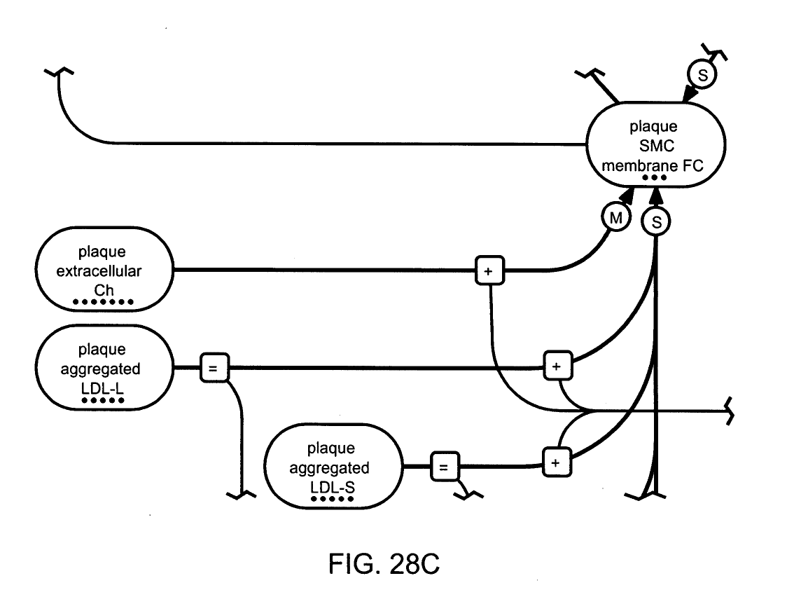

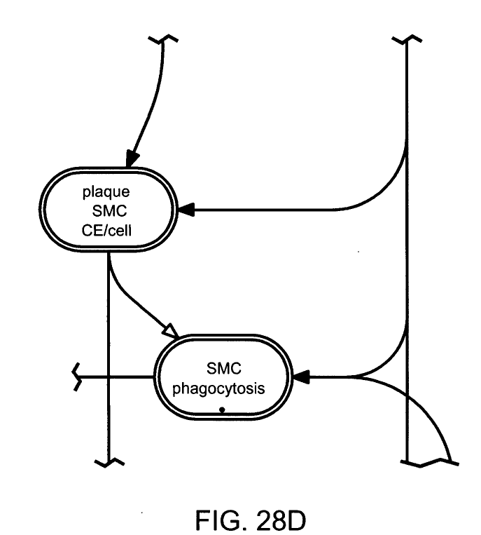

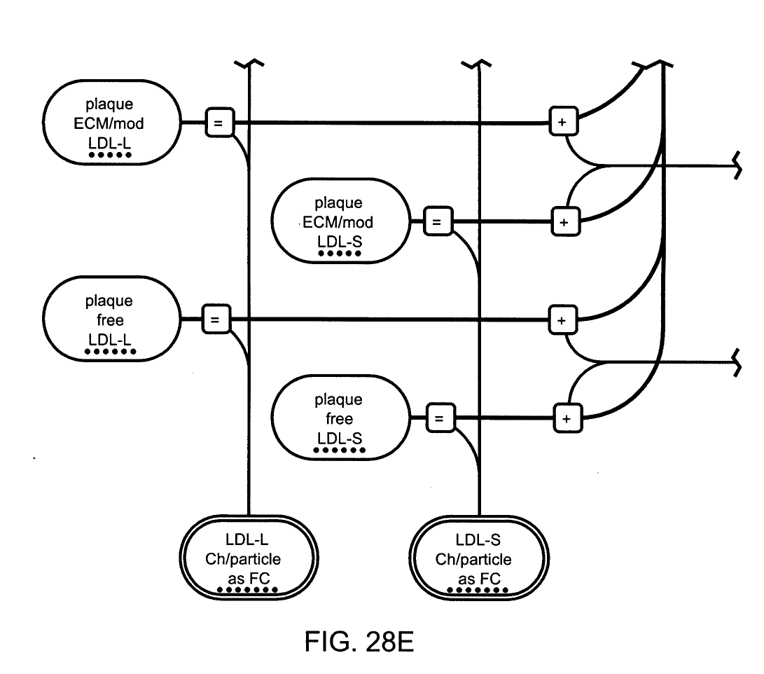

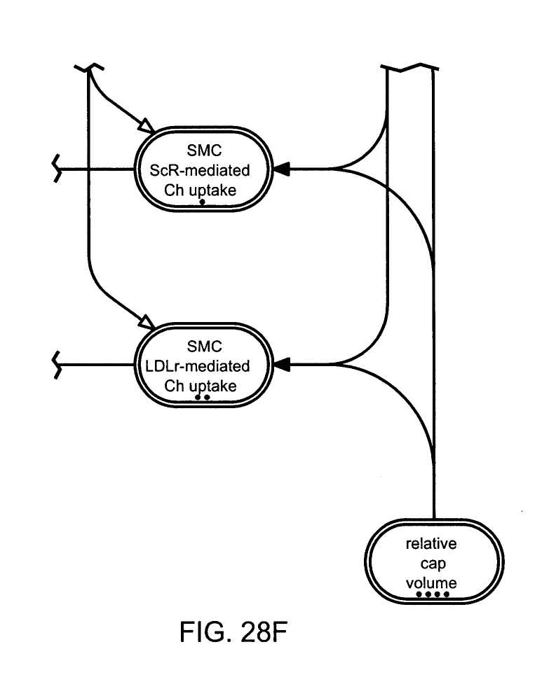

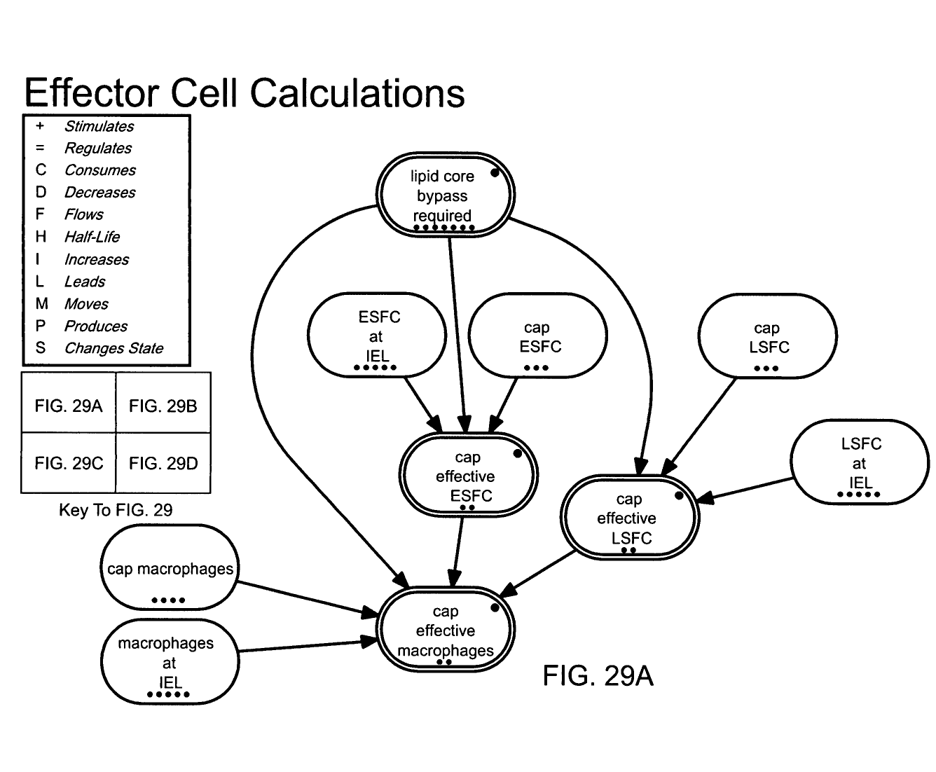

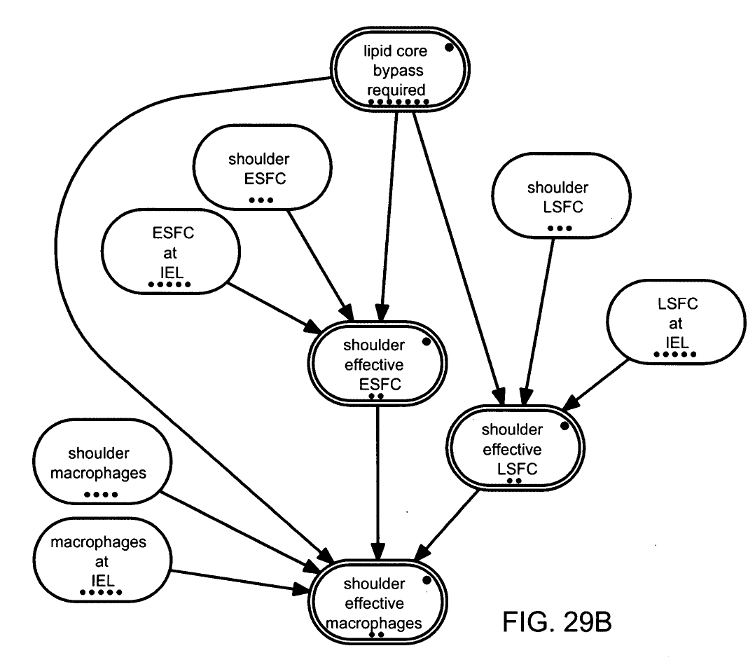

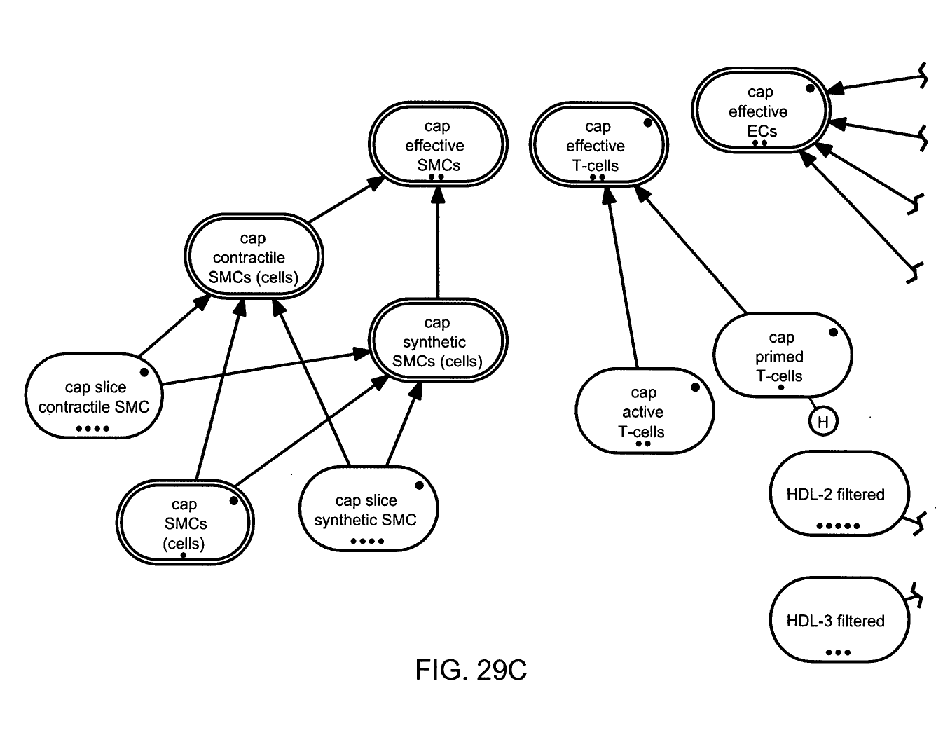

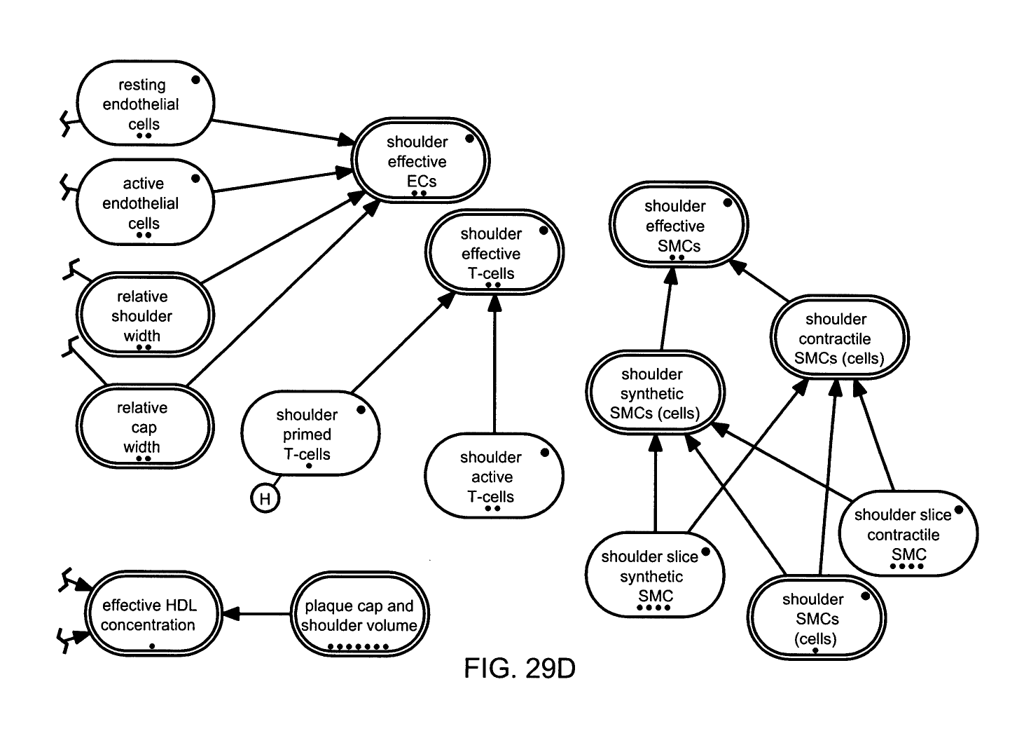

Lipid processing and deposition primarily occurs through the action of macrophages, foam cells and smooth muscle cells. FIG. 22 provides an exemplary Effect Diagram illustrating various biological processes relating to early-stage foam cell lipid processing. FIG. 23 provides an exemplary Effect Diagram illustrating various biological processes relating to late-stage foam cell lipid processing. FIG. 24 provides an exemplary Effect Diagram illustrating various biological processes relating to macrophage lipid processing. FIG. 25A illustrates one implementation representing macrophage and foam cell life cycles in the plaque. FIG. 25B illustrates one implementation representing macrophage and foam cell recruitment and apoptosis. FIG. 26 provides and exemplary Effect Diagram illustrating macrophage and foam cell reclassification, in which macrophages transition to early-stage foam cells which transition to late-stage foam cells and the reverse. FIG. 27 provides an exemplary Effect Diagram describing macrophage reclassification and migration rate calculations. FIG. 28 provides an exemplary Effect Diagram illustrating various biological processes relating to smooth muscle cell (SMC) lipid processing. FIG. 29 provides an Effect Diagram illustrating a representation of effector cell calculations.

In another implementation, the model can represent overloading of macrophages with cholesterol impairing cell migration and therefore cholesterol efflux from the intima. Further, as cholesterol levels increase the macrophages morph to foam cells and ultimately can be immobilized due to cholesterol overload.

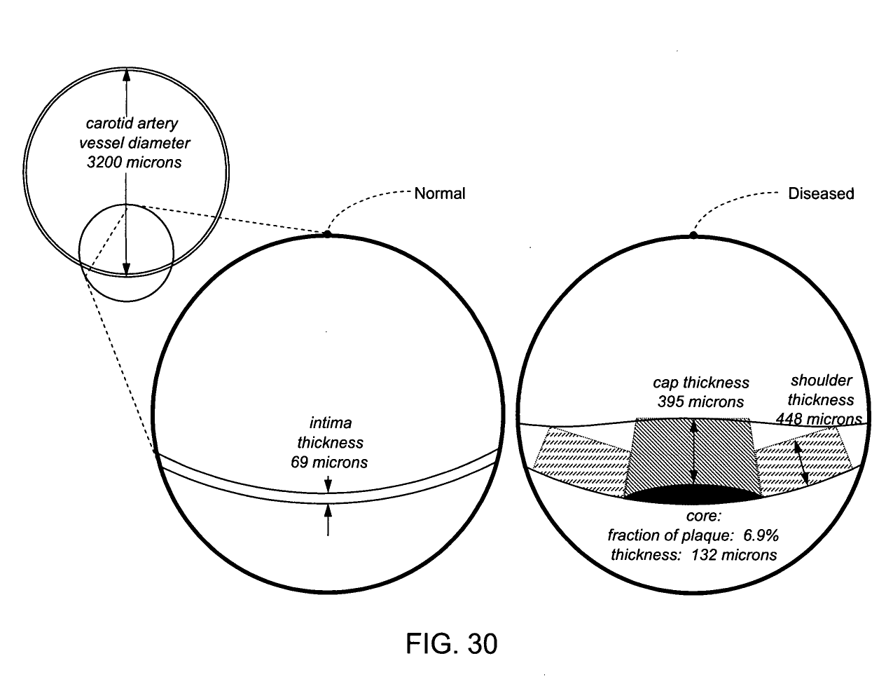

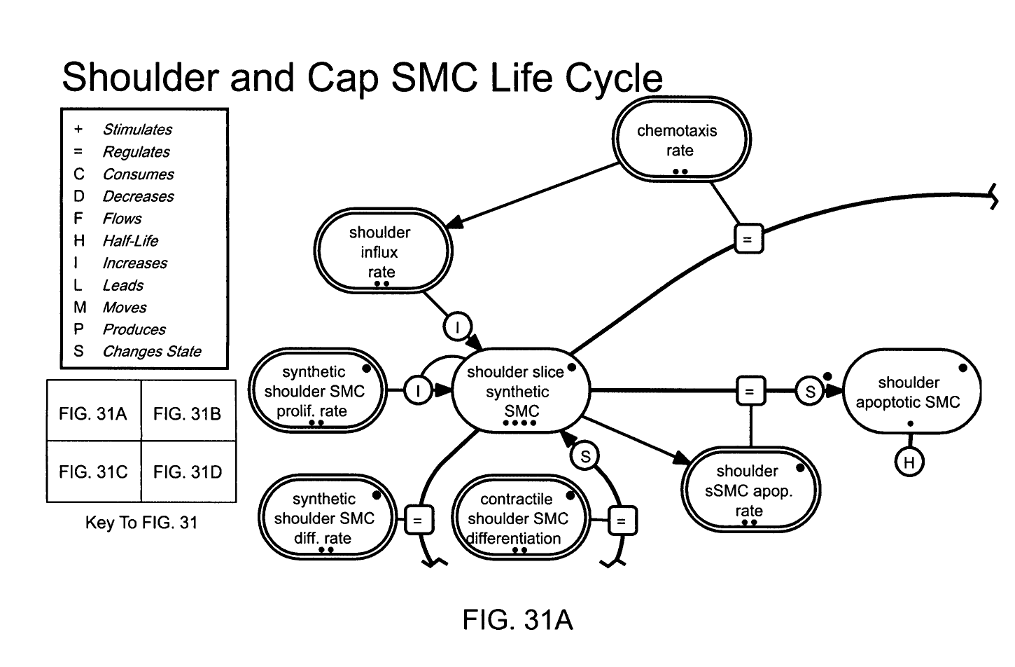

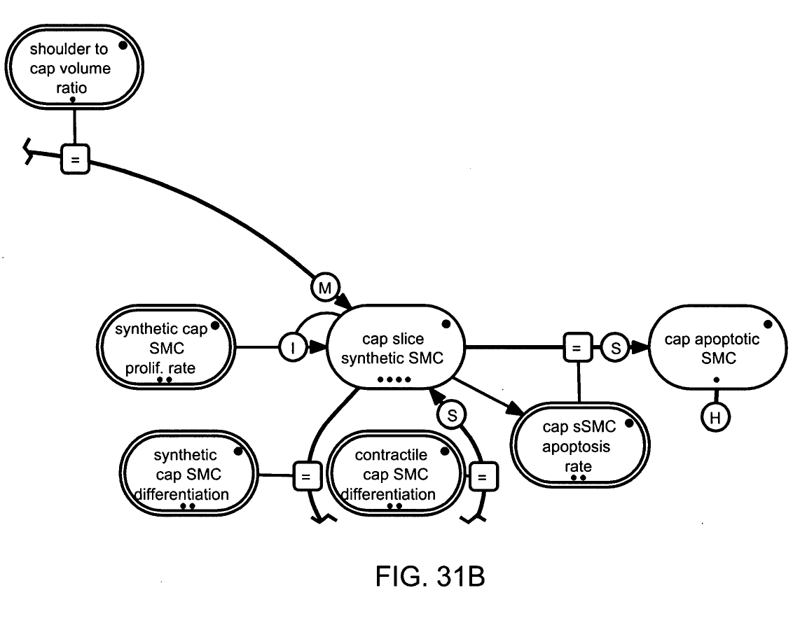

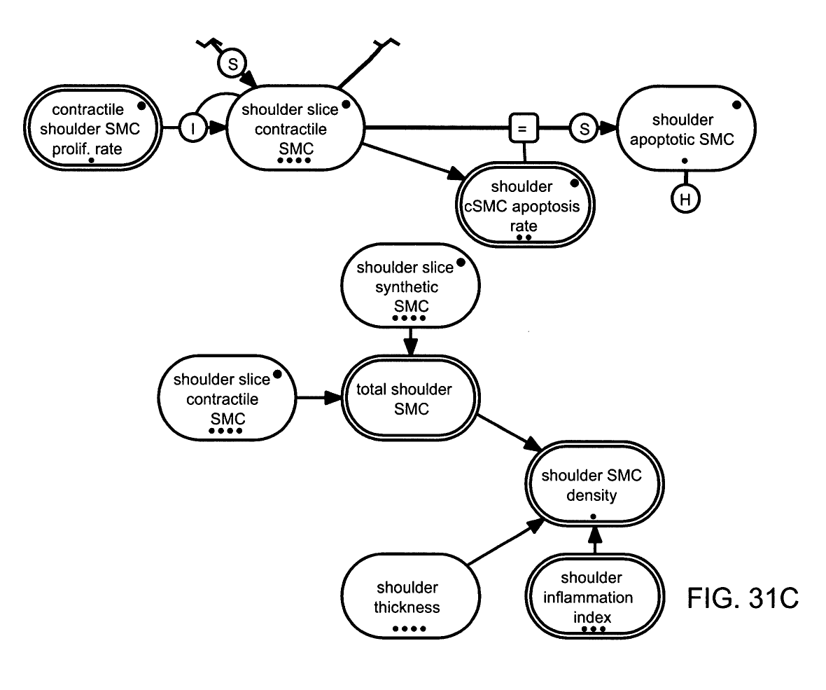

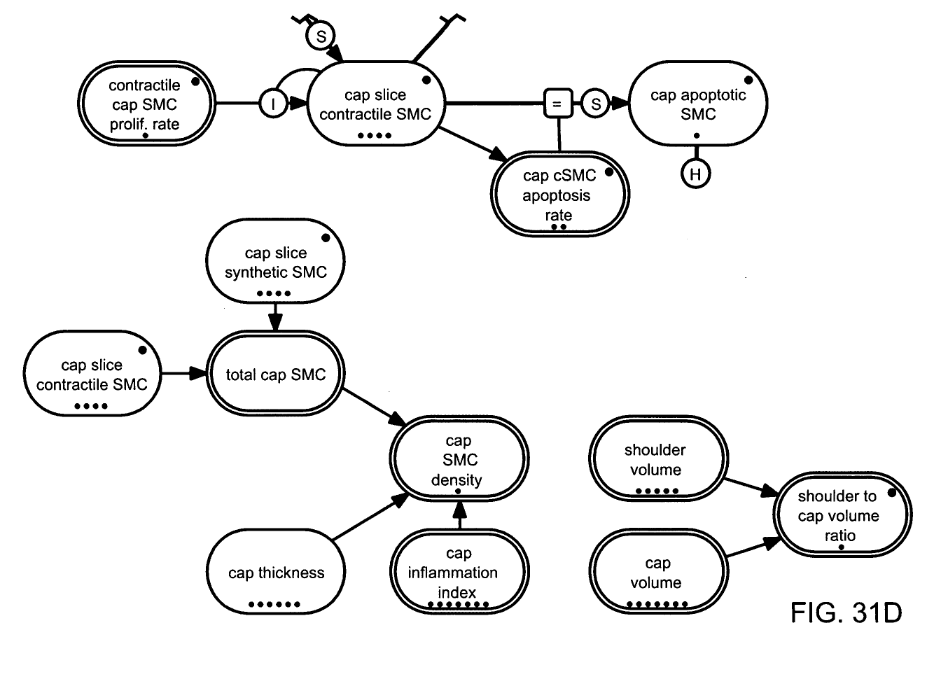

In one implementation of the invention, the module describes growth of a “spatial average” of all plaques in all locations of a virtual subject. Complex plaque growth can, thereby, be reduced to a single-core, single-cap model. Plaque growth can be appropriately modeled by representing two distinct spatial regions, a cap and a shoulder (see FIG. 30). The shoulder is defined as the fibrous region of the plaque adjacent to both the lipid core and the healthy intima. Each region has independent inflammation indices. FIG. 31 provides an exemplary Effect Diagram describing biological processes associated with smooth muscle cell life cycle in the shoulder and cap of an atherosclerotic plaque.

A reference equilibrium state typically exists and can be specified. For example, in a healthy patient, total lipid flux is in balance and a lipid core does not grow. A representation of one or more “risk factors” for atherosclerosis can be added to the module in order to simulate plaque progression. Exemplary risk factors include increased levels of circulating lipids, increased inflammation, and increased retention and modification of LDL particles in the intima.

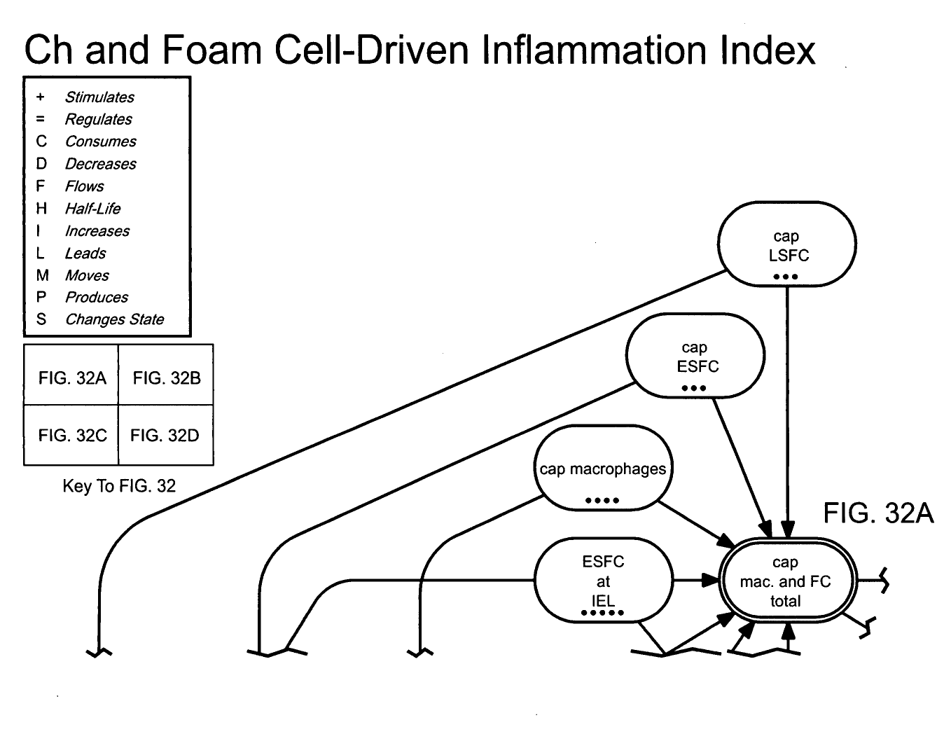

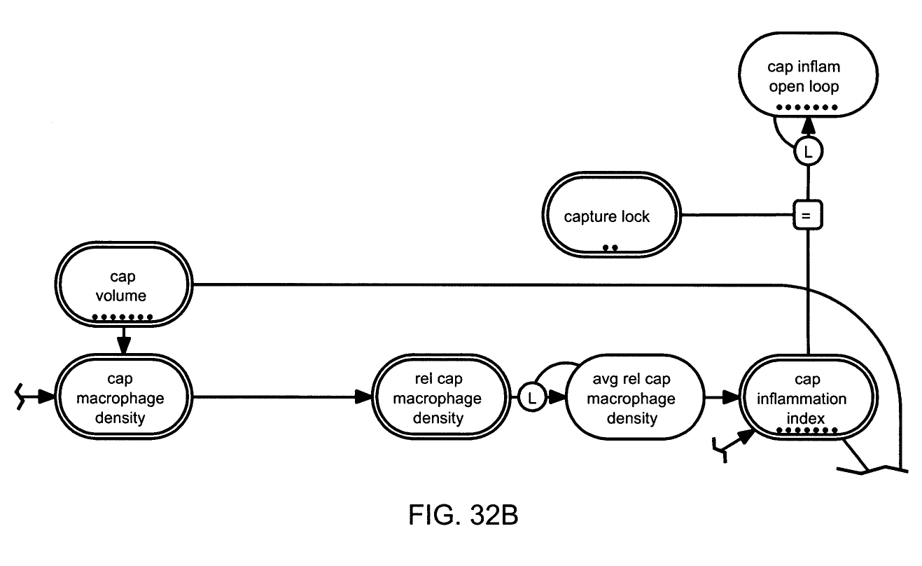

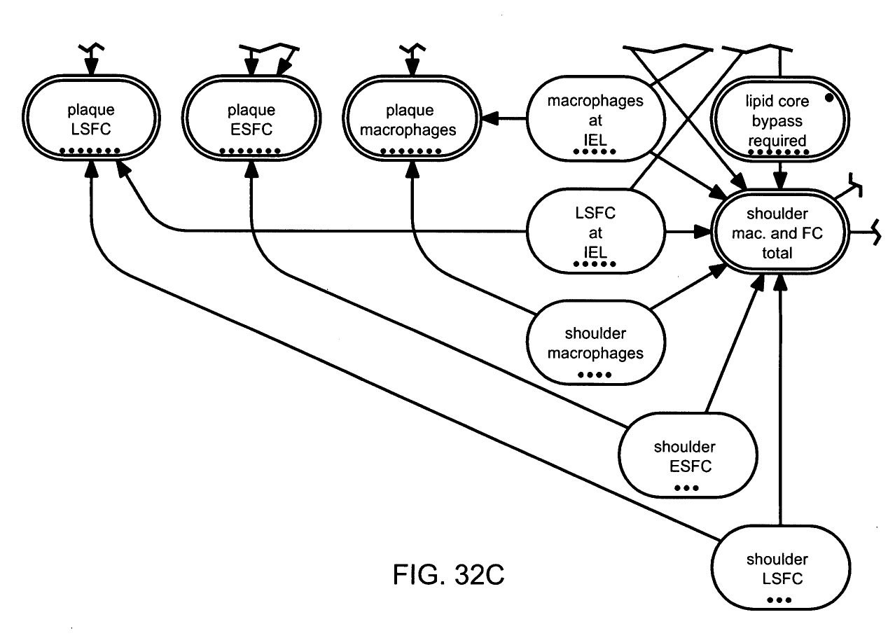

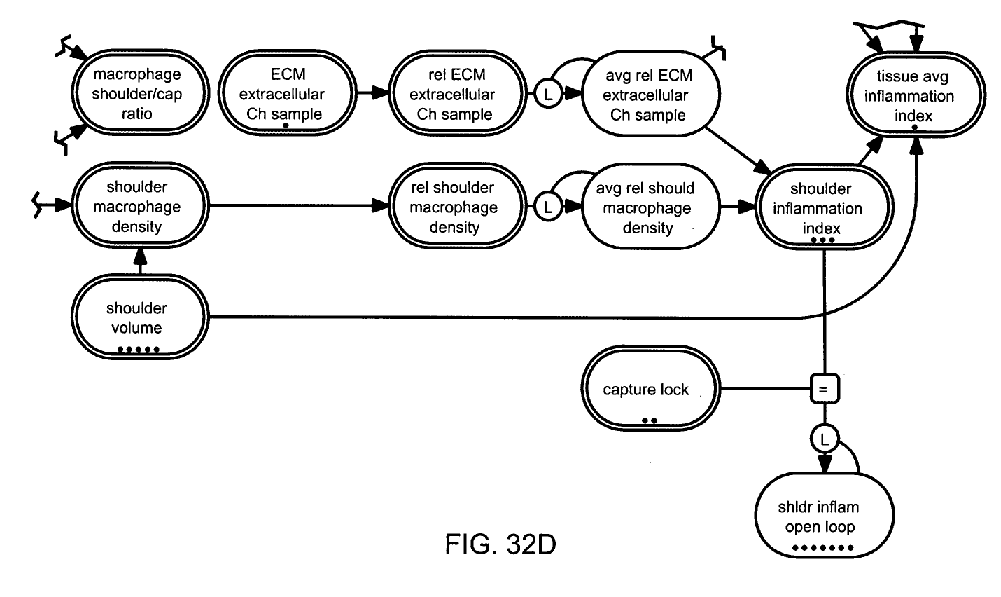

Lipid core growth typically is due to apoptosing foam cells. As more lipid is deposited in the plaque, macrophages and smooth muscle cells have to work harder to remove cholesterol. The core of the plaque itself creates a physical barrier. Macrophages must travel farther, around the core, to exit the blood vessel. Increased travel times also result in increased exposure of macrophages to high levels of cholesterol, leading to increased likelihood of transition to foam cell. Foam cells typically have a higher rate of apoptosis than macrophages. Apoptosis of cells in the blood vessel not only add lipid to the existing plaque, but also can cause release of toxic cytokines, which can exacerbate inflammation. FIG. 32 illustrates the interactions that can lead to calculation of a tissue-averaged inflammation index dependent upon macrophage density and extracellular cholesterol content.

In a preferred implementation, the distinct effects of specific cytokines and growth factors, are represented by a composite parameter representation of inflammation. In an alternate preferred implementation, the distinct effects of specific cytokines and growth factors, are represented by a complex inflammatory network—a distributed parameter representation of key cytokines and growth factors. Inclusion of a complex inflammatory network can enhance different types of research and analyses, including: (1) creation of multiple new virtual patient phenotypes (e.g., diabetic, hypertensive, smoker, chronic systemic inflammation); (2) evaluation of therapies targeting specific inflammatory cytokines (e.g., MCP-1); and (3) exploration of patient variability and biological uncertainty underlying inflammation.

The biology of ACAT-1 activity in plaque macrophages and smooth muscle cells (SMCs) is relatively well established. Under ACAT-1 inhibition, free cholesterol may build up in the cell membrane to levels that the cell is incapable of effluxing. High levels of membrane free cholesterol lead to cell toxicity. While the threshold of membrane free cholesterol concentration for toxicity may be variable among macrophages and foam cells, it is likely that a two-fold increase in membrane free cholesterol is the maximum amount tolerated by macrophages. Preferably, free cholesterol-mediated toxicity are implemented for macrophages, early stage foam cells (ESFCs), and late-stage foam cells (LSFCs) in a manner consistent with this threshold. Additionally, ACAT-1 and CEH activity rates preferably reflect cellular free cholesterol requirements to maintain membrane integrity.

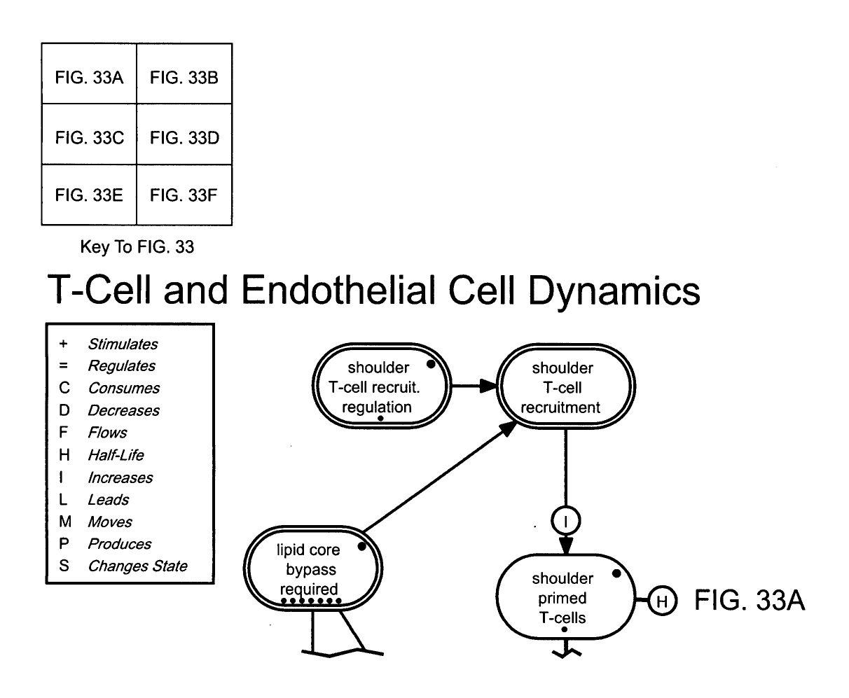

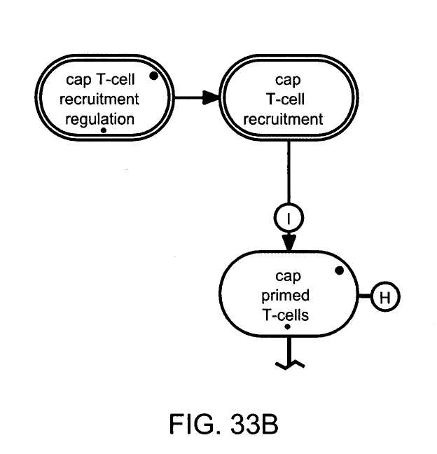

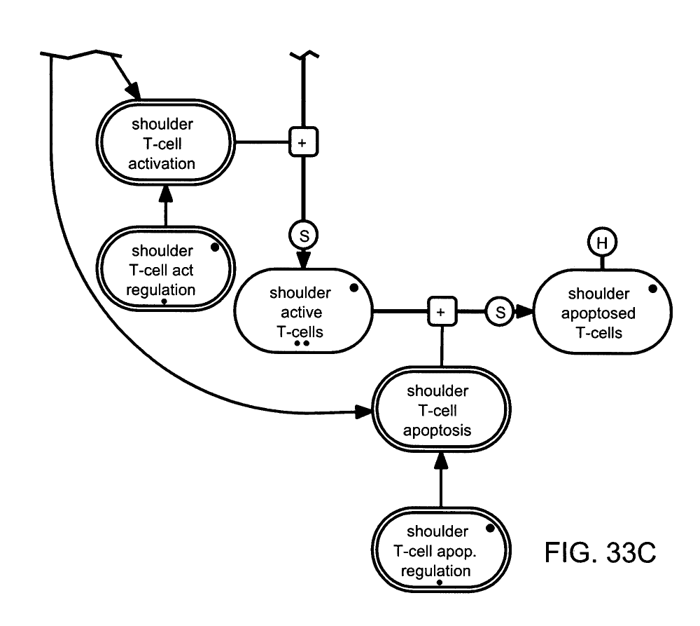

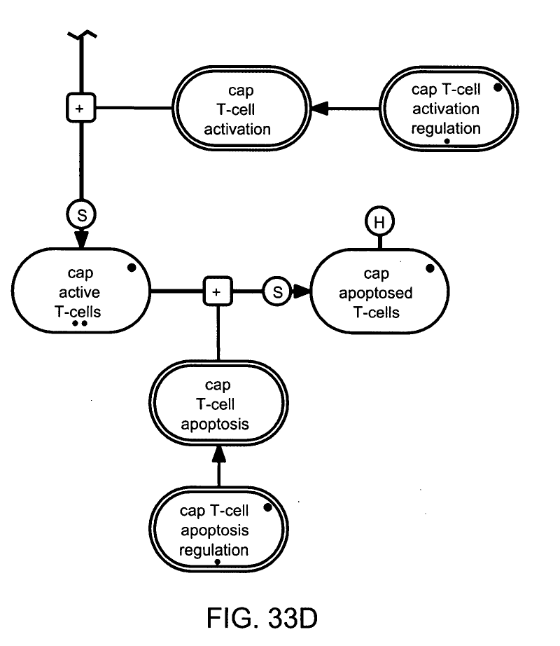

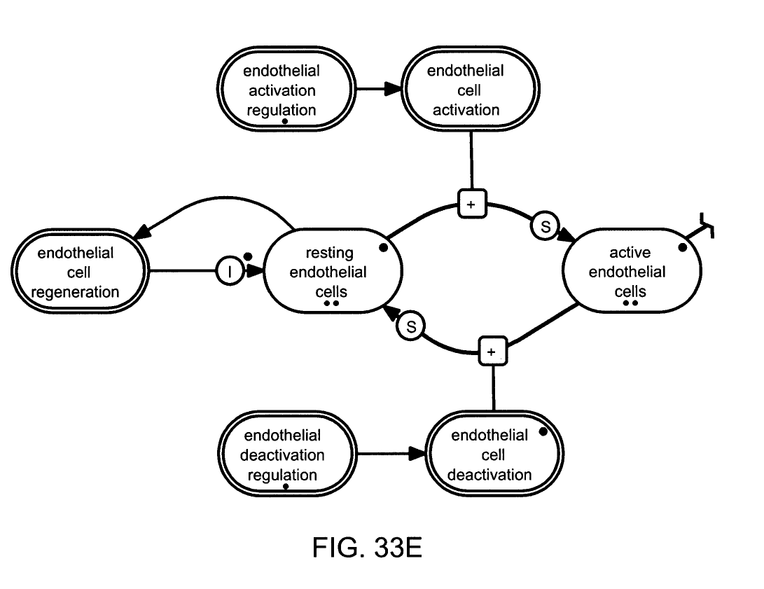

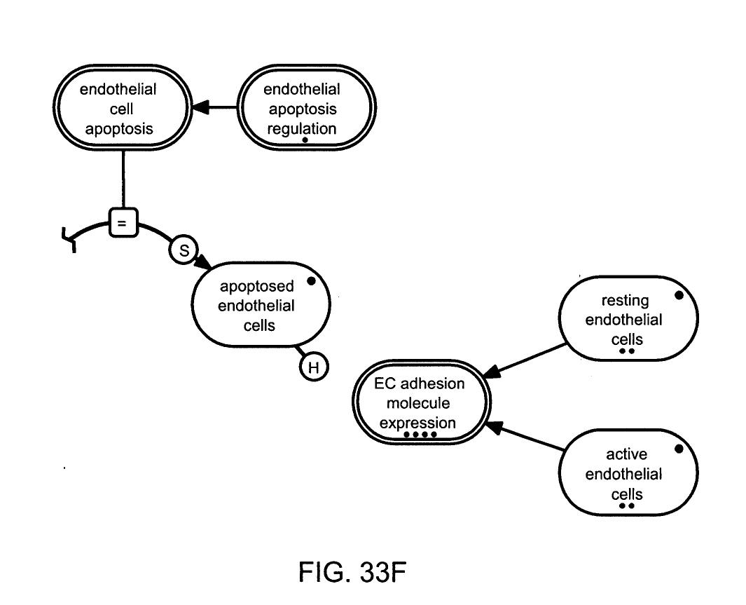

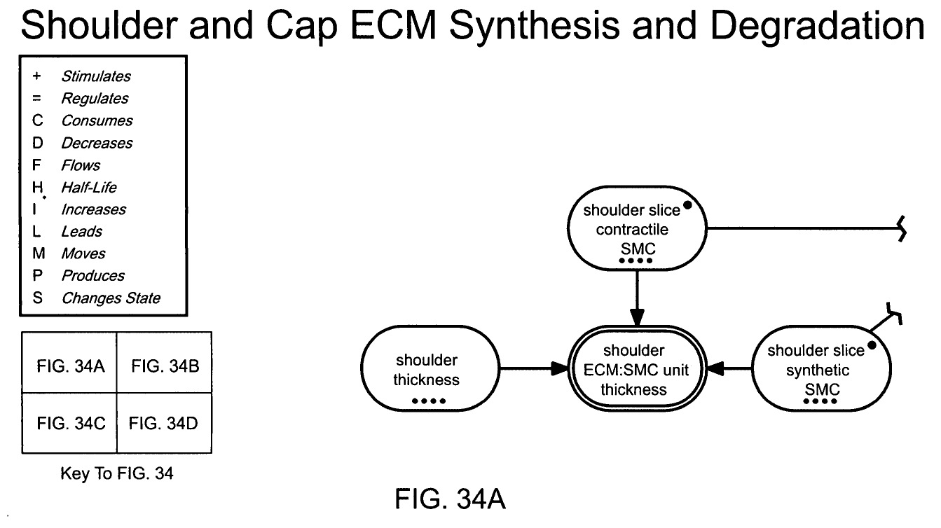

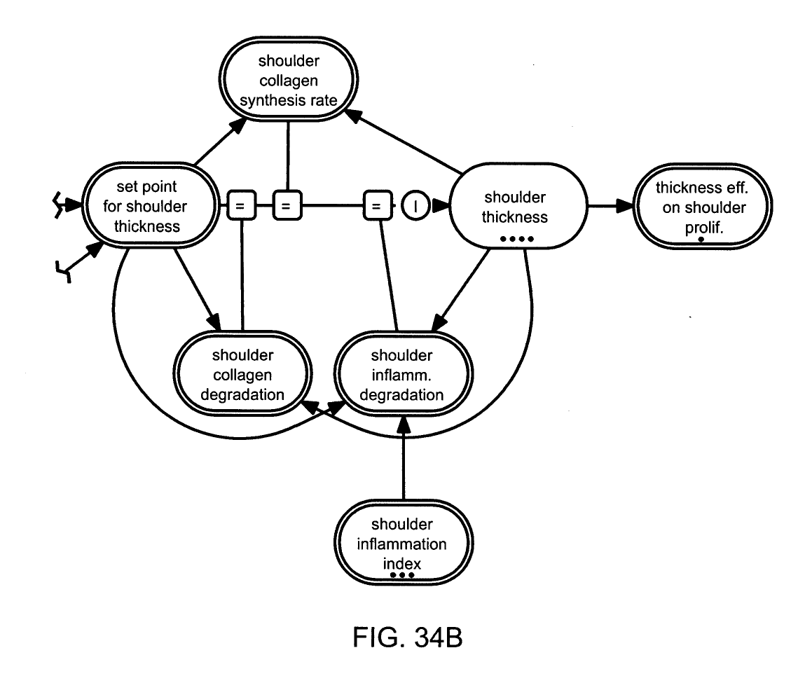

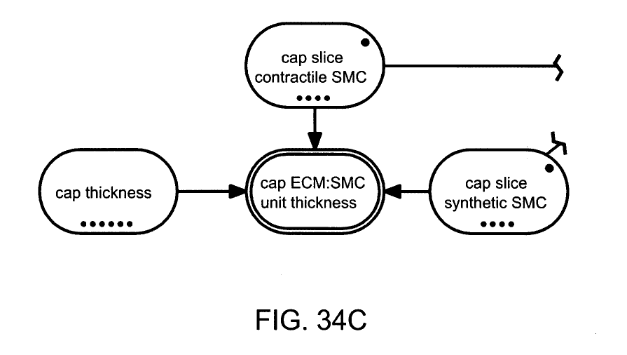

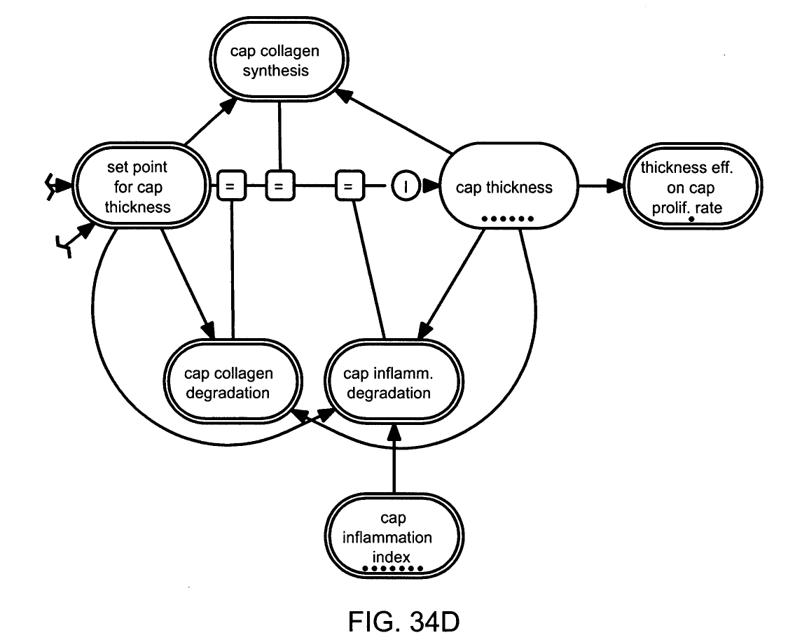

The complex inflammatory network also can include a representation of T-cell and endothelial cell population dynamics, as well as a representation of systemic inflammatory biomarkers and their key local effects within the plaque. FIG. 33 provides an exemplary effect diagram illustrating biological processes associated with T-cell and endothelial cell dynamics. FIG. 34 provides and exemplary Effect Diagram of extracellular matrix (ECM) synthesis and degradation in both shoulder and cap.

In one implementation of the invention, three states of T cells are represented in distinct populations in the plaque shoulder and cap: primed, active, and apoptosed. The model can include an enhanced representation of T-cell population dynamics in the shoulder and cap regions of the plaque. The transition of cells between states is regulated by inflammation, which has relatively little effect on apoptosis, but significant effects on recruitment and activation. Moreover, the fates of the primed and activated T-cell populations typically are different; primed T-cells are capable of migrating out of the plaque, while once activated, T-cells can only apoptose. The capability of primed T-cells to emigrate from the plaque is implemented as a half-life on the primed T-cell population. This additional granularity is consistent with the requirements of “primed” T-cells in the plaque for additional stimulation (via antigen presentation or co-stimulus) before becoming “activated” and secreting inflammatory mediators.

In one implementation of the model, three states are represented for endothelial cells, as well (FIG. 33). The slow proliferation of resting endothelial cells can be implemented to replace cell influx as the primary pathway for cell replenishment and leukocyte adhesion molecule expression by the activated endothelial cell fraction also can be included. Activated, but not quiescent, endothelial cells can be represented as undergoing regulated apoptosis. As with T cells, movement of cells between states is modulated by inflammation in a manner consistent with known biology. Both activation and apoptosis of endothelial cells increase generally with inflammation.

It is well established in the literature that different cytokines, chemokines, and systemic inflammatory markers can have differential effects on target pathways within a plaque. In order to capture the effects of specific cytokines and/or systemic factors in the atherogenesis module, the model represents key cytokines with multiple characteristics, which include parameters characterizing the effects of each inflammatory mediator on each affected regulator, including per-cell production rates (ng/10⁶ cells/hour) of each inflammatory mediator by each cell type, half-lives of each mediator, the effect (stimulator (S), potentiator (P), or inhibitor (I)) of each mediator on relevant target pathways, and characteristics of receptor binding, e.g., Kₘ, Vₘₐₓ, or Hill coefficients, for each mediator on relevant target pathways. Further, it is preferred that the atherogenesis module dynamically calculate changes in concentrations of each mediator in the plaque shoulder and cap in response to changes in inflammatory cell populations in each region. Preferably, the module dynamically integrates multiple input signals due to the combined effects of all stimulators, potentiators, and inhibitors affecting each regulator. Finally, it is preferred that the module output an integrated signal for each regulator reflecting the calculations above.

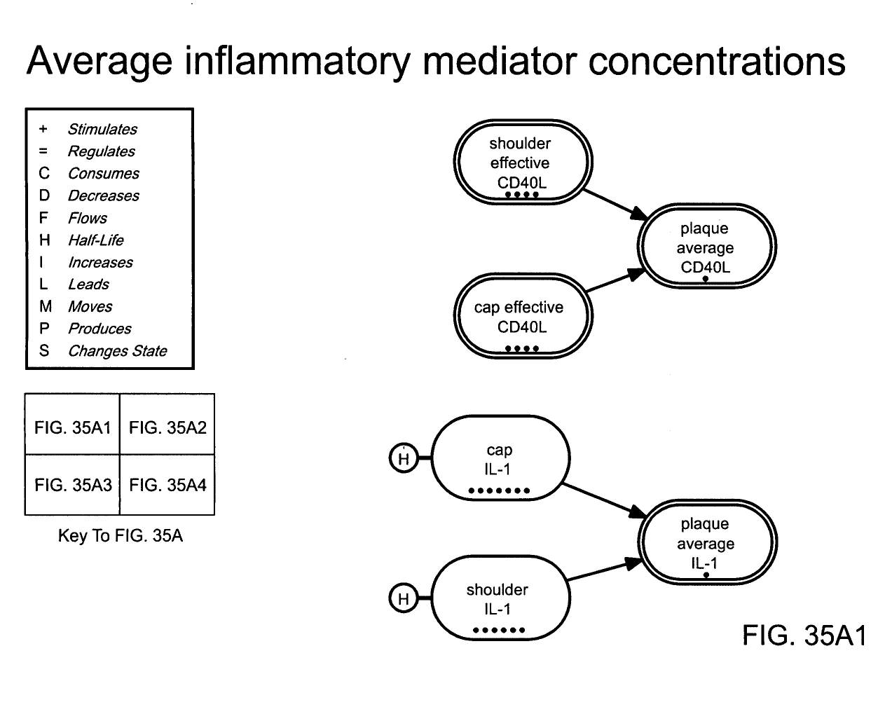

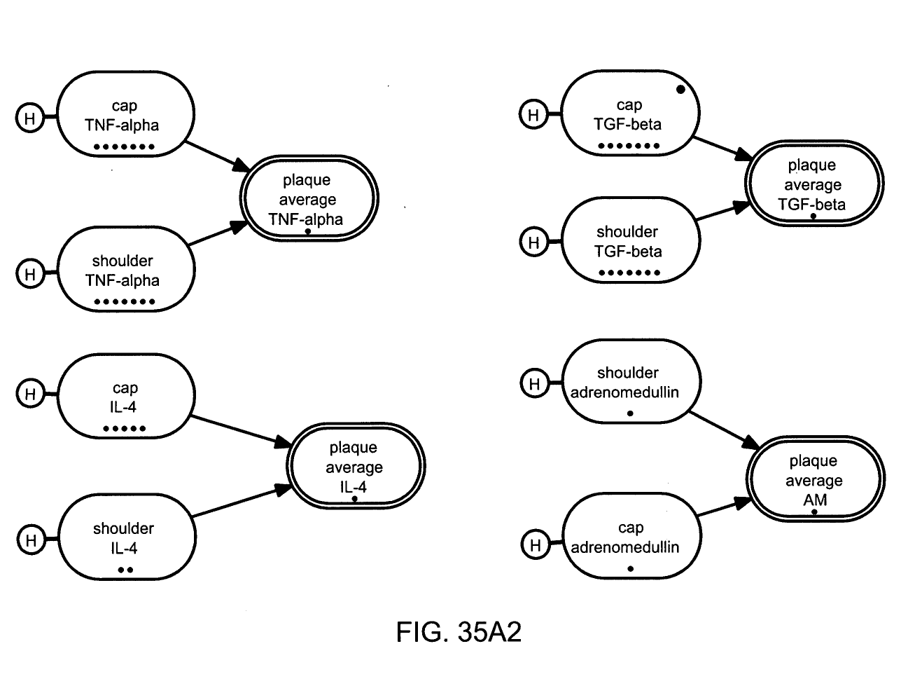

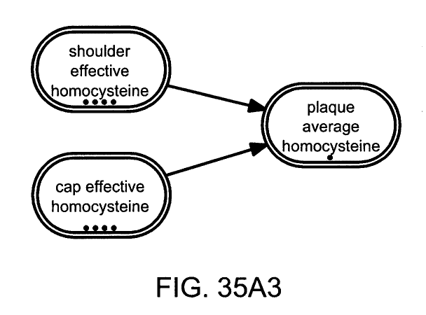

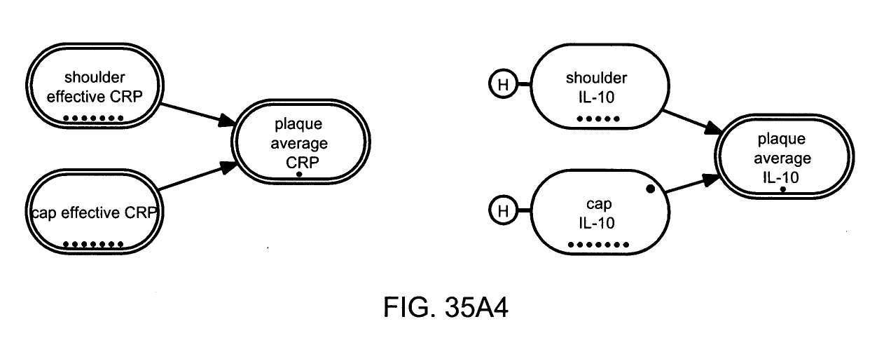

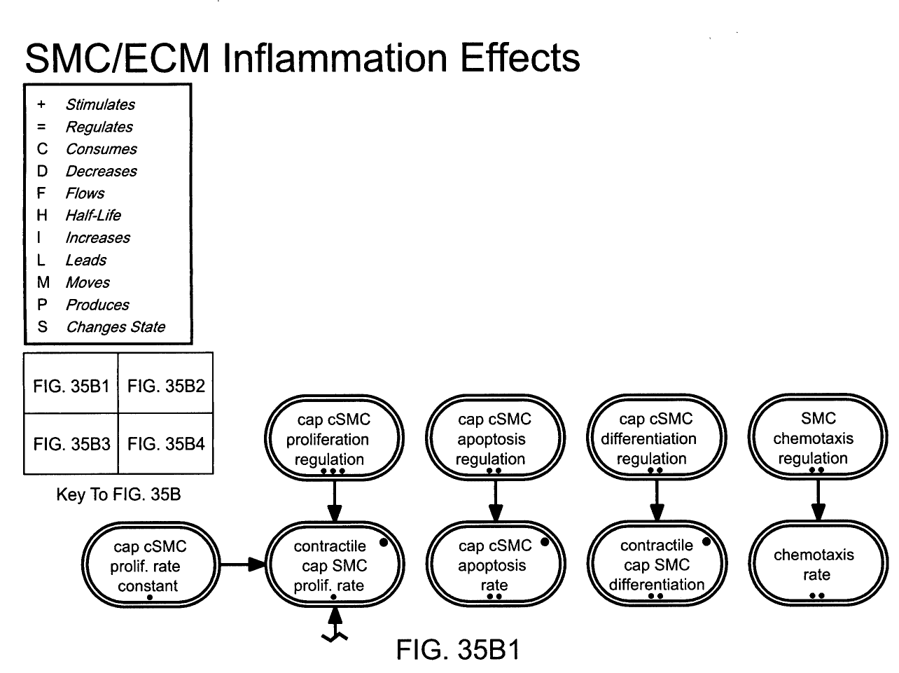

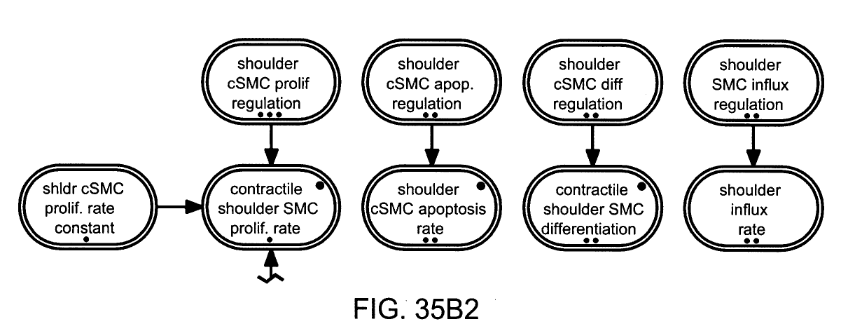

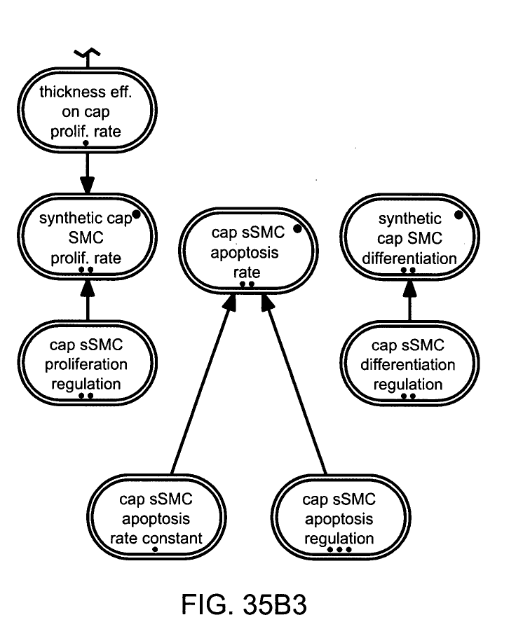

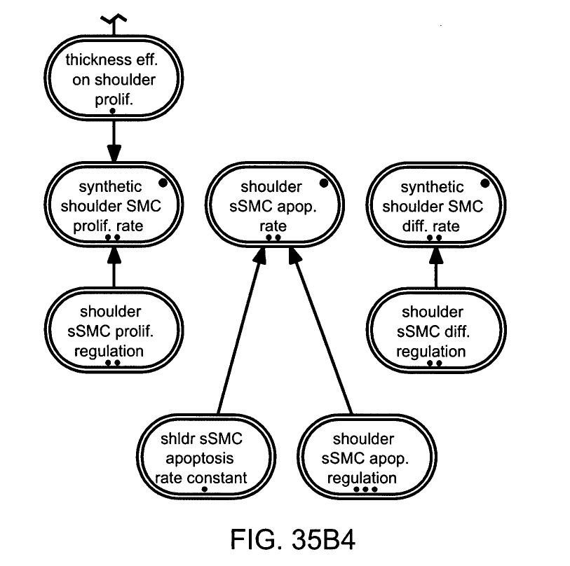

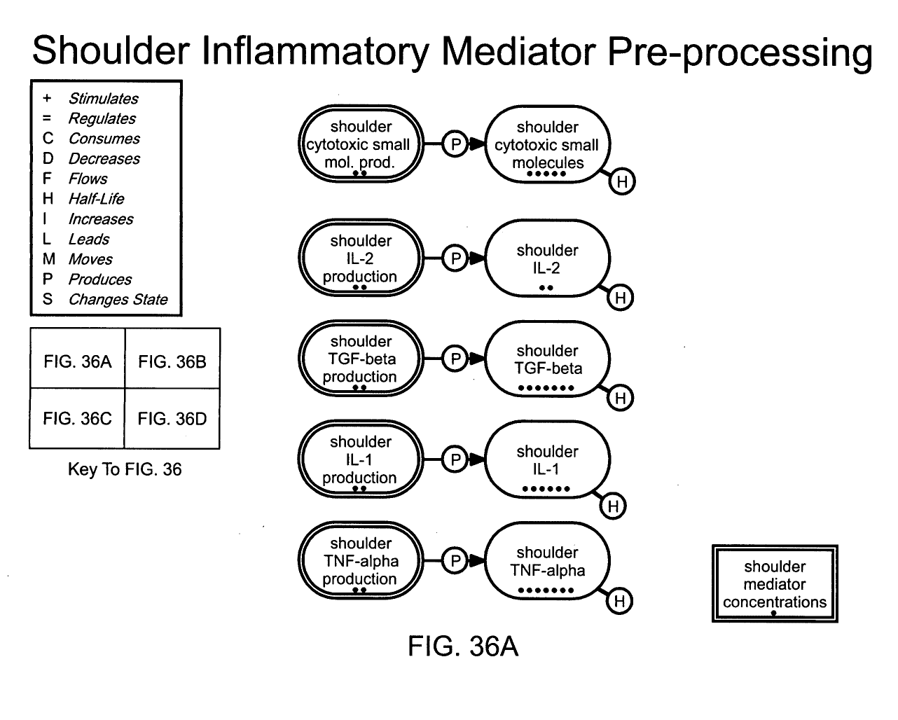

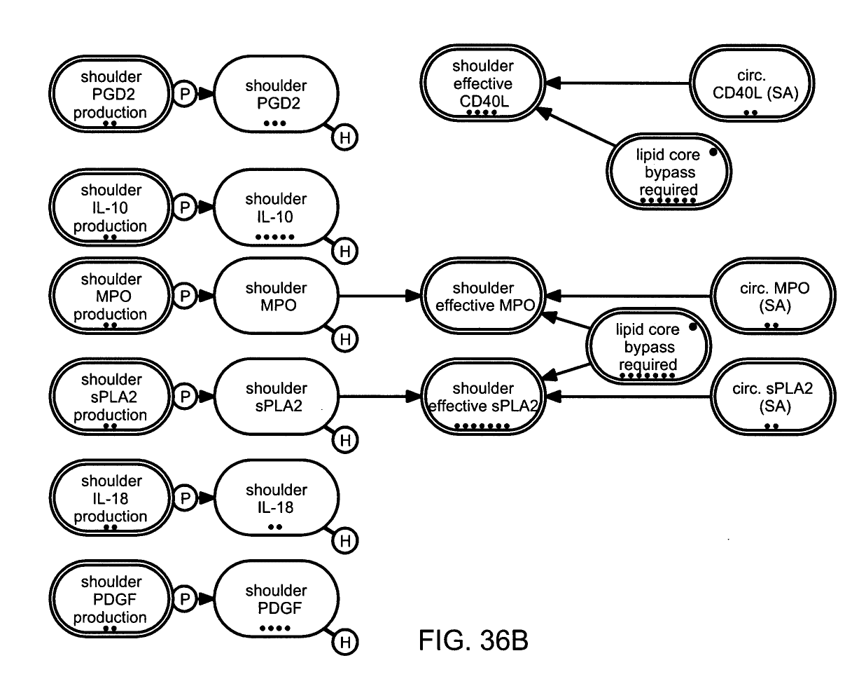

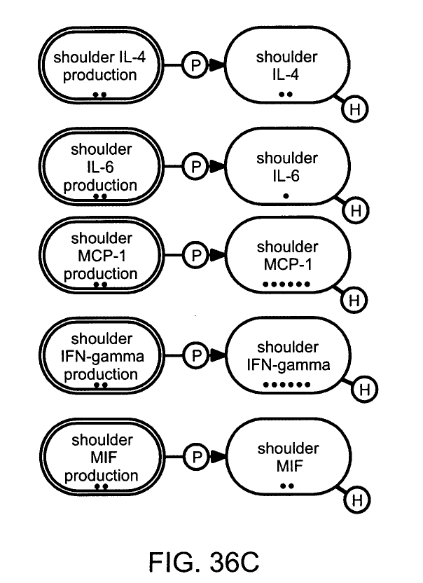

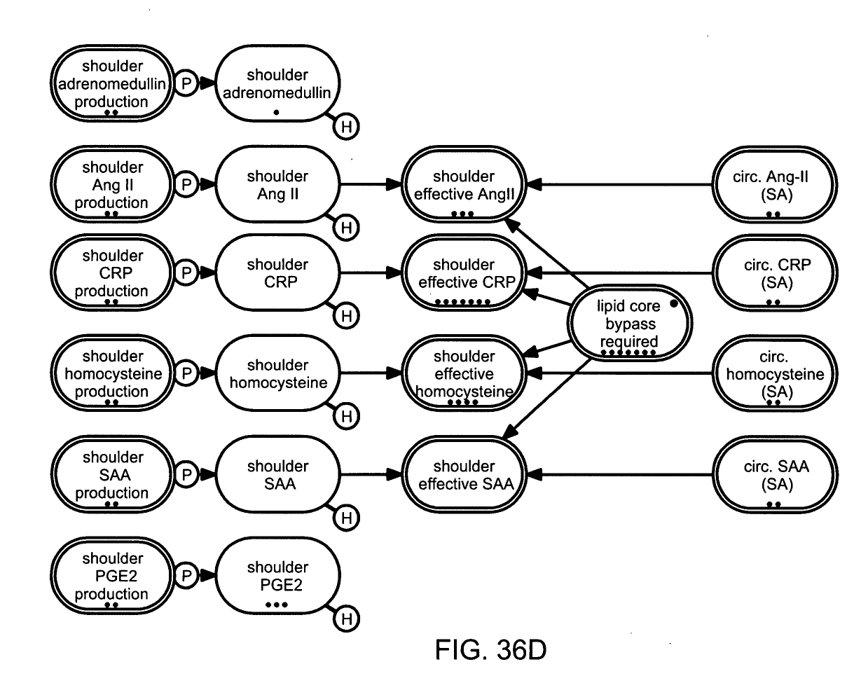

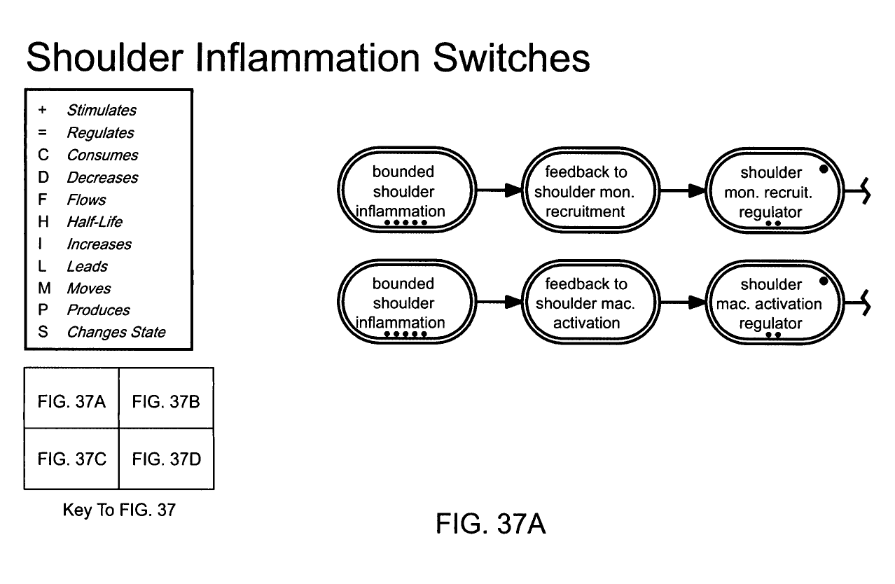

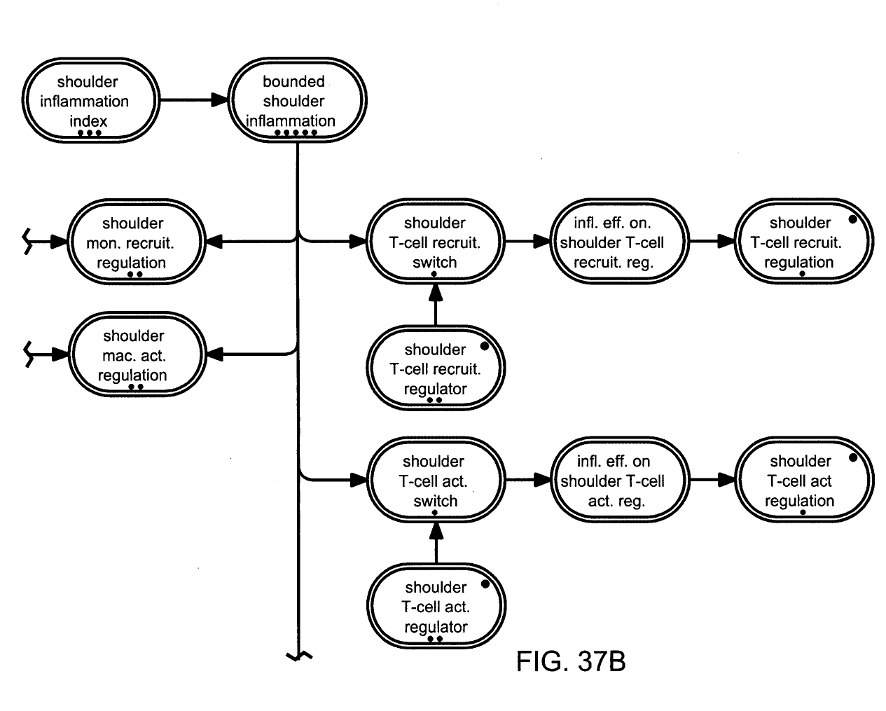

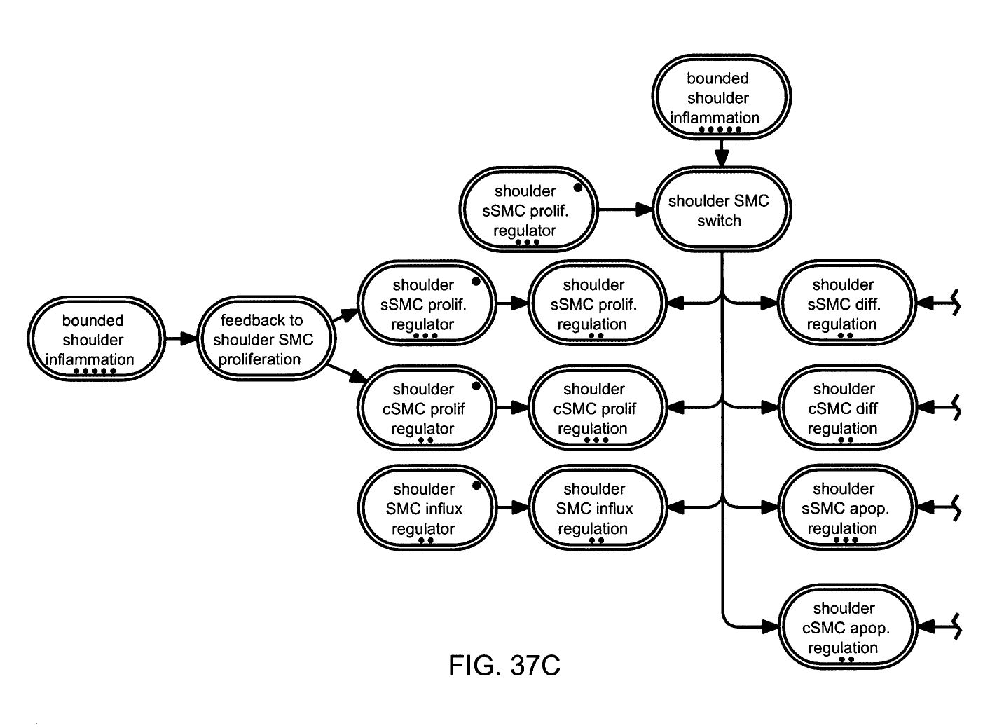

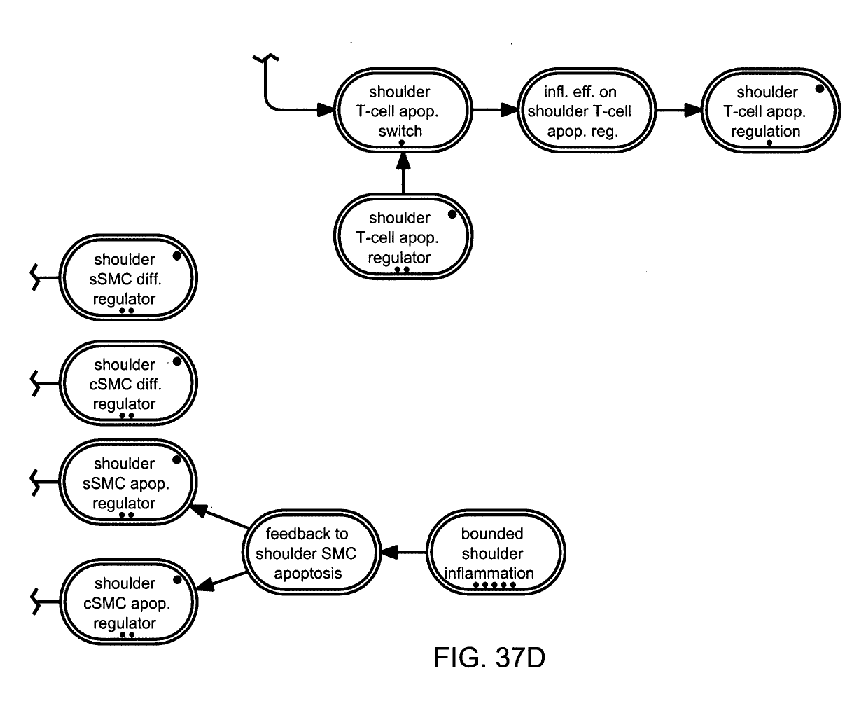

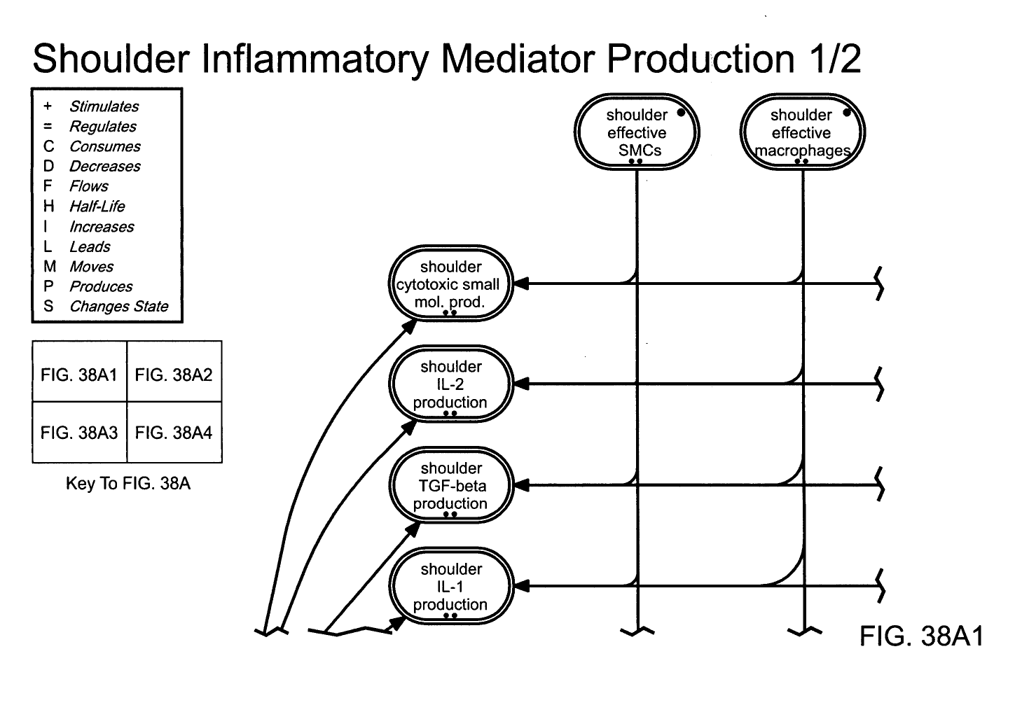

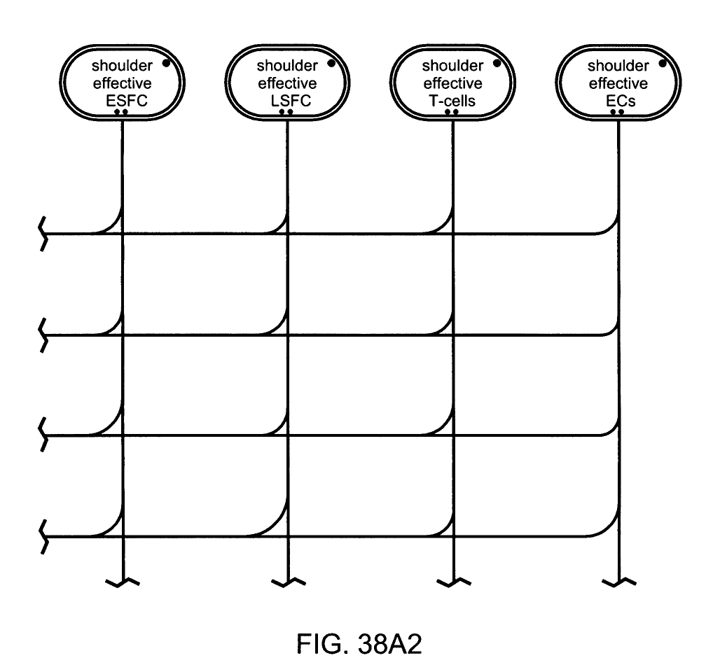

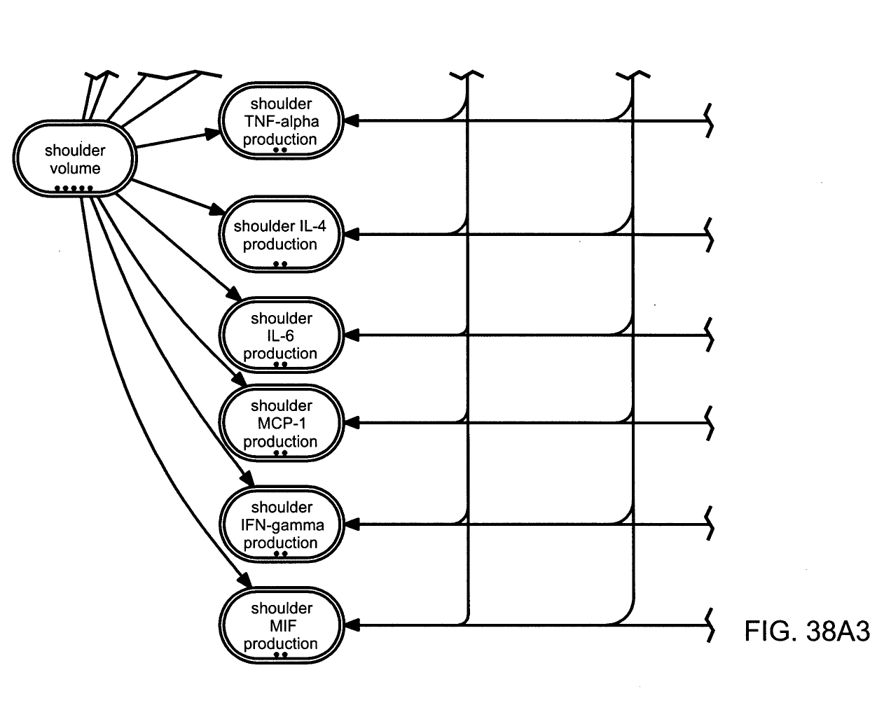

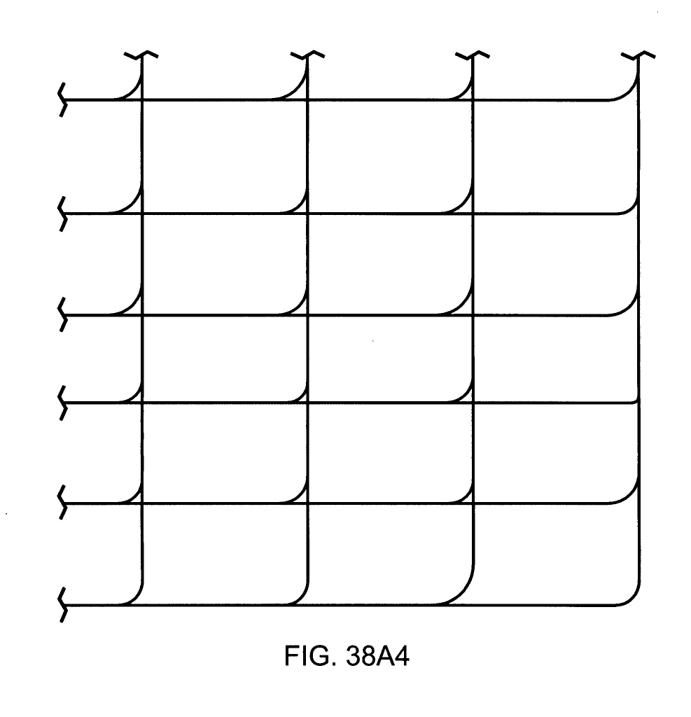

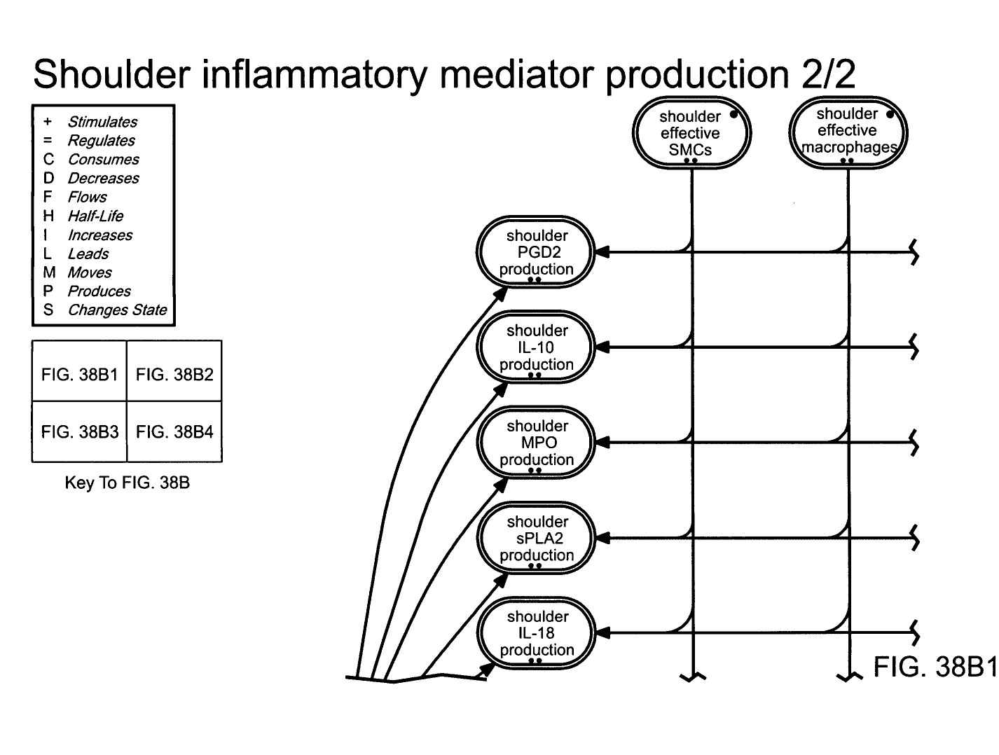

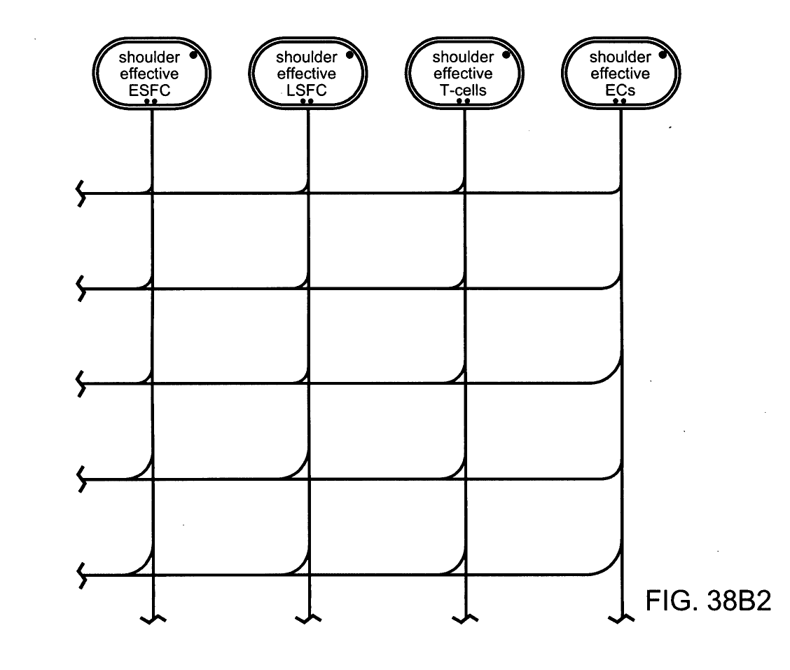

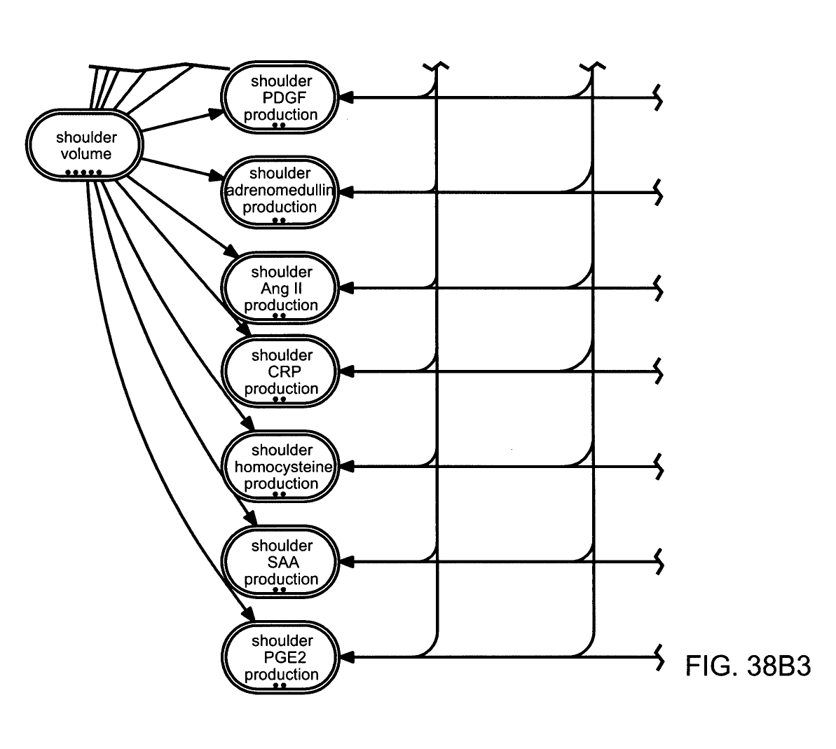

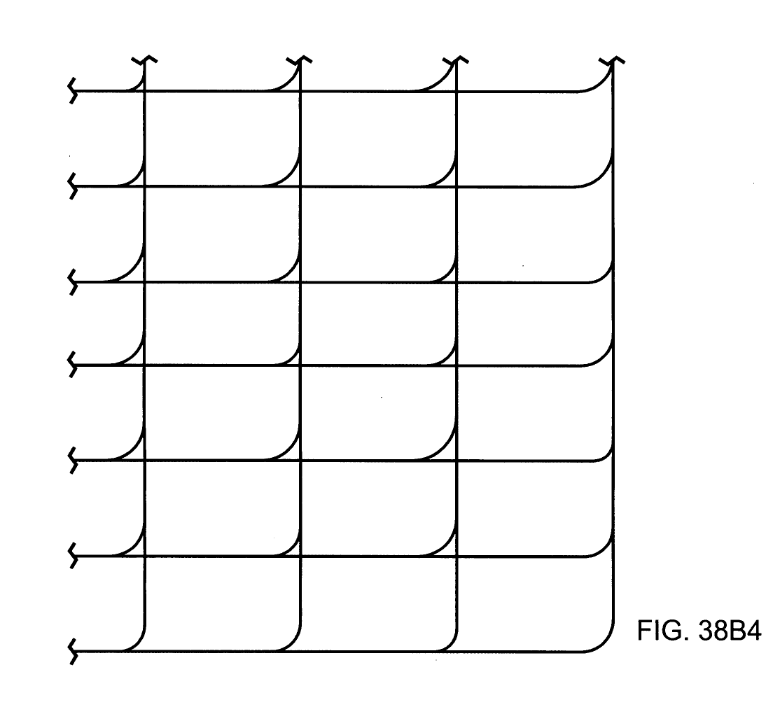

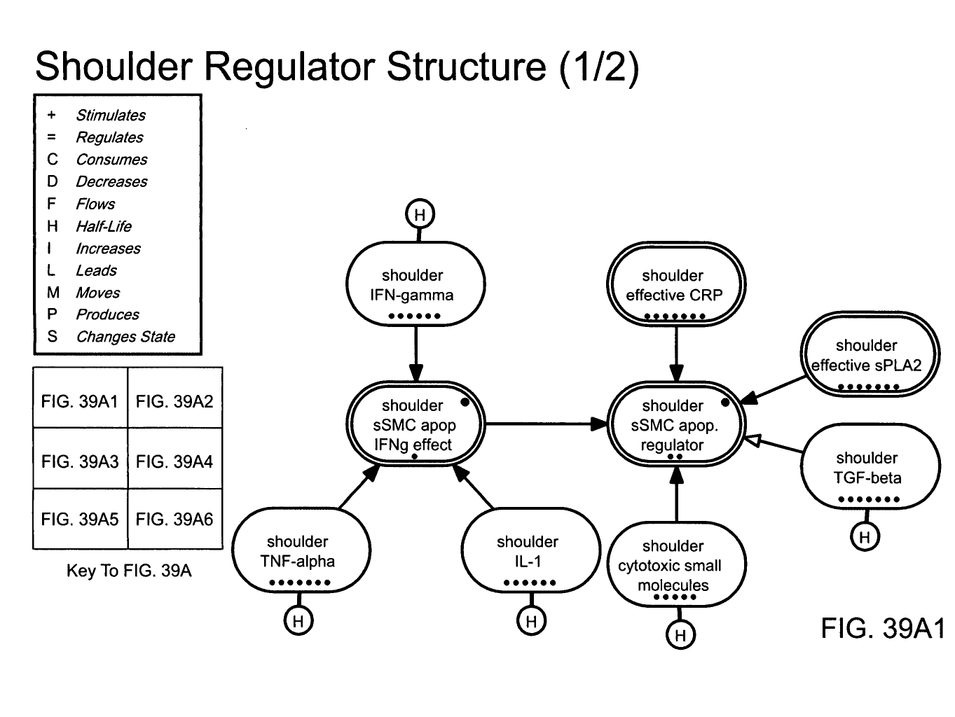

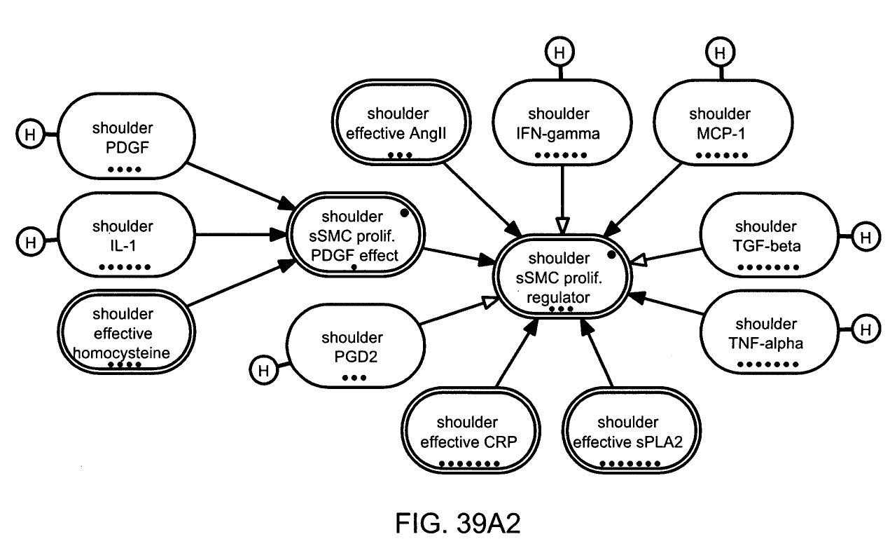

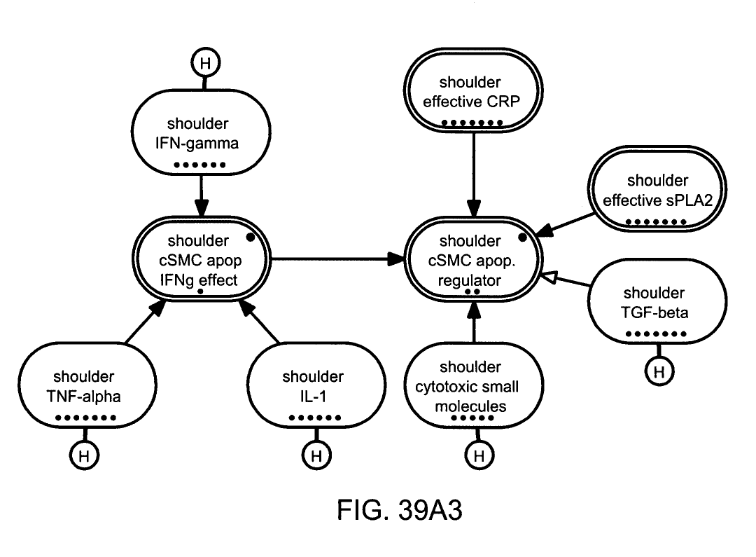

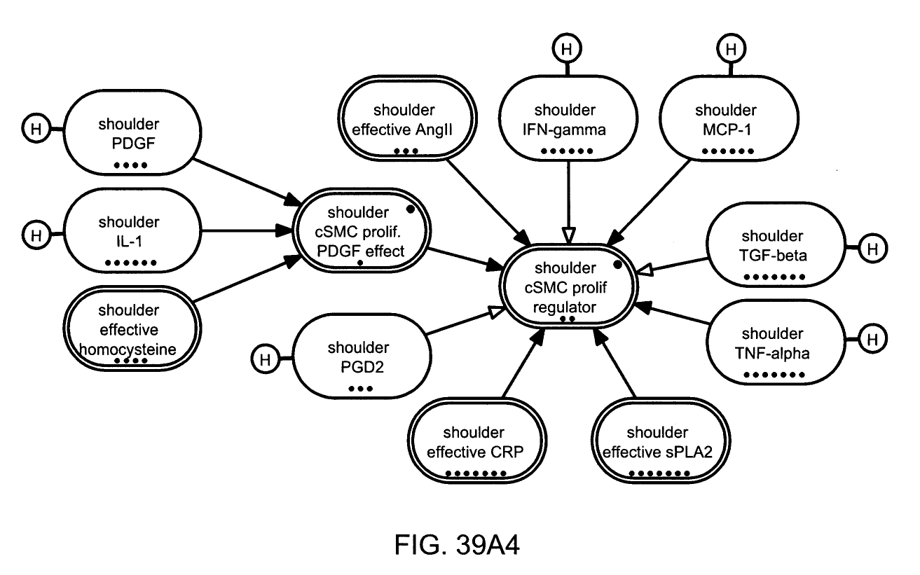

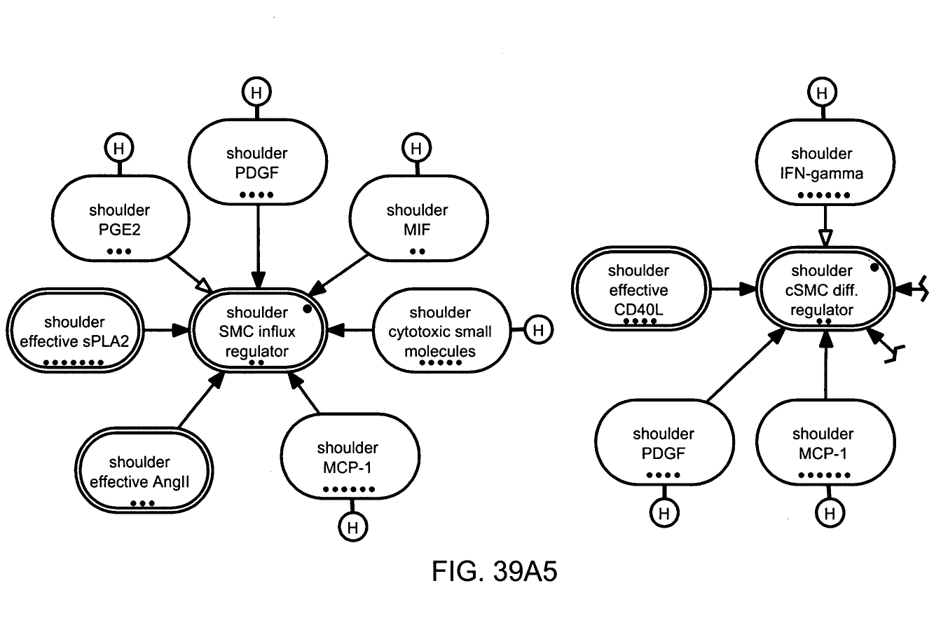

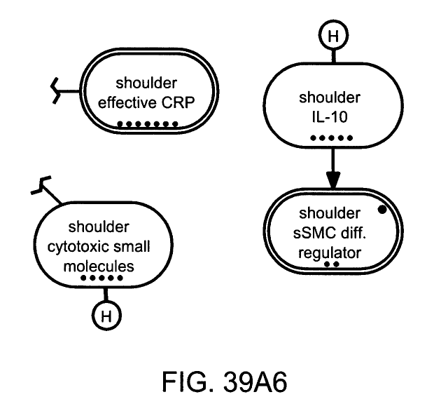

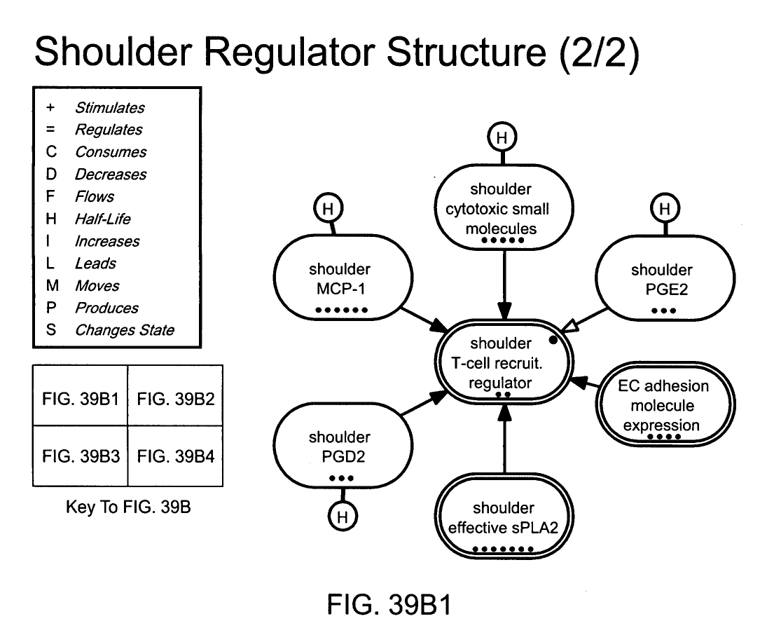

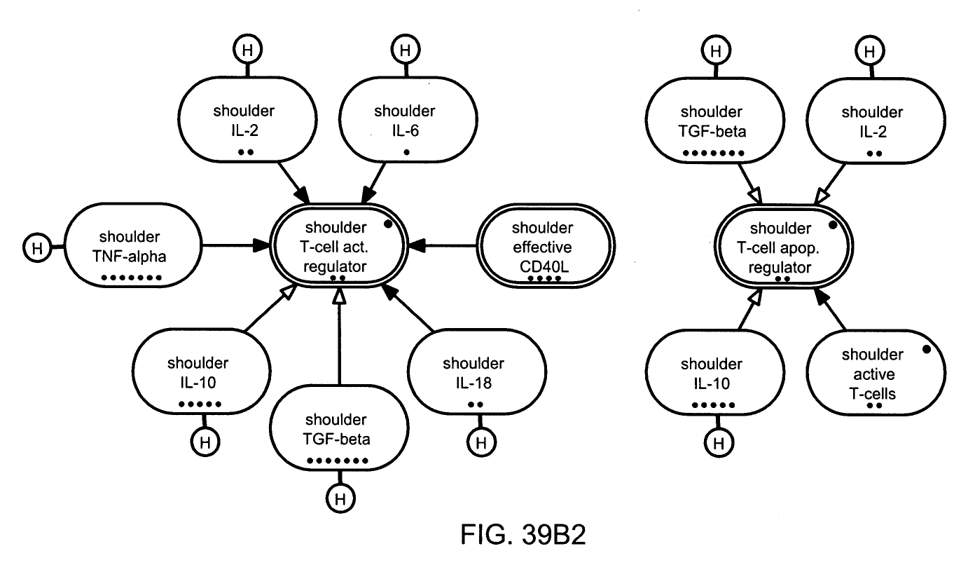

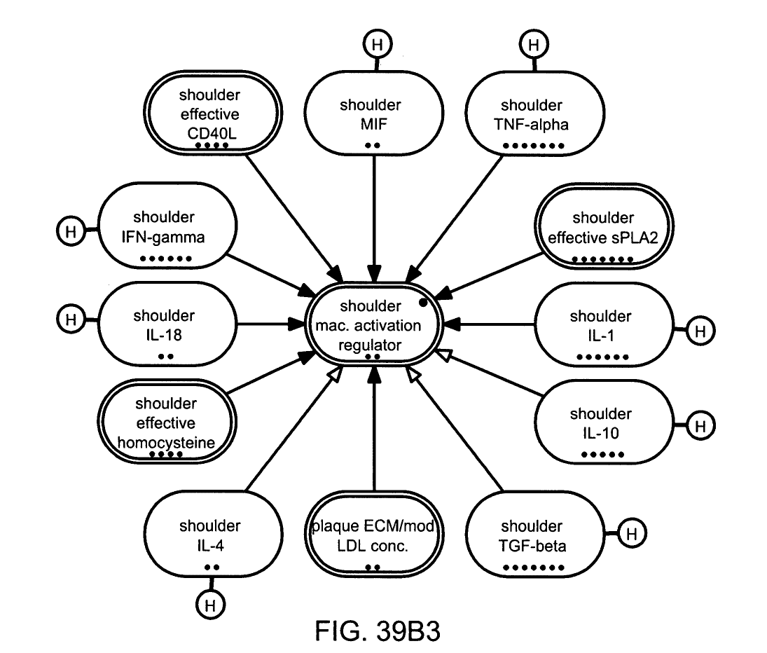

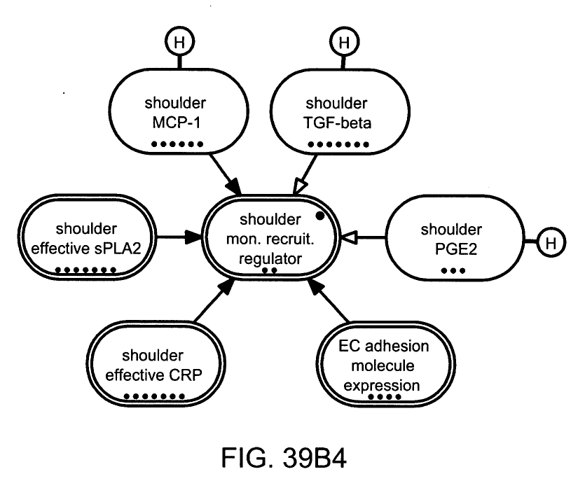

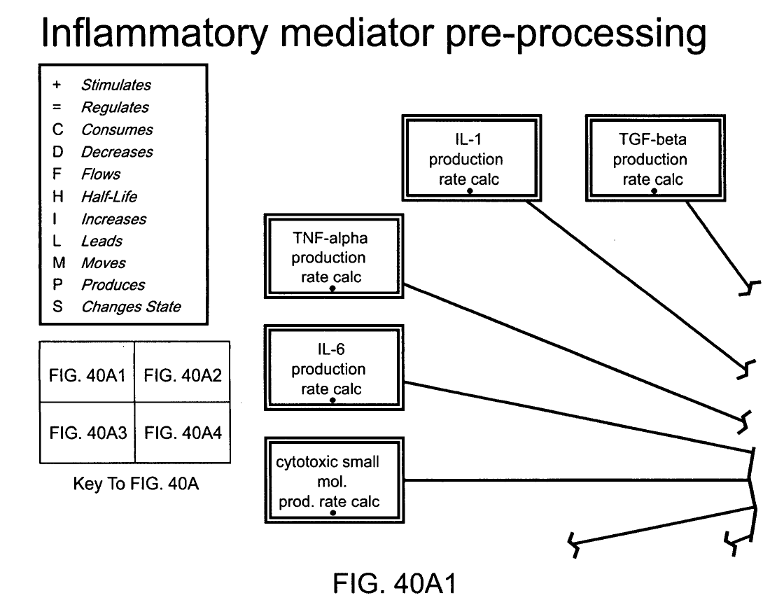

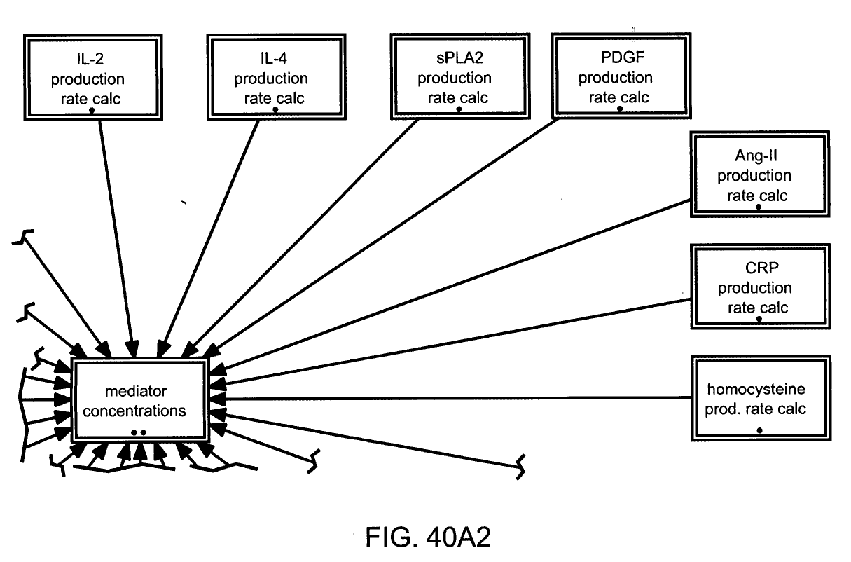

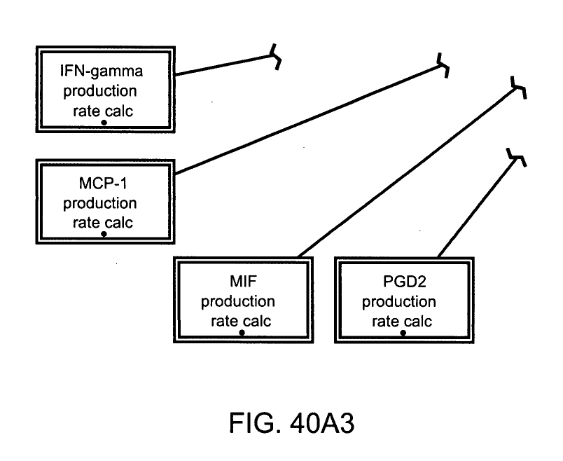

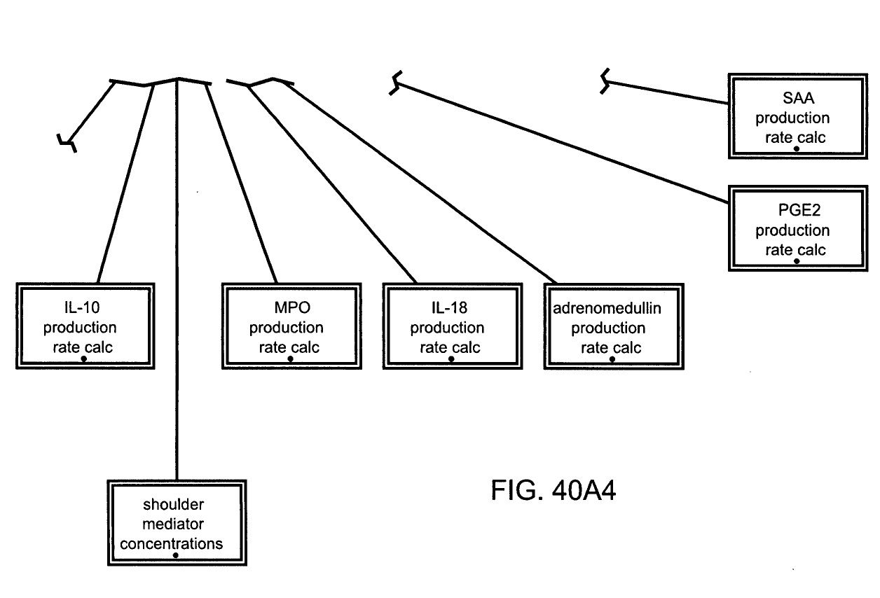

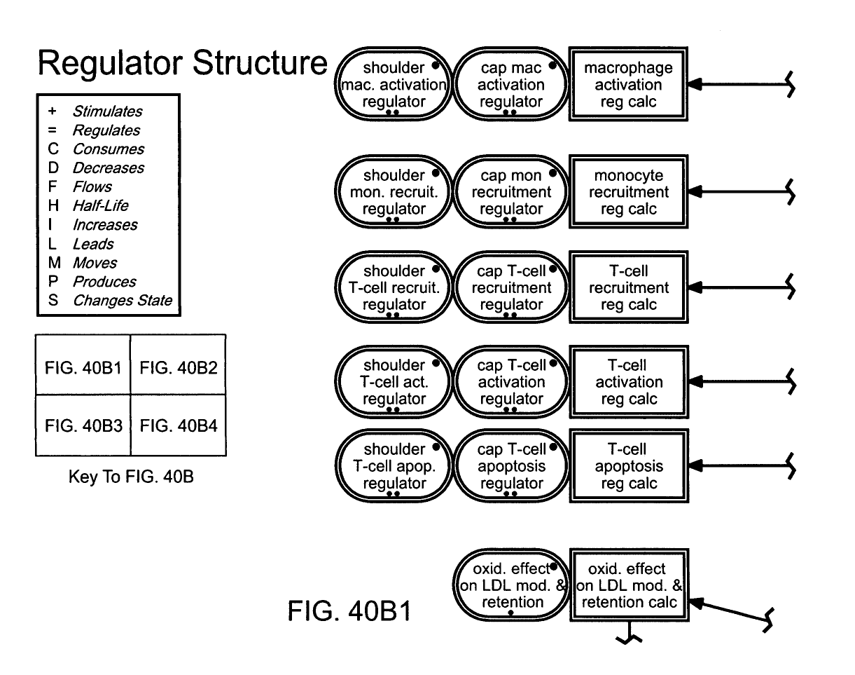

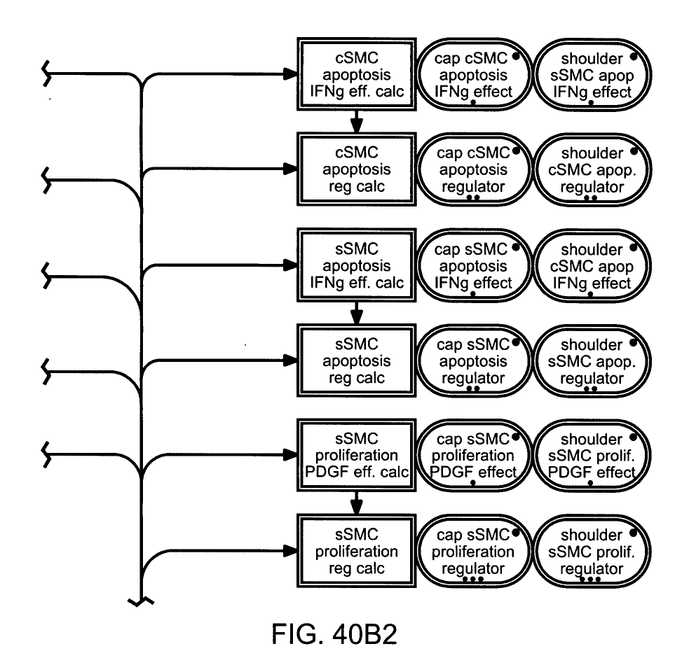

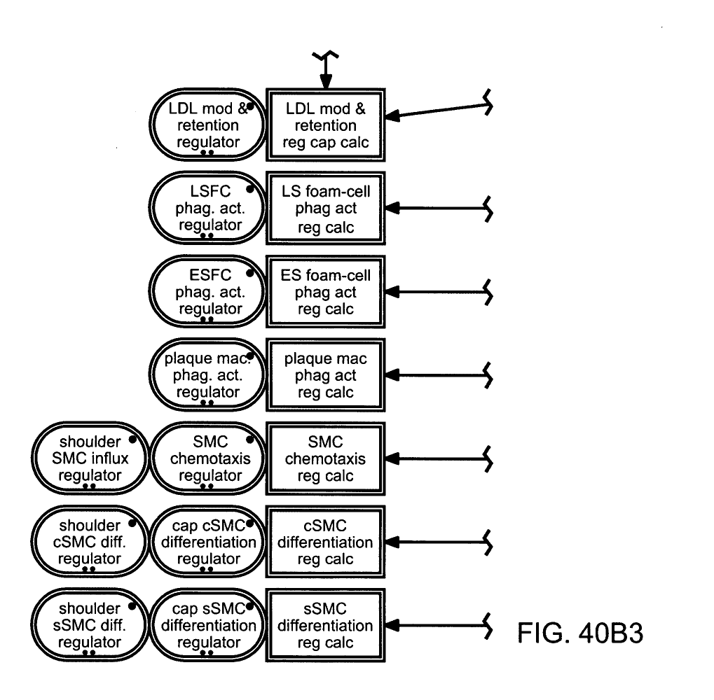

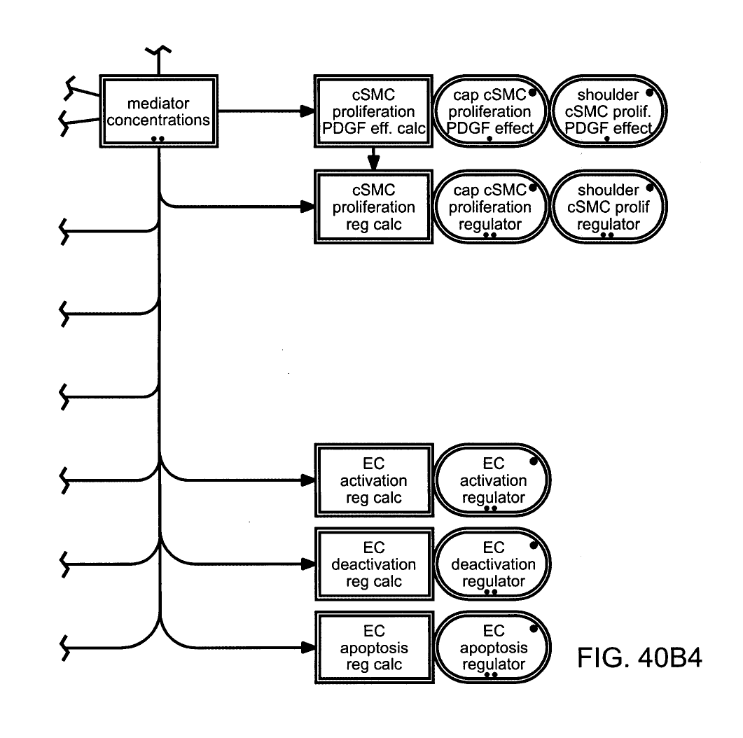

FIG. 35A provides exemplary calculations of average inflammatory mediator concentrations. FIG. 35B provides exemplary calculations of the effects of the smooth muscle cell population and extracellular matrix on inflammation. FIG. 36 provides an exemplary illustration of shoulder inflammatory mediator pre-processing, in which equilibrium values for the per-cell production rate of each inflammatory mediator in the plaque shoulder is calculated. FIG. 37 illustrates calculations that can be made to switch from a lumped index of shoulder inflammation to a network of inflammatory mediators. FIGS. 38A and 38B provide exemplary effect diagrams describing inflammatory mediator production in a plaque shoulder. FIGS. 39A and 39B illustrate regulator structure in a plaque shoulder. FIG. 40A provides an exemplary illustration of inflammatory mediator pre-processing, in which a lumped value for inflammatory mediators is calculated. FIG. 40B provides an Effect Diagram illustrating a correlation between a lumped mediator concentration and individual regulator concentrations in an atherosclerotic plaque.

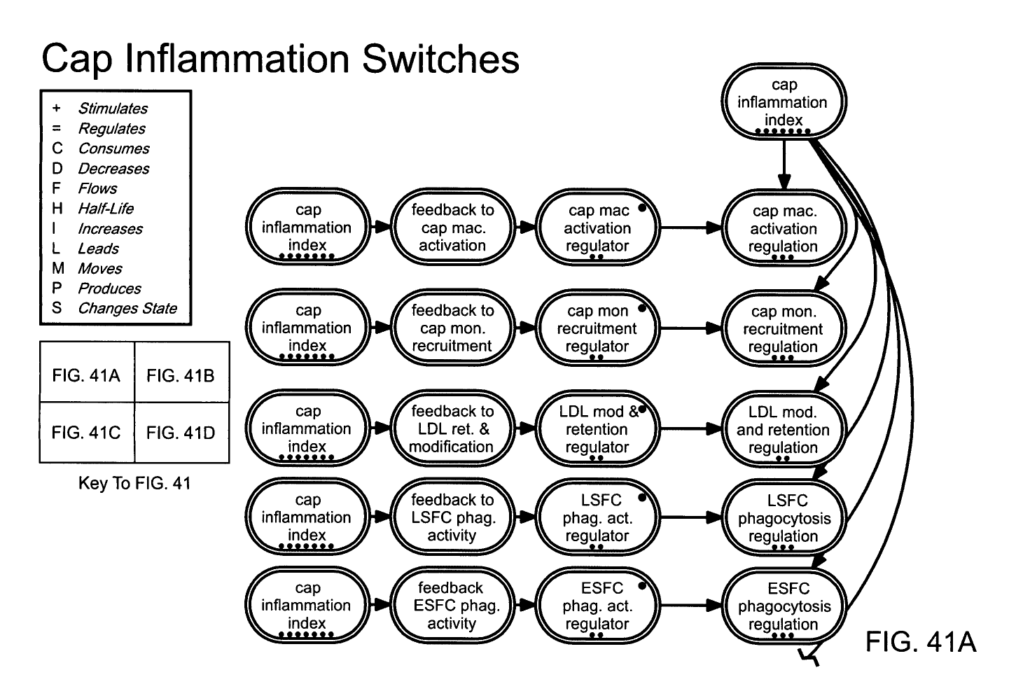

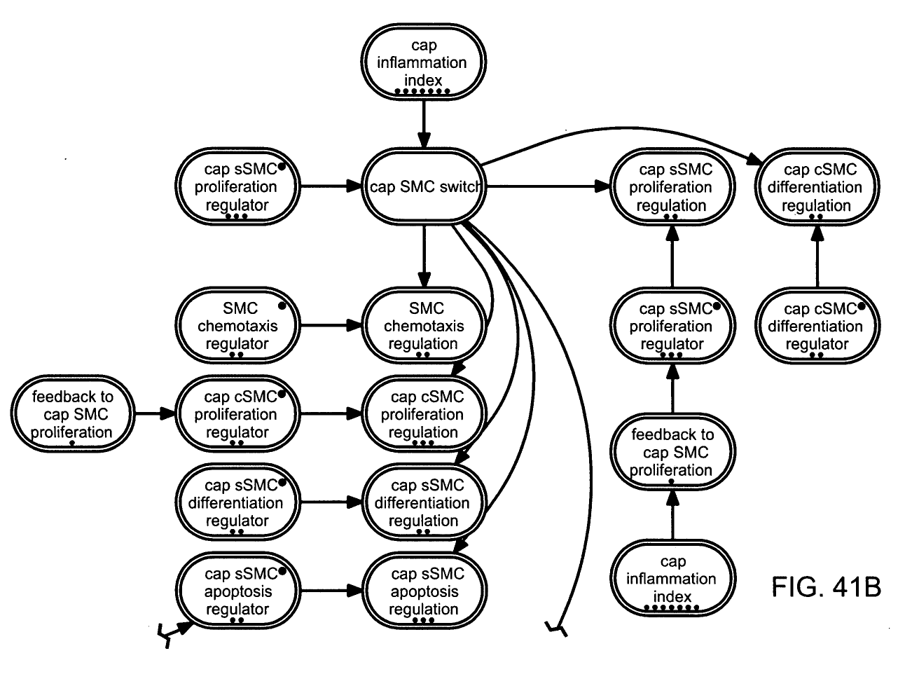

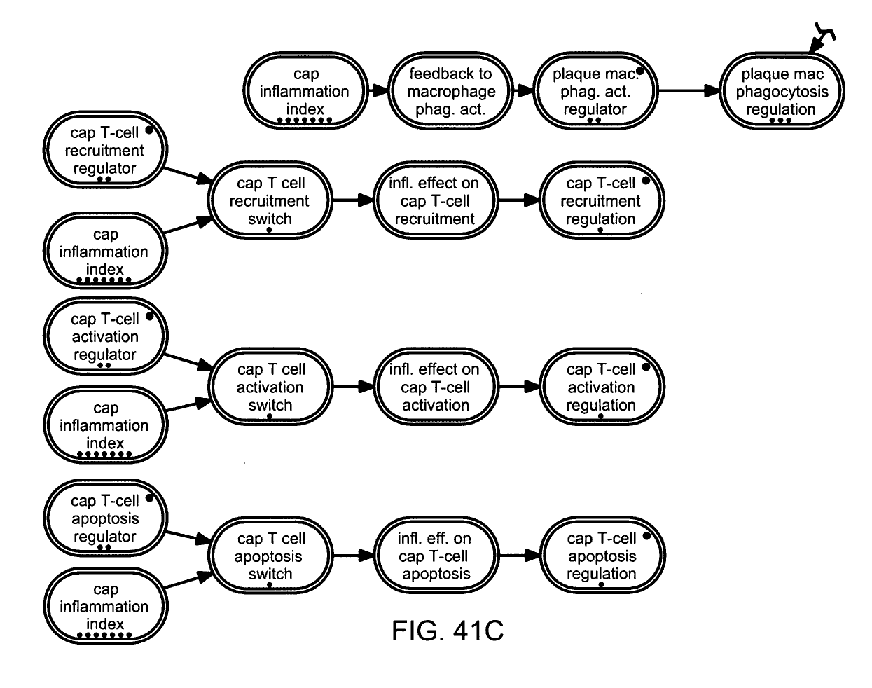

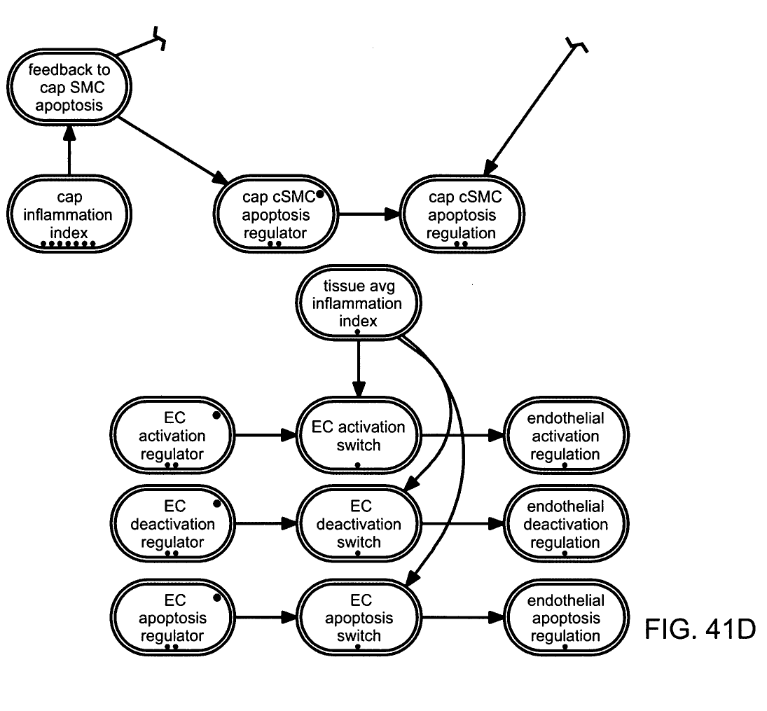

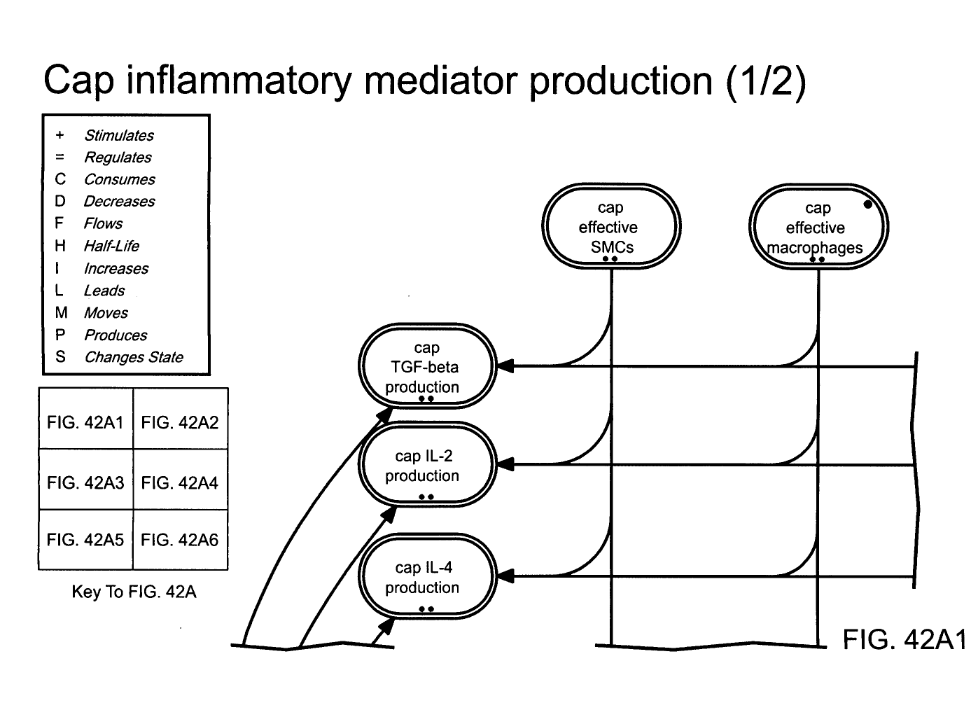

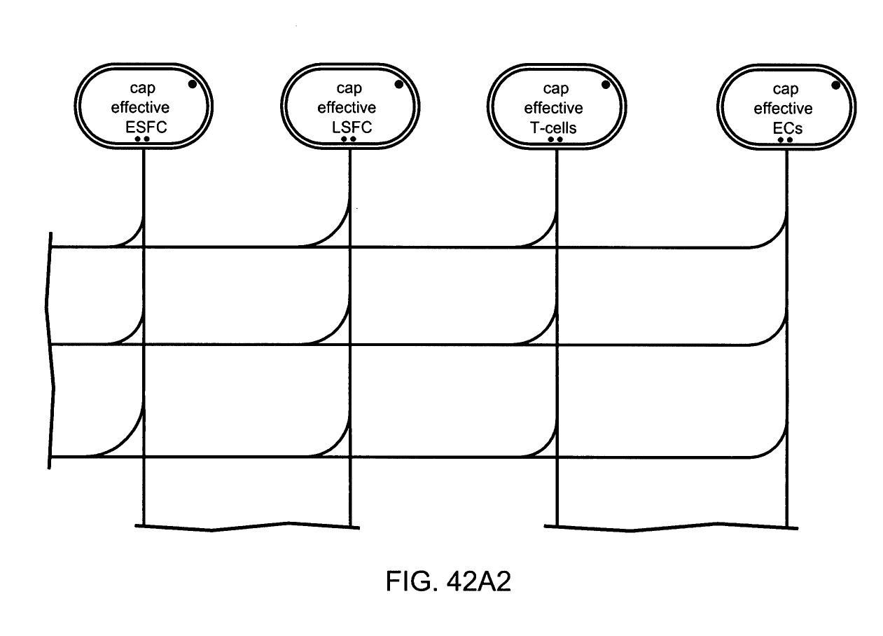

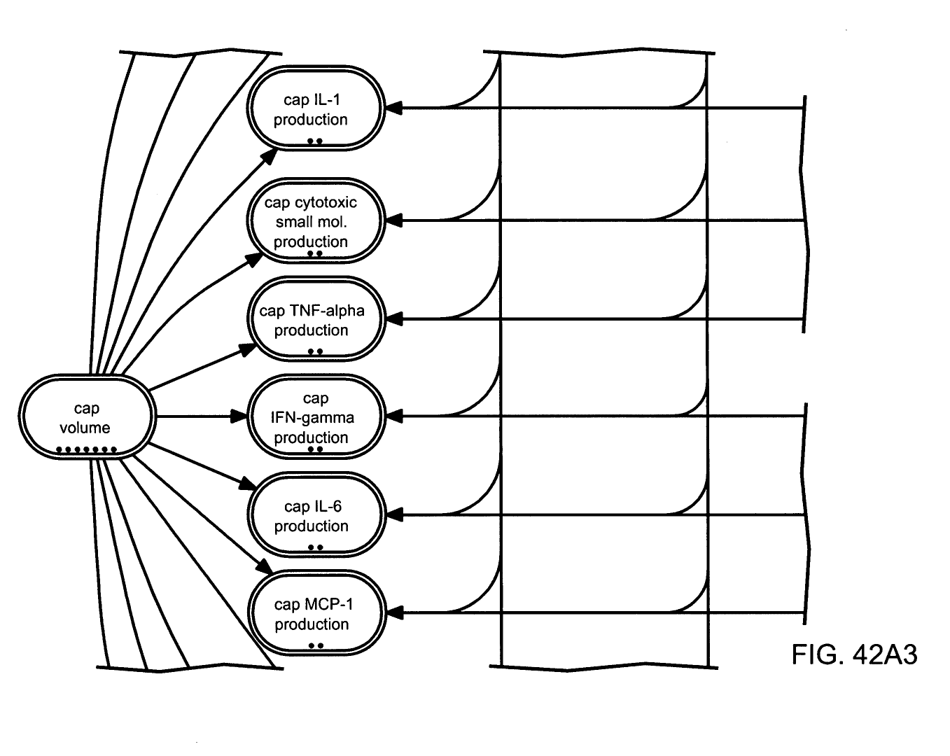

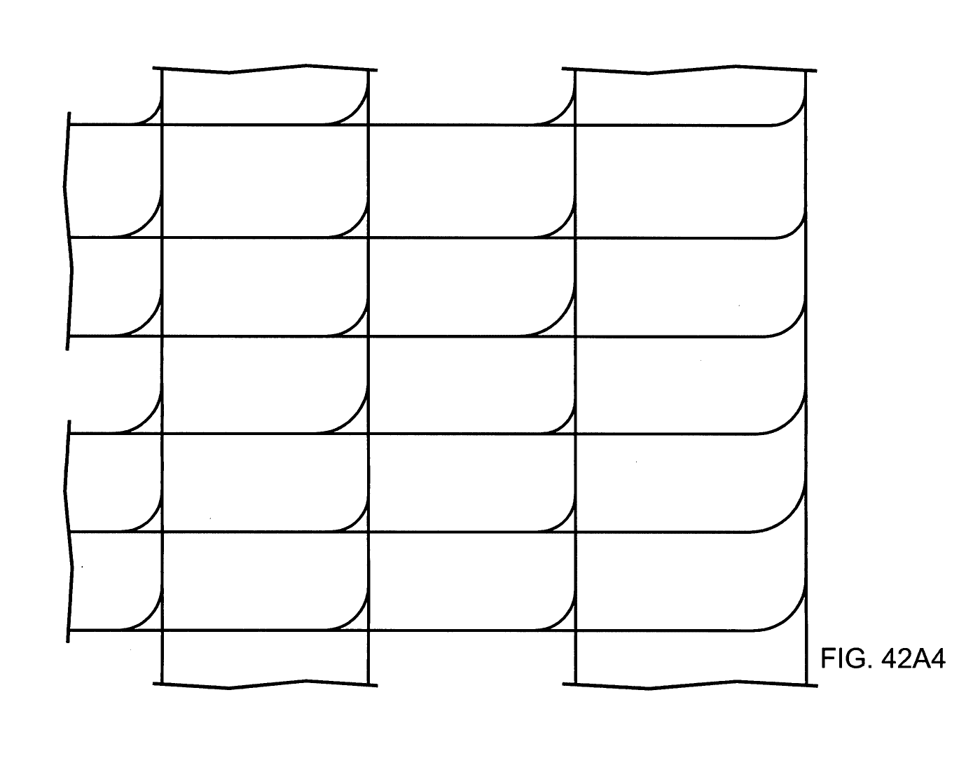

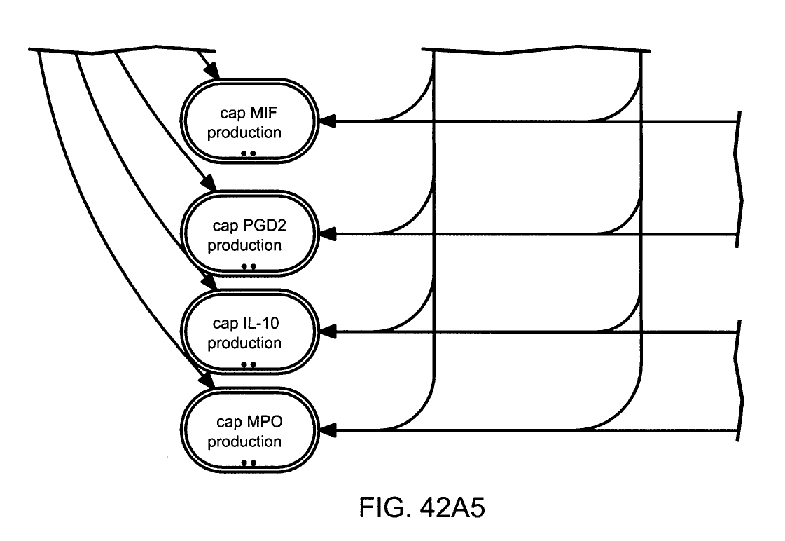

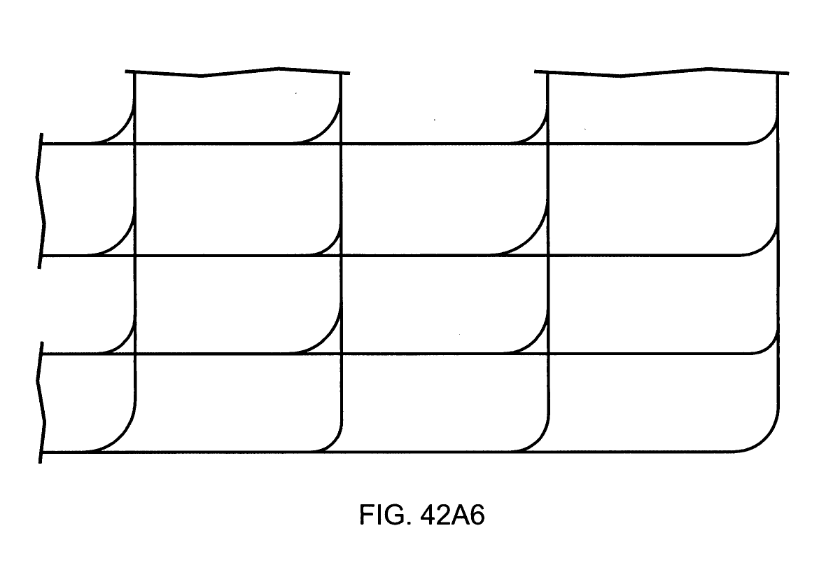

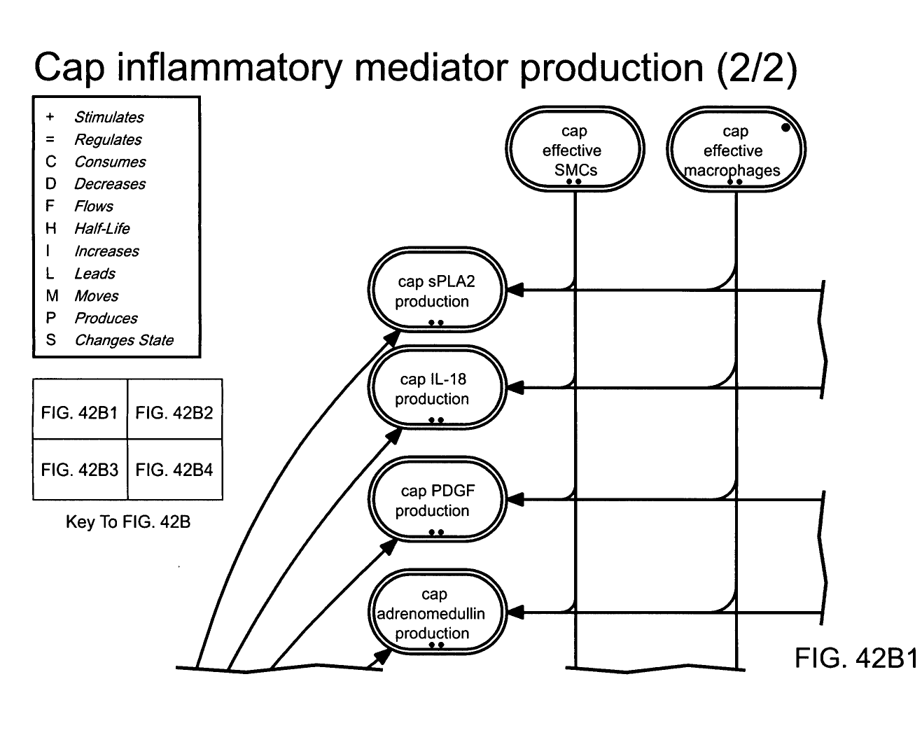

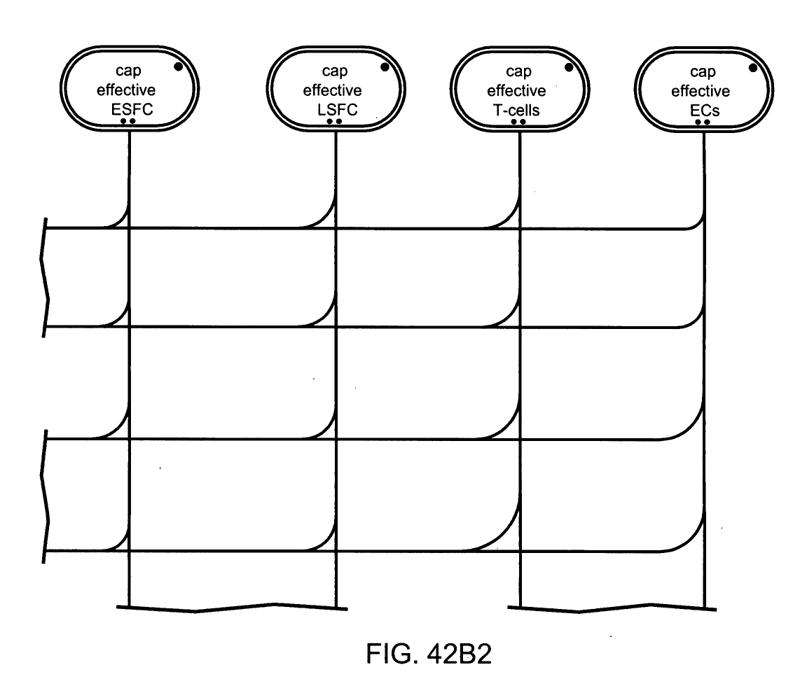

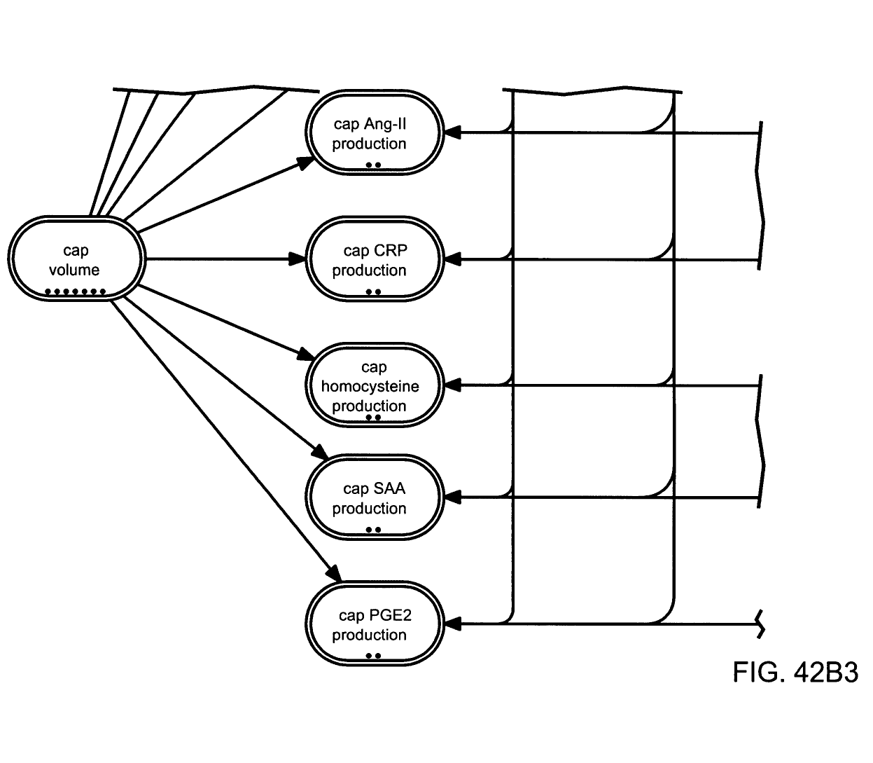

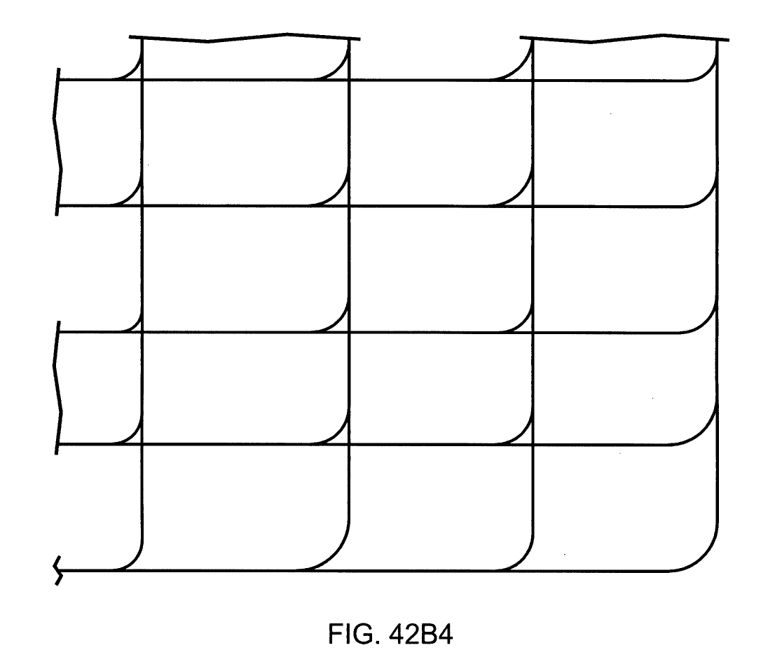

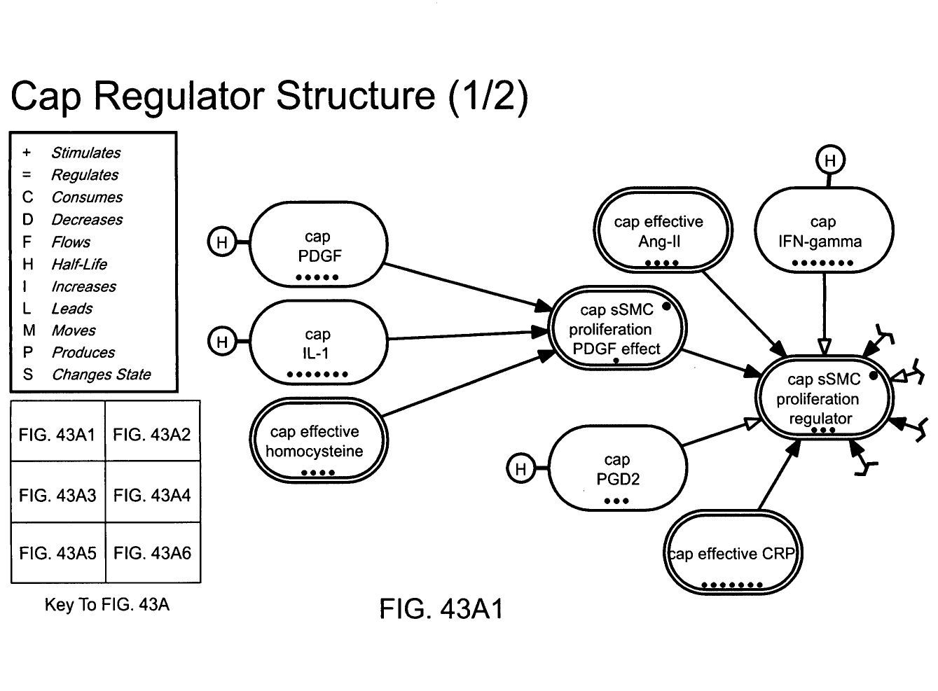

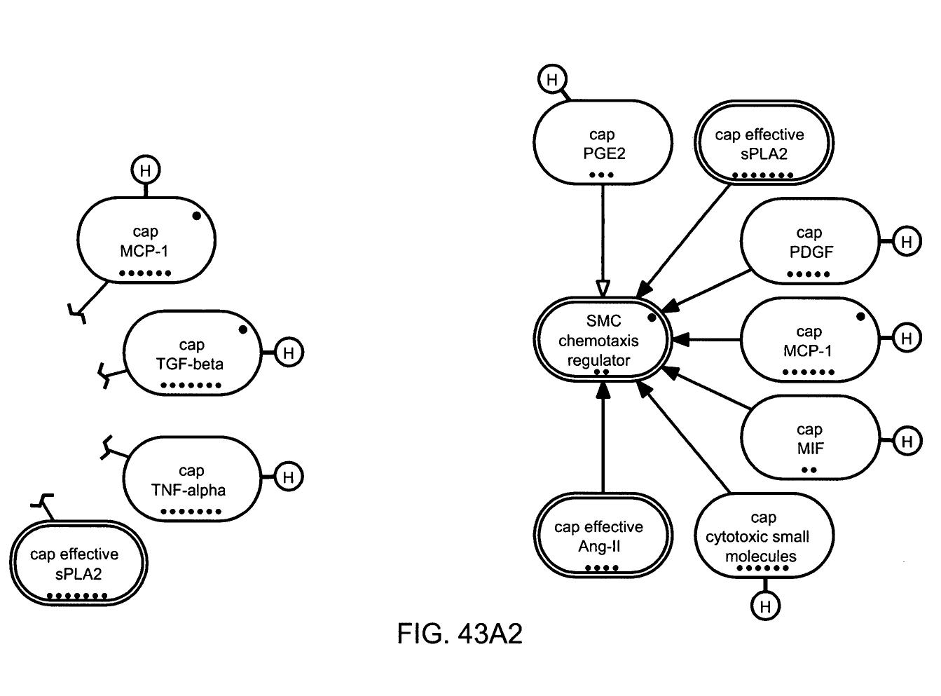

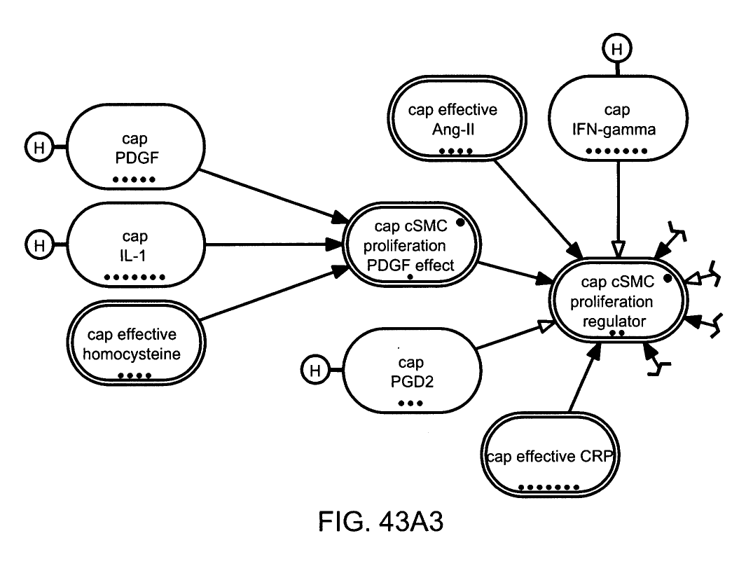

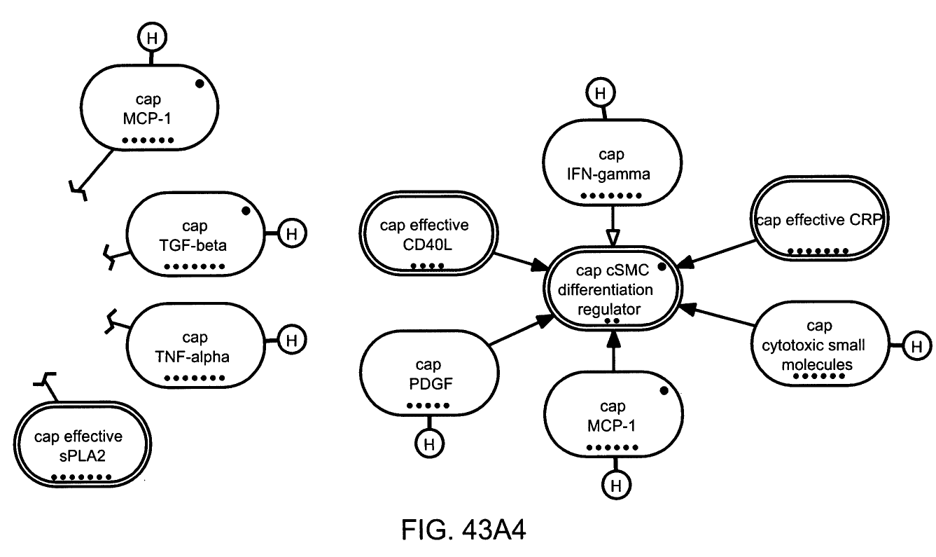

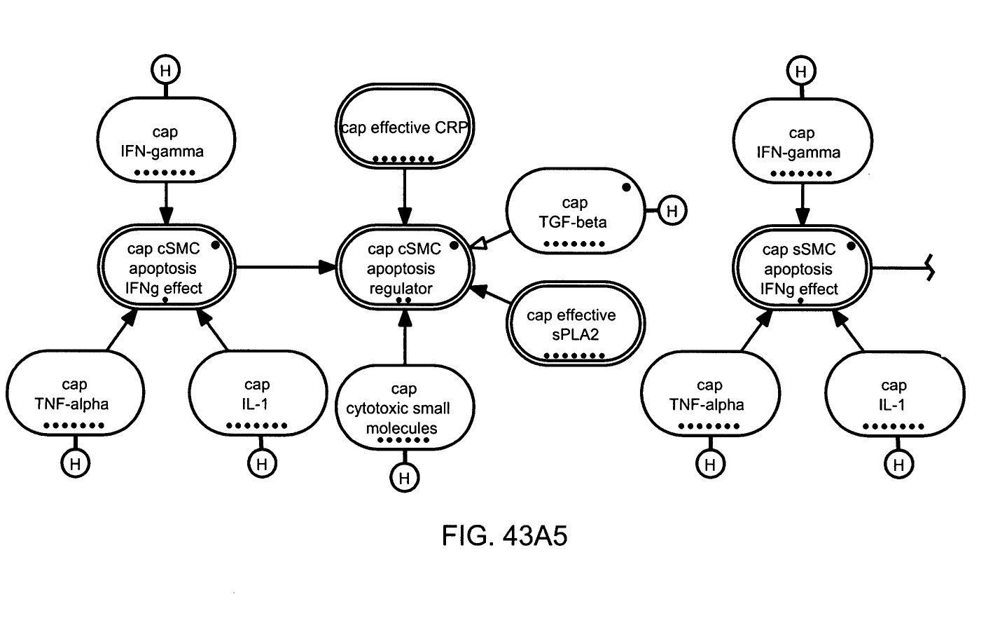

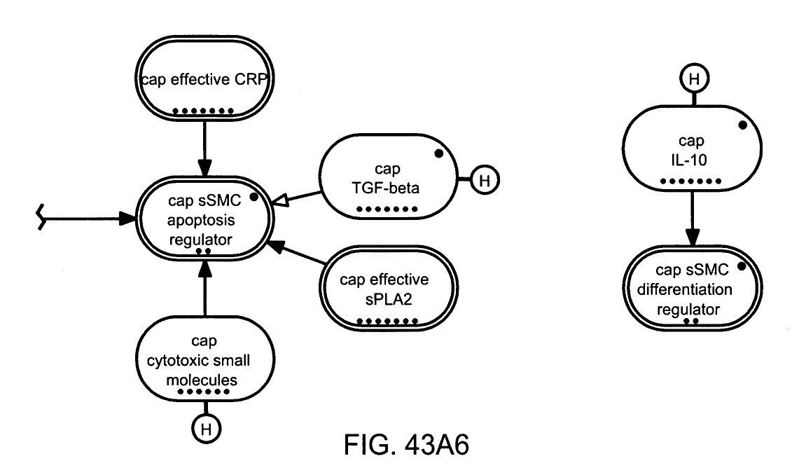

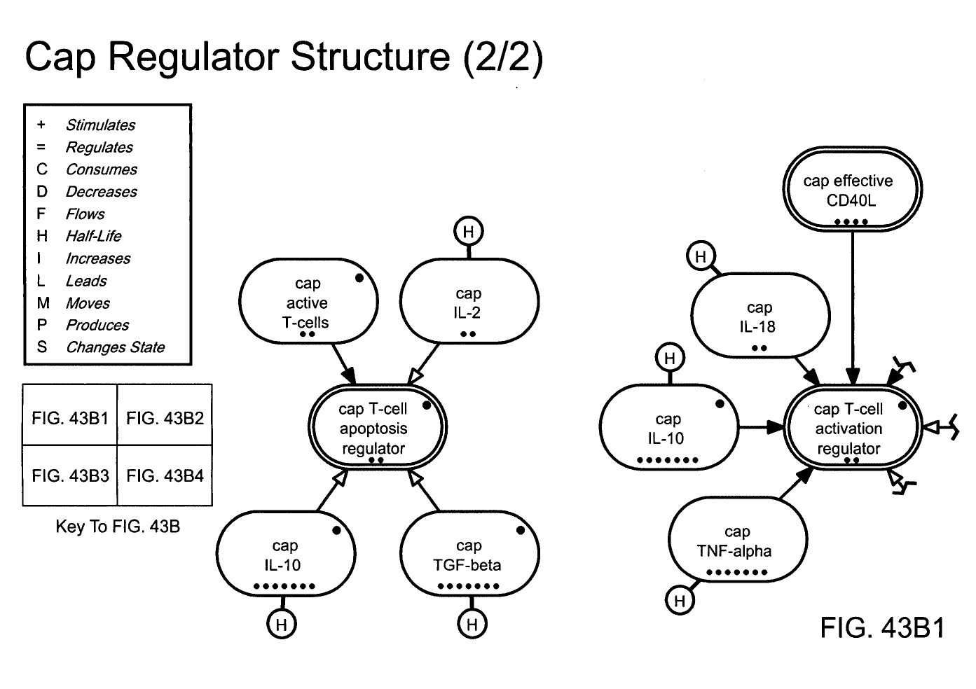

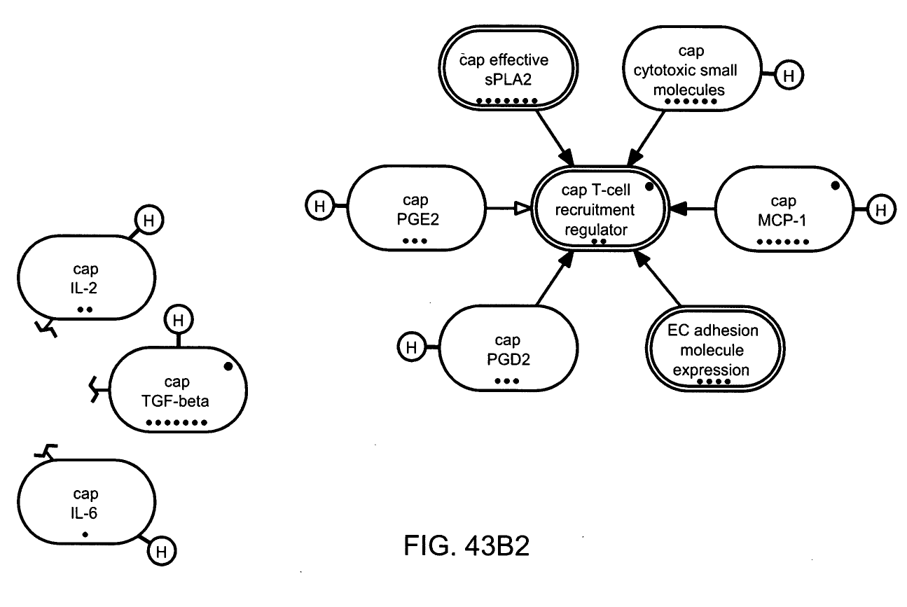

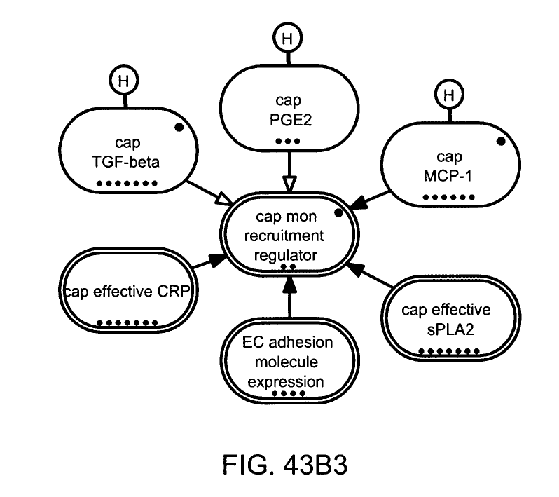

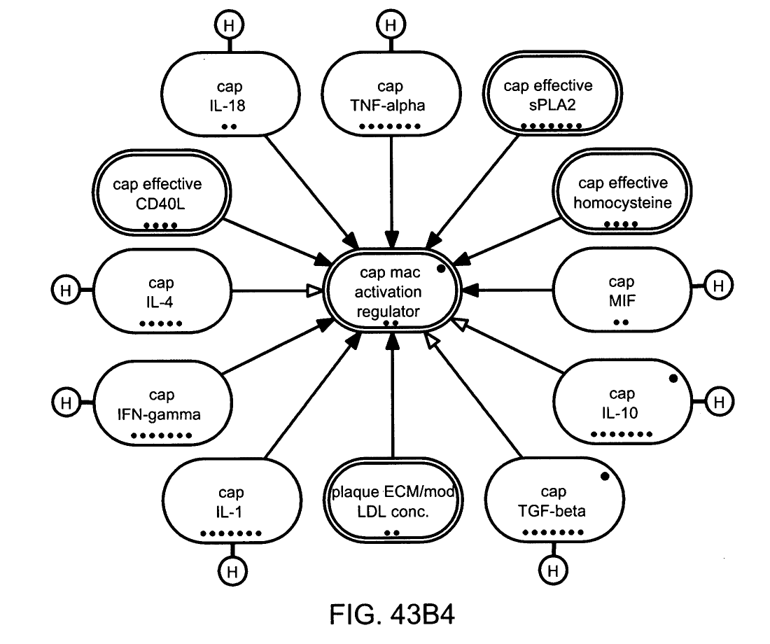

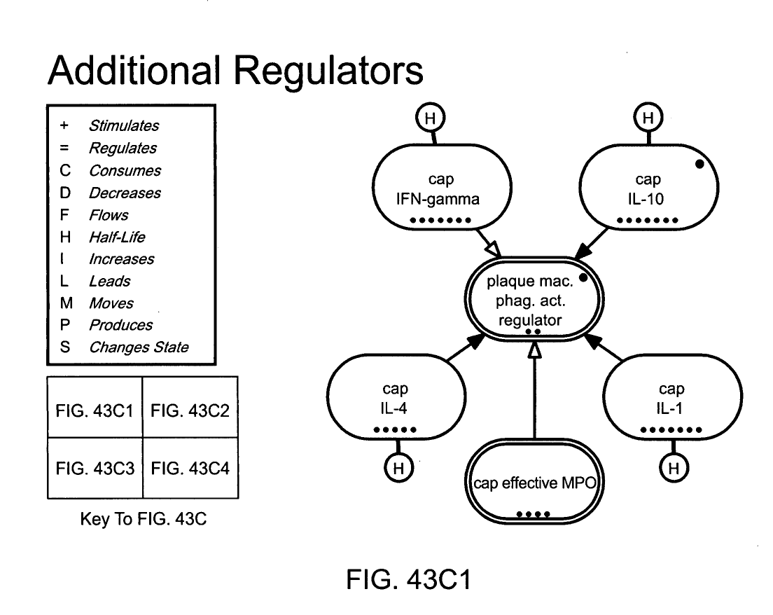

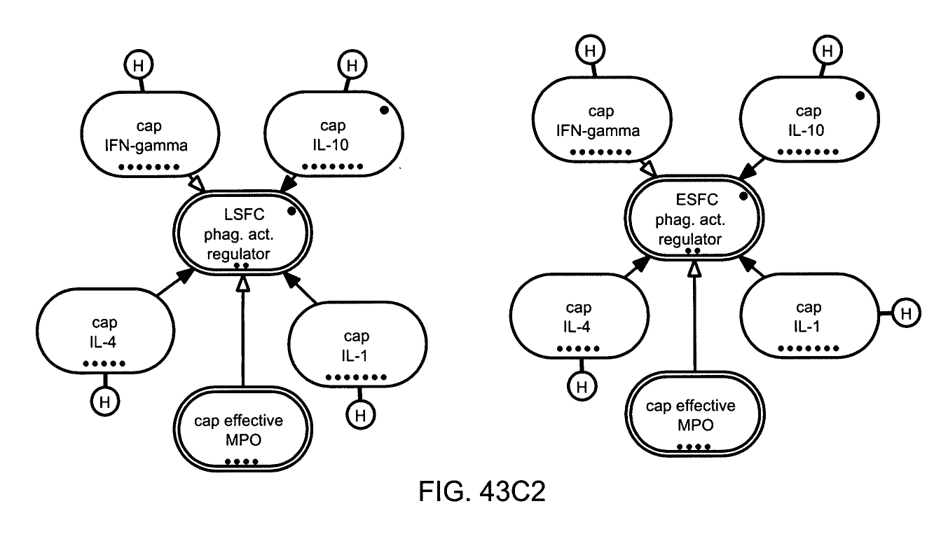

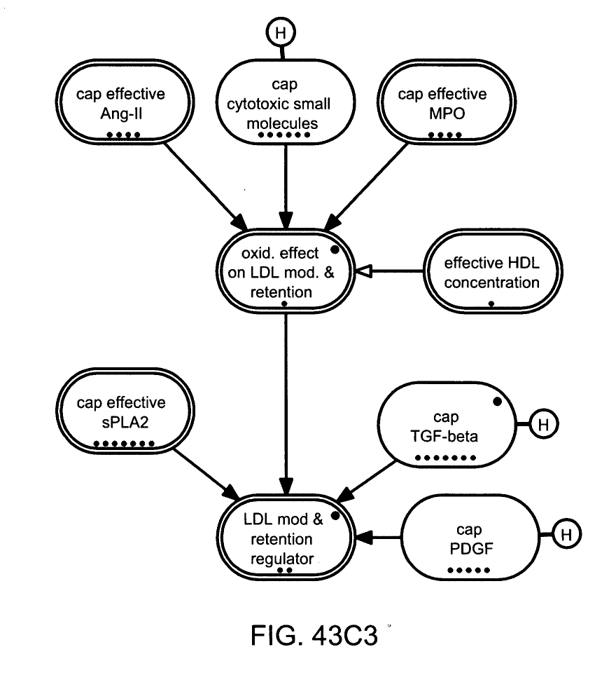

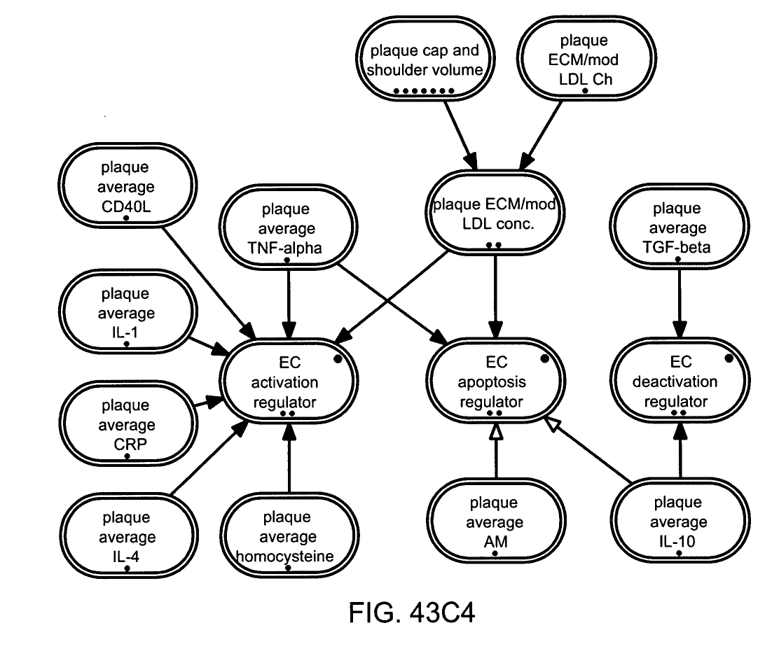

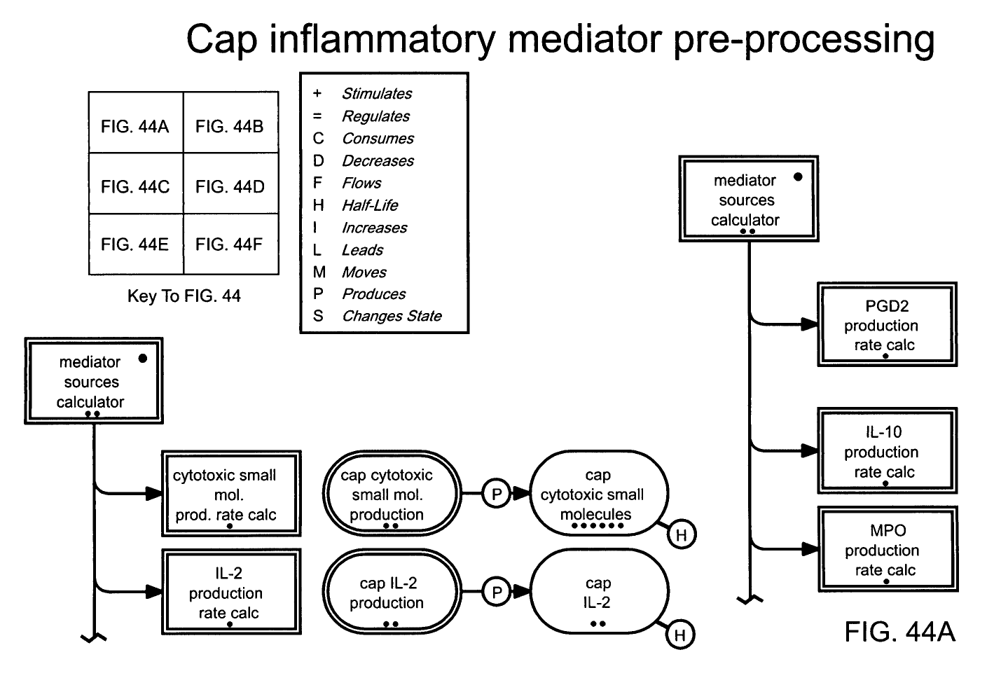

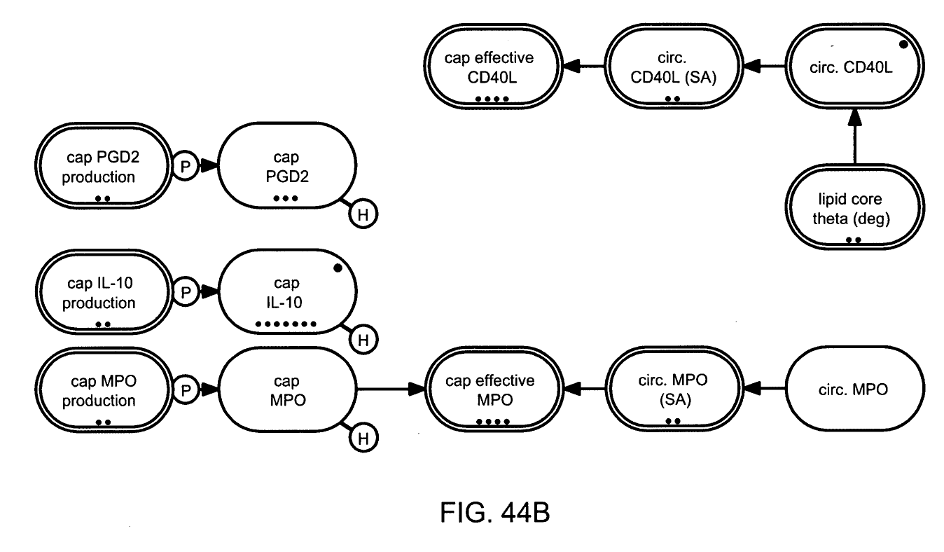

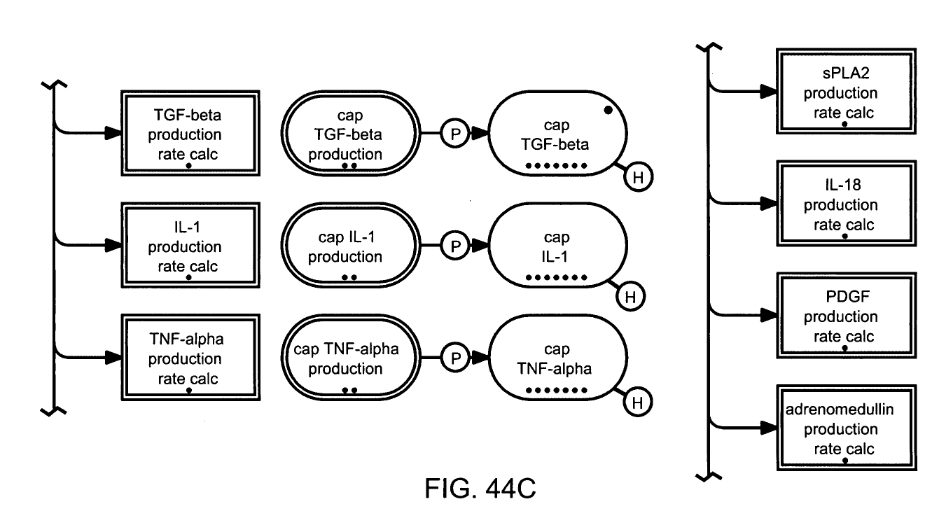

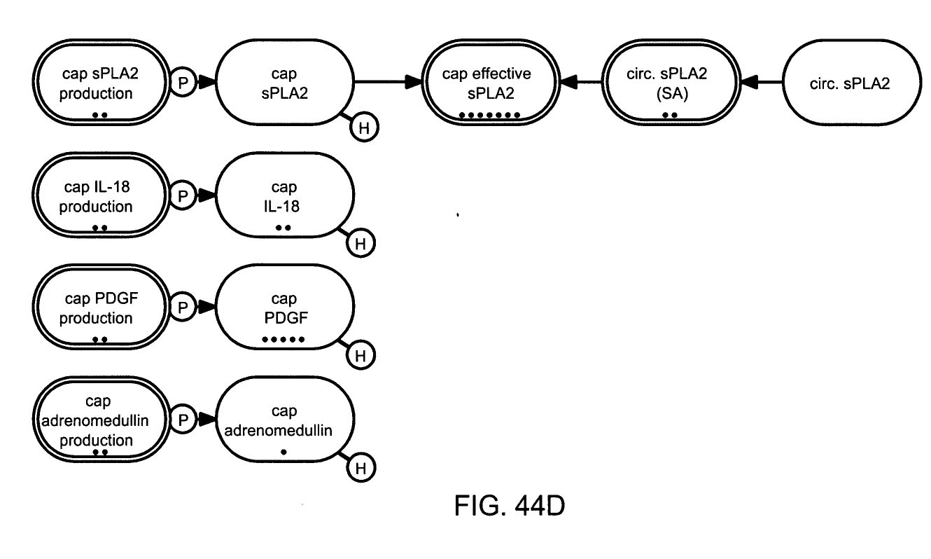

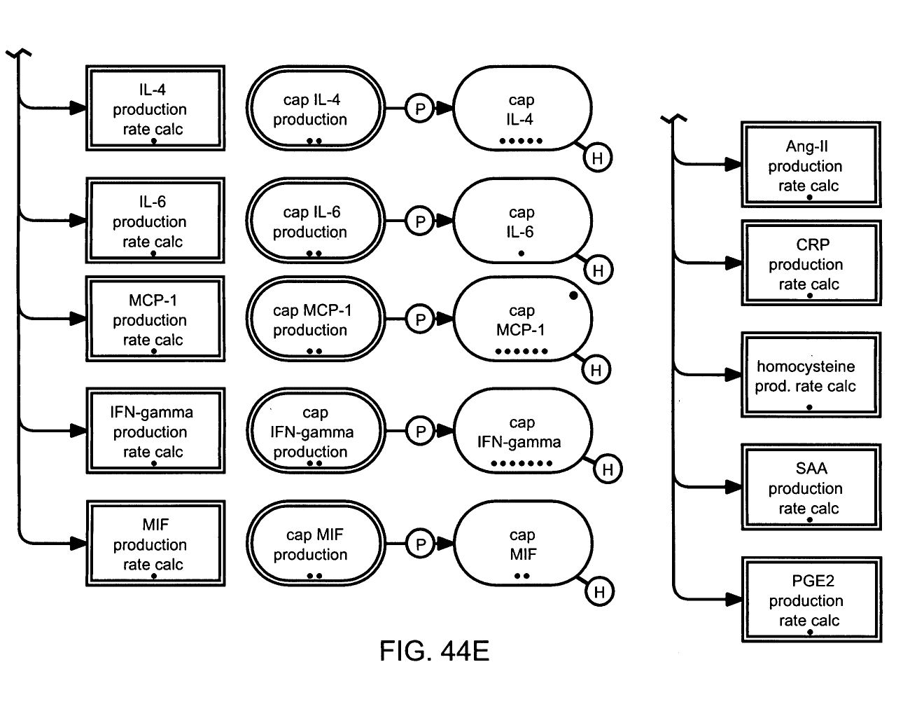

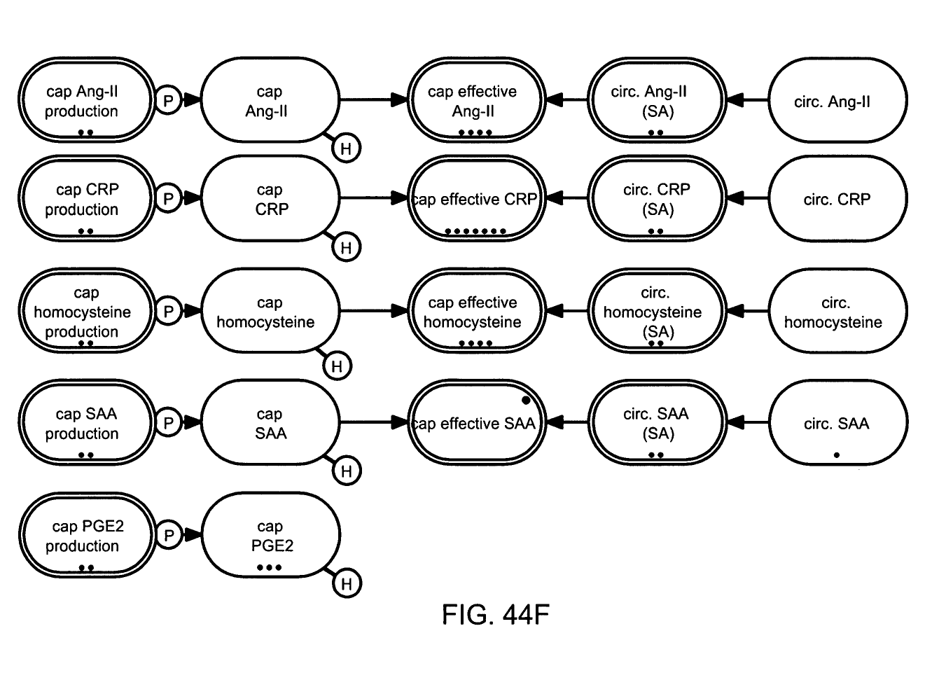

FIG. 41 illustrates calculations that can be made to switch from a lumped index of inflammation to a network of inflammatory mediators in a plaque cap. FIGS. 42A and 42B provide exemplary effect diagrams describing inflammatory mediator production in the cap of a plaque. FIGS. 43A and 43B illustrate regulator structure in a plaque cap. FIG. 43C illustrates additional regulators that may be included in the model of atherosclerosis. FIG. 44 provides an exemplary illustration of cap inflammatory mediator pre-processing.

3. Plaque Stability Module

Development of the plaque stability module extends the capabilities of the model of atherosclerosis to endpoints of plaque stability. The atherosclerotic plaque can continue to grow in size until either (i) the plaque occludes blood flow through the artery or (ii) the plaque ruptures, leading to an inflammatory response and blood clots. This module determines how changes in plaque geometry during atherosclerosis progression or regression affect the distribution of stresses within the plaque. Using finite element modeling (FEM), the plaque geometry, material properties, and blood pressure are used as inputs to calculate the magnitude and location of peak biomechanical stress within the plaque. Based on data quantifying the maximum pre-rupture biomechanical stress tolerable by the plaque, the module computes a plaque instability index (PII) as a function of time that identifies the relative stability of the plaque.

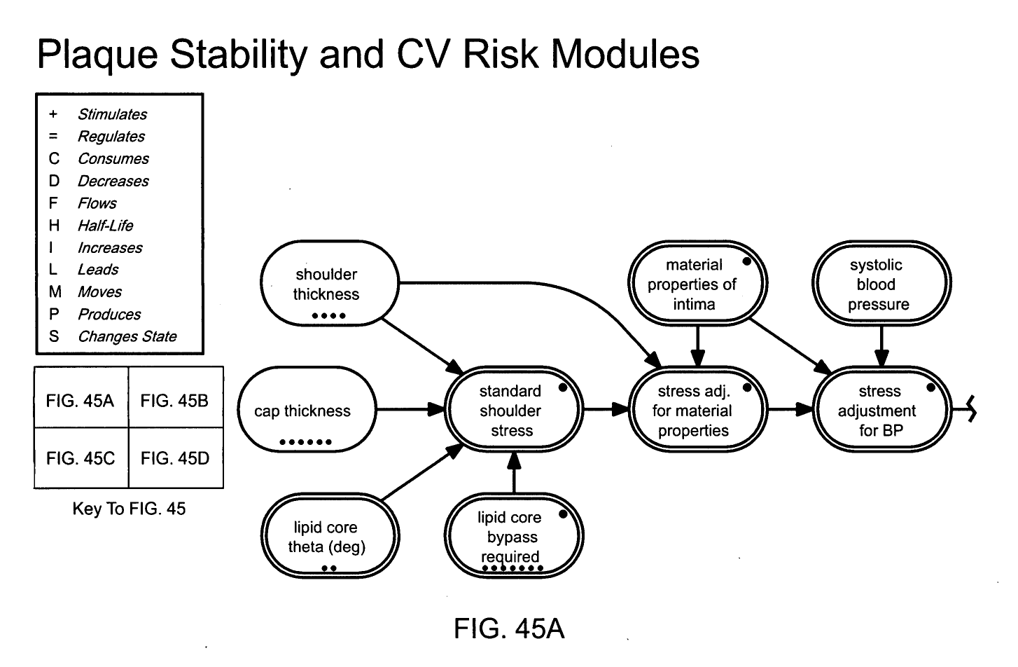

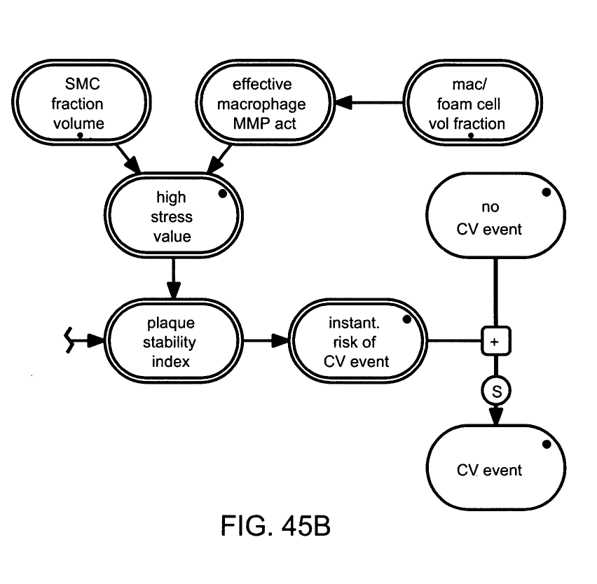

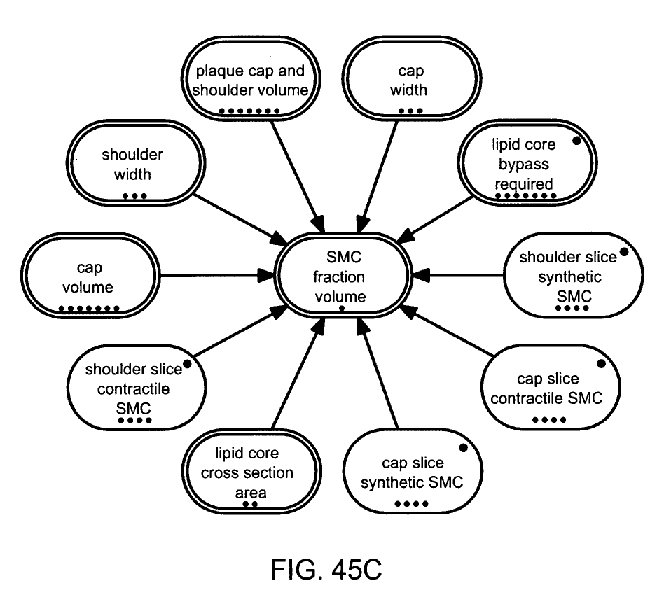

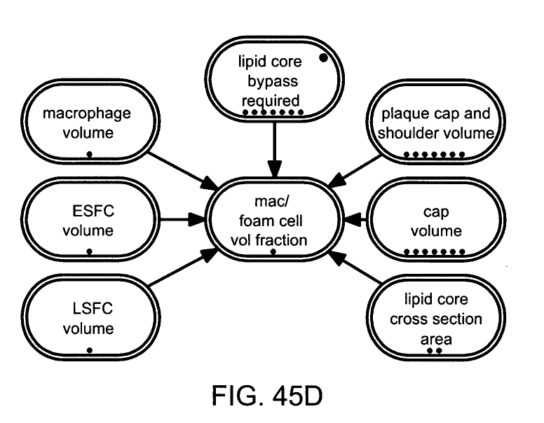

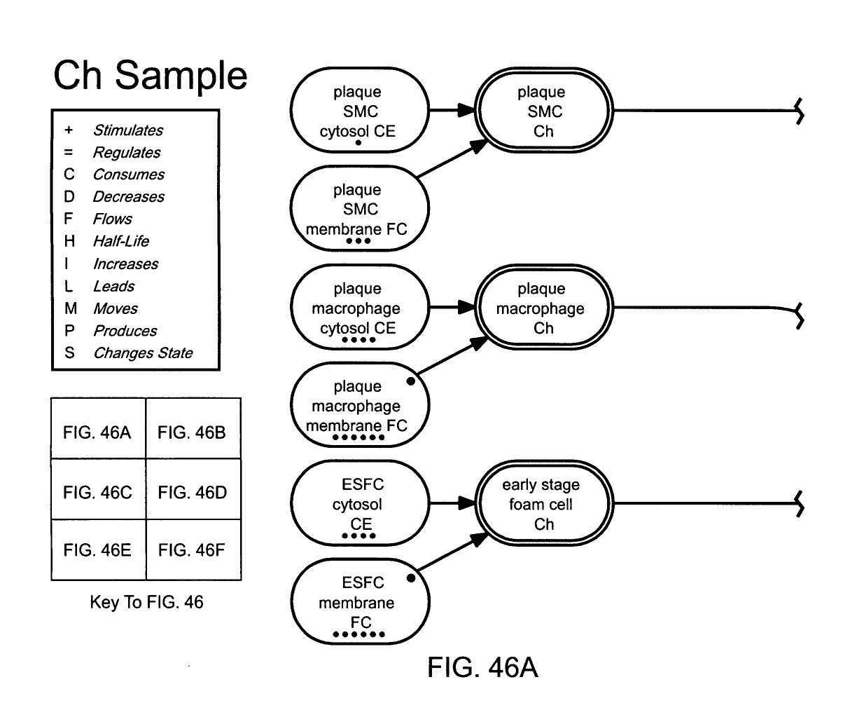

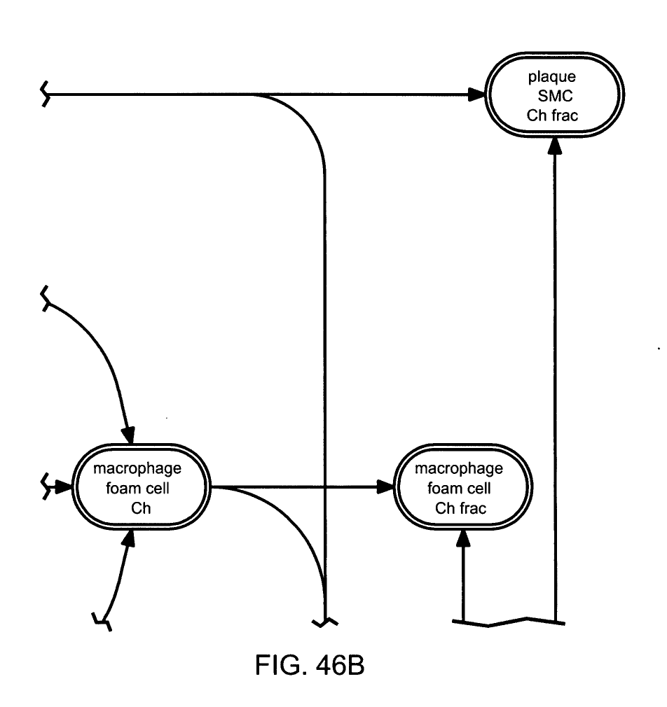

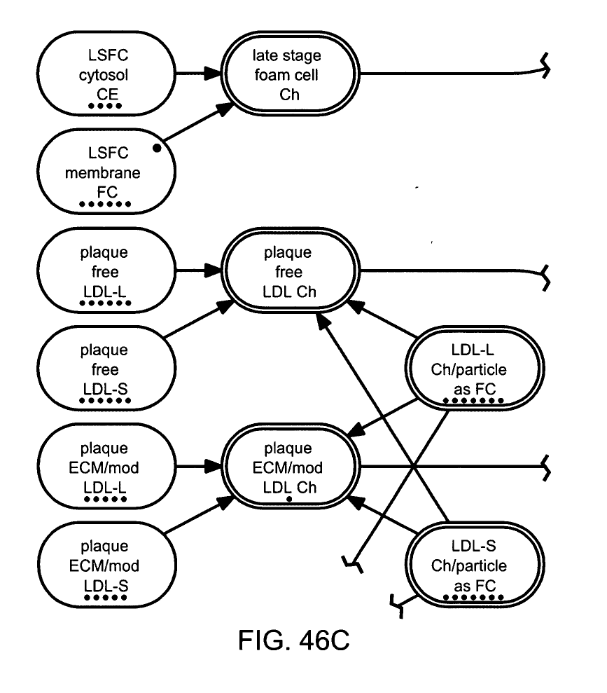

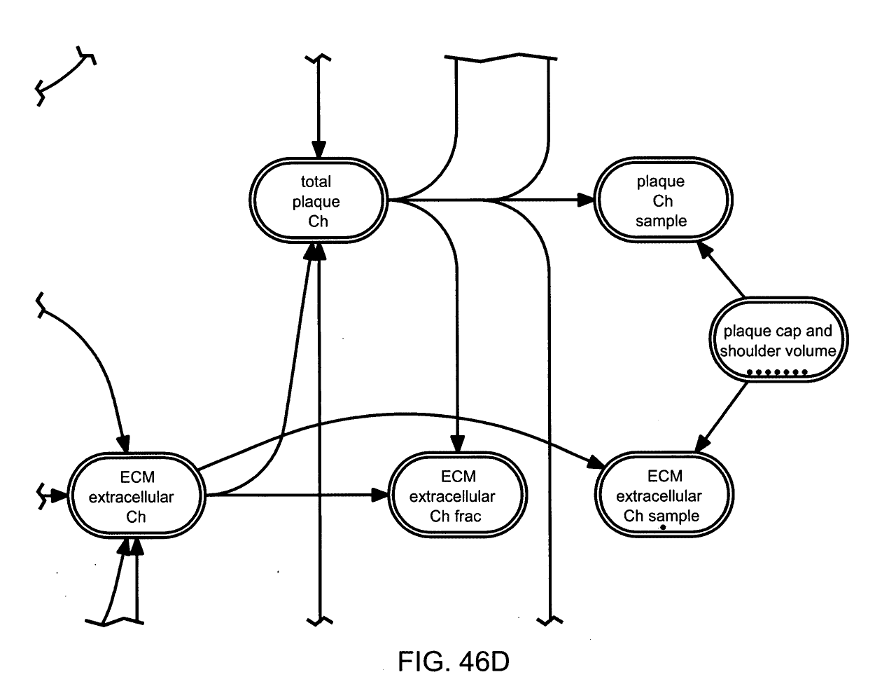

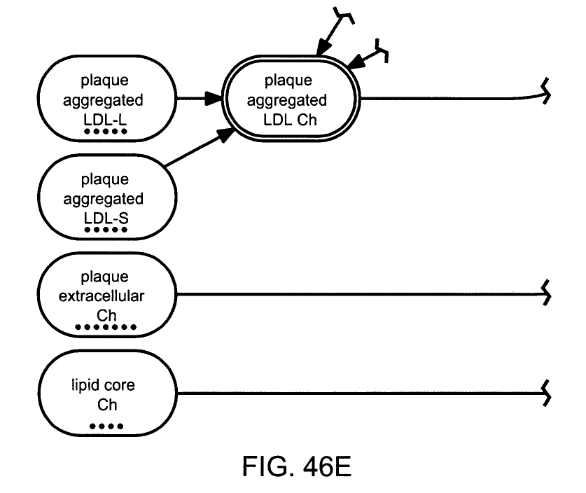

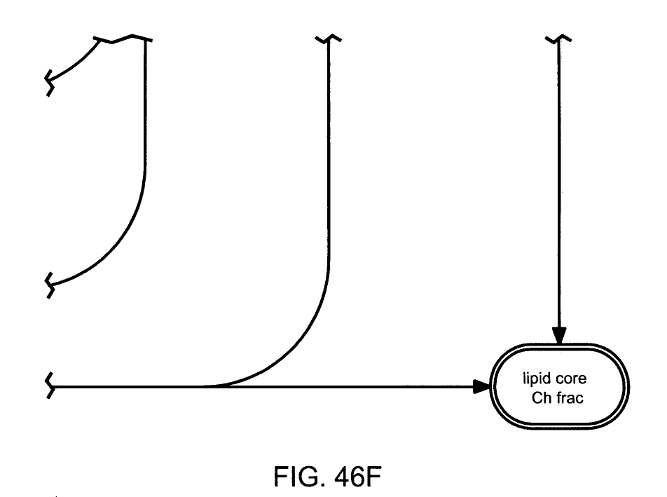

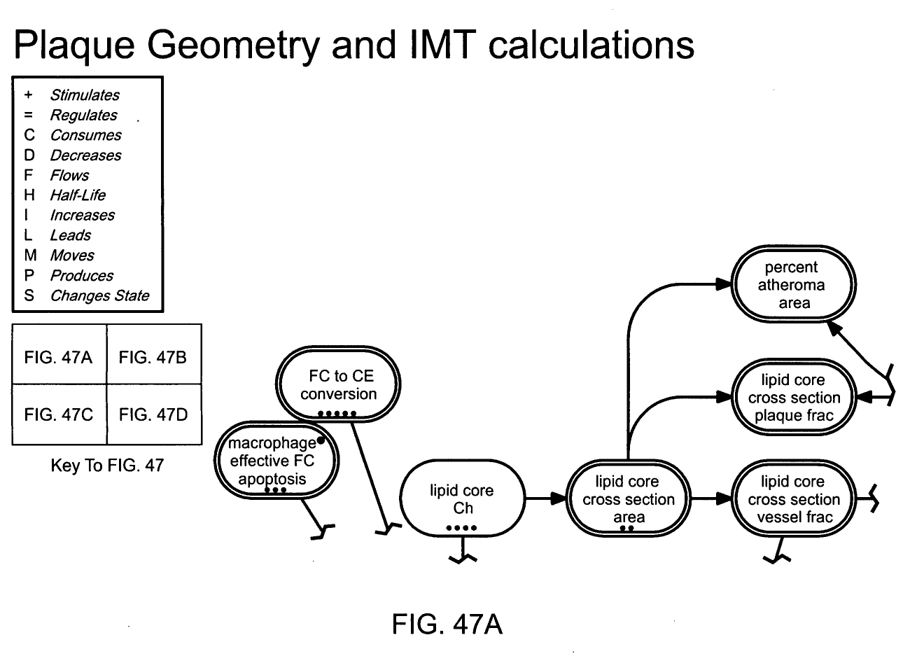

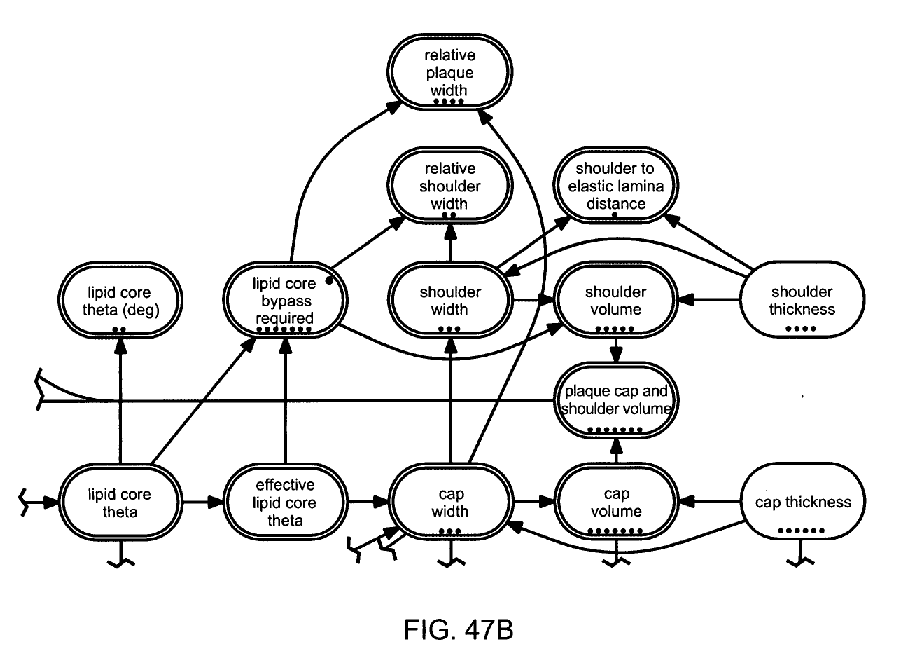

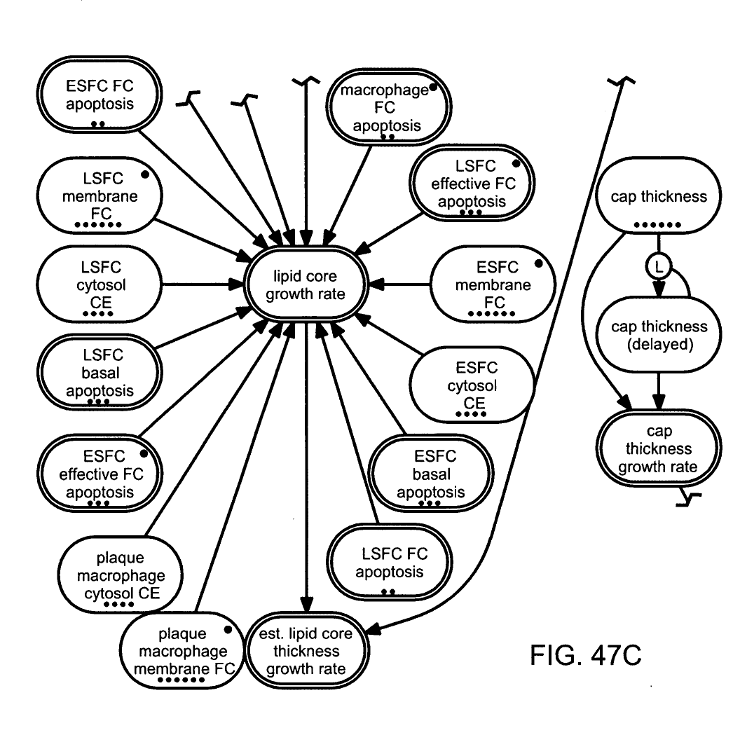

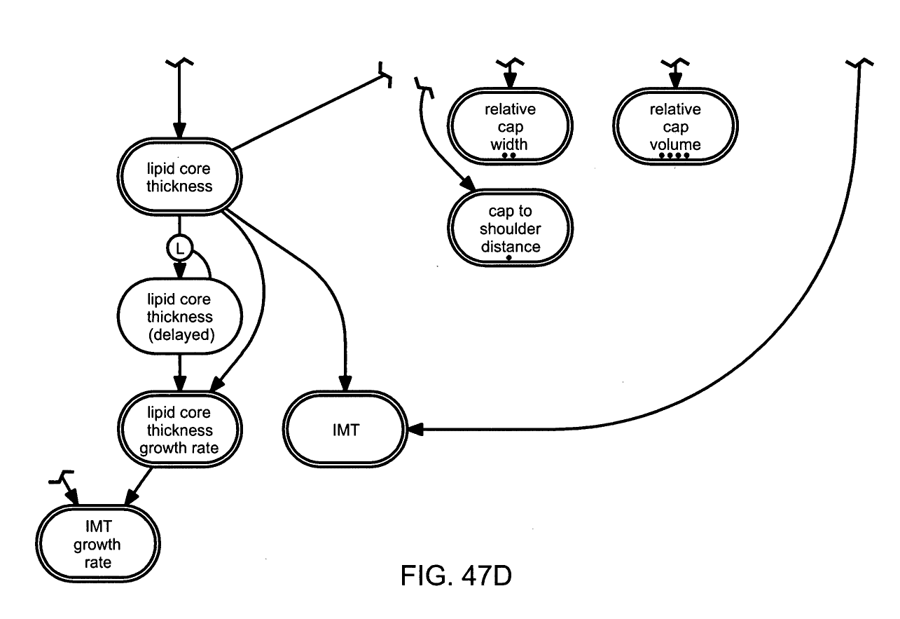

An overview of the plaque stability module is provided in FIG. 45. Outputs of the atherogenesis module (e.g. shoulder thickness, cap thickness, lipid core theta, and plaque volume) are used as inputs to determine the stress at the shoulder region of the plaque. FIG. 46 provides an overview of various characteristics and pathways that can influence plaque volume. FIG. 47 provides an exemplary Effect Diagram illustrating calculations that describe plaque geometry and IMT. Variations in plaque material properties and static systolic pressure load on the vessel are also incorporated into the calculation. Finally, a plaque instability index (PII) can be computed to determine the relative stability of the plaque.

The assumptions for the plaque stability module can split into two groups: assumptions used for the finite element modeling analysis (FEM) to determine the magnitude and location of peak biomechanical stress in the plaque, and the assumptions used to determine the PII given the peak biomechanical stress. PII is defined as maximum shoulder stress divided by the stress threshold for rupture.

The following data-based assumptions were employed in FEM of plaque stress. A two-dimensional (2-D) slice through the thickest area of a three-dimensional (3-D) atherosclerotic plaque can be modeled as an approximation of the location most likely to rupture. The lipid core of the plaque and vessel media possess different material properties than the cap and shoulder regions. Due to knowledge gaps surrounding the effects of varying cellularity and matrix on material properties, the plaque intima was assumed to possess homogeneous material properties estimated from the literature (Chau, et al. Ann Biomed Eng 32:1494-1503 (2004)). The maximum systolic blood pressure was implemented as a static pressure load on the lumen of the artery.

The following data-based assumptions were employed in determining the PII from the plaque stress. Plaques typically rupture in the shoulder, when the local peak biomechanical stress (maximum shoulder stress) exceeds a specific threshold (300 kPa). The threshold for plaque rupture is independent of the material properties. Maximum shoulder stress can be pre-calculated for specific parameters that span a range of values output from the atherogenesis submodel (see Table 1).

Peak biomechanical stress in a representative plaque can be calculated using finite element methods (FEM). Finite element meshes were generated for plaques of varying cap thickness, shoulder thickness, lipid core angle (θ), and material properties. Different material properties are used for the plaque intima, lipid core, and vessel media based upon data from the literature. FEM analysis determines the stress distribution within each plaque, including the location and magnitude of peak stress.

Table 1 shows the ranges of input parameter variation used in the plaque stability submodel. The range of values for each parameter was chosen to span the ranges expected to be observed in virtual patients representative of the general population. Soft and stiff material properties were based upon increases or decreases from the standard plaque material properties determined from the literature.

TABLE 1
Shoulder Stress Input Parameters

| Input parameter | Range of variation |
|---|---|
| Cap thickness | 150-500 μm |
| Shoulder thickness | 70-500 μm |
| Plaque angle (theta) | 90-180 degrees |
| Material properties | Standard, soft (healthy), stiff (acellular/calcified) |
| Blood pressure | 80-200 mm Hg |

A multi-dimensional polynomial can be fit to determine maximum shoulder stress as a function of the input parameters in Table 1 to interpolate the value of the maximum shoulder stress for plaque geometries between those for which a value is explicitly calculated. After maximum shoulder stress is determined, the resulting PII can be computed by normalizing by the threshold for plaque rupture. Preferably, a PII of ‘1’ indicates a plaque on the threshold of rupture.

4. Cardiovascular Risk Module

The cardiovascular risk module, illustrated in FIG. 45, extends the capabilities of the computer model of atherosclerosis to encompass the clinical endpoint of patient morbidity and mortality. The basic premise of this module is that a causal relationship exists between the structural stability of a plaque and the risk of occurrence of a cardiovascular event. Under this premise, the cardiovascular risk module will predict the probability of the occurrence of a cardiovascular event, both instantaneously and over time, given a PII from the plaque stability module. While direct data relating PII to cardiovascular risk are lacking, the relationship can be derived using clinical trial cardiovascular risk data and the PII of virtual patients designed to reflect the clinical trial population.

Statistical analysis methods can be applied to clinical trial data and used to determine the relationship between PII and the instantaneous probability of a cardiovascular event. Once this relationship has been derived and encoded in the platform, the cumulative probability of a cardiovascular event occurring within a time interval can be calculated for a given virtual patient by integrating the instantaneous probability as the virtual patient's plaque evolves over that same interval.

In one implementation of the model, a relationship is established between the PII of any virtual patient and the instantaneous probability of a cardiovascular event in order to predict cardiovascular risk. A virtual population that mirrors the risk factor and clinical endpoint statistics of a clinical trial population can be used to derive this relationship. The clinical trial population provides statistical data on the occurrence of cardiovascular events in response to the trial protocol, and simulation of that same protocol on the virtual population provides the PII. Typically, the virtual population will not be developed patient-by-patient for the actual population. Rather, a cohort of virtual patients (each embodying an alternate hypothesis of disease pathophysiology) will be derived for each phenotype cluster, characterized by specific risk factors and clinical measures, within the actual population. The actual patients in each phenotype cluster will lie within a focused range of risk factors that will be used in designing the pathophysiology of their virtual patient counterparts.

Data on the cardiovascular risk of the clinical trial phenotype clusters preferably is represented in a form that can be related to the PII of the corresponding virtual patient cohorts at any point in time. Clinical trial reports typically include the time to occurrence of a cardiovascular event for each patient. This information can be related to a hazard function (λ), defined as the instantaneous probability that a cardiovascular event will occur in the next specified time interval, given that one has not already occurred. Specifically, clinical trial data can be represented comprehensively by a proportional hazards regression, wherein the hazard function is represented as both a function of time and of key risk factors and/or clinical measures (e.g., lipid levels, blood pressure) with the most significant correlations to cardiovascular risk. The methodology for the application of this process to survival data is well-established in the clinical literature (Assmann et al., Circulation 105:310-315 (2002) and Stamler et al., JAMA 282:2012-2018 (1999)).

Since the virtual patient cohorts used for the cardiovascular risk module development represent each phenotype cluster, the PII output for each cohort also captures the same risk factors and clinical measures, representing how they affect the plaque characteristics and associated plaque stability over time. The virtual patient cohorts can be simulated in the computer model of the invention under the same conditions (drug therapy, time period, etc.) as the phenotype cluster. Therefore, at any point in time, the PII output for a virtual patient can be mapped to the associated hazard function for the phenotype cluster it was designed to represent.

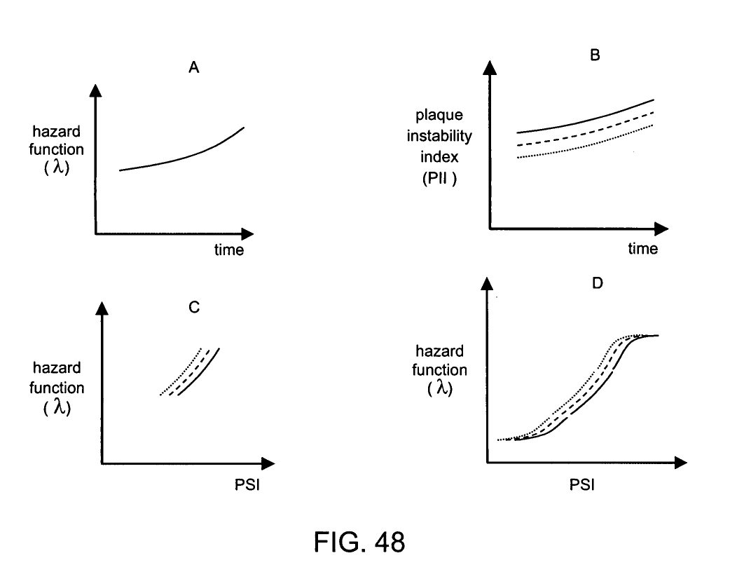

This mapping process can be performed for all phenotype clusters represented in the clinical trial population. Deriving the relationship for PII to a hazard function (illustrated in FIG. 48) typically begins with selecting a clinical data set and divide the trial population into phenotype clusters using covariates available within that data set. A hazard function is determined for each phenotype cluster using proportional hazard regression (FIG. 48A). λ will vary over the time period of the clinical trial.

Subsequently, a clinical trial protocol is simulated on a virtual patient cohort developed for a particular phenotype cluster, yielding a series of PII vs. time curves, one per virtual patient (FIG. 48B). In one implementation a cohort of virtual patients is generated having initial conditions (e.g., starting lipid levels), observed behaviors (e.g., change in lipid levels and inflammatory biomarkers), and underlying hypotheses (e.g., representation of risk factors resulting from diabetes) that are all consistent with the phenotype cluster. Knowledge gaps in various mechanistic pathways, particularly those involved in regulating plaque inflammation, preferably will be reflected in multiple virtual patient hypotheses within the cohort.

The curves generated in ‘48A’ and ‘48B’ are then combined to create λ vs. PII curves for the phenotype cluster (FIG. 48C). A clinical trial protocol on the virtual patient cohort typically is simulated to generate a series of PII vs. time curves, one curve per patient (FIG. 48B). The PII outputs will vary with time, as they reflect the changing plaque characteristics of each virtual patient in the cohort. Using the hazard function curve, the PII vs. time curves are translated to λ vs. PII curves (FIG. 48C) for every point in time over the real and simulated trial period. This relationship can be made based on the fact that both PII and λ are functions of both time and the covariates that define the phenotype cluster. Since there is a cohort of virtual patients for each phenotype, there will be a range of possible PII values for each value of λ in time.

Finally, the process is repeated for the remaining phenotype clusters and the graphs are combined (FIG. 48D). Three different phenotypes, each represented by a virtual patient cohort, are shown in this figure on the same plot. Each phenotype exhibits a different λ vs. PII range.

The process outlined above will generate an envelope of many possible λ-PII relationships whose width is a result of using multiple virtual patients to represent competing mechanistic hypotheses for each phenotype cluster. However, within the framework of the current platform, the net effects of all metabolic and inflammatory risk factors on cardiovascular risk are embodied within the PII. Therefore, a single λ-PII relationship should be appropriate for representing a patient subpopulation.

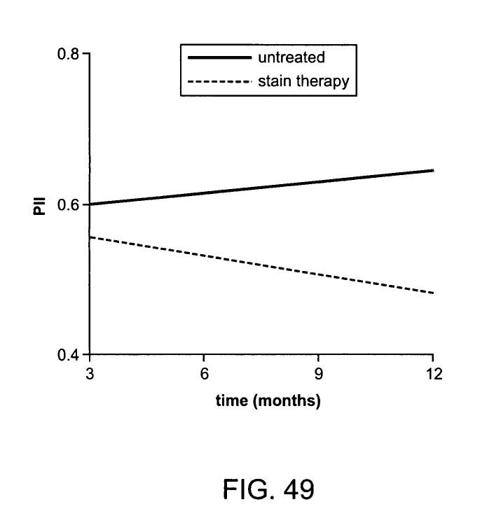

This approach to selecting a single λ-PII curve within this envelope recognizes that any one λ-PII curve has a corresponding virtual population (at least one prevalence-weighted virtual patient representing each phenotype) whose individual virtual patients lay along that curve (FIG. 49). Each λ-PII curve/virtual population pairing within the envelope of possible λ-PII curves can be thought of as a population-level hypothesis of the mechanistic diversity within the population and how that diversity gives rise to varying cardiovascular risk in a manner consistent with clinical data. In one implementation of the invention, clinical trial simulations can utilize multiple λ-PII curve/virtual population pairings for the evaluation of biomarker patterns.

A comparison of the PII as a function of time for a reference virtual patient having two or three risk factors for atherosclerosis in the untreated state and treated with statin therapy is shown in FIG. 49. FIG. 49 illustrates the variation of the plaque instability index (PII) over time in a reference virtual patient for untreated progression and statin therapy. In this experiment, material properties of the plaque and blood pressure were considered to be constant. The PII varies as plaque geometry changes over time, and statin therapy over one year results in a decrease in the PII compared to untreated progression. Increasing PII corresponds to an increase in shoulder stress, while decreasing PII corresponds to a decrease in maximum shoulder stress. The one-year experiment demonstrates how lipid lowering under statin therapy translates into changes in plaque geometry, and hence, a change in the PII over time.

The value of λ any point in time is determined by the relationship between λ and PII derived as discussed above. In the exemplary Effect Diagram provided in FIG. 45, the representation of λ as a function of PII has been integrated into the computer model as a function node (“CV risk”). For a given virtual patient, the plaque characteristics will change over time as conditions such as inflammation change. Accordingly, PII will vary over time, as will the associated λ. In this way, the progression or regression of a plaque will be captured by the PII value, and reflected in the instantaneous risk of a cardiovascular event.

In an exemplary implementation, two state nodes are used to represent the condition of not having a cardiovascular event (“no CV event”) and of having a cardiovascular event (“CV event”). The goal of the module is to track the probability of a cardiovascular event over time, i.e., to determine the probability of moving from the “no CV event” state to the “CV event” state. This probability is represented at each time step by the instantaneous value of λ, which is the risk that an event will occur in the next time interval. Integrating λ over time enables computation of the probability that an event will occur over time. The hazard function relates only to the probability of moving from the “no CV event” state to the “CV event”, since once a cardiovascular event has occurred, there is no possibility of moving back to the “no CV event” state.

Validation of the cardiovascular risk module can be performed using data from a different clinical trial containing similar patient phenotypes, and comparing the hazard functions from the model of atherosclerosis to those generated by similar proportional hazards regression of the clinical trial cardiovascular event data.

E. Simulating Atherosclerosis

The invention also provides methods and systems for simulating atherosclerosis. The system of the invention comprises: a) a computer-executable data editor, capable of accepting data describing a subject; b) a computer-executable integrator, capable of executing a computer model of atherosclerosis with the data to generate a set of outputs describing the result of the simulation of atherosclerosis; and c) a computer-executable report generator capable of reporting the set of outputs. The computer model comprises: i) a cholesterol metabolism module; ii) an atherogenesis module; and iii) a plaque stability module. Methods of simulating atherosclerosis comprise executing the models of the invention, optionally in conjunction with a virtual stimulus.

Methods of simulating induction of atherosclerosis can comprise applying a virtual protocol to the computer model to generate a set of outputs to represent a phenotype of the biological system. The phenotype can represent a normal state or a disease state. In certain implementations, the methods can further include accepting user input specifying one or more parameters or variables associated with one or more mathematical representations prior to executing the computer model. Preferably, the user input comprises a definition of a virtual patient or a definition of the virtual protocol, such as administration of a therapy.

Running the computer model produces a set of outputs for a biological system represented by the computer model. The set of outputs can represent one or more phenotypes of the biological system, i.e., the simulated subject, and includes values or other indicia associated with variables and parameters at a particular time and for a particular execution scenario. For example, a phenotype is represented by values at a particular time. The behavior of the variables is simulated by, for example, numerical or analytical integration of one or more mathematical relations to produce values for the variables at various times and hence the evolution of the phenotype over time. The level of detail of the output can vary dependent upon the level of sophistication of the target user. Exemplary outputs can range from an exhaustive report including all parameters of the computer model to a simple indicator of likelihood of a cardiovascular event during a set period of time. Additional clinically relevant outputs include therapeutic effects on circulating lipids and plaque progression, as measured by IMT.

The computer executable software code numerically solves the mathematical equations of the model(s) under various simulated experimental conditions. Furthermore, the computer executable software code can facilitate visualization and manipulation of the model equations and their associated parameters to simulate different patients subject to a variety of stimuli. See, e.g., U.S. Pat. No. 6,078,739, entitled “Managing objects and parameter values associated with the objects within a simulation model,” the disclosure of which is incorporated herein by reference. Thus, the computer model(s) can be used to rapidly test hypotheses and investigate potential drug targets or therapeutic strategies.

In one implementation, the computer model can represent a normal state as well as a disease (e.g., plaque rupture or large plaque) state of a biological system. For example, the computer model includes parameters that are altered to simulate a disease state or a progression towards the disease state. The parameter changes to represent a disease state are typically modifications of the underlying biological processes involved in the disease state, for example, to represent the genetic or environmental effects of a condition on the underlying physiology. By selecting and altering one or more parameters, a user modifies a normal state and induces a phenotype of interest. In one implementation, selecting or altering one or more parameters is performed automatically.

In the present implementation of the invention, various mathematical relations of the computer model, along with a modification defined by the virtual stimulus, can be solved numerically by a computer using standard algorithms to produce values of variables at one or more times based on the modification. Such values of the variables can, in turn, be used to produce the first set of results of the first set of virtual measurements. Typically, the virtual stimulus is a representation of administration of a therapy.

One or more virtual patients in conjunction with the computer model can be created based on an initial virtual patient that is associated with initial parameter values. A different virtual patient can be created based on the initial virtual patient by introducing a modification to the initial virtual patient. Such modification can include, for example, a parametric change (e.g., altering or specifying one or more initial parameter values), altering or specifying behavior of one or more variables, altering or specifying one or more functions representing interactions among variables, or a combination thereof. For instance, once the initial virtual patient is defined, other virtual patients, e.g., patients possessing certain risk factors for developing atherosclerosis, may be created based on the initial virtual patient by starting with the initial parameter values and altering one or more of the initial parameter values. Alternative parameter values can be defined as, for example, disclosed in U.S. Pat. No. 6,078,739. These alternative parameter values can be grouped into different sets of parameter values that can be used to define different virtual patients of the computer model. For certain applications, the initial virtual patient itself can be created based on another virtual patient (e.g., a different initial virtual patient) in a manner as discussed above.

In the context of one implementation of the invention, three exemplary virtual patients were developed: a healthy reference patient, a reference patient with two to three general risk factors for atherosclerosis, and a reference patient heterozygous for the familial hypercholesterolemia gene.

The computer model of the invention can be used to explore patient variability and biological uncertainty. Two new virtual patients were created as perturbations of the reference virtual patient with two to three risk factors, to explore some of the variability associated with the Michaelis-Menten data for CRP, which has multiple effects throughout the inflammatory network (as shown in Example 1). The new virtual patients, A and B, are designed with different magnitudes of CRP effect on SMC apoptosis and proliferation; however, their IMT growth rates are similar to those of the reference virtual patient over a ten year span. Despite this high-level of clinical similarity, the plaque progression in the reference patient, patient-A, and patient-B following an acute inflammatory challenge is predicted to be significantly different, illustrating that changes in the underlying biology not detectable in the clinic can have major effects on response to insult or intervention.

A simulation of atherosclerosis using the model of the invention predicts that as ACAT-1 inhibition in the reference virtual patient with two or three risk factors for atherosclerosis is increased from 0% to 100%, death of foam cells and macrophages increases, resulting in progressive increases in the size of the lipid core and increased rate of intimal growth. 80% ACAT-1 inhibition in macrophages and foam cells resulted in a 5.5× greater change in lipid core cross-sectional area relative to the untreated case. A 2.5-4.3× increase is reported in clinical trials, where the percent inhibition of ACAT-1 is not quantified. The simulated prediction thus exhibits the expected trend from the literature.

Alternatively, or in conjunction, one or more virtual patients in the computer model can be created based on an initial virtual patient using linked simulation operations as, for example, disclosed in the following publication: “Method and Apparatus for Conducting Linked Simulation Operations Utilizing A Computer-Based System Model”, (U.S. Application Publication No. 20010032068, published on Oct. 18, 2001). This publication discloses a method for performing additional simulation operations based on an initial simulation operation where, for example, a modification to the initial simulation operation at one or more times is introduced. In the present embodiment of the invention, such additional simulation operations can be used to create additional virtual patients in the computer model based on an initial virtual patient that is created using the initial simulation operation. In particular, a virtual patient can be customized to represent a particular subject. If desired, one or more simulation operations may be performed for a time sufficient to create one or more “stable” virtual patient of the computer model. Typically, a “stable” virtual patient is characterized by one or more variables under or substantially approaching equilibrium or steady-state condition.

Various virtual patients of the computer model can represent variations of the biological system that are sufficiently different to evaluate the effect of such variations on how the biological system responds to a given scenario. In particular, one or more biological processes represented by the computer model can be identified as playing a significant role in modulating biological response to a therapy, and various virtual patients can be defined to represent different modifications of the one or more biological processes. The identification of the one or more biological processes can be based on, for example, experimental or clinical data, scientific literature, results of a computer model, or a combination thereof. Once the one or more biological processes at issue have been identified, various virtual patients can be created by defining different modifications to one or more mathematical relations included in the computer model, which one or more mathematical relations represent the one or more biological processes. A modification to a mathematical relation can include, for example, a parametric change (e.g., altering or specifying one or more parameter values associated with the mathematical relation), altering or specifying behavior of one or more variables associated with the mathematical relation, altering or specifying one or more functions associated with the mathematical relation, or a combination of them. The computer model may be run based on a particular modification for a time sufficient to create a “stable” configuration of the computer model.

In certain implementations, the model of atherosclerosis is executed while applying a virtual stimulus or protocol representing, e.g., a change in diet. A virtual stimulus can be associated with a stimulus or perturbation that can be applied to a biological system. Different virtual stimuli can be associated with stimuli that differ in some manner from one another. Stimuli that can be applied to a biological system can include, for example, existing or hypothesized therapeutic agents, treatment regimens, and medical tests. Additional examples of stimuli include exercise and diet. Further examples of stimuli include environmental changes such as those relating to changes in level of exposure to an environmental agent.

A virtual protocol, e.g., a virtual therapy, representing an actual therapy can be applied to a virtual patient in an attempt to predict how a real-world equivalent of the virtual patient would respond to the therapy. Virtual protocols that can be applied to a biological system can include, for example, existing or hypothesized therapeutic agents and treatment regimens, mere passage of time, exposure to environmental toxins, increased exercise and the like. By applying a virtual protocol to a virtual patient, a set of results of the virtual protocol can be produced, which can be indicative of various effects of a therapy.

For certain applications, a virtual protocol can be created, for example, by defining a modification to one or more mathematical relations included in a model, which one or more mathematical relations can represent one or more biological processes affected by a condition or effect associated with the virtual protocol. A virtual protocol can define a modification that is to be introduced statically, dynamically, or a combination thereof, depending on the particular conditions and/or effects associated with the virtual protocol.

This invention can include a single computer model that serves a number of purposes. Alternatively, this layer can include a set of large-scale computer models covering a broad range of physiological systems. In addition to including a model of atherosclerosis, the system can include complementary computer models, such as, for example, epidemiological computer models. For use in healthcare, computer models can be designed to analyze a large number of subjects and chemicals. In some instances, the computer models can be used to create a large number of validated virtual patients and to simulate their responses to a large number of chemicals.

The invention and all of the functional operations described in this specification can be implemented in digital electronic circuitry, or in computer software, firmware, or hardware, including the structural means disclosed in this specification and structural equivalents thereof, or in combinations of them. The invention can be implemented as one or more computer program products, i.e., one or more computer programs tangibly embodied in an information carrier, e.g., in a machine readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the invention, can be performed by one or more programmable processors executing one or more computer programs to perform functions of the invention by operating on input data and generating output. The processes and logic flows can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

### V. EXAMPLES

### A. Example 1

### Regulators of Smooth Muscle Cell Proliferation

An example of Michaelis-Menten parameters for a representative regulator and the structure implemented for dynamic computation of mediator production and signal integration are provided in Table 2 and FIGS. 42, 43B and 43C. Table 1 provides data for Michaelis-Menten parameters characterizing the effects of specific inflammatory mediators on vascular SMC proliferation. Kₘ and Vₘₐₓ parameters were determined from in vitro dose-response data according to standard methods in the art. Hill coefficients were determined by curve fit of Michaelis-Menten equation with associated Kₘ and Vₘₐₓ to reported dose-response data.

TABLE 2
Regulators of vascular smooth muscle cell proliferation

| | | Hill | Kₘ | |
|---|---|---|---|---|
| mediator | effect | coefficient | (ng/mL) | Vₘₐₓ |
| IFN-γ | inhibitor | 1.94 | 8.18 | 0.5553 |
| IL-1 | potentiator | 0.72 | 0.002 | 2.5229 |
| MCP-1 | stimulator | 0.69 | 0.005 | 0.8361 |
| PDGF | stimulator | 7.78 | 1.09 | 1.8707 |
| PGD2 | inhibitor | 1.00 | 0.032 | 0.6000 |
| TGF-β | inhibitor | 1.00 | 0.06 | 0.3622 |
| TNF-α | stimulator | 0.80 | 0.10 | 0.5925 |

FIG. 42 provides an example of architecture for production of inflammatory mediators within the atherogenesis module. Changes in effector cell populations of the represented cell types drive the production of each mediator. Differential production in the cap and shoulder regions of the plaque is determined based upon the spatial distribution of cell populations. FIGS. 43B and 43C provide examples of regulators that can be included in the atherogenesis module. The regulatory nodes dynamically integrate the signals from the various inflammatory mediators as their concentration within the cap and shoulder of the plaque change over time, due to varying cell populations and the regions' volume. Dynamic signal integration is based upon data reporting cell-receptor binding kinetics of each mediator to each cell type.

### B. Example 2

### Method for Developing a Computer Model for Cholesterol Metabolism Based Particle Number and Lipid Content

The key equations that define the models described herein are those that calculate the net CE flux and net TG flux for each lipoprotein particle class. The net CE and TG fluxes can then be used to determine the dynamic changes in lipoprotein particle composition and particle number that can occur within each size class. An explanation of the variables used in the equations is shown below:

1. Indices and Subscripts

Index i covers apoB-100 particles (5 classes): VLDL-1, VLDL-2, IDL, LDL-L, and LDL-S (index increases with decreasing particle size)

Index j covers HDL particles (2 classes): HDL1, HDL2 (index increases with decreasing particle size)

CE: Cholesterol Ester

TG: Triglycerides

### Variables

Nᵢ: number of particles in class i

SAᵢ: Surface area of particle in class i

CEᵢ: average CE content of particle in class i

CEᵢ^{syn}: CE content of newly synthesized particle in class i

TGᵢ: average TG content of particle in class i

Rᵢ: CETP exchange molar ratio for class i

C. Scalars

synᵢ: synthesis rate for particles of class i

catabᵢ: catabolism rate for particles of class i

Vᵢ: specified volume for particles of class i

d_{CE}: density of CE

d_{TG}: density of TG

M_{CE}: molar mass of CE

M_{TG}: molar mass of TG

A: Scalar for hepatic flux from particle class i

B: Scalar for peripheral flux from particle class i

C: Scalar for CETP-mediated flux from particle class i to particle class j

W1-W10: Weighting exponent

2. Calculation of Net CE Flux and Net TG Flux Based on Enzymatic and Receptor-Mediated Actions for Each Particle Class

An example of the flux equations for apoB-100 particles are shown below:

Hepatic CE Flux via SR-B1 per particle class i

(Hᵢ^{CE})=Aᵢ^{CE}*nᵢ*(SAᵢ^{W1}*CEᵢ^{W2})

Peripheral CE Flux via SR-B1 per particle class i

(Pᵢ^{CE})=Bᵢ^{CE}*nᵢ*(SAᵢ^{W3}*CEᵢ^{W4})

CE Flux from particle class i to j via CETP

(Fᵢⱼ^{CE})=Cᵢⱼ^{CE}*TGᵢ^{W5}*(nᵢ*SAᵢ)^{W6}

CE Flux from particle class i to j via CETP

$$( {F}_{ij}^{TG} ) = \frac{{F}_{ij}^{CE}}{{R}_{i}^{*} \frac{{M}^{CE}}{{M}^{TG}}}$$

Hepatic TG Flux via HL per particle class i

(Hᵢ^{TG})=Aᵢ^{TG}*nᵢ*(SAᵢ^{W7}*TGᵢ^{W8})

Peripheral TG Flux via LPL per particle class i

(Pᵢ^{TG})=Aᵢ^{TG}*nᵢ*(SAᵢ^{W9}*TGᵢ^{W10})

Net CE Flux per particle class i

Fₙₑₜ_{ᵢ}^{CE}=−Hᵢ^{CE}−Pᵢ^{CE}+ΣⱼFᵢⱼ^{CE}

Net TG Flux per particle class i

Fₙₑₜ_{ᵢ}^{TG}=−Hᵢ^{TG}−Pᵢ^{TG}−ΣⱼFᵢⱼ^{TG}

Flux equations for HDL particles are not provided, because they are similar to the equations used for the apoB-100 particles.

3. Calculation of Remodeling and Reclassification Terms for Each Particle Class Based on the Fluxes and Constraints of Each Particle Class Being Defined as Constant Volume

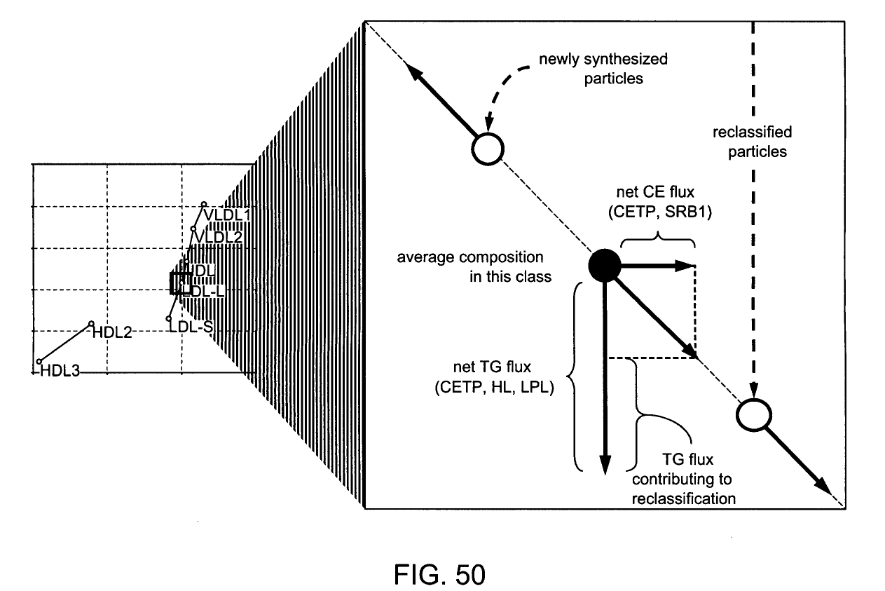

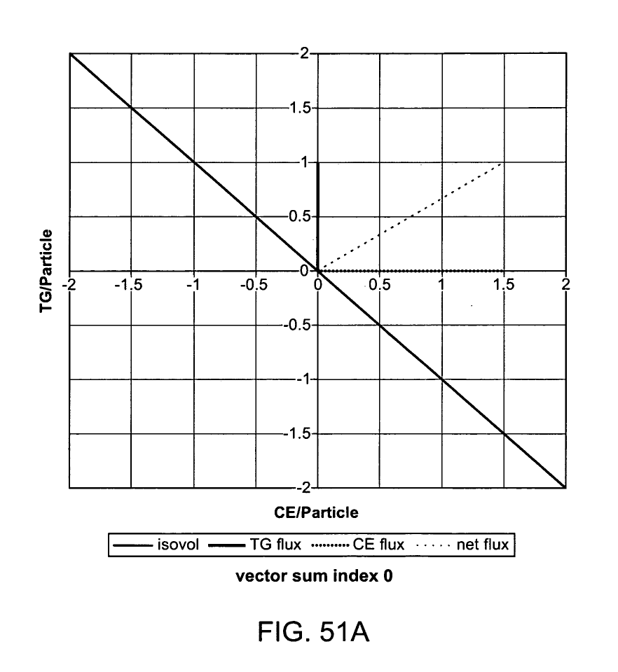

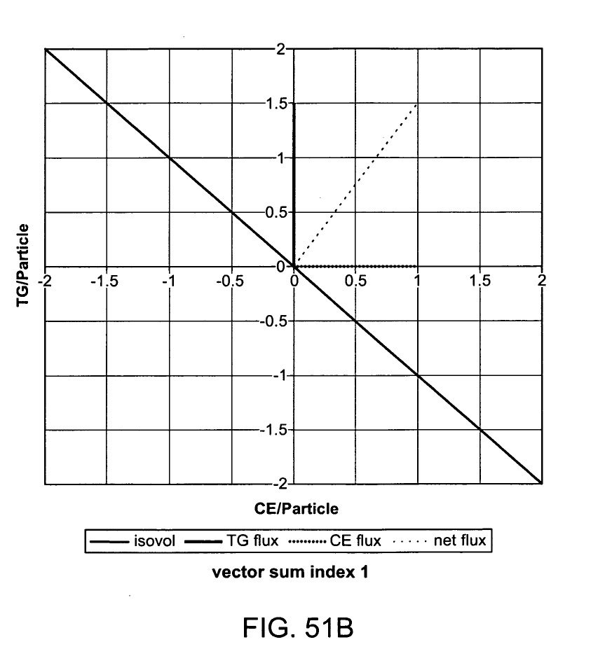

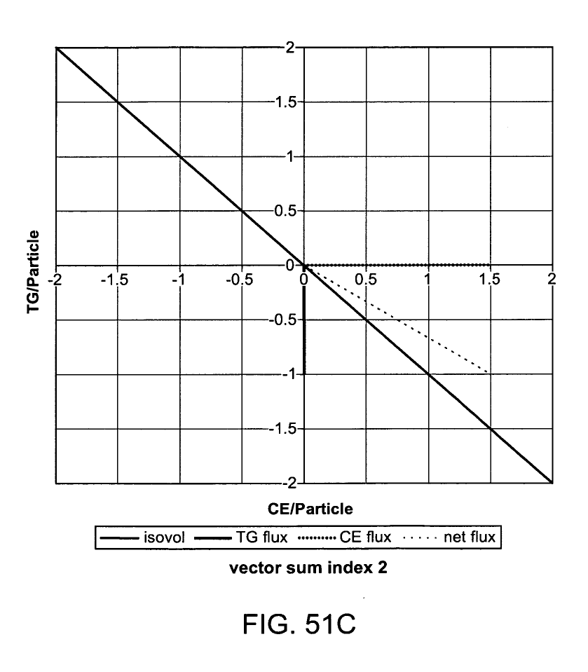

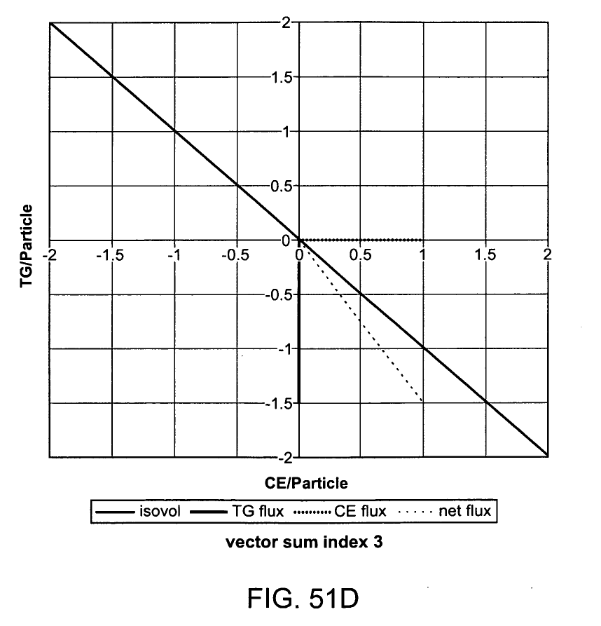

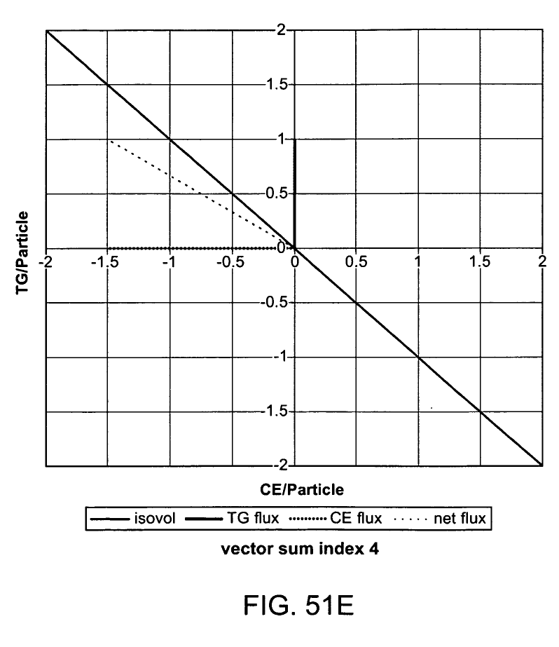

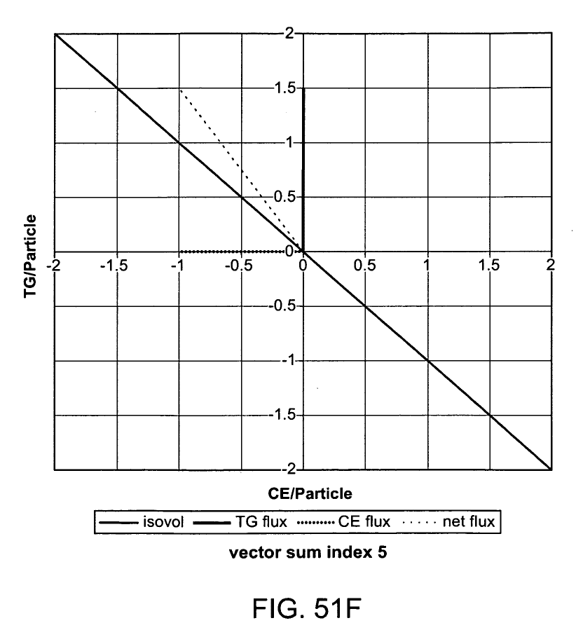

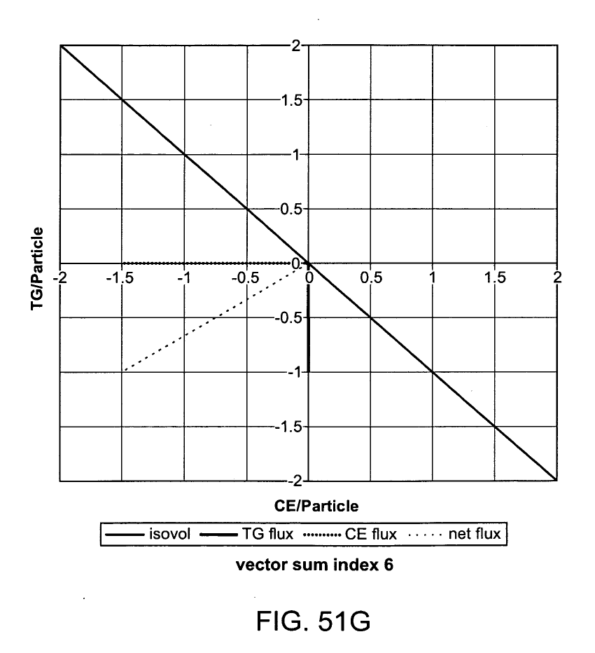

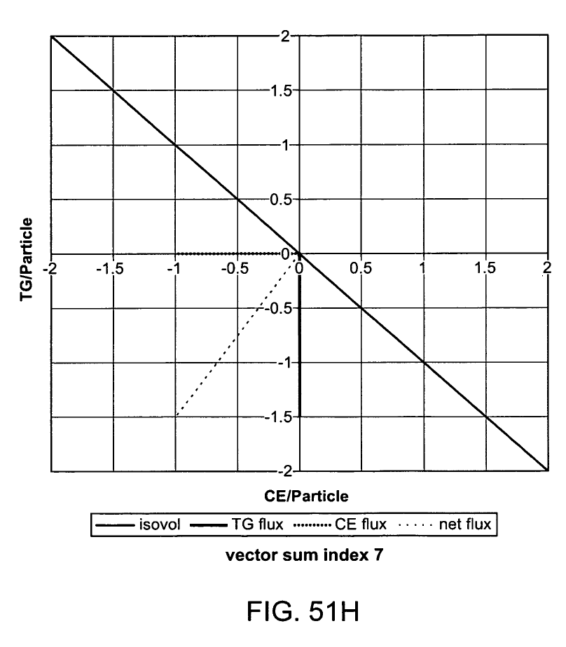

As depicted in FIG. 50 and FIGS. 51A-H, the net CE flux and net TG flux can be combined in a vector sum to determine the net effect of the underlying enzymatic and receptor-mediated actions on each particle class. Since each particle class is defined by physical size, the composition of a particle class is constrained to lie along an iso-volume contour depicted within TG-CE space as a diagonal line whose slope is determined by the relative densities of TG and CE. In the diagram shown, the vector sum of the two net fluxes leads to two distinct terms: a remodeling term which is along the iso-volume contour (in this case, increased CE and decreased TG for a net movement of right and down), with a reclassification term (in this case, negative TG flux for a reclassification of particles from this particle class to a smaller particle class along an iso-CE contour).

FIG. 50 depicts only one of 8 possible configurations of the vector sum of the net TG and CE fluxes. Table 3 below lists all possible configurations of the vector sum resulting from different signs and relative magnitudes of the fluxes:

TABLE 3

| vector sumindex | Fₙₑₜ_{ᵢ}^{CE} | Fₙₑₜ_{ᵢ}^{TG} | $\frac{\vert {F}_{{net}_{i}}^{CE} \vert}{{d}_{CE}} - \frac{\vert {F}_{{net}_{i}}^{TG} \vert}{{d}_{TG}}$ | condition | reclassdirection |
|---|---|---|---|---|---|
| 0 | + | + | + | diag | up |
| 1 | + | + | − | diag | up |
| 2 | + | − | + | isoTG | up |
| 3 | + | − | − | isoCE | down |
| 4 | − | + | + | isoTG | down |
| 5 | − | + | − | isoCE | up |
| 6 | − | − | + | diag | down |
| 7 | − | − | − | diag | down |

FIG. 50 is an example of vector sum index tree. Vector diagrams for all eight vector sum indices are shown in FIGS. 51A-51H.

Each of the eight vector sum indices in Table 1 results in a different set of conditions that define the equations for the four terms needed to calculate the dynamics of particle reclassification and remodeling. Descriptions of the three conditions that define the equations are shown below:

isoTG: reclassification results from an excess of net CE flux relative to the net TG flux for the iso-volume constraint. As a result, the particle is reclassified in smaller or larger class with the same TG content as the original particle.

isoCE: reclassification results from an excess of net TG flux relative to the net CE flux for the iso-volume constraint. As a result, the particle is reclassified in smaller or larger class with the same CE content as the original particle.

diag: reclassification results from either both net fluxes being positive (particle reclassified in larger class) or both net fluxes being negative (particle reclassified in smaller class).

Definitions for the terms used in the equations are as follows:

reclassᵢ^{down} rate at which particles are reclassified into a smaller particle class

reclassᵢ^{up} rate at which particles are reclassified into a larger particle class

CEᵢ^{reclass} CE composition of particles upon reclassification

remodelᵢ rate of change of average CE content for a particle class

Equations for the terms and conditions resulting from the vector sum indices are shown below in Table 2.

TABLE 4

| | Condition | | |
|---|---|---|---|
| Term | isoCE | isoTG | diag |
| reclassᵢ^{down} | $\frac{\frac{\vert {F}_{{net}_{i}}^{TG} \vert}{{d}_{TG}} - \frac{\vert {F}_{{net}_{i}}^{CE} \vert}{{d}_{CE}}}{{V}_{i} - {V}_{i + 1}}$ | $\frac{\frac{\vert {F}_{{net}_{i}}^{CE} \vert}{{d}_{CE}} - \frac{\vert {F}_{{net}_{i}}^{TG} \vert}{{d}_{TG}}}{{V}_{i} - {V}_{i - 1}}$ | $\frac{- ( \frac{{F}_{{net}_{i}}^{CE}}{{d}_{CE}} + \frac{{F}_{{net}_{i}}^{TG}}{{d}_{TG}} )}{{V}_{i} - {V}_{i + 1}}$ |
| reclassᵢ^{up} | $\frac{\frac{\vert {F}_{{net}_{i}}^{TG} \vert}{{d}_{TG}} - \frac{\vert {F}_{{net}_{i}}^{CE} \vert}{{d}_{CE}}}{{V}_{i - 1} - {V}_{i}}$ | $\frac{\frac{\vert {F}_{{net}_{i}}^{CE} \vert}{{d}_{CE}} - \frac{\vert {F}_{{net}_{i}}^{TG} \vert}{{d}_{TG}}}{{V}_{i - 1} - {V}_{i}}$ | $\frac{\frac{{F}_{{net}_{i}}^{CE}}{{d}_{CE}} + \frac{{F}_{{net}_{i}}^{TG}}{{d}_{TG}}}{{V}_{i - 1} - {V}_{i}}$ |
| CEᵢ^{reclass} | CEᵢ | $for reclass down : \\ {d}_{CE} ( {V}_{i + 1} - \frac{{TG}_{i}}{{d}_{TG}} )$ | $for reclass down : \\ {CE}_{i} - \frac{{F}_{{net}_{i}}^{CE} {d}_{CE} {d}_{TG} ( {V}_{i} - {V}_{i + 1} )}{{F}_{{net}_{i}}^{CE} {d}_{TG} + {F}_{{net}_{i}}^{TG} {d}_{CE}}$ |
| | | $for reclass up : \\ {d}_{CE} ( {V}_{i - 1} - \frac{{TG}_{i}}{{d}_{TG}} )$ | $for reclass up : \\ {CE}_{i} + \frac{{F}_{{net}_{i}}^{CE} {d}_{CE} {d}_{TG} ( {V}_{i - 1} - {V}_{i} )}{{F}_{{net}_{i}}^{CE} {d}_{TG} + {F}_{{net}_{i}}^{TG} {d}_{CE}}$ |
| remodelᵢ | $\frac{{F}_{{net}_{i}}^{CE}}{{N}_{i}}$ | $\frac{- {d}_{CE} ( \frac{{F}_{{net}_{i}}^{TG}}{{d}_{TG}} )}{{N}_{i}}$ | 0 |

4. Calculation of Final Remodeling (CE/Particle) and Reclassification (Number of Particles Per Class) Rates

The equations shown in Table 4 can be combined to provide a final equation that calculates the reclassification rate:

$$\frac{d {N}_{i}}{d t} = {syn}_{i} - {catab}_{i} + {reclass}_{i - 1}^{down} + {reclass}_{i + 1}^{up} - {reclass}_{i}^{down} - {reclass}_{i}^{up}$$

and a final equation that calculates the remodeling rate:

$$\frac{d {CE}_{i}}{d t} = \frac{{syn}_{i} ( {CE}_{i}^{syn} - {CE}_{i} )}{{N}_{i}} + \frac{{reclass}_{i - 1}^{down} ( {CE}_{i - 1}^{reclass} - {CE}_{i} )}{{N}_{i}} + \frac{{reclass}_{i + 1}^{up} ( {CE}_{i + 1}^{reclass} - {CE}_{i} )}{{N}_{i}} + {remodel}_{i}$$

### C. Example 3

### Computer Simulated Lipoprotein Profiles of Virtual Patients Treated with HMG-CoA Reductase Inhibition Therapy

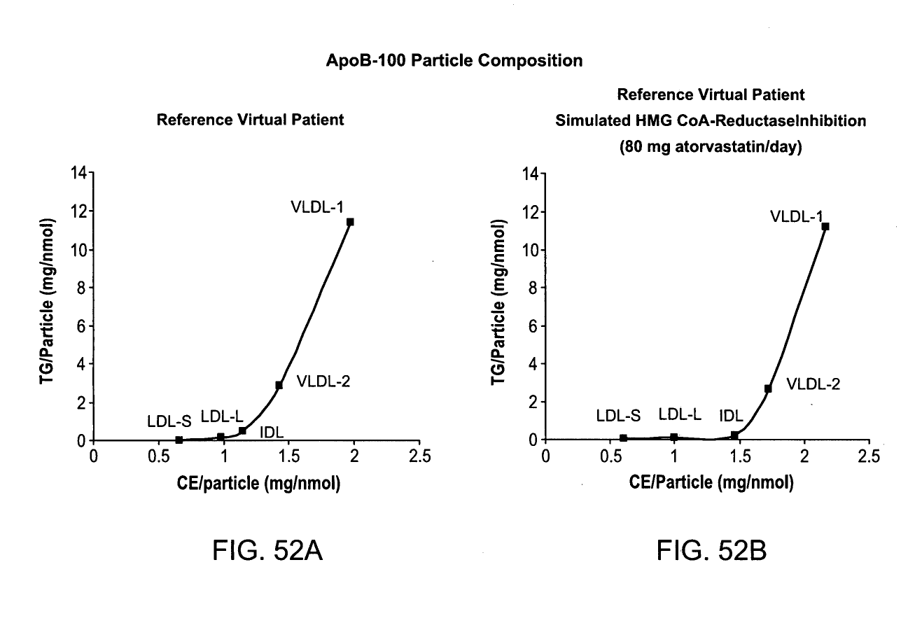

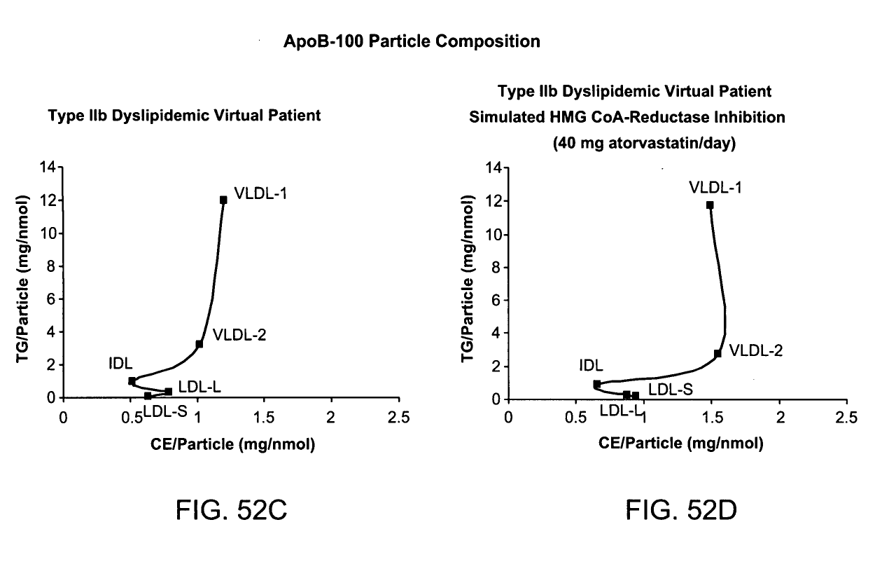

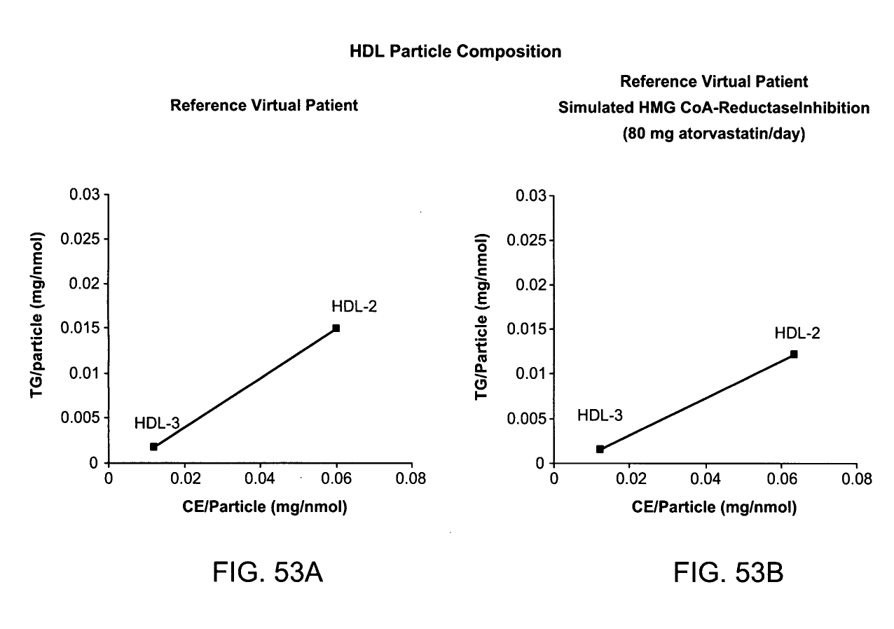

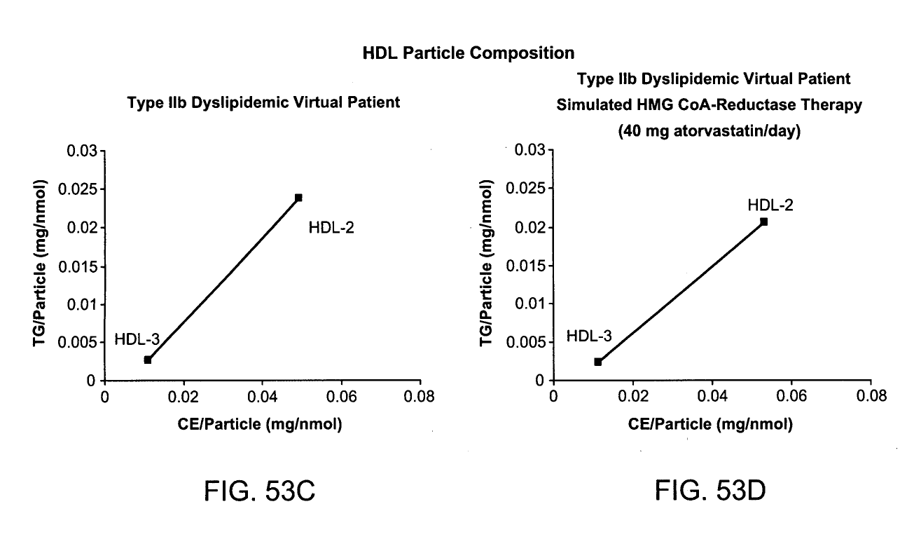

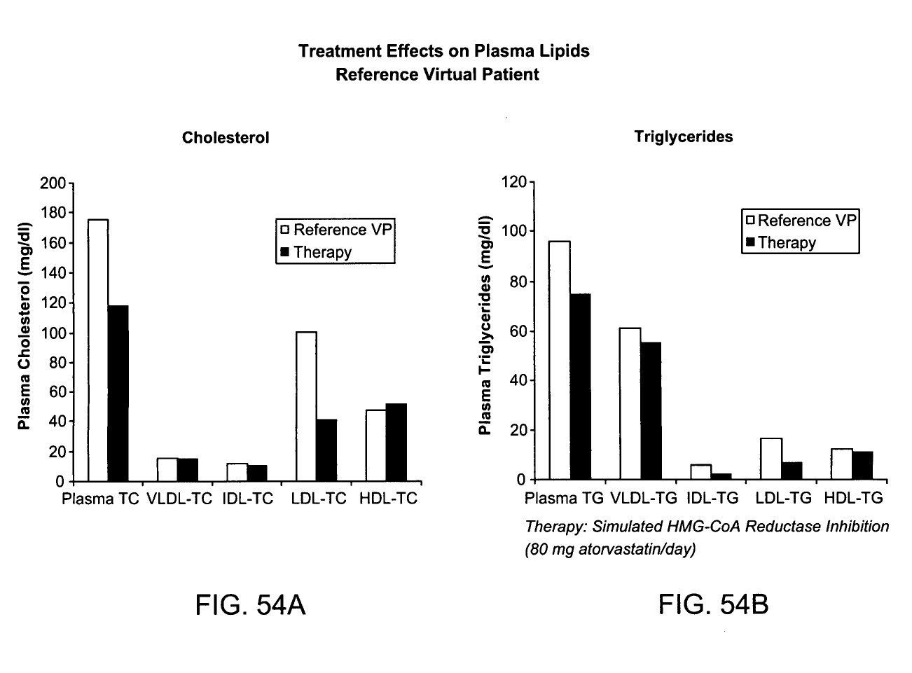

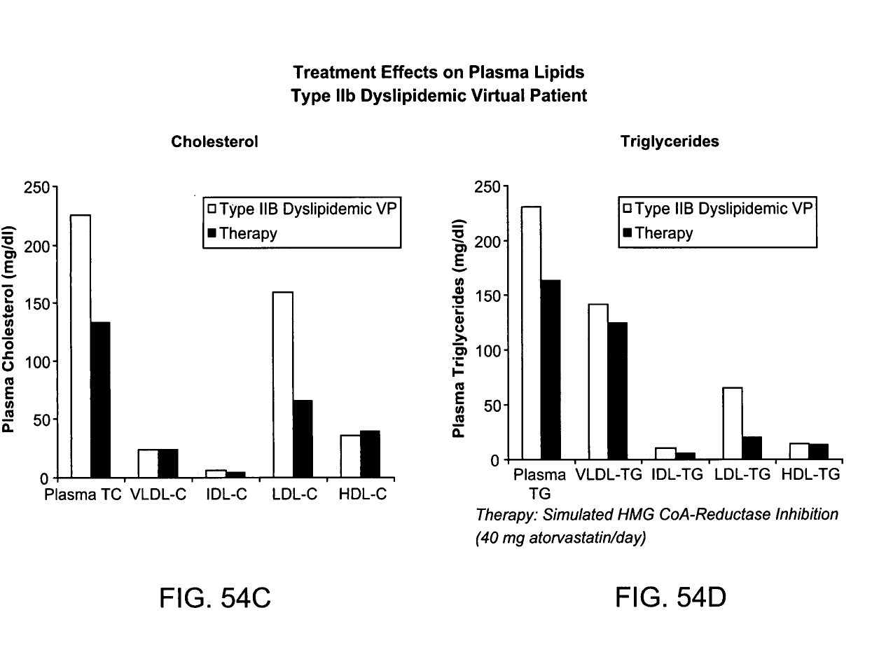

As shown in FIG. 13A, the CE and TG content of each particle class can be computed and plotted at each time point during a simulation to provide real-time insight into the change of a virtual patient's lipoprotein profile during a treatment regimen. A reference virtual patient's baseline (equilibrium) lipoprotein profile and that exhibited after a typical HMG-CoA Reductase inhibition therapy are shown in FIGS. 52A-52B and 53A-53B. FIGS. 54A and 54B depict the reference virtual patient's baseline plasma lipid profile and that exhibited after a typical HMG-CoA Reductase inhibition therapy.

The direct effect of a typical atorvastatin (HMG CoA reductase inhibition) therapy on the Reference Virtual Patient is a reduction in hepatic cholesterol stores. Two independent feedback loops respond to this reduction, resulting in: 1) a decrease in the number of apoB-100 particles synthesized (see FIG. 8A); and 2) an increase in hepatic catabolism of apoB-100 particles due to upregulation of LDL-R (see FIG. 11D). The combination of these two responses causes both a net reduction in the total number of apoB-100 particles circulating in the plasma and a concomitant reduction in plasma total cholesterol (FIG. 54A). The simulation predicts that the LDL classes exhibit the most significant reduction in particle number; hence, LDL-C is also greatly reduced (FIG. 54A). No feedback response to the simulated therapy significantly affects steady-state apoB-100 TG/particle; hence, the reduction in total apoB-100 particle number reduces total plasma TG as well (FIG. 54B). The therapy-induced changes to apoB-100 particle synthesis also result in modified apoB-100 and HDL particle compositions. For example, the simulated therapy causes a shift of the lipoprotein TG/CE content curve to the right, reflecting increases in steady-state average CE/particle for the LDL-L, IDL, VLDL-2, and VLDL-1 particle classes post-treatment (FIGS. 52A-B). This behavior can be explained by a reduced contribution of newly-synthesized particles, which contain low CE/particle, to the new equilibrium condition under therapy (see vector math equations). Furthermore, fewer plasma apoB-100 particles necessitate a reduction in CETP-mediated TG flux from apoB-100 particles into HDL-2 particles. This is reflected in the reduced TG/particle observed in HDL-2 after simulated therapy (FIGS. 53A-B).

Similarly, the baseline lipoprotein profile and plasma lipid profile can be modeled for a type IIb dyslipidemic virtual patient. The type IIb dyslipidemic virtual patient baseline (equilibrium) lipoprotein profile and that exhibited after a typical HMG-CoA Reductase inhibition therapy are shown in FIGS. 52C-52D and 53C-53D. FIGS. 54C and 54D depict the type IIb dyslipidemic virtual patient baseline plasma lipid profile and that exhibited after a typical HMG-CoA Reductase inhibition therapy.

The qualitative response of the Type IIb Dyslipidemic Virtual Patient to simulated 40 mg/day atorvastatin therapy is similar to that observed for the Reference Virtual Patient on atorvastatin. apoB-100 particles increase in steady-state average CE/particle, resulting in a shift of the TG/CE content curve to the right (FIGS. 52C-D). HDL-2 particles exhibit a reduction in TG/particle (FIGS. 53C-D). Finally, plasma TC, LDL-C, plasma TG, and LDL-TG are markedly reduced as a result of the mechanisms discussed above.

What is claimed is:

1. A computer model of atherosclerosis comprising
a) a cholesterol metabolism module;
b) an atherogenesis module; and
c) a plaque stability module.

2. The computer model of claim 1, further comprising a cardiovascular risk module.

3. The computer model of claim 2, wherein the cardiovascular risk module comprises a representation of plaque rupture.

4. The computer model of claim 2, wherein the cardiovascular risk module comprises a representation of blood vessel occlusion by a plaque.

5. The computer model of claim 2, wherein the cardiovascular risk module comprises a representation of endothelial erosion.

6. The computer model of claim 2, wherein the cardiovascular risk module comprises a representation of intra plaque hemorrhage.

7. The computer model of claim 1, wherein the cholesterol metabolism module comprises a representation of apoB-100 and apoA-I particles.

8. The computer model of claim 1, wherein the atherogenesis module comprises a representation of influx of cholesterol into a vascular intima.

9. The computer model of claim 1, wherein the atherogenesis module comprises a representation of processing of cholesterol in a vascular intima.

10. The computer model of claim 9, wherein the representation of processing of cholesterol in the intima comprises a representation of deposition of cholesterol in extracellular matrix.

11. The computer model of claim 9, wherein the representation of processing of cholesterol in the intima comprises uptake of apoB-100 particles by macrophage or foam cells.

12. The computer model of claim 11, wherein the atherogenesis module further comprises a representation of lipid influx and a representation of lipid efflux.

13. The computer model of claim 1, wherein the atherogenesis module comprises a representation of efflux of cholesterol from a vascular intima.

14. The computer model of claim 1, wherein the atherogenesis module comprises a representation of deposition of cholesterol in the intima.

15. The computer model of claim 1, wherein the atherogenesis module comprises a representation of a plaque.

16. The computer model of claim 15, wherein the representation of the plaque comprises a representation of a plaque cap and a plaque shoulder.

17. A system for simulating atherosclerosis comprising:
a) a computer-executable data editor, capable of accepting data describing a subject;
b) a computer-executable integrator, capable of executing a computer model of atherosclerosis with the data to generate a set of outputs describing the result of the simulation of atherosclerosis, wherein the computer model comprises
i) a cholesterol metabolism module;
ii) an atherogenesis module; and
iii) a plaque stability module; and
c) a computer-executable report generator capable of reporting the set of outputs.

18. The system of claim 17, wherein the computer-executable data editor further is capable of accepting a set of parameters describing a virtual patient.

19. The system of claim 18, wherein the computer-executable integrator further is capable of executing the computer model with the set of parameters describing the subject.

20. The system of claim 17, wherein the computer-executable data editor further is capable of accepting a virtual protocol and the computer-executable integrator is capable of executing the computer model with the virtual protocol.

21. The system of claim 17, wherein the computer model further comprises a cardiovascular risk module.

22. The system of claim 17, wherein the cholesterol metabolism module comprises a representation of apoB-100 and apoA-I particles.

23. The system of claim 17, wherein the atherogenesis module comprises a representation of influx of cholesterol into a vascular intima.

24. The system of claim 17, wherein the atherogenesis module comprises a representation of processing of cholesterol in a vascular intima.

25. A system comprising:
a) a processor including computer-readable instructions stored thereon that, upon execution by a processor, cause the processor to simulate atherosclerosis, the computer readable instructions comprising:
i) a mathematical representation of one or more biological processes associated with cholesterol metabolism, wherein the one or more biological processes comprises synthesis, catabolism or remodeling of apoB-100 particles;
ii) a mathematical representation of one or more biological processes associated with atherogenesis, wherein the one or more biological processes comprises a biological process selected from the group consisting of influx of cholesterol into an intima, processing of cholesterol within the intima, and efflux of cholesterol out of the intima;
iii) a mathematical representation of one or more biological processes associated with plaque progression, wherein the one of more biological processes comprises a biological process selected from the group consisting of dimensions of a cap and shoulder of the plaque, influx of cholesterol into the intima, processing of cholesterol within the intima, and efflux of cholesterol out of the intima;
iv) defining a set of mathematical relationships between the representations of biological processes associated with cholesterol metabolism, atherogenesis and plaque progression;
v) applying a virtual protocol to the set of mathematical relationships to generate a set of outputs;
b) a first user terminal, the first user terminal operable to receive a user input specifying one or more parameters associated with one or more mathematical representations defined by the computer readable instructions; and
c) a second user terminal, the second user terminal operable to provide the set of outputs to a second user.
